(19) United States
(12) Patent Application Publication
(10) Pub. No.: US 2004/0213170 A1
(43) Pub. Date: Oct. 28, 2004

(54) Extended-performance echo-canceled duplex (EP ECD) communication

(76) Inventor: Gordon Bremer, Largo, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/420,204

(22) Filed: Apr. 22, 2003

(51) Int. Cl. H04B 1/44

(52) U.S. Cl. 370/282

(57) ABSTRACT

The preferred embodiments of the present invention generally improve communications capabilities between at least two devices (arbitrarily called local and remote). In the preferred embodiments of the present invention, the signal levels of communication are adjusted in response to a change between and/or among a plurality of modes. The adjusted signal levels affect not only received signal levels, but also received noise levels of echo. Even after echo cancellation is attempted, imperfect echo cancellation leaves residual echo noise. Thus, adjusting signal levels also adjusts noise levels of residual echo noise. This change in signal levels and the resulting change in residual echo noise leads to a change in signal-to-noise ratios in response to the devices changing between and/or among the plurality of modes. The communication system can be changed to maximize performance over the communication channels with specific signal-to-noise ratios that are established during the plurality of modes.

### TECHNICAL FIELD

The present invention generally is related to telecommunications and, more particularly, is related to a system and method for enhancing bi-directional use of communication channel bandwidth.

### BACKGROUND OF THE INVENTION

Communication systems typically use devices to encode information by manipulating physical phenomena. The physical phenomena convey the information from one location to another location by propagating through a communications medium. A non-limiting example of such a communication system is a digital subscriber line system that uses modem devices to encode digital information into signals formed by electromagnetic waves. In many digital subscriber line (DSL) systems, the electromagnetic waves then propagate through a two-wire or single-pair transmission line or communications medium between a customer premise and a central office. Although electromagnetic waves are commonly used in communications due to their propagation speed and other characteristics, other types of non-electromagnetic waves can also be used to carry communication signals.

Communication devices, such as but not limited to modems, may comprise transmitters and/or receivers. In addition, communication devices are often packaged as transceivers, which are capable of both transmitting and receiving information over one or more communications media. Communication systems may be point-to-point with a first device communicating with a second device or multi-point with communication among more than two devices.

Use of Communications Media

Various terms are used to describe communication between two devices and/or among multiple devices. Generally, simplex communication provides uni-directional conveyance of information from a first device to a second device. In contrast, duplex communication provides bi-directional communications between two devices. In full-duplex communications each device of the two devices may simultaneously transmit and receive. In contrast with half-duplex communications, generally at any one time one device may transmit but may not receive, while the other device may receive but may not transmit. When more than two devices are sharing a communication medium, multiplex is the term more commonly used to describe sharing of the communications medium.

Typically, when a communications medium is shared by multiple devices, various multiplexing and/or media access control (MAC) mechanisms are used to facilitate the sharing of the communications medium. Often communication media allow one device to transmit a signal into the media and multiple devices to simultaneously receive the signal from the media. Decisions on which devices may use a communications media can be centralized in one or a small number of devices, or the decisions may be distributed with each device of a plurality of devices executing an instance of a MAC protocol or algorithm to determine access to the media. In addition, these decisions on arbitration for control of the media may be static such that they are generally non-changing. Alternatively, these media access decisions may be dynamic and may change as a result of currently occurring demands for transmission bandwidth.

Because most modem communication systems use electromagnetic signals due to their speed of propagation, at least three parameters or characteristics of electromagnetic waves are used in various duplexing, multiplexing, and/or media access control mechanisms. To prevent electromagnetic waves from interfering with each other and destroying the information carried in the electromagnetic signals, electromagnetic waves are often separated by time, frequency, and/or spatial location. Separating electromagnetic signals by time leads to time-division multiplexing (TDM), time-division duplexing (TDD), and time-division multiple access (TDMA). Also, separating electromagnetic signals by frequency leads to frequency-division multiplexing (FDM), frequency-division duplexing (FDD), and frequency-division multiple access (FDMA). In addition, because the speed of electromagnetic waves in a particular medium generally is equal to their frequency times their wavelength, frequency-division multiplexing generally is analogous to wavelength-division multiplexing (WDM). As is known by one skilled in the art, electromagnetic waves can be separated spatially by using transmission lines, conductors, wave guides, and/or fiber optics as communications media to constrain a large portion of the energy from an electromagnetic signal so that the signal causes less interference on other electromagnetic waves in other media. In addition, wireless electromagnetic signals that are not constrained to a wired medium can be spatially constrained by placing enough distance between transmitters so that the electromagnetic signals are attenuated to the point that they cause less interference on electromagnetic signals from adjacent transmitters. This space division multiplexing has been used in four-wire duplexing, in the space-division switching of old cross-bar central office switches, and in the separation of wireless transmitters for cellular phones and for airwave broadcast television stations.

In addition, communications systems may share a communications medium to provide full-duplex communications by separating electromagnetic signals based on the direction of propagation of the signals. Sharing a communications medium based on the direction of propagation of the signals generally implies that a transmitter and a receiver of a device generally contemporaneously both use the same communications medium in the same frequency range. However, when electromagnetic waves propagating in a first direction in a communications medium encounter an impedance mismatch in the communications medium and/or transmission line, some of the energy of the electromagnetic wave continues in the same first direction while a portion of the energy is reflected back in a direction opposite to the first direction.

Echo

With a single impedance mismatch in a communications medium and/or transmission line, the received signal includes, among other components, a delayed and attenuated version of the transmitted signal that is known as an echo. Generally, echo cancellation involves estimating the echo (e.g., a delayed and/or attenuated version of the transmit signal) based on the originally transmitted signal. Then this estimate is subtracted from the receive signal to reduce, mitigate, or cancel the effect of the echo signal on the receive signal. This simple subtraction of a delayed and attenuated version of the transmit signal performs a simple echo cancellation that generally is based on the communications medium being linear. Linearity is an idealized characteristic of systems theory and communication channels, and the linearity of a channel generally implies that the signal received at a local device is a superposition of the signal transmitted by a remote device and the echo signal from the transmissions of the local device. (In general, the linearity property implies a scaling property and an additivity property.) Actual echo cancellers that have to deal with channel non-linearities are more sophisticated.

With more than a single impedance mismatch in the communications medium and/or transmission line, the problem of echo cancellation becomes more complicated because each impedance mismatch generally causes reflections and echoes of signals. Thus, echo cancellation generally involves subtracting several different echo components from the receive signal. In general, these echo components would include, among other things (inter alia), various versions of the transmit signal at different delays and/or different attenuation levels. Multiple impedance mismatches in a transmission line generally result in first order echo or reflection components of the transmitted signal as well as higher order echo components based on reflections of reflections or echoes of echoes. To estimate these echo components and the proper coefficients for echo cancellation, many echo cancellation solutions involve testing the transmission line during training by generating test patterns and measuring the resulting echo components.

Many communication media and/or transmission lines have impedance mismatches at locations such as, but not limited to, interfaces, junction points, splices, and cable imperfections. Basically, it is economically infeasible to custom engineer and tune all the large number of deployed communication transmission lines because of the costs of the human skill level and equipment needed to remove impedance mismatches from communications media or communication transmission lines. Therefore, the effect of echo or signal reflection is common in communication transmission lines, and engineers have pursued various solutions to the problem of echo. Often this echo effect is mitigated through echo cancellation.

Modulation of Signals to Carry Information

Information generally is encoded in electromagnetic waves using a process of modulation. In general, modulation involves varying the properties of electromagnetic waves to convey information with the varied electromagnetic waves. Some common non-limiting properties of electromagnetic waves that may be manipulated to convey information include the frequency, phase, and amplitude as well as combinations and permutations thereof. Also, varying the frequency and/or phase of an electromagnetic wave often is called angle modulation because both the frequency and phase affect the angle of sinusoidal function components that can be added together to represent most electromagnetic waves. Furthermore, by encoding information using orthogonal codes, code division multiple access (CDMA) provides another method of sharing a communications media among multiple devices.

Common non-limiting examples associated with varying the amplitude of electromagnetic waves are amplitude modulation (AM) of analog broadcast AM radio and amplitude shift keying (ASK) often used in digital communication. The frequency modulation (FM) of analog broadcast FM radio as well as the frequency shift keying (FSK) and the phase shift keying (PSK) of digital communications are common non-limiting examples of varying the frequency, phase, and/or angle of electromagnetic waves.

In digital communications the information to be conveyed is often measured in bits or binary digits, which represent 0 or 1 and are the smallest quanta of information. As is well known in the art, the formalized theory of information generally began with the work of Claude Shannon in C. E. Shannon, “A Mathematical Theory of Communication,” The Bell System Technical Journal, Vol. 27, pp. 379-423, 623-656, July, October 1948, which is incorporated by reference in its entirety herein. Based on Shannon's work, the maximum ability to encode information in a band-limited, additive white Gaussian noise (AWGN) channel generally can be described by the equation C=B log₂ (1+S/N), which generally is known as the Shannon-Hartley capacity theorem. In this basic equation, C is the capacity of the communications channel in bits per second (bps); B is the bandwidth of the channel in hertz (Hz or sec⁻¹); S is the average received signal power or signal level in the same units as N; and N is the average noise power or level in the same units as S. The signal level to noise level ratio (S/N) term is the signal-to-noise ratio of a communications channel and is sometimes represented as SNR. The dimensionless quantity of the ratio of S to N is sometimes listed in decibels (dB). Furthermore, the average power levels generally are related to the square of voltage or current levels.

Also in digital communications, the transmit signal space generally represents each possible signal that may be transmitted. In general, communication is a time-varying process in which sequences of bits or other representations of information are encoded as sequences of symbols with each symbol generally being one selection of a signal point from a signal space. Often the time-varying nature of communications is measured in periods or cycles of the symbol clock. These cycles also are known as symbol clock ticks. Thus, at each symbol clock tick a different signal point selection may result in a different symbol being transmitted and/or received.

Because the minimum quanta of digital information is a bit, codewords are usually strings of bits that are mapped onto signal space to form signal constellations for conveying the binary information contained in the codewords. Thus, the signal space of a communications device generally is a set representing the variations in physical phenomena (such as, but not limited to amplitude, frequency, and/or phase) of electromagnetic waves that may carry information. Often some of the characteristics of a signal space are displayed graphically in signal constellations or signal space diagrams. However, signal constellation or signal space diagrams generally do not display all the characteristics that would completely describe the physical phenomena of the electromagnetic waves that generally are used to carry information. Also, for memory-less communications, each point in a signal space generally is associated with a specific string of bits or other non-binary form of information. Thus, for memory-less communications there generally exists a mapping between specific codewords, strings of bits, or other non-binary form of information and specific signal points. For memory-based communications, the selection of signal point from signal space often depends not only on the specific codeword or string of bits to be communicated, but also on previous and/or future communication of information. Thus, in memory-based communications there may or may not be a fixed mapping between codewords and signal points from a signal space diagram or signal constellation.

The number of points in a signal space need not be a power of two, and need not encode an integer number of codeword bits in each symbol clock tick. For example, see Section 5.4.3 of the V.90 specification that describes a modulus encoder. The V.90 specification is incorporated by reference in its entirety herein. Also, see U.S. Pat. No. 5,103,227, entitled “Modulus Converter for Fractional Rate Encoding”, filed on Sep. 26, 1990, and issued on Apr. 7, 1992 to William L. Betts. U.S. Pat. No. 5,103,227 to Betts is incorporated by reference in its entirety herein. In addition, some of the points in a signal space may directly relate to sending notification of the occurrence of special events in the communications system. These signal points for special events would allow notification of the special events without encoding the notification in the normal signal points that are used for carrying generic information. However, in general the number of signal points in a signal space used to carry generic information is represented by the letter M (for modulus), and is capable of completely encoding the floor of (log₂ M) bits in the transmission of one symbol. The floor (log₂ M) is sometimes written mathematically as └log₂ M┘ and is the largest integer less than or equal to log₂ M. A signal space with M possible signal points is known as an M-ary signal space.

As at least part of transmitting information, a selection of a signal or signal point to be transmitted generally is made based at least upon the use of a mapping that relates the information to be transmitted to at least one signal or signal point in the transmit signal space. When communication is occurring, a symbol is transmitted by selecting a signal point from the signal space generally based at least upon the mapping of information in the codewords to signal points. Thus, the transmitted symbol generally may be thought of as representing the codeword. In general, after transmission of a particular symbol during a symbol clock period or symbol clock tick, the transmission process repeats itself with another selection from the signal space based at least upon the next codeword in the time-varying sequence of bits. In many memory-less communication systems, the next symbol can be chosen without considering the last symbol. In some memory-based information modulation and/or coding systems (such as, but not limited to, trellis coding for error correction), the selection of the next symbol to be transmitted depends not only on the information to be transmitted but also on which previous signal points were chosen for previously transmitted symbols.

In a memory-less modulation scheme, the currently transmitted signal point generally maps to the currently transmitted specific string of bits or other form of information whereas in a memory-based modulation scheme the currently transmitted signal point generally does not directly map to the currently transmitted specific string of bits or other form of information. Therefore, because memory-less modulation and/or coding schemes generally have a fixed mapping between signal points and information or bits, the bits of the fixed mapping are often displayed on the signal constellation diagrams for memory-less modulation and/or coding schemes. In contrast, the generally changing nature of the mapping between signal points and information based on previous transmissions generally makes it more difficult to statically display the specific string of bits associated with a signal point in constellation diagrams for memory-based modulation and/or coding schemes. Thus, the signal point constellation diagrams in memory-based modulation and/or coding schemes generally are not illustrated with specific bit string mappings.

Information is recovered from the received signal generally by detecting and estimating the proper signal point in the receive signal space. Then another mapping generally relates signal points in the receive signal space to associated codewords and/or information. Often this recovery process involves various signal processing techniques in an attempt to remove or reduce noise from the received signal. In addition, the recovery process may involve probabilistic techniques as well as error control coding to determine the maximum likely signal point that was originally transmitted. Furthermore, the mapping(s) between information and signals in transmission and reception may actually utilize relative changes in information and/or relative changes in signals. As a non-limiting example, each signal point may represent a change in information from an earlier transmission/reception as opposed to a specific set of bits or information.

In general, one technical goal of communications systems is to provide the highest throughput with the lowest delay. In addition, other things being equal (i.e., ceteris parabus) it is often important to reduce the bit error rate (BER) so that less mistakes are made in recovering the originally transmitted information from the received signal. Also, improving the communications systems so that the length of the transmission line may be increased or the gauge of wire decreased before the signal is distorted beyond recovery is another design issue. These and other factors are only some of the design considerations that are considered in developing communication systems. Based on these and other design considerations, many example communication systems have been developed with various duplexing techniques to provide bi-directional communications.

Duplexing Techniques

Basically, there are four common methods of providing bi-directional communications between two devices (i.e., duplexing): 1) four-wire duplexing, 2) time-division duplexing, 3) frequency-division duplexing, and 4) echo-cancelled duplexing. Four-wire duplexing is possibly the simplest duplexing method, and may be implemented by physically separating the two directions of information flow into separate communication media. However, four-wire duplexing may be costly and impractical because it requires that more than two conductors are used to carry duplex communications in the two directions. Although this form of duplexing is called four-wire duplexing, it can be implemented by less than four wires. For example, the unbalanced transmission line of RS-232 has separate transmit data and receive data leads, but a common ground lead. Thus, in RS-232 the transmit and receive wires are separate to allow full-duplex communications with each direction of communication in a separate conductor or media. However, the common ground of RS-232 for both transmit data conductors and receive data conductors makes RS-232 quite susceptible to noise and results in relatively low limits on the maximum data rate and transmission line length.

In contrast to RS-232, other balanced four-wire transmission lines such as, but not limited to, RS-422, V.35, Alternate Mark Inversion (AMI) T1, the S/T-Interface of Basic Rate Interface (BRI) ISDN (Integrated Services Digital Network), and 10/100BaseT ethernet generally have two conductors or wires to carry transmit data signals and two wires to carry receive data signals. In general, these balanced four-wire transmission lines have transmit positive, transmit negative, receive positive, and receive negative leads or conductors that a low information to be conveyed in the difference in signals between the two wires or conductors carrying signals in one direction. This differential use of balanced conductors provides much better noise immunity than unbalanced conductors because noise generally will tend to affect both the signal on the transmit positive and the signal on the transmit negative leads in a similar fashion. In a balanced transmission line, noise will tend not to affect the differential between the wires as significantly as noise would have affected an unbalanced transmission line.

Furthermore, because RS-422 and V.35 are generally designed for very short distances, it is not very costly to include additional conductors for clocking and status signals. In contrast, the greater distances of AMI T1, the S/T-Interface of Basic Rate Interface (BRI) ISDN, and 10/100BaseT make it generally uneconomical to have additional conductors for clocking and status in these interface standards for longer distance transmission lines. Instead, clocking and status information for these longer distance transmission lines generally is carried in the transmit and receive data communication signals. In addition, some of the transmission lines allow for powering end devices such as, but not limited to, ISDN phones or terminals on an S/T-Interface ISDN BRI line and internet protocol (P) phones on a 10/100BaseT transmission line. (The four-wire S/T-interface of BRI ISDN supports both point-to-point and multi-point operation with an NT1 handling media access control of the D-channel in multi-point operation by echoing some D-channel bits. Arbitration of the ISDN B-channels generally is handled by a central office switch using a call signaling protocol such as, but not limited to, Q.931.)

Though the four-wire duplexing strategy will work for shorter transmission lines, the added cost of additional wires is even more expensive as the distance increases. This additional cost generally has not been economically viable for services sold at lower price levels such as BRI ISDN and ADSL (Asymmetric Digital Subscriber Line). Thus, other solutions have been pursued to provide duplexing for bi-directional communications.

Time-division duplex technology generally uses the same frequency bands for transmission in both directions. Time-division duplex technology generally only transmits in each direction part of the time in such a way that data streams traveling in opposite directions do not cause undesirable echo interference. A non-limiting example of time-division duplexing (TDD) is Japanese Basic Rate Interface (BRI) ISDN that was designed to operate over a two-wire loop using a static 50% duty cycle. The 50% duty cycle generally time-shares the transmission line to allow one direction of communication to use the line for nearly 50% of the time. Then the direction of communication is reversed to allow communication in the opposite direction for almost 50% of the time.

Unfortunately, this static or fixed version of TDD generally results in inefficiencies whenever the distribution of information to be transmitted does not match the static time allocations of the transmission line. Also, transmitting only half the time undesirably fixes the throughput in each direction at 50% of the channel capacity. In addition, there may be some inefficiency in reversing the direction of the channel and waiting for echoes and/or signal reflections to subside to a minimal level. In TDD, there generally is no transmission echo or only very minimal echo while receiving because there generally is no transmission while receiving. (The minimal level of echo is due to previous transmissions, and it takes the echo signal a small amount of time to attenuate to a completely imperceptible level.)

In contrast to static or fixed TDD, adaptive time-division duplex (ATDD) technology generally allows the direction of traffic flow in TDD to be dynamically changed to respond to situations such as, but not limited to, significant events and changes in the distribution of data at one or both of the end devices. In communication systems employing adaptive time-division duplex technology, transmission duration may be adaptively and relatively instantaneously controlled based on the demands to send user data or to establish a desired quality of service (QoS). Therefore, the throughput in each direction can approach 100%. However, for higher-capacity symmetrical applications the throughput in each direction may be reduced to approximately 50% of the channel capacity.

In general, frequency-division duplex (FDD) technology uses higher frequency bands for transporting one of the directions of data streams between transceivers. Some effects such as, but not limited to, signal dispersion may cause more distortion in the higher frequency band than in the lower frequency band. In general, dispersion may involve higher frequency (i.e., lower wavelength) signals propagating through the communications medium at a lower velocity than lower frequency signals propagate through the medium. Thus, the higher frequency bands generally do not carry data streams as efficiently as the lower frequency bands. Often these limitations of the higher frequency bands in FDD may result in undesirable reach limitations that do not exist in other duplexing techniques, other things being equal (i.e., ceteris parabus). Some proposed ADSL (Asymmetric Digital Subscriber Line) and VDSL (Very high-speed Digital Subscriber Line) solutions use FDD to provide bi-directional communications.

With the development of various signal processing techniques and specialized digital signal processing chips, echo-cancelled duplex (ECD) technology has become quite widely utilized in wire pair communication systems such as voice band modems and digital subscriber line communication systems. Some examples of echo-cancelled duplex communication systems are V.34/V.90 modems, the 2B1Q (2 Binary-1 Quaternary) North American U-Interface of Basic Rate Interface (BRI) ISDN, HDSL (High bit-rate Digital Subscriber Line), HDSL2 (High bit-rate Digital Subscriber Line 2), and G.shdsl (Single-pair High-speed Digital Subscriber Line).

Some of the technologies (V.34, V.90, 2B1Q North American U-Interface ISDN BRI, HDSL2, and G.shdsl) are designed to use echo-cancelled duplex to provide bi-directional communications over a single two-wire circuit. In contrast, HDSL is designed to use echo-cancelled duplex over a four-wire circuit in providing full DS1 (1.536 Mbps) service that is equivalent to the full DS1 service available from AMI T1 using four-wire duplexing. The difference is that HDSL has a longer loop reach than A MI T1 before repeaters are needed in the circuit. AMI T1 presents problems in providing power to mid-span repeaters in the four-wire duplexed circuit. In contrast, the echo cancellation logic in HDSL is located at the ends of the circuit, where a power source generally is readily available. Thus, HDSL actually uses the four wires as two bi-directional two-wire circuits that are each using echo-cancelled duplex and are each providing one half of the DS1 data rate service.

Conventional echo-cancelled duplex technology is attractive because it theoretically makes optimum use of the available channel bandwidth when the theoretical model of a communications channel is restricted to additive noise (i.e., the communications channel basically exhibits linearity with respect to noise). Theoretically, in conventional echo-cancelled duplex technology both directions of transmission can simultaneously utilize the same desirable frequency bandwidth. Despite these theoretical advantages, conventional echo-cancelled duplex technology suffers from several drawbacks that prevent the technology from making optimum use of the available channel bandwidth. For example, the hardware and/or software used to implement actual echo-cancelled duplex technology generally limits the achievable cancellation.

Also, in reality the channels of transmission lines or communication media exhibit such non-ideal characteristics as non-linearity and time-varying system response. Basically, the lack of linearity and/or the lack of time-invariance in communication channels make it more difficult to perform signal processing to completely eliminate noise from echo signals. These real world effects in communication systems (such as, but not limited to, line-shared digital subscriber line systems) may result in a dramatic reduction of the performance for standard ECD transmission even more than the reductions due to hardware and/or software limitations. Furthermore, these real-world conditions that occur in conventional ECD communication systems may cause repeated trainings, excessive training time, and a decreased ability to robustly adapt to varying channel conditions, with both possibly leading to service outages that are unacceptable for many applications.

Because the conventional duplexing technologies employed to prevent or minimize echo interference have undesirable drawbacks, a heretofore unaddressed need exists in the industry to address the aforementioned deficiencies and inadequacies.

### SUMMARY OF THE INVENTION

The preferred embodiments of the present invention provide a method and/or apparatus for enhancing bi-directional communication systems. Briefly described, in architecture, one embodiment of the method, among others, may be broadly summarized to include the following steps: transmitting an information-bearing signal in the presence of another received information-bearing signal that overlaps the transmitted signal in frequency, changing a plurality of times among at least two modes, encoding information on the information-bearing signal at a non-zero information rate during the at least two modes, and causing the information-bearing signal to exhibit a non-zero signal level during the at least two modes. In addition, one embodiment of the apparatus, among others, may be broadly summarized to include the following implementation: a means for transmitting an information-bearing signal in the presence of another received information-bearing signal that overlaps the transmitted signal in frequency and a means for changing a plurality of times among at least two modes with information being encoded on the information-bearing signal at a non-zero information rate during the at least two modes and with the information-bearing signal exhibiting a non-zero signal level during the at least two modes.

The preferred embodiments of the present invention can be used to enhance bi-directional (between devices arbitrarily called local and remote) use of channel bandwidth in communication systems. Changing modes generally may involve adjusting the transmit level. In general, adjusting the transmit level adjusts not only the signal level received by the receiving device, but also the level of echo reflected back at the transmitter. To the extent that echo cancellation is imperfect, the residual echo left over from echo cancellation adds to noise from the communications channel. Thus, changing the transmit level generally adjusts not only the signal level but also the level of residual echo noise. In general, the changes to signal levels and the resulting changes to residual echo noise levels modify the signal-to-noise ratio and potential communication bit rates of the two directions of communication between a local device and a remote device. One skilled in the art will be aware of various changes to communication systems that can be employed to advantageously utilize a communications channel with a specified signal-to-noise ratio. The changing of modes generally may occur without the substantial delay needed for training to determine the communication parameters and transmission characteristics for the communications medium.

Furthermore, unlike TDD/ATDD the preferred embodiments of the present invention generally allow communication between a local device and a remote device in both directions to be greater than zero bits per second during at least one and possibly both of the at least two modes. This potentially continuous transmission capability of the preferred embodiments of the present invention may be used to support different communication queues and different classes of traffic, including but not limited to continuous bit rate (CBR) and/or variable bit rate (VBR). Also, the preferred embodiments may be used (and in most cases would be expected to be used) with echo cancellation technology. In addition, the preferred embodiments of the present invention may switch to pure ECD and/or pure TDD/ATDD manners of operation. Furthermore, the preferred embodiments of the present invention may be used in a line-shared or multi-point fashion.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1a is a functional block diagram of one end in a communication system including a transceiver that might incorporate the extended-performance echo-cancelled duplex system.

FIG. 1b is a block diagram of one possible implementation for an echo canceller.

FIG. 2 is a block diagram of one possible stored program control system implementing the transceiver of FIG. 1.

FIG. 3 is a block diagram of a general bi-directional communications system.

FIG. 4 is a more complex block diagram of a general bi-directional communication system showing at least some effects of noise and echo.

FIG. 5 is a transmit signal space diagram at either the transmitter of a local device or the transmitter of a remote device.

FIG. 6 is a receive signal space diagram at either the receiver of a local device or the receiver of a remote device, the receive signal space diagram being an attenuated version of the transmit signal space diagram from FIG. 5.

FIG. 7 is a receive signal space diagram after amplification of the attenuated signal from FIG. 6.

FIG. 8 is signal space diagram of the echo received from the associated transmit signal space of FIG. 5 with just a single reflection or impedance mismatch in the transmission line or communication media.

FIG. 9 is a more realistic echo noise distribution that is likely to occur from multiple reflections and/or impedance mismatches in a communications media.

FIG. 10 shows how the echo noise of FIG. 9 generally would cause communication reception errors when superimposed on the amplified receive signal space of FIG. 7.

FIG. 11 shows the residual echo noise distribution after echo cancellation has been performed on the echo noise distribution of FIG. 9.

FIG. 12 shows how the residual echo noise of FIG. 11 generally would not cause communication reception errors when superimposed on the amplified receive signal space of FIG. 7 because the echo cancellation technology gives the receive signal space a good margin for detecting transmitted symbols.

FIG. 13 is a block diagram of a time division duplexing (TDD) and/or an adaptive time division duplexing (ATDD) communication system.

FIG. 14a is timing diagram of data transmission using TDD/ATDD from a local device to a remote device.

FIG. 14b is timing diagram of data transmission using TDD/ATDD from a remote device to a local device.

FIGS. 15a and 15b are signal space diagrams of a TDD/ATDD communication during mode 1 in the absence of channel noise.

FIGS. 16a and 16b are signal space diagrams of a TDD/ATDD communication during mode 2 in the absence of channel noise.

FIGS. 17a and 17b are signal space diagrams of a TDD/ATDD communication during mode 1 in the presence of channel noise.

FIG. 18 is a block diagram of an echo cancelled duplexing (ECD) communication system.

FIG. 19a is timing diagram of data transmission using echo-cancelled duplex (ECD) from a local device to a remote device.

FIG. 19b is timing diagram of data transmission using echo-cancelled duplex (ECD) from a remote device to a local device.

FIGS. 20a and 20b are signal space diagrams of a symmetric ECD communication in the absence of channel noise.

FIGS. 21a and 21b are signal space diagrams of a symmetric ECD communication in the presence of channel noise.

FIGS. 22a and 22b are signal space diagrams of an asymmetric ECD communication in the absence of channel noise.

FIGS. 23a and 23b are signal space diagrams of an asymmetric ECD communication in the absence of channel noise.

FIG. 24 is a block diagram of an extended performance echo cancelled duplexing (EP ECD) communication system using a preferred embodiment of the present invention.

FIG. 25a is timing diagram of data transmission using EP ECD from a local device to a remote device.

FIG. 25b is timing diagram of data transmission using EP ECD from a remote device to a local device.

FIG. 26 is a block diagram of a bi-directional communications system during mode 1 that might be using the concepts of an embodiment of the present invention.

FIG. 27 is a block diagram showing different optional coding blocks and different bit rates at different places in a communication system.

FIG. 28a is a timing diagram showing how the local-to-remote transmission as shown in FIG. 25a can be decomposed into two transmission channels with different characteristics.

FIG. 28b is a timing diagram showing how the remote-to-local transmission as shown in FIG. 25b can be decomposed into two transmission channels with different characteristics.

FIG. 29 is a block diagram showing how a communications channel can be treated as a constant bit rate (CBR) channel and a variable bit rate (VBR) channel.

FIG. 30 is a block diagram of an extended performance echo cancelled duplexing (EP ECD) communication system using another preferred embodiment of the present invention that has a second manner of pure TDD/ATDD operation in addition to a first manner of EP ECD operation.

FIG. 31 is a block diagram of an extended performance echo cancelled duplexing (EP ECD) communication system using another preferred embodiment of the present invention that has a third manner of pure ECD operation in addition to a first manner of EP ECD operation.

FIG. 32 is a block diagram showing multi-point or line-shared operation among three devices capable of at least EP ECD.

FIG. 33 is a block diagram showing multi-point or line-shared operation among six devices capable of at least one of EP ECD, pure TDD/ATDD, and pure ECD.

FIG. 34 is a chart from a model comparing uni-directional bits per symbol and average bi-directional bits per symbol versus channel loss for pure TDD/ATDD and pure ECD.

FIG. 35 is a chart from a model comparing uni-directional bits per symbol and average bi-directional bits per symbol versus channel loss for a first non-limiting example A of EP ECD.

FIG. 36 is a chart from a model comparing uni-directional bits per symbol and average bi-directional bits per symbol versus channel loss for a second non-limiting example B of EP ECD.

FIG. 37 is a chart from a model comparing forward direction uni-directional bits per symbol versus channel loss for pure ATDD, a first non-limiting example A of EP ECD, and a second non-limiting example B of EP ECD.

FIG. 38 is a chart from a model comparing reverse direction unidirectional bits per symbol versus channel loss for pure ATDD, a first non-limiting example A of E P ECD, and a second non-limiting example B of EP ECD.

FIG. 39 is a chart from a model comparing average bi-directional bits per symbol versus channel loss for pure TDD/ATDD, pure ECD a first non-limiting example A of EP ECD, and a second non-limiting example B of EP ECD.

### DETAILED DESCRIPTION OF THE PREFERRED EMBODIMENT

In addition to other advantages, an extended-performance echo-cancelled duplex (EP ECD) system includes numerous features that may be used as an integrated package or separately. These features of the extended-performance echo-cancelled duplex system include extending duplex digital subscriber line reach to that achievable by a simplex digital subscriber line system. An extended-performance, echo-cancelled duplex system can achieve this extended duplex reach even in line-shared digital subscriber lines. An extended-performance, echo-cancelled duplex system generally allows sub-second full training and seamless-error-free rate adaptation. Also, an extended-performance, echo-cancelled duplex system may be used in multi-point communications.

In one embodiment, a communications system incorporates extended-performance, echo-cancelled duplex technology. In another embodiment, a communications system incorporates the extended-performance, echo-cancelled duplex technology and one or both of the conventional echo-cancelled duplex technology and the conventional time-division duplex technology (including regular TDD and/or adaptive TDD); furthermore, such a communications system with the proper control logic and/or configuration would be able to automatically, adaptively, and seamlessly transition among the three technologies of EP ECD, pure ECD, and pure TDD/ATDD. Additional preferred embodiments are also described below.

Digital subscriber line communication systems generally may be grouped according to the duplexing technologies employed in the systems. Conventional duplexing technologies include echo-cancelled duplex technology, time-division duplex technology, adaptive time-division duplex technology, frequency-division duplex technology, and four-wire duplexing technology. These duplexing technologies are described below.

Echo-cancelled duplex technology is employed in V.32 dial modems, 2B1Q North American U-interface Basic Rate Interface (BRI) integrated services digital network (ISDN) communication systems, symmetric digital subscriber line (SDSL) communication systems, G.shdsl communication systems, and high-bit-rate digital subscriber line (HDSL) communication systems. One version of conventional echo-cancelled duplex (ECD) technology is described in U.S. Pat. No. 5,394,392, entitled “Method for Transferring Information Using Modems,” issued to Scott on Feb. 28, 1995, which is entirely incorporated herein by reference.

In addition, echo-cancelled duplex technology theoretically offers optimal duplex performance on certain linear, band limited channels. However, the performance of echo-cancelled duplex technology is limited by implementation non-linearities, channel non-linearities, and time-varying channel characteristics. Echo-cancelled duplex technology generally transmits contemporaneously in the same lower frequency band in each direction of transmission, although echo-cancelled duplex technology is also utilized in partially overlapped systems wherein the frequency band in one direction extends beyond the band in the other direction. Furthermore, echo-cancelled duplex technology attempts to remove the locally transmitted signal from the locally received signal.

Traditional channel capacity analyses (additive noise on a time-invariant channel) shows echo-cancelled duplex technology allows optimum duplex performance because perfect echo-cancellation generally is assumed so that the performance may be analyzed as a simplex system. However, practical limitations of echo-cancelled duplex technology implementations, including limitations such as channel non-linearities and time-varying channel characteristics, limit the performance of echo-cancelled duplex technology significantly short of the ideal. Furthermore, the training of communication systems employing echo-cancelled duplex technology is notoriously long. Note that a variation of echo-cancelled duplex technology called “partially overlapped echo canceling” provides for one direction of transmission to have a larger bandwidth than the other.

Conventional full-duplex echo-cancelled duplex technology communication systems, such as those described in the standards defining V.34 communication systems, which are incorporated by reference in their entirety herein, allow different data rates in each direction of transmission. However, conventional full-duplex echo-cancelled duplex technology communication systems do not include an adaptive time-division duplex technology mode nor an extended-performance, echo-cancelled duplex technology mode.

Time-division duplex (TDD) technology is employed in Japanese Basic Rate Interface (BRI) ISDN communication systems. Time-division duplex technology transmits in the same lower frequency band in each direction. However, time-division duplex technology only transmits in each direction for a generally fixed duty cycle. Often this duty cycle is approximately fifty percent (50%) of the total time for two devices sharing a communications medium in such a way that the two directions of data streams do not interfere with each other, resulting in a fixed maximum throughput in each direction of about fifty percent (50%).

In addition to the generally static or fixed duty cycle of TDD, adaptive time-division duplexing (ATDD) technology generally allows for the dynamic varying of the amount of time that a channel is used for one direction of communication and the amount of time that a channel is used for the opposite direction of communication. One version of adaptive time-division duplex is described in U.S. Pat. No. 6,016,311, entitled “Adaptive Time-division Duplexing Method and Apparatus for Dynamic Bandwidth Allocation within a Wireless Communication System,” issued on Jan. 18, 2000 to Gilbert et al., which is entirely incorporated herein by reference. Adaptive time-division duplex technology generally halts all traffic (i.e., the data rate over the period of the traffic halt generally falls to zero bits per second during the traffic halt) in one direction when traffic is sent in the other direction. Therefore, there generally is little or no transmission echo while receiving because there generally is no transmission while receiving. Adaptive time-division duplex technology can be used to transmit in the same lower frequency band in each direction of transmission. Transmissions generally do not overlap in time, so adaptive time-division duplex does not suffer from the limited reach and performance limitations of echo-cancelled duplex technology. Unlike TDD, ATDD technology transmit durations are often adaptively and instantaneously controlled by the need to send user data or establish a desired Quality of Service (QoS), so the throughput in each direction can approach one hundred percent (100%). However, for truly symmetrical applications, the throughput is reduced to around fifty percent (50%).

Frequency-division duplex technology is employed in asymmetric digital subscriber line (ADSL) communication systems, G.lite communication systems, and rate adaptive digital subscriber line (RADSL) communication systems that generally separate the frequency ranges of the signals for the different directions of communication. Frequency-division duplex technology generally requires much greater frequency bandwidth than echo-cancelled duplex technology and various time-division duplex technologies. Frequency-division duplex technology therefore generally uses higher frequencies than echo-cancelled duplex technology and adaptive time-division duplex technology. In frequency-division duplex technology, data streams traveling in one direction use a frequency band that generally is greater than data streams traveling in the other direction. In many communication systems and especially digital subscriber line systems, higher frequency bands generally are subject to greater channel loss, coupled noise, and crosstalk compared to the lower frequency bands of other duplexing technologies. Thus, frequency-division duplex technology suffers from reach limitations and often forces communications to operate in a frequency band where subscriber line bridged taps commonly cause problems.

Finally, four-wire duplexing is a term generally used to describe using two different communications media with little or no interference to carry the two different directions of communication.

The various contemporary duplexing technologies offer advantages. However, the various contemporary duplexing technologies also include compromises on performance. Extended-performance, echo-cancelled duplex (EP ECD) communication systems offer the advantages of conventional echo-cancelled and adaptive time-division duplexing technologies, while minimizing the performance compromises inherent in those other technologies and introducing new advantages.

Non-Limiting Example of a Transceiver

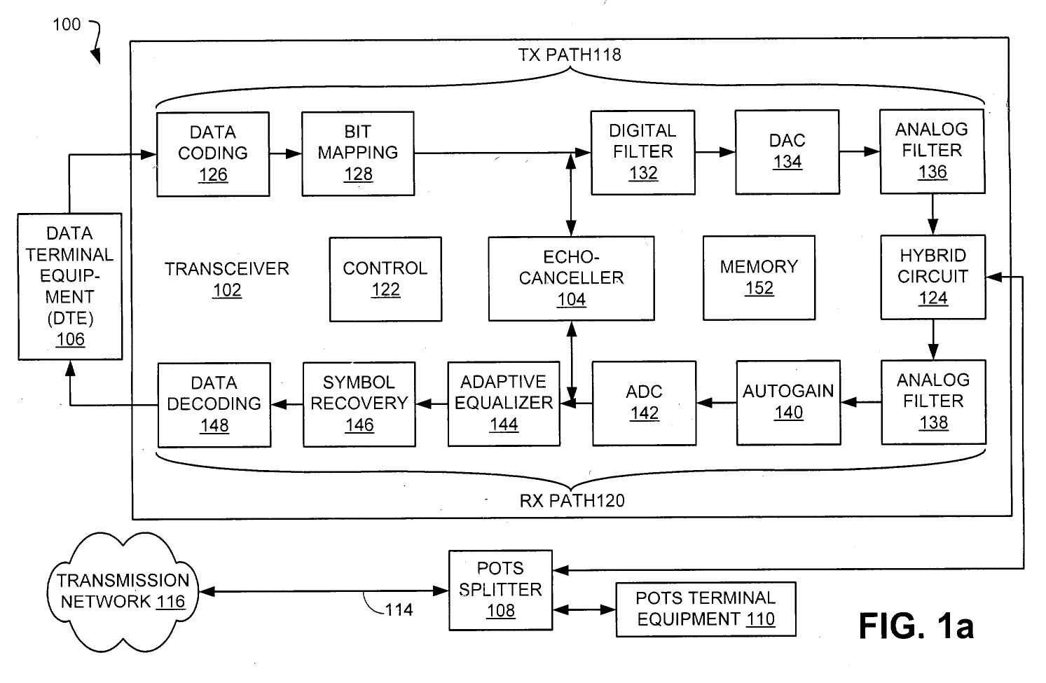

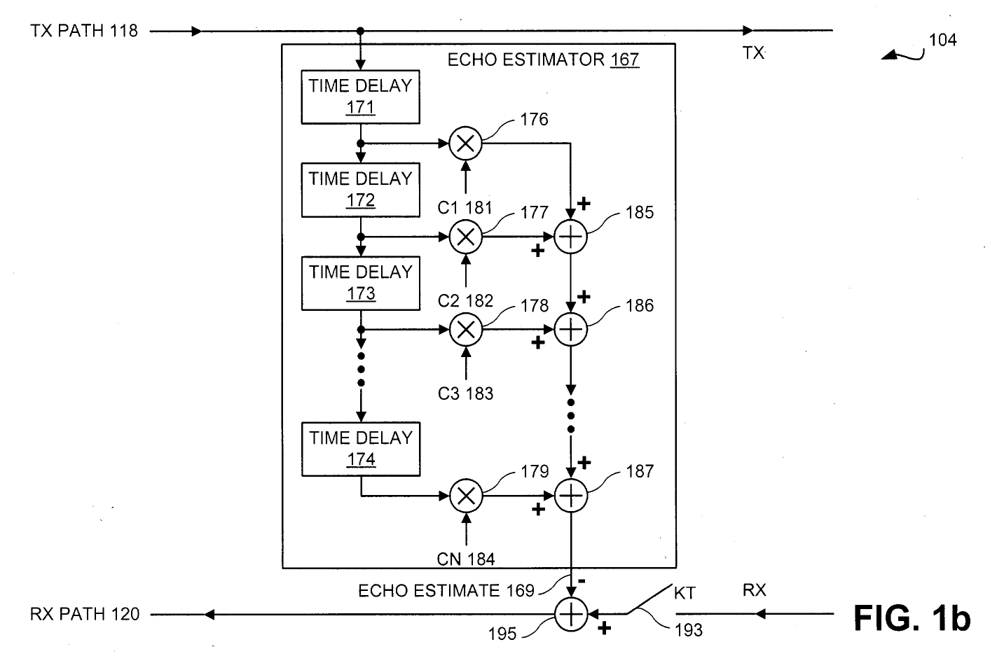

FIG. 1a is a block diagram showing the equipment and connections of one side of a communication system 100 including a transceiver 102 incorporating the extended-performance echo-cancelled duplex system. The transceiver 102 might be incorporated into various communication devices, and the blocks of FIG. 1a may be implemented using components that integrate many of the functions into larger systems. Furthermore, the components within the transceiver 102 of FIG. 1a are only an example of a transceiver that could implement the preferred embodiment of the present invention. In general, those skilled in the art will recognize that the concepts of the preferred embodiment of the present invention can be used in communication transceivers and devices that have different implementations and different functional components than the example components of the transceiver 102.

As shown in FIG. 1a, the transceiver 102 has an echo canceller 104. Furthermore, transceiver 102 is connected to data terminal equipment (DTE) 106 and to a plain old telephone service (POTS) splitter 108. POTS splitter 108 also provides for the communication of POTS terminal equipment 110 using transmission network 116 via communication link 114.

The preferred embodiments of the present invention generally are described with respect to DSL loops that may have POTS splitters and may provide service to customer premises (CP). However, those skilled in the art will be aware that the concepts of the preferred embodiments of the present invention are quite general and apply to all types of communications where duplexing is an issue and where some residual noise from echo and/or echo cancellation errors still exists in the incoming signals at the point an attempt is made to recover information from the incoming signals. Echo is a common occurrence in many types of communication systems and generally results from physical phenomena that occur when electromagnetic waves encounter impedance mismatches. Those skilled in the art will be aware of the common problem of echo in communication systems and how this disclosure of the preferred embodiment of the present invention may now be used as a way of improving many types of communication systems that are affected by the problem of echo including, but not limited to, many DSL communication systems.

For convenience in describing the relationship of devices and components in a communication system, the devices are often given relative names such as local and remote. These names are not meant to imply any limitations, but are only used to help identify the relative direction of information and/or signal flows. Thus, transceiver 102 could represent the local or the remote side of communications. Generally, the transceiver 102 would be responsible for communicating from DTE 106 as a source of information to another transceiver (not shown) that forwards the information to another DTE (not shown) as a destination. Also, in bi-directional communications, the transceiver 102 generally also would be responsible for receiving communications and forwarding information to DTE 106 as a destination or sink for the information.

In addition to the echo canceller 104, transceiver 102 generally may include transmission components in transmission path 118, reception components in reception path 120, a control panel 122, and a hybrid circuit 124. Transmission path 118 includes an data coding element 126, a bit mapping element 128, a digital filter 132, a digital-to-analog converter (DAC) 134, and an analog filter 136. Reception path 120 includes an analog filter 138, an autogain element 140, an analog-to-digital converter (ADC) 142, an adaptive equalizer element 144, a symbol recovery element 146, and an data decoding element 148.

Furthermore, most communications devices have some memory 152 to store values for various communication parameters. Although shown as a single block in FIG. 1a, it is to be understood that memory 152 might be broken up and associated with the other various functions and components of the transceiver 102. Also, though memory 102 may commonly be implemented a s RAM (Random Access Memory), any type of permanent or temporary storage capable of at least holding some of the communication parameters of transceiver 102 could be used.

The communication parameters usually specify some of the characteristics of communication and/or the communication channel(s). Generally, various models of a communication channel have parameters that specify the behavior of the channel. Often communication devices, such as transceivers, have various settings or communication parameters that determine the behavior of the communication device. Usually, the communication parameters are set to optimize various performance criteria. Some communication parameters generally may be permanently set in software and/or hardware by the device manufacturer. Other communication parameters can be set by the users of the device through various interfaces. Some examples of interfaces that have been used to set communication parameters include, but are not limited to, dip switches, jumpers, interactive LCD/LED consoles, RS-232 serial console ports, Hayes AT commands, telnet messages, SNMP messages, HTML/HTTP web pages, as well as many others.

Furthermore, because of the number and complexity of communication parameters, many communication devices test the communications line to learn the parameters of the communication channel(s) and set the parameters of the communications device accordingly. As is known by one skilled in the art, user communication is commonly delayed or stalled during a training process, and this is one type of substantial delay that generally adversely affects communication system performance. Often the communication parameters used between two communicating devices are negotiated through various protocols (and this negotiation process may in some instances add more unwanted substantial delay, especially when following a training process). These communication parameters might be originally set during training as part of initialization, but later the parameters might be adjusted to meet changes (such as increased noise) in the communication system. Thus, one skilled in the art is aware of many parameters that are used in models of communication systems as well as many user interfaces to allow entry of settings and/or communication parameters. Also, one skilled in the art is aware of many methods for dynamically determining communication parameters through processes such as, but not limited to, training as well as many methods and protocols for negotiating and/or exchanging parameters among two or more communication devices.

The components of transceiver 102 in communication system 100 may be implemented with hardware, software, firmware, or combinations thereof. In modem communication systems, the blocks within transceiver 102 are often implemented, in whole or part, in software or firmware where the blocks represent portions of the software or firmware. Those skilled in the art will recognize that various alternative block diagrams may be used to represent communication systems and transceiver components implemented in software or firmware. Those of ordinary skill in the art are adept at translating block diagrams to software and/or firmware. Those of ordinary skill in the art also are adept at using the various alternative block diagrams to create the software and/or firmware. Those of ordinary skill in the art will be able to translate transceiver 102 into any of the various block diagrams known to those of ordinary skill in the art and shown in various industry standards and other publications.

Returning to FIG. 1a, generally the transmission path 118 modulates the incoming signal from DTE 106 to generate a signal transmitted onto a transmission line or communication medium through hybrid 124. Often the incoming signal from DTE 106 is a baseband signal carrying digital data and the outgoing signal is an analog data stream; however, the preferred embodiments of the present invention are not limited to conversions between baseband digital and analog streams. The digital data generally includes digital data generated by data terminal equipment 106. Data terminal equipment (DTE) 106 may be one or more personal computers, servers, routers, and many other devices known to those skilled in the art. In general, DTE 106 is any source of information for the outgoing data and/or a sink or destination of information for the incoming data.

Generally, two transceivers (arbitrarily called local and remote transceivers) would be connected through common communication facilities, which could be one or more communications media. A local transceiver generally has a local-side interface to a local source and/or sink of information or data. In addition, a local transceiver generally has another interface to the common communication facilities, which are connected to the remote transceiver. Furthermore, a remote transceiver generally has a remote-side interface to a remote source and/or sink of information or data. Also, a remote transceiver generally has another interface to the common communication facilities, which are connected to the local transceiver. The local and remote transceivers generally are concerned with communicating digital information between the local-side interface of the local transceiver and the remote-side interface of the remote transceiver.

Though FIG. 1a shows DTE 106 connected to transceiver 102, in general DTE 106 just represents a source and/or sink (or destination) of information and/or data relative to transceiver 102. Although many DTE interfaces (such as, but not limited to, RS-232, V.35, 10Base2, 10Base5, 10BaseT) carry baseband signals, the preferred embodiments of the present invention with respect to transceiver 102 are not limited to only working with baseband signals. In general, the functions of transceiver 102 (which generally could be called either a local or a remote transceiver) basically are just concerned with communicating digital information between the local and remote transceiver.

The responsibility for getting digital information from a source or destination (such as DTE 106) into transceiver 102 may be the responsibility of other transceivers. For example, if DTE 106 has an RS-232 interface, then DTE 106 likely has an RS-232 transceiver to communicate information into the equipment (not shown) comprising transceiver 102. To receive the information from DTE 106, the equipment (not shown) comprising transceiver 102 likely has an RS-232 transceiver to communicate with DTE 106. The interface between DTE 106 and the equipment (not shown) comprising transceiver 102 may be any type of interface, and this interface is not in any way limited in the preferred embodiments of the present invention. As some non-limiting examples, the interface may be baseband, broadband, wired, wireless, fiber, metallic, serial, parallel, and any known or to be developed method of communicating digital information between a source/destination of information and transceiver 102.

Often a transceiver 102 using the preferred embodiment of the present invention may be located in modem equipment. For DSL modem equipment, the communications medium between local and remote transceivers is a digital subscriber line (DSL). Furthermore, common local interfaces for modems and/or DSL modems include, but are not limited to, RS-232, RS-449, V.35, USB (Universal Serial Bus), Ethernet (10Base2, 10Base5, 100BaseT etc.), PC parallel port, as well as others. Many of these interfaces are baseband because of the low costs of baseband interfaces and the relatively short distances of communication lines or media between modems (or DSL modems) and DTEs such as, but not limited to, PCs or computers. Also, a transceiver using a preferred embodiment of the present invention could be incorporated into communications equipment that uses various parallel and/or serial digital logic buses to pass digital information to and/or from the transceiver. The digital logic buses could use various types of logic signaling such as, but not limited to, TTL (Transistor-Transistor Logic) and/or CMOS (Complimentary Metal-Oxide Semiconductor).

In general, a transceiver using the preferred embodiments of the present invention just takes digital data and generates the proper electromagnetic signals for communicating the digital data over the common communication facilities between the local transceiver and the remote transceiver. In addition, a transceiver using the preferred embodiments of the present invention converts the electromagnetic signals received over the common communication facilities back into digital data.

Generally, because the physical world is continuous-time, the electromagnetic signals communicated over the common communication facilities are continuous-time physical phenomena. Therefore, the transmit portion of a transceiver generally converts digital data or discrete quantities of information (called bits when the information is represented in base two) to continuous-time electromagnetic signals to be propagated through the common communication facilities. (Note: although this detailed description often refers to information or data as bits, which are binary or base two representations of data, it is to be understood that the preferred embodiments of the present invention are not limited to base two or binary representations of information or data, and the preferred embodiments of the present invention generally will work with M-ary representations of data or information, where M is any integer greater than or equal to two.)

In the receiver portion of a transceiver, the incoming continuous-time electromagnetic signals generally are sampled at discrete time instants or intervals that generally are based on the symbol clock. When a digital receiver samples an incoming continuous-time electromagnetic signal, it generally tries to quantize the incoming signal that may be continuous-time and continuous-amplitude to recover the originally transmitted discrete quantities of data (or digital data). Even though the original transmission of signals into a communication facilities may have been based on discrete amplitude signals, the incoming signal at a receiver may have continuous-amplitude values because a random noise process may have added various random amounts of noise as the electromagnetic signal propagates through the communications facilities.

This conversion by transceivers (and the noise in communication facilities) between discrete data and continuous-time signals is sometimes colloquially referred to digital-to-analog conversion (DAC) or analog-to-digital (ADC) conversion depending on the direction of the conversion. The preferred embodiment of the present invention might be used to improve the performance of the communication system whether the continuous-time electromagnetic signals in the common communication facilities between a local transceiver and a remote transceiver are sine waves (that in some contexts are called analog signals) with generally continuous variations in amplitude or baseband square waves (that in some contexts are called digital signals) with generally potentially more significant amplitude variations from one instant to the next. (Also, those skilled in the art will recognize that square waves generally can be approximately represented as infinite sums of sine waves.)

In general, the preferred embodiment of the present invention will work with any modulation system that encodes some information in the amplitude, magnitude, phase, frequency and/or signal level of the electromagnetic signals propagated through the common communication facilities. Thus, the preferred embodiments of the present invention apply not only to modulation methods such as QAM (Quadrature Amplitude Modulation) and CAP (Carrier-less Amplitude Phase) that encode at least some portion of the transmitted information in the amplitude, magnitude, and/or signal level of the transmitted sine waves, but also to PAM (Pulse Amplitude Modulation), which may utilize variations in the amplitude of square waves and/or sine waves to encode information. The 2B1Q line coding of North American U-Interface BRI ISDN and HDSL is one non-limiting example of a four-level PAM system.

More description of various modulation techniques may be found in “Digital Communications: Fundamentals and Applications, Second Edition” by Bernard Sklar, which is incorporated by reference in its entirety herein. Also, “Digital Communications, Fourth E dition” b y John G. Proakis, which is incorporated by reference in its entirety herein, describes the mathematics of various modulation schemes. Thus, the preferred embodiments of the present invention generally may work with any digital communication system and associated modulation technique that communicates digital information based on at least some form of amplitude variation to encode at least part of the transmitted information.

Returning once again to FIG. 1a, transceiver 102 and POTS splitter 108 may be enclosed by a modem housing (not shown). POTS splitter 108 often provides filtering to allow transceiver 102 to communicate using a digital data stream over the same local loop or communication link 114 that also is used for carrying analog POTS signals generally in the 0 to 4 KHz range. The communication link 114 is connected to transmission network 116. The communication link 114 may include a twisted pair telephone loop. Communication link 114 and transmission network 116 also may provide standard POTS analog service to POTS terminal equipment 110. POTS terminal equipment 110 may be, but is not limited to, one or more analog phones 116 (such as a Western Electric 2500 set), voice-band modems, voice-band facsimile devices, answering machine devices, and/or a POTS telephone switch. POTS splitter 108 generally receives a combined DSL digital data stream and POTS signal(s) from the transmission network 116 over communication link 114. POTS splitter 108 includes filters that separate the DSL digital data stream from the POTS signal. The DSL digital data stream is passed on to the transceiver 102 and the POTS signal is passed on to the POTS terminal equipment 110. Thus, the POTS splitter 108 often allows for the use of the subscriber line or loop for simultaneous communication with POTS terminal equipment 110 and DSL data terminal equipment 106.

Control 122 often includes control links (not shown) to various transceiver 102 components. Control 122 usually allows the user (not shown) to setup the transceiver 102 for operation and usually allows the user to vary the operation of the transceiver 102 and/or perform diagnostics. In addition, a user might potentially be able to manually enter some communication parameters into transceiver 102 through control 122. The communication parameters that are entered through control 122 could be stored in memory 152, which may be any form of temporary or permanent storage. This permanent or temporary storage could be large amounts of memory in items such as, but not limited to, RAM or disks. Alternatively, memory may be more simple devices such as a shift register or a single flip-flop.

Furthermore, those skilled in the art will be aware that prior to the dramatically decreased costs of microprocessors and memory (both volatile and non-volatile), other more cumbersome methods than control 122 were used to configure communication devices such as transceiver 102 and to store communication parameters. Two commonly used historical methods for configuring communication devices are dip switches and jumpers, which are both simplistic forms of memory or storage. Thus, these older and less user-friendly methods of configuring a communications device and storing information such as communication parameters in switches and/or jumpers are intended to be covered in the preferred embodiments of the present invention. Furthermore, memory or storage may be little more than tying a particular signal trace to a reference source such as +5 volts for binary 1 in TTL and a 0 volt ground for binary 0 in TTL.

Although the public today may have some contextual definitions of memory or storage based on the products that they buy for their personal computers and consumer electronics, the use of the terms memory or storage in describing the preferred embodiments of the present invention generally is not intended to limit the memory or storage to transistor-based (e.g., flip-flops), transistor-capacitor-based (e.g., Dynamic RAM), or magnetic/optical media (e.g., disks or drives) forms of information storage. Instead the terms memory or storage are to be interpreted based upon the more general information technology definition (including relay and switching circuits as well as paper tape) dating back at least to the development of digital computers and information theory around the 1940s as evidenced by Claude E. Shannon's master's thesis “A Symbolic Analysis of Relay and Switching Circuits” from 1938.

In general, the hybrid circuit element 124 is an interface converter that handles conversion between four-wire, simplex and two-wire, duplex (i.e., between four-wire duplexing, with each pair of the four-wire communication media generally carrying one direction of simplex communication, and some form of duplexing over a two-wire interface, with the resulting single wire-pair carrying both directions of communication).

The transmit path 118 digital data for transceiver 102 may be processed by an data coding element 126. The data coding element 126 may use various techniques known to those in the art to data code the digital data for transmission so that a receiver can detect and/or correct communication errors that generally are introduced by noise as the data is communicated. Though data coding serves many functions, one of the functions generally involves interrelating the data so that any data affected by noise during transmission may be detected and/or recovered due to the data's relationship with preceding and/or following data.

The bit mapping element 128 selects a signal point from the potential points in a signal space. The mapping or selection generally is made based on the information to be transmitted and/or the change in information to be transmitted relative to previous transmissions. Signal spaces generally may be at least partially represented in diagrams with each signal point generally corresponding to some physical phenomena (or change in the phenomena) of electromagnetic waves. The use of signal space diagrams or signal constellations is well-known to those skilled in the art for modulation methods such as, but not limited to, quadrature phase shift keying (QPSK), quadrature amplitude modulation (QAM), pulse amplitude modulation (PAM), and carrier-less amplitude-phase (CAP) modulation. Those skilled in the art will be aware that this list of modulation methods is in no way completely extensive of all the possible modulation methods because the possible modulation methods generally are too numerous to list all variations. More detailed discussion of some non-limiting modulation methods can be found in “Digital Communications, Fourth Edition” by Proakis and “Digital Communications: Fundamentals and Applications, Second Edition” by Sklar.

To communicate information in the physical phenomena of electromagnetic waves, the modulation methods generally modify some characteristic of the waves. In general, the change in the characteristics of an electromagnetic waves is used to convey information from the source to the destination. As a non-limiting example, QAM generally involves using two sinusoidal waves that are offset by ninety degrees or π/2. Because the phase difference in the two sinusoidal waves generally is ninety degrees, the two sinusoidal waves are often represented by sine and cosine functions. In QAM, the amplitude of the two sinusoidal waves generally is manipulated, and the phase differences between the two sinusoidal functions commonly is represented by real and imaginary numbers.

Also, one skilled in the art will be aware that many of the functions in transceiver 102 can be combined together. As a non-limiting example, one skilled in the art will be aware that some error control coding techniques such as trellis coding combine convolutional error coding with modulation and/or mapping of information (usually in bits) to physical phenomena or electromagnetic signals. Furthermore, one skilled in the art will be aware that the functional blocks of transceiver 102 shown in FIG. 1a may or may not be used in various implementations of transceivers.

Digital filter 132 generally performs some signal clean up using various digital signal processing (DSP) techniques. The digital-to-analog converter (DAC) 134 generally forms the continuous-time outbound signal, while analog filter 136 generally eliminates unwanted components in the signal before it is transmitted through hybrid circuit 124 into the common communications facilities or media between transceivers. (As described above, this process of generating the outbound signal for transceiver 102 is often called digital-to-analog conversion even though the resulting signal may be a baseband PAM square wave that in some contexts could be called a digital signal).

In the receive path 120, analog filter 138 generally eliminates some of the unwanted components of the incoming electromagnetic waves. In FIG. 1a analog filters 136 and 138 generally may provide a frequency-filtering function to only allow signals in the proper frequency ranges to enter and exit transceiver 102. The autogain element 140 adjusts the received signal to a level that is compatible with the analog-to-digital converter (ADC) 142. Echo canceller 104 may be linked to the output of bit mapping 128 and to the input of analog-to-digital converter 142. Again, though ADC 142 is called an analog-to-digital converter in FIG. 102, the incoming continuous-time signal may in fact be a baseband PAM square wave that in some contexts could be called a digital signal. Whether the incoming continuous-time signals are square waves or some other type of signal, ADC 142 generally samples the incoming continuous-time signal at discrete increments of time. This sampling process generally is performed based on clocking information that may come from various sources including, but not limited to, the incoming signals that also carry the data, incoming clock signals in separate communication media, local clocking circuitry in the equipment (not shown) containing transceiver 102, and/or combinations thereof.

The adaptive equalizer 144 generally tries to adjust the amplitude or magnitude of various frequency components of the incoming signal to compensate for frequency-dependent signal attenuations and/or phase shifts caused during propagation through the communications medium. Symbol recovery 146 generally involves making best guess estimations of the symbols that were originally transmitted. Inherently, this estimation process often involves Bayesian inference or probabilities of picking the most probable originally transmitted symbol given that a certain signal was received. Then data decoding 148 generally uses redundant information in the presently transmitted symbol and/or redundant information from previously received signals (for codes with memory) to detect and/or correct errors in the digital data.

In operation, the transceiver 102 basically performs an encoding function, a modulation function, a demodulation function, and/or a decoding function. Though the above functions are found in typical transceivers, the transceiver does not have to be capable of performing all of the described functions in order to incorporate the preferred embodiments of the present invention. As a non-limiting example, an HDSL CSU/DSU (Channel Service Unit/Data Service Unit) device might incorporate a transceiver 102 utilizing the preferred embodiments of the present invention. The HDSL CSU/DSU may have a V.35 interface and associated baseband digital transceiver to communicate with DTE 106 over the V.35 interface, which might use a non-return-to-zero (NRZ) line code to communicate with DTE 106 at a DS1 (digital speed 1) rate of 1.536 Mbps. The V.35 NRZ signals from DTE 106 may be converted to CMOS and/or TTL signals in the HDSL CSU/DSU (not shown) comprising transceiver 102. Then transceiver 102 could generate HDSL signals using a 2B1Q line code (i.e., 4 level PAM) for transmission over the communications media to another transceiver utilizing the preferred embodiment of the present invention. In this case, the 2B1Q HDSL signals would not be called analog signals in some contexts, and correspondingly the transceiver 102 generating such 2B1Q HDSL signals would not be considered to perform analog-to-digital conversion. However, the preferred embodiments of the present invention are general and still apply to this kind of use of PAM.

Non-Limiting Example of an Echo Canceller

FIG. 1b further shows a block diagram of a potential implementation of an echo canceller 104. Note that the echo canceller 104 of FIG. 1b is only one possible way of implementing an echo canceller, and those skilled in the art will be aware of many other implementations. In general, the echo canceller 104 is connected between the transmit path 118 and the receive path 120 of a communication device such as transceiver 102. Basically, echo cancellation technology involves estimating the echo and subtracting this estimate from the incoming signal. Because echo generally is a function of the transmitted signals, in an echo canceller 104 some hardware and/or software generally performs an echo estimator 167 function by using the outbound information of the communication device as input to the echo estimator 167. Echo estimator 167 generally would take input from the transmit path 118 and generate an echo estimate 169 as output. Because echo in a communication medium or transmission line may include the sum of the echoes from previous transmissions, an echo estimator 167 often involves using various time delayed versions of the outbound signals. This delay of various signal echoes is shown in FIG. 1b as time delays 171, 172, 173, and 174, which often are implemented as memory in digital systems.

In general, the mathematical models of echo are infinite series. However, in reality at some point the echoes of echoes or reflections of reflections become so small that they generally are indistinguishable from background thermal noise in the communication system. Also, it is expensive in terms of hardware and/or software to include more and more time-delayed versions of the transmit signal in the computation of an echo estimate. Thus, at some point there are diminishing returns from trying to use more time-delayed versions of the previous transmissions to have closer approximations to infinite series. Therefore, real-world echo cancellers 104 generally have a finite limit on the number of time delayed versions of previous transmissions that are included in an echo estimate computation. In general, echo estimator 167 might use N time-delayed versions of the transmitted signals with each version numbered with the integers 1 to N.

Echo estimator 167 generally takes the time-delayed versions of the previously transmitted signals and multiplies them in multipliers 176, 177, 178, and 179 by coefficients C1, C2, C3, and CN at multiplier inputs 181, 182, 183, and 184, respectively. Basically the coefficients C1, C2, C3, and CN provide a scaling function to estimate the amount of attenuation that would have occurred as the transmitted signals propagate in the medium before the attenuated version of the signals is received back in the receive path as an echo. Often the coefficients C1, C2, C3, and CN of an echo estimator 167 are determined during device training when the characteristics of the transmission facilities, lines, and/or channels are tested. However, those skilled in the art will be aware that the coefficients C1, C2, C3, and CN used in echo cancellation might be determined through other means instead of or in addition to device training. As a non-limiting example, the coefficients C1, C2, C3, and CN might be determined by independent equipment or models of echo and manually configured through the control panel 122, although this would be a very tedious process.

After the time-delayed versions of the previously transmitted signals are scaled with coefficients C1, C2, C3, and CN through multipliers 176, 177, 178, and 179, respectively, the results are added together in adders 185, 186, and 187 to come up with the echo estimate 169. This echo estimate 169 is subtracted from the signals in the receive path 120 to try to estimate the correct receive signal. In digital communications where transmissions generally are at discrete time increments, switch 193 shows that the echo estimate 169 is subtracted from the signals in the receive path 120 generally at discrete or integer multiples, K, of a time clock with period T. The subtraction of the echo estimate 169 from the signals in the receive path 120 takes place in FIG. 1b at adder 195.

Non-Limiting Example of a Transceiver Implementation

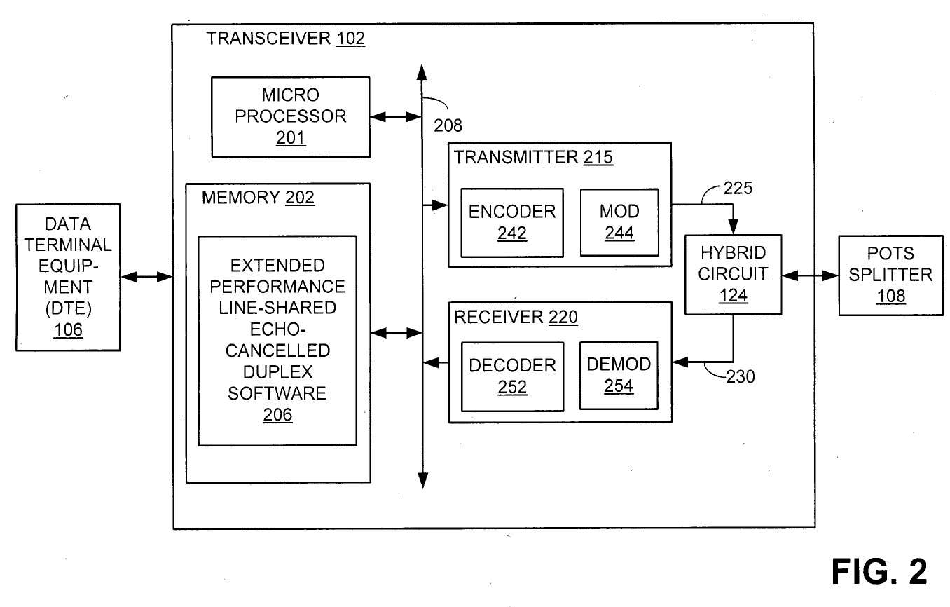

FIG. 2 is a block diagram of one possible stored program control system implementing the transceiver 102 of FIG. 1a. Transceiver 102 includes microprocessor 201, memory 202, transmitter 215 and receiver 220 in communication via logical interface 208. Memory 202 could be used to store the extended-performance, echo-canceller system software 206. Furthermore, memory 202 may store the communication parameters that were associated with memory 152 in FIG. 1a. Those skilled in the art will be aware of many ways of putting the instructions (or code) and/or data (such as but not limited to communication parameters) into a single memory or dividing the information across many different memory storage mechanisms of different types and/or technologies. Often this division of information into different storage mechanisms is based on the costs, size, and performance characteristics of the memory and/or storage technologies. Any type of memory/storage architecture and/or technology for transceiver 102 is intended to be within the preferred embodiments of the present invention.

In general, one skilled in the art will be aware that a stored program control system with a microprocessor 201 may operate by fetching an instruction (such as the instructions to perform the preferred embodiments of the present invention) from memory 202 (or any other storage location, not shown), decoding the instruction, and executing the instruction. The extended-performance, echo-canceller system software 206 shown in memory 202 may execute as software in microprocessor 201 in order to achieve and perform the benefits of the present invention. Those skilled in the art will be aware of the many ways of using hardware implementations instead of or in addition to at least part of a transceiver that is implemented with a microprocessor 201 that generally performs a fetch-decode-execute loop.

In general, transceiver 102 facilitates the bi-directional communication of information between a source/destination such as DTE 106 and an interface with communication facilities such as found at the connection between POTS splitter 108 and hybrid circuit 124. A transceiver 102 often has circuitry, logic, and/or software such as transmitter 215 and receiver 220 to handle transmitting and receiving, respectively, on communications media or facilities. As shown in FIG. 2 for the transceiver 102 that might be used on a DSL line, transmitter 215 has connection 225 to hybrid circuit 124 for transmitting on the communications media between hybrid circuit 124 and POTS splitter 108. In addition, receiver 220 has connection 230 to hybrid circuit 124 for receiving from the communications media between hybrid circuit 124 and POTS splitter 108. As was previously shown in FIG. 1a, the POTS splitter 108 may be connected to communication facilities such as, but not limited to, a digital subscriber line (DSL).

Transmitter 215 includes, among other elements that are known to those having ordinary skill in the art, encoder 242 and modulator 244. Similarly, receiver 220 includes, among other elements that have been omitted for clarity but are known to those having ordinary skill in the art, decoder 252 and demodulator 254. Thus, at least some of the operation of transmitter 215 might be further broken down into encoder 242 and modulator 244. In general, the encoding function in encoder 242 is the process of mapping information (often represented in binary form as a series or string of data bits) from the data terminal equipment 106 to representations of symbols. The symbols often correspond to various physical characteristics and phenomena of electromagnetic waves and often may be defined by various quantities specifying some of the characteristics of the electromagnetic waves. Also, sometimes the information is encoded in the change from one electromagnetic wave to another electromagnetic waves such as in a phase shift. Furthermore, sometimes only the change in information from one state to the next (e.g., the change in bits) is encoded as opposed to the actual bits of the current state. These and other information coding methods are well known by one of ordinary skill in the art.

Generally, the modulator 244 actually forms the continuous-time signal that is transmitted into the communications medium. Although digital communications generally involves discrete amounts or quanta of information transmitted and received during discrete intervals of time, the actual signals transmitted in the physical world generally are continuous-time signals. A receiver, such as receiver 220, of the signals is usually responsible for sampling the incoming continuous-time signals at various time intervals. Also, in digital communications the receiver 220 generally has to attempt to recover the originally transmitted quanta of information by making decisions at discrete time intervals on the sampled continuous-time waveform.

Thus, the modulation function generally is the process of converting the mapped incoming series of bits (or potentially a representation of information in a number base other than binary base two) from the data terminal equipment 106 into a continuous-time analog signal. The incoming information (which usually is a series of bits) is commonly processed in the transceiver 102 as groups (or groups of bits). The size of the groups (or bit groups) often depends upon the line coding employed by transceiver 102. Furthermore, a complete integer number of bits need not be utilized in each symbol clock interval. (See for example, U.S. Pat. No. 5,103,227, “Modulus Converter for Fractional Rate Encoding” to William L. Betts.) A complementary transceiver (not shown) converts the continuous time analog signal back into digital form (usually in base-two binary digits or bits).

Also, at least some of the operation of receiver 220 might be further broken down into decoder 252 and demodulator 254. In general, demodulator 254 performs the process of converting a received continuous time analog signal into discrete symbols of information. Then the decoder 252 generally performs the process of mapping the best estimate of the symbol to the appropriate discrete representation of the information, which usually is in the binary form of a series or string of bits.

The extended-performance, echo-cancelled duplex system of the present invention can be implemented in hardware, software, firmware, or a combination thereof. In the preferred embodiment(s), the extended-performance, echo-cancelled duplex system is implemented in software or firmware that is stored in a memory and that is executed by a suitable instruction execution system. If implemented in hardware, as in an alternative embodiment, the extended-performance, echo-cancelled duplex system can be implemented with any or a combination of the following non-limiting technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The extended-performance, echo-cancelled duplex system program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions for the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The operation of the extended-performance, echo-cancelled duplex system is provided below in regard to CAP/QAM transmission. However, extended-performance, echo-cancelled duplex system may be applied to any transmission technology, such as PAM, as is apparent to those having ordinary skill in the art in light of the current disclosure.

In general, all echo cancellation technologies have a limit to their echo-cancellation ability. This results in some level of residual echo or noise appearing in the received signal. Thus, the echo cancellation technologies recognize a “self-noise floor” that is a direct function of the transmit signal level. The self-noise floor is generally independent of the received signal level. Thus, for a given channel noise level, such as that due to near-end crosstalk (NEXT), the self-noise adds to the channel signal-to-noise ratio (SNR). In many cases the self-noise becomes the limiting factor of the transmitter. In contemporary echo-cancellation technology for bi-directional communication, reducing the local transmit signal level allows reception of lower received signal levels. However, in contemporary echo-cancellation technology there is no net improvement in SNR, and thus no performance improvement, because the remote transmitter signal level must also be reduced for the same reason. The extended-performance, echo-cancelled duplex system provides controlled reductions in transmitter signal level and data rate, thus overcoming this limitation of contemporary echo-cancellation technology.

Communication System Models

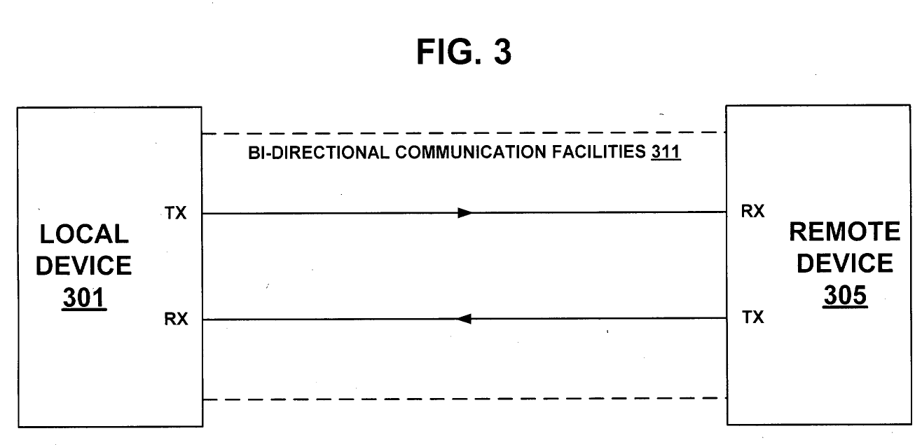

FIG. 3 shows a simplified communications system with two devices in communication. For the sake of convenience, the devices in the communications system are referred to as a local device 301 and a remote device 305 that communicate through bi-directional communications facilities 311. However, the use of the terms local and remote is not intended to limit the embodiments of the present invention. The local and remote terms are only used to establish reference directions by which the concepts of the preferred embodiments can be more easily described. The use of the terms local and remote does not imply anything about the actual physical location of the devices.

The bi-directional communications facilities 311 could be provided through the use of four-wire duplexing, time-division duplexing, frequency-division duplexing, echo-cancelled duplexing, and/or variations thereof such as, but not limited to, an embodiment of the present invention. For these various technologies, the bi-directional communications facilities 311 may include, but are not limited to, one or more communications media, one or more time-division channel, and one or more frequency-division channel. Thus, the communication facilities 311 actually might be one or more channels in one or more communications media that are carrying other signals (potentially in other channels) using various forms of multiplexing.

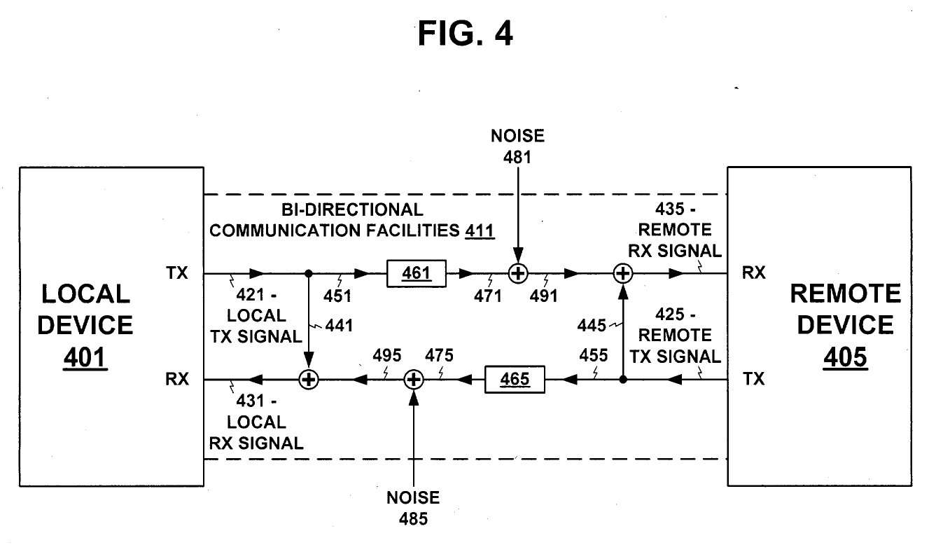

Furthermore, while FIGS. 3 and 4 show two devices communicating through bi-directional communication facilities 311 and 411 that might be physical constrained media such as wires, fiber, and/or a wave guide, one skilled in the art will be aware that the concepts of the preferred embodiments of the present invention also may be applied in the wireless context. Estimating echo in the wireless context may be a little more difficult than estimating echo in a constrained media communication system. Moreover, estimating echo may be somewhat easier in a fixed wireless communication system as opposed to a mobile wireless communication system. However, assuming that a fixed and/or mobile wireless system uses some form of echo cancellation, the preferred embodiments of the present invention also likely will improve the performance of such a wireless communication system. In addition to wired and/or wireless electromagnetic communications, the preferred embodiments of the present invention will work if the signals carrying the information are not be electromagnetic waves, but instead are other types of waves including, but not limited to, pressure waves such as acoustic waves and/or aquatic waves.

FIG. 4 shows a more complex (but still idealized) model of a communications system including some echo and channel noise. Local device 401 communicates with remote device 405 through bi-directional communications facilities 411. Local device 401 transmits a local transmit signal 421 and receives a local receive signal 431. Remote device 405 transmits a remote transmit signal 425 and receives a remote receive signal 435. The communications facilities 411 show an idealized single impedance mismatch in the local-to-remote direction that causes part of the energy of local transmit signal 421 to be reflected back towards the local device 401 as local receive echo noise 441, while part of the energy continues in the original direction resulting in attenuated signal 451. Also, the communications facilities 411 show an idealized single impedance mismatch in the remote-to-local direction that causes part of the energy of remote transmit signal 425 to be reflected back towards the remote device 405 as remote receive echo noise 445, while part of the energy continues in the original direction resulting in attenuated signal 455. Although these points of impedance mismatch in the local-to-remote and remote-to-local directions are a point source of attenuation in the idealized model of FIG. 4, in reality many factors cause attenuation of signals as they propagate through communications media. Generally, increases in the distance of propagation result in increases of the attenuation of signals, and signal attenuation is not a point source phenomena. Also, real-world communication facilities generally may have multiple impedance mismatches at different points along the transmission line media.

Attenuated signal 451 enters the local-to-remote communication channel represented by block 461, which generally may be associated with frequency dependent signal loss and phase change that results in signal 471 at the remote end of the communications facilities 411. Similarly, attenuated signal 455 enters the remote-to-local communication channel represented by block 465, which generally may be associated with frequency dependent signal loss and phase change that results in signal 475 at the local end of the communications facilities 411. Also, communications facilities 411 are affected by local-to-remote channel noise 481 that is shown as an idealized point source. In addition, communications facilities 411 are affected by remote-to-local channel noise 485 that also is shown as an idealized point source. In reality the way that noise impinges on a communications facility may be much more complicated than as a point source. Also, for some analyses the local-to-remote channel noise 481 may be the same as the remote-to-local channel noise 485.

As shown in FIG. 4, local-to-remote channel noise 481 is added to signal 471 to result in noise-impaired signal 491. Similarly, remote-to-local channel noise 485 is added to signal 475 resulting in noise-impaired signal 495. The additive nature of the communications facilities 411 causes the local receive echo noise 441 to be added to noise-impaired signal 495 with the result being local receive signal 431. Similarly, the additive nature of the communications facilities 411 causes the remote receive echo noise 445 to be added to noise-impaired signal 491 with the result being remote receive signal 435. Those skilled in the art will recognize the idealized nature of this model and realize that the concepts of the preferred embodiments of the present invention apply not only to this idealized model of FIG. 4, but also to other models of communication systems. Though the idealized model of FIG. 4 may not accurately depict real-world communication systems with real-world impairments, the model is a useful aid that helps in understanding the preferred embodiments of the present invention.

In addition to the relationship between local device 301 (or 401) and remote device 305 (or 405) in FIGS. 3 and 4, communications systems often have communication parameters that generally help to characterize the behavior and communications of devices in a communications system. Often at least some of these communication parameters are stored in the devices of the communication system. Sometimes the communication parameters are negotiated between and/or among devices in the communication system to better adapt the communication devices to various conditions. Thus, the behavior of the communication system in FIGS. 3 and/or 4 often may be at least partially characterized by various communication parameters.

Overview of Signal Constellations or Signal Space Diagrams

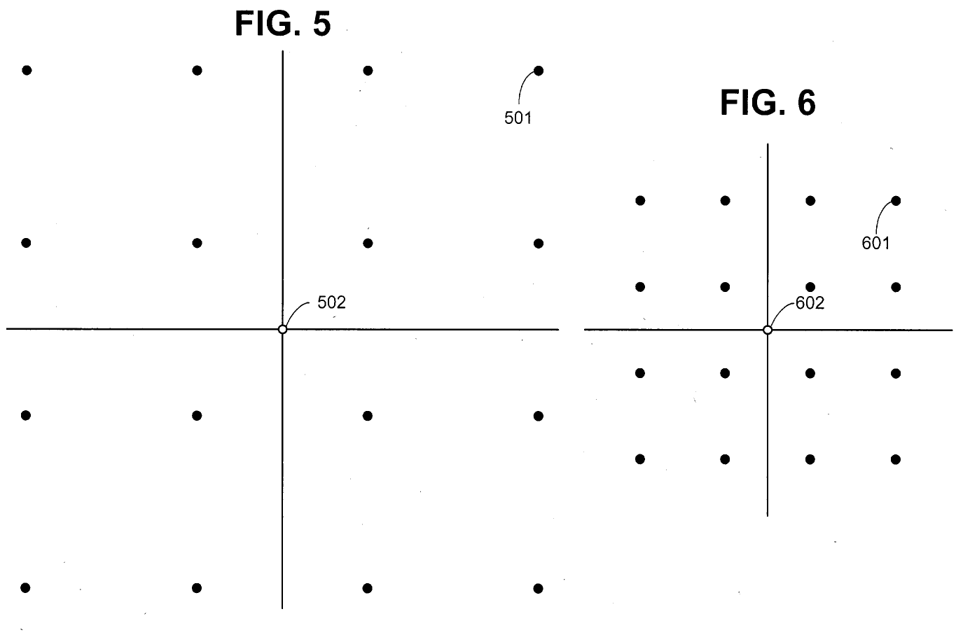

The number of signal points in the signal space diagrams of FIGS. 5-12, 15a-17b, and 20a-23b is not intended to be limiting and is only used as an example to more clearly explain the concepts of preferred embodiments of the present invention. Instead of focusing on the exact number of signal points in any of the signal spaces of FIGS. 5-12, 15a-17b, and 20a-23b, it is more relevant to consider the changes in the signal spaces from one figure to the next in understanding the concepts of the preferred embodiments of the present invention. Those skilled in the art will recognize that the concepts of the preferred embodiments of the present invention apply to other signal spaces in addition to the simplistic signal spaces used in the figures to illustrate the concepts of the preferred embodiments of the present invention. Also, black dots, white dots, and circles are used as signal points and/or distributions in the signal spaces of FIGS. 5-12, 15a-17b, and 20a-23b as a method of graphically differentiating one type of signal point and/or distribution from another type of signal point and/or distribution. The color of the dots and circles is not intended to imply any limitations.

Furthermore, each signal point in a signal space generally represents a physical phenomena of electromagnetic waves. Also, because communication systems need to know when to sample the physical phenomena of the electromagnetic waves to properly recover the encoded information, each signal point (representing a physical phenomena) generally is associated with a duration. In general, the duration for the signal points in a signal space is the same for each signal point. The duration of the signal points in a signal space generally is directly related to the symbol clock period or interval, and the duration of the signal points in a signal space generally is inversely related to the symbol clock rate or symbol rate. Thus, although some forms of communicating information and modulating signals, such as but not limited to pulse width modulation (PWM), may have different durations for each symbol, more commonly the durations of each signal and associated symbol in a signal space are approximately the same. Also, the time it takes to change from one transmitted symbol to the next transmitted symbol generally is the symbol clock period (or 1/symbol clock rate). These types of timing information on the duration of a signal and the rate at which signals change from one symbol to the next symbol (i.e., the symbol clock rate) generally are not conveyed in the graphical representations of signal constellations or signal space diagrams.

In addition, the two axes in FIGS. 5-12, 15a-17b, and 20a-23b might represent the amplitude of the in-phase (I) and the quadrature phase (Q) cosine and sine waves of quadrature amplitude modulation (QAM). As known in the art, the modulations of the amplitude of a sine wave and a cosine wave, which generally have the same base frequency, and which are combined or added together, generally result in the equivalent modulation of the amplitude and phase of the combined sinusoidal waveform. This result generally follows from the basic trigonometric angle addition formulas. QAM and CAP are two examples of modulation techniques that encode information based on changing the amplitudes and/or phases of the physical phenomena of electromagnetic waves. One skilled in the art will recognize that other signal space diagrams are used for other modulations (such as but not limited to PAM) that also apply to the preferred embodiments of the present invention. Moreover, one skilled in the art will be aware that many real-world communication systems support significantly more signal points in a signal space than are shown in the illustrative signal spaces of FIGS. 5-12, 15a-17b, and 20a-23b. The preferred embodiments of the present invention also apply to these signal spaces of different sizes (i.e., with a larger and/or smaller number of signal points).

Although the signal space diagrams of FIGS. 5-12, 15a-17b, and 20a-23b display the signal points of the signal spaces, the diagrams do not display the timing and/or durations of the physical phenomena of the signal points in the signal spaces. As a non-limiting example, a signal point in a signal space may represent transmitting a voltage cosine wave at a specific amplitude for a certain duration. This time-related nature of the signal points in signal space is well-known to those skilled in the art. In many modulation techniques, the signal points in signal space generally have the same duration. Also, many modulation techniques change from transmitting a signal representing one symbol to a signal representing another symbol at a symbol clock rate that is not explicitly displayed in the signal space diagrams of FIGS. 5-12, 15a-17b, and 20a-23b. In general, when the signal points in a signal space have the same duration, the symbol clock rate (or symbol rate) generally indicates how fast the communication system can change from communicating one signal point to communicating another signal point in the signal space. Thus, signal spaces generally comprise signal points, durations, and symbol rates, which generally may be thought of respectively as different physical phenomena of electromagnetic waves, the duration of a physical phenomena, and the rate of changing from one physical phenomena to another physical phenomena. Changing the duration and/or the symbol rate in a communications system effectively changes the signal space by altering the duration of the signal points and associated physical phenomena. However such a change in the duration and/or symbol rate of the points in a signal space generally would not be shown graphically in symbol space diagrams or signal constellations.

FIG. 5 shows a transmit signal space with the sixteen black dots each being a point in the transmit signal space. Signal point 501 is one exemplar of the sixteen black dots in the transmit signal space of FIG. 5. The choice of sixteen signal points in the transmit signal space of FIG. 5 is not intended to be limiting, and the number of signal points is just used to clearly illustrate the concepts of the preferred embodiments of the present invention. The white dot 502 at the axis cross-point of the signal space represents silence in FIG. 5. The transmit signal space of FIG. 5 might be transmitted by local device 301, local device 401, remote device 305, and/or remote device 405 during various modes of operation.

FIG. 6 shows a receive signal space that could be an attenuated version of the FIG. 5 transmit signal space after transmission through a communication facility such as bi-directional communication facilities 311 or bi-directional communication facilities 411. The FIG. 6 signal space generally might represent an attenuated version of the FIG. 5 signal space in the absence of noise. The signal space of FIG. 6 might represent received signals after equalization, but before amplification. The receive signal space of FIG. 6 has sixteen black dots each being a point in the receive signal space. Signal point 601 is one exemplar of the sixteen black dots in the receive signal space of FIG. 6. The choice of sixteen signal points in the receive signal space of FIG. 6 is made to match the sixteen signal points of FIG. 5 and is not intended to be limiting. The number of signal points is just used to clearly illustrate the concepts of the preferred embodiments of the present invention. The white dot 602 at the axis cross-point of the signal space represents silence in FIG. 6. The receive signal space of FIG. 6 might be received by local device 301, local device 401, remote device 305, and/or remote device 405 during various modes of operation.

According to Shannon's 1948 paper, “If a particular transmitted signal always produces the same received signal, i.e., the received signal is a definite function of the transmitted signal, then the effect may be called distortion. If this function has an inverse—no two transmitted signals producing the same received signal—distortion may be corrected, at least in principle, by merely performing the inverse functional operation on the received signal.” Thus, as shown in FIG. 5 and FIG. 6, the distortion of attenuation that occurs in the idealized communications facilities causes the transmit signal space of FIG. 5 to result in the receive signal space of FIG. 6. Because this attenuation effect of the communication facilities produces the same result on each transmission, an inverse function can be found to correct for the distortion. In the case of the distortion causing the transmit signal space of FIG. 5 to result in the attenuated receive signal space of FIG. 6, an amplification function will provide an inverse of the attenuation distortion.

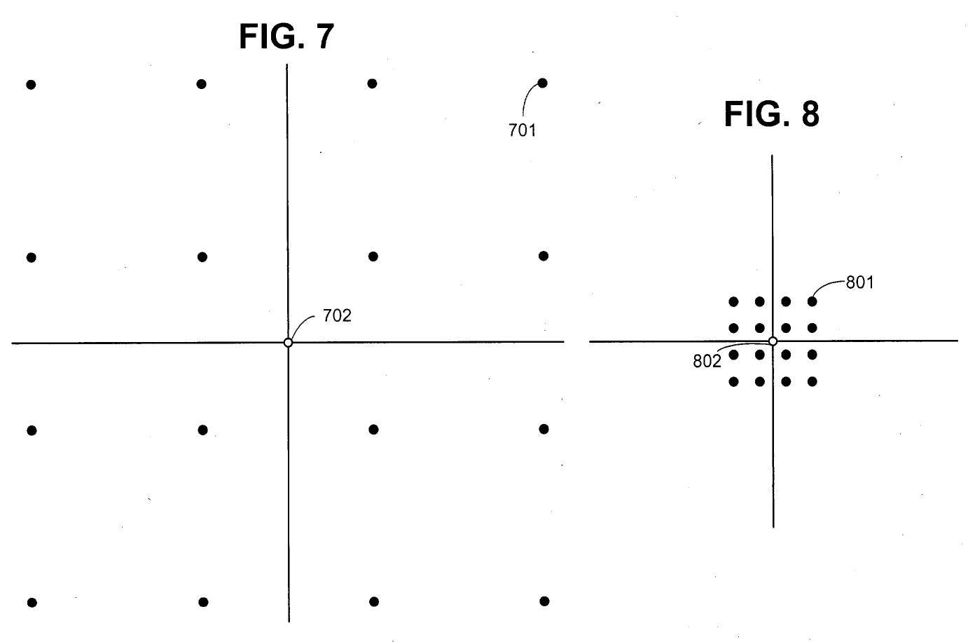

FIG. 7 shows how the receive signal space of FIG. 6 could be amplified to exactly recover the transmit signal space of FIG. 5. Thus, FIG. 7 is an amplified version of the receive signal space of FIG. 6. The receive signal space of FIG. 7 has sixteen black dots each being a point in the amplified receive signal space. Signal point 701 is one exemplar of the sixteen black dots in the amplified receive signal space of FIG. 7. The choice of sixteen signal points in the receive signal space of FIG. 7 is made to match the sixteen signal points of FIG. 6 and is not intended to be limiting. The number of signal points is just used to clearly illustrate the concepts of the preferred embodiments of the present invention. The white dot 702 at the axis cross-point of the signal space represents silence in FIG. 7. The amplified receive signal space of FIG. 7 might be created in local device 301, local device 401, remote device 305, and/or remote device 405 during various modes of operation.

The use of amplification in an exact recovery of the receive signal space of FIG. 7 that matches the transmit signal space of FIG. 5 generally depends on, among other things, idealized communication facilities that are not affected by noise or any non-linearities in the communication channel. However, unlike analog communications, error-free digital communications generally does not need such idealized transmission facilities and conditions. Instead, in digital communications the receiver generally just needs to be able to properly detect the receive signal and correctly perform a mapping back to the originally transmitted signal. This difference in communication processes allows digital communications generally to be more noise resistant than analog communications.

The Theory of Echo and Echo Cancellation

FIG. 8 shows a diagram that could represent echoes of the transmit signal space of FIG. 5 as the echoes are reflected back towards the transmitting device from a single reflection corresponding to a single impedance mismatch in the transmission line or communication media. In general, the idealized echo signal space of FIG. 8 is an attenuated version FIG. 5 with echo noise point 801 being one exemplar of the sixteen black dots in the echo signal space of FIG. 8. The choice of sixteen signal points in the echo signal space of FIG. 8 is made to match the sixteen signal points of FIG. 5 and is not intended to be limiting. The number of echo noise signal points is just used to clearly illustrate the concepts of the preferred embodiments of the present invention. The white dot 802 at the axis cross-point of the signal space represents silence in FIG. 8.

Even for an idealized model, which has an echo signal space of FIG. 8 that is an attenuated version of the transmit signal space of FIG. 5, the echo signal may be different from the transmit signal in other ways such as, but not limited to, frequency-dependent amplitude variation and phase variation. Also, the echo signal is at the very least a time-shifted version of the transmitted signal because it takes propagation time for the transmitted signal to reach a transmission line impairment and more propagation time for the echo to return to the receiver of the device that originally transmitted the signal. In addition, if FIGS. 5-12 generally are QAM constellation diagrams, then the axes relate to the in-phase (I) and quaternary-phase (Q) portions of the sine and cosine components. To the extent that propagation delays through the transmission line cause the received echo signal to have a different phase than the originally transmitted signal, the echo signal space of FIG. 8 may actually be not only attenuated but also rotated relative to the example transmit signal space of FIG. 5. With QAM modulation, the signal space representations using axes that represent sine and cosine component waves would be rotated at least by the phase shift corresponding to the propagation delay from the transmitted signal propagating to the single impedance and the reflection of the signal propagating back from the impedance. Also, the reflection itself may cause a phase shift.

Furthermore, the echo signal space of FIG. 8 is idealized to the extent that multiple reflections or echoes due to multiple impedance mismatches in a communication system generally may result in the received echo signal including components from multiple previous transmissions that have been reflected back at the various impedance mismatch points in the transmission line. Thus, the resulting echo at a receiver generally may include some components from several previous transmissions. Moreover, when echo includes the summation of several signal components with different delays, the one-to-one correspondence may no longer exist between transmitted signal points and the signal points of the received echo. These additional reflections from multiple impedance mismatches generally make it more difficult to perfectly estimate the effect of echo on the received signal. In general, echo cancellation technology depends on estimating or predicting the echo in the received signal. To the extent that the estimates of echo are imperfect, echo cancellation is imperfect.

Because of imperfections in echo cancellation, the echo signal space of FIG. 8 likely will result in a residual echo noise after echo cancellation has been performed. In general, echo cancellation tries to estimate the amount of echo in the received signal and subtract this amount from the received signal. To the extent that echo cancellation technology underestimates the echo in the received signal, echo cancellation does not fully cancel all of the echo. To the extent that echo cancellation technology overestimates the echo in the received signal, echo cancellation subtracts too large an amount from the received signal.

Furthermore, because the echo signal generally cannot be perfectly predicted, echo cancellation technology generally cannot perform a perfect inverse function to perfectly remove echo from the received signal. Based on the terminology of Shannon's 1948 paper, generally the lack of a perfect inverse function in echo cancellation technology results in residual echo noise as opposed to potentially correctable distortion. This lack of a perfect inverse function may occur due to echo being the summation of components at various delays from multiple impedance mismatches. The summation of echo components in an additive channel might destroy a one-to-one relationship between the transmitted signals and the received echo. In addition, channel non-linearities might destroy the ability to perform an inverse function that perfectly eliminates the effects of echo in the receive signal.

As a result of these problems, echo cancellation technology has some residual noise floor that might be called residual echo noise. However, the residual echo noise may be caused not only by the echo signal, but also by the imperfect echo estimation of the echo cancellation technology. If the echo cancellation technology uses an unbiased estimator or predictor of the echo signals, then the average error generally will be zero with the positive and negative echo estimation errors canceling each other out on average.

Also, the echo cancellation technology may well result in a Gaussian distribution for the residual echo cancellation noise. If the residual echo noise is a Gaussian random variable, and if the other noise in the channel is Gaussian, then the total noise will be Gaussian for an additive channel. This result occurs because sums of Gaussian random variables are themselves Gaussian random variables. If the total noise from the channel and residual echo noise is Gaussian, then the Shannon-Hartley coding capacity theorem for a band-limited additive Gaussian white noise (AWGN) channel may apply to the communication system including the echo cancellation technology. However, the concepts of the preferred embodiment of the present invention are not limited to the residual echo noise having a Gaussian distribution.

In general, the echo signal space may not look exactly like FIG. 8 because echo could be based not only on initial reflection of signals at a first impedance mismatch, but also the summation of other components of echo from additional impedance mismatches in a transmission line or communication medium. Each impedance mismatch will cause some energy to be reflected back against the previous direction of propagation. Because of propagation delays, the echo signal likely will be a summation of various time-delayed and attenuated versions of the transmit signal. Echo cancellation technology attempts to deal with these various time-delayed versions of the transmit signal by subtracting various versions of the transmitted signal.

In contrast to the general memory-less model of a communications medium, echo cancellation technology generally includes memory to maintain information about previously-transmitted signals and to perform the subtraction of various previously-transmitted versions of the signals. In such a real-world communication system using echo cancellation, there might not be a one-to-one correspondence between the signal points in the transmit signal space of FIG. 5 and the echo noise points in the echo signal space of FIG. 8. Instead echo from previous signals (including signals originally transmitted both by the local device and the remote device and the potential multiple reflection of those original signals) is likely to result in a distribution of noise as opposed to the sixteen distinct signal points of FIG. 8. Although echo cancellation technology may tend to remove some of the echo noise, thus making the distribution of echo noise smaller, the imperfection of real-world echo cancellation technology still leaves a residual amount of echo noise that also is a noise distribution.

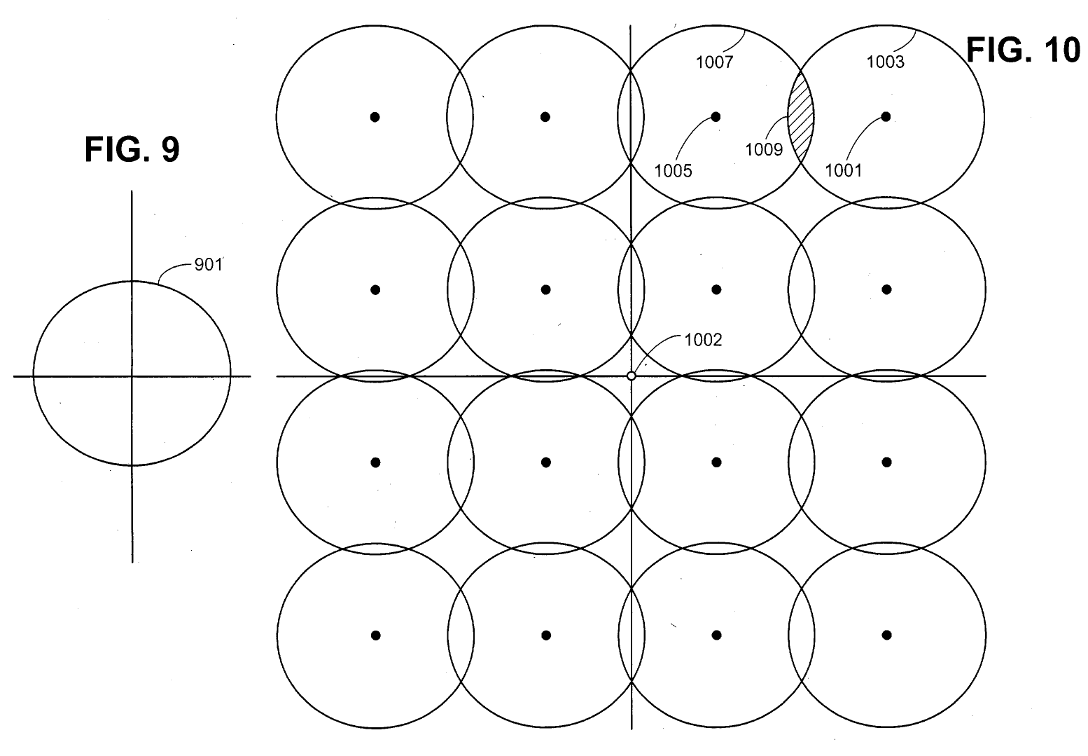

FIG. 9 shows another signal space diagram that could represent the distribution of echo noise for the communication example of FIGS. 5-12. Circle 901 in FIG. 9 might represent an approximation of the area containing most of the energy from the echo noise. In general, the distribution of noise including echo noise is a probability distribution. However, communication systems are usually designed by specifying an arbitrary bit error rate (BER) such as 1 bit error in 1,000,000,000 bits or 10⁻⁹ BER. Based on the arbitrarily specified bit error rate (BER), the circle 901 of FIG. 9 might contain a certain percentage of the energy distribution associated with echo noise.

FIG. 10 shows how the echo noise of FIG. 9 can be added to the receive signal space of FIG. 7 to illustrate the resulting amplified received signal space and the effect of amplified echo noise that is received. In FIG. 10 it is assumed that both local device 301 and/or 401 and remote device 305 and/or 405 are contemporaneously transmitting and receiving using the transmit signal space of FIG. 5 and using the amplified receive signal space of FIG. 7. Furthermore, both local device 301 and/or 401 and remote device 305 and/or 405 are also assumed to be receiving the echo noise of FIG. 9.

In FIG. 10, the sixteen black dots, with black dot 1001 being one exemplar, represent the sixteen signal points of FIGS. 5 and 7. In addition, the small white dot 1002 represents the reception of silence. The larger circles, with circle 1003 being one exemplar, represent the graphical addition of the echo noise from FIG. 9 to the sixteen signal points from FIGS. 5 and 7. The addition can be performed graphically by considering each black dot (as exemplified by signal point 1001) of FIG. 10 to be an origin onto which the echo noise signal space of FIG. 9 is overlaid. Graphical additions of the signal spaces in the figures are only described to help better understand the preferred embodiments of the present invention and are not intended to introduce any limitations on the way signals are added together in a communication system. Thus, the signal space of FIG. 10 shows a graphical representation of the addition of the echo noise signal space of FIG. 9 with the receive signal space of FIG. 7. The graphical addition of the echo noise signal space of FIG. 9 with the receive signal space of FIG. 7 to yield the signal space of FIG. 10 is idealized based on a linear system. However, this linearity is only an idealized condition, and the concepts of the preferred embodiments of the present invention are not limited to perfectly linear communication facilities, media, systems, and channels. The linearity of additions in the figures is not intended to be limiting and is only used to more clearly illustrate the concepts of the preferred embodiments of the present invention.

The fact that the circles of FIG. 10 overlap indicates that the communication system would experience additional errors beyond the arbitrary threshold that could be specified in selecting the size of the circle 901 in FIG. 9 and the probability levels for containing the echo noise distribution. In the regions where the circles overlap, it is ambiguous as to which signal point was originally transmitted. For example, signal points 1001 and 1005 are nearest neighbors and the echo noise circle 1003 around signal point 1001 overlaps with the echo noise circle 1007 around signal point 1005. This overlap region is shown in FIG. 10 as the shaded area 1009. If a receiver detects energy in the overlap region 1009, it generally is indeterminate whether the transmitted signal point was signal point 1001 or signal point 1005. Similar ambiguity problems exist in the other overlap regions of FIG. 10. Therefore, decision regions generally cannot be specified in FIG. 10 without creating the probability of introducing errors in the decision making process of detecting a transmitted signal. Although not shown in FIG. 10, even when the transmission of a remote device is silent as represented by white dot 1002, the local device will still be receiving some echo from its own previous transmissions. The echoes from previous transmissions of a device take a small but not infinitesimal amount of time to attenuate to an imperceptible level relative to other noise in the communication system.

The signal space of FIG. 10 may result in communication errors because without additional information even a perfect detector cannot differentiate whether the transmitted signal point corresponds to signal point 1001 or corresponds to signal point 1005 when the received signal is in the overlapping portion 1009 of echo noise circles 1003 and 1007. Thus, for a memory-less receiver, the signal space of FIG. 10 has some uncertainty or ambiguity as to whether the reception of a signal that lies on the intersection 1009 of echo noise circle 1003 and echo noise circle 1007 is from the transmission of signal point 1001 or 1005. In his 1948 paper, Shannon called this situation equivocation and developed a mathematical measure of equivocation. For an error-free communication channel, equivocation is zero.

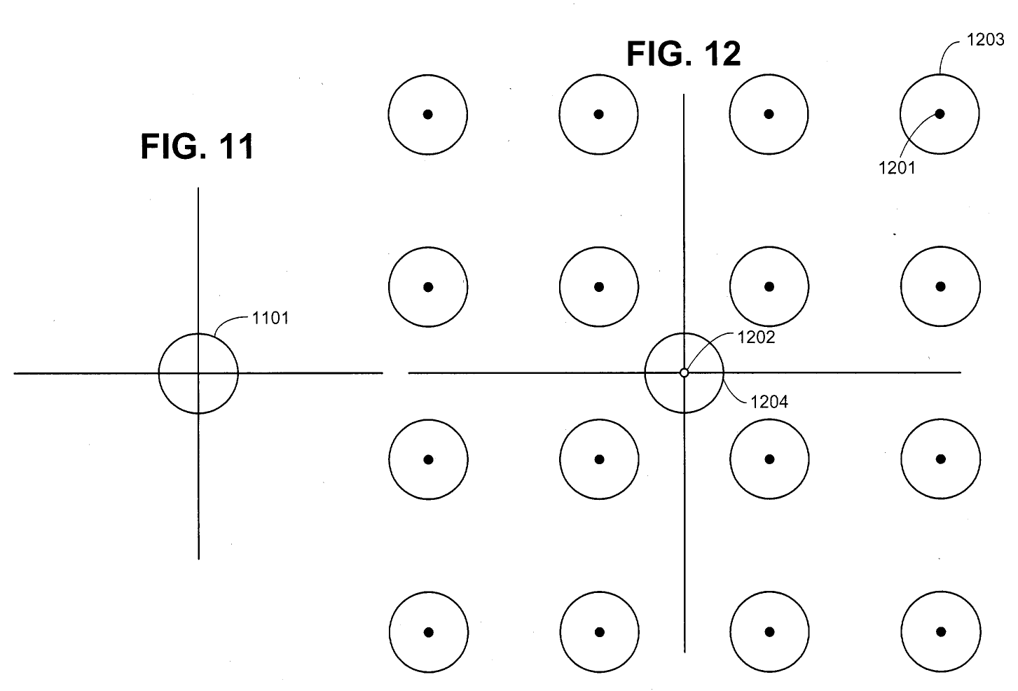

FIG. 11 shows the effect of echo cancellation technology on the echo signal space of FIG. 9. In comparing FIGS. 9 and 11, it can be seen that echo cancellation technology generally operates to reduce the echo noise such that circle 1101 is smaller than circle 901. However, the imperfections of echo cancellation technology still result in some residual echo noise. This residual echo noise also has a distribution, and circle 1101 in FIG. 11 might represent an approximation of the area containing most of the energy from the residual echo noise. Based on an arbitrarily specified bit error rate (BER), the circle 1101 of FIG. 11 might contain a certain percentage of the energy distribution associated with residual echo noise.

FIG. 12 shows how the residual echo noise of FIG. 11 can be added to the receive signal space of FIG. 7 to illustrate the resulting amplified received signal space and the residual effects of amplified echo noise after performing imperfect (and real-world) echo cancellation. In FIG. 12 it is assumed that both local device 301 and/or 401 and remote device 305 and/or 405 are contemporaneously transmitting and receiving using the transmit signal space of FIG. 5 and using the amplified receive signal space of FIG. 7. Furthermore, both local device 301 and/or 401 and remote device 305 and/or 405 are also assumed to be receiving the echo noise of FIG. 9 that is reduced through echo cancellation to the residual echo noise of FIG. 11.

In FIG. 12, the sixteen black dots, with dot 1201 being one exemplar, represent the sixteen signal points of FIGS. 5 and 7. In addition, the small white dot 1202 represents the reception of silence. The larger circles, with circle 1203 being one exemplar, represent the graphical addition of the residual echo noise from FIG. 11 to the sixteen signal points from FIGS. 5 and 7. The addition can be performed graphically by considering each black dot (as exemplified by signal point 1201) of FIG. 12 to be an origin onto which the residual echo noise signal space of FIG. 11 is overlaid. Graphical additions of the signal spaces in the figures are only described to help better understand the preferred embodiments of the present invention and are not intended to introduce any limitations on the way signals are added together in a communication system. Thus, the signal space of FIG. 12 shows a graphical representation of the addition of the residual echo noise signal space of FIG. 11 with the receive signal space of FIG. 7. The graphical addition of the residual echo noise signal space of FIG. 11 with the receive signal space of FIG. 7 to yield the signal space of FIG. 12 is idealized based on a linear system. However, this linearity is only an idealized condition, and the concepts of the preferred embodiments of the present invention are not limited to perfectly linear communication facilities, media, systems, and channels. The linearity of additions in the figures is not intended to be limiting and is only used to more clearly illustrate the concepts of the preferred embodiments of the present invention.

In contrast to FIG. 10, the fact that the circles of FIG. 12 do not overlap indicates that the communication system would not experience additional errors beyond the arbitrary threshold that could be specified in selecting the size of the circle 1101 in FIG. 11 and the probability levels for containing the residual echo noise distribution. Assuming a high-enough quality receiver, decision regions of FIG. 12 can be determined such that there is no ambiguity as to which signal point was transmitted by a remote device despite the residual echo noise. Thus, detection of energy in the circle 1203 would result in the unambiguous determination that the originally transmitted signal was signal point 1201. Similarly, detection of energy in the circle 1204 would result in the unambiguous determination that the transmitter had been silent as associated with white dot 1202. FIG. 12 also shows that even when the transmission of a remote device is silent as represented by white dot 1202, the local device might still be receiving some echo from its own previous transmissions as represented by circle 1204. The echoes from previous transmissions of a device take a small but not infinitesimal amount of time to attenuate to an imperceptible level relative to other noise in the communication system.

Thus, FIGS. 9-12 generally show how echo cancellation can improve the performance of a communication system that would otherwise experience errors due to the level of echo noise. However, echo cancellation technology cannot perfectly remove echo noise from the received signal because perfect removal of echo noise generally would need perfect prediction of the received echo. Furthermore, perfect prediction of received echo might well require infinite memory of all previously transmitted signals in the echo cancellation technology because in theory with multiple impedance mismatches the echoes or reflections generally result in sums of infinite series. However, because memory is costly, no real-world echo cancellation technology has infinite memory. Thus, for these and other various reasons, echo cancellation technology is not perfect, and there is some residual echo noise.

Although not shown in FIG. 12, even using echo cancellation technology, the residual echo noise from imperfections in echo cancellation may still result in some ambiguity about the originally transmitted signal point. If the receive signal space of FIG. 12 tried to communicate more signal points that were closer together, then even the smaller circle residual echo noise circle 1101 of FIG. 11 might also result in overlapping decision regions that create ambiguity in detecting the originally transmitted signal points. Therefore, an echo-cancelled duplex (ECD) communication system generally also may experience communication errors due to imperfect echo cancellation even though the system would likely experience even more errors without echo cancellation.

Ideal or perfect echo-cancellation is not achievable. DSL transmission systems generally include linear modem elements, non-linear modem elements, non-linear channel elements, and linear channel elements that prevent contemporary echo-cancellation technology from reaching ideal echo-cancellation. Non-linear modem elements that reduce the effectiveness of echo-cancellation technology include digital-to-analog converters and analog-to-digital converters. Linear channel elements that reduce the effectiveness of echo-cancellation technology include wire gauge changes and bridged taps. Non-linear channel elements that reduce the effectiveness of echo-cancellation technology include line-shared telephone sets, micro-filters, surge protection devices and POTS splitters. Performance degradation of contemporary echo-cancellation technology may be at least 6 dB at only moderate reaches. Such performance degradation is a very substantial problem for contemporary echo-cancellation technology. Regardless of the amount, there is generally is some echo-cancellation limitation which manifests itself as noise in the received signal.

Time Division Duplex (TDD)/Adaptive Time Division Duplex (ATDD)

One solution to the communication errors experienced in ECD generally is to stop simultaneously transmitting and receiving signals at each transceiver. In this case, there can be very little echo that affects the receive signal. (Even though the mathematical models of echoes or reflections with multiple impedance mismatches are the sums of an infinite series, at some point the echoes or reflections components of the series become negligible relative to other noise in the communications system.) Depending on the amount of time delay between the last transmission and the current signal reception and depending on the amount of time it takes for echoes or reflections to attenuate in the communications medium, the interference from echo can be made negligible relative to other noise in the communications system by using time-division duplexing (TDD).

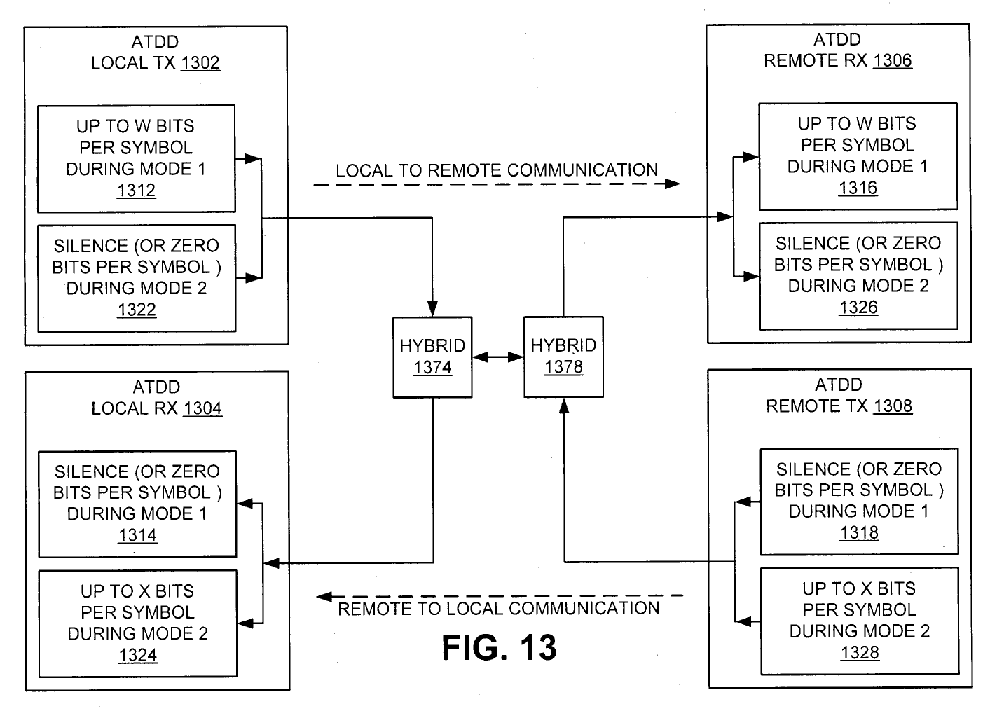

FIG. 13 shows a block diagram of communication devices that might be using TDD and/or ATDD. The local transceiver generally comprises local transmitter 1302 and local receiver 1304, while the remote transceiver generally comprises remote receiver 1306 and remote transmitter 1308. Local transmitter 1302 and remote receiver 1306 generally provide local-to-remote communication, while remote transmitter 1308 and local receiver 1304 generally provide remote-to-local communication. Furthermore, TDD and/or ATDD generally divides communication up into essentially or substantially (but not necessarily perfectly) non-overlapping intervals of time that might be known as mode 1 and mode 2 with respect to FIG. 13. In general, there is some small amount of time involved in switching between modes 1 and 2.

Furthermore, the local and remote devices might not switch between modes 1 and 2 at the exact same instant. The actual procedures used to cause the local and remote devices to switch modes may vary. As a non-limiting example, the local and remote devices may communicate with each other about switching between mode 1 and 2 in adaptive time division duplexing (ATDD). However, this communication on switching modes takes time to be propagated between the local device and the remote device. As a result, the two devices might not switch between modes 1 and 2 at the exact same instant of time. However, the two devices can be expected to change between modes 1 and 2 at approximately the same time. Another non-limiting example of mode switching in a fixed time division duplexing (TDD) arrangement might be based on the number of clock ticks that each device has received. However, even the distribution of synchronized clock information between the local device and the remote device also may require propagation time. Regardless of the use of different types of mechanisms to synchronize the local and remote devices, one skilled in the art will recognize that the switching between modes 1 and 2 in the local device may not occur at the exact same time as the switching between modes 1 and 2 in the remote device. Thus, at a detailed technical level, the absolute time during which the local device is in mode 1 (after switching from mode 2) might slightly overlap the absolute time during which the remote device is in mode 2 and preparing to switch to mode 1. Thus, mode 1 and mode 2 generally correspond to essentially or substantially (but not necessarily perfectly) non-overlapping intervals of time.

Referring again to FIG. 13, the local transmitter 1302 in TDD/ATDD may transmit up to W bits per symbol during mode 1 as shown in block 1312 that relates to local-to-remote communication during mode 1. Also, during mode 1, the remote receiver 1306 may receive up to W bits per symbol during mode 1 as shown in block 1316 that relates to local-to-remote communication during mode 1. During this time of mode 1, the reverse direction of communication (i.e., remote-to-local communication) is silent. This silence is shown in FIG. 13 as block 1318 of remote transmitter 1308 and as block 1314 of local receiver 1304. Silence generally may be thought of as zero bits per second as well as zero bits per symbol.

In switching between mode 1 and mode 2, a TDD/ATDD communication system switches the direction of communication between local-to-remote communication and remote-to-local communication. The remote-to-local communication during mode 2 is shown in FIG. 13 as remote transmitter 1308 transmitting up to X bits per symbol from block 1328 during mode 2 to local receiver 1304 receiving up to X bits per symbol in block 1324 during mode 2. Also, during mode 2 local-to-remote communication is silent as shown in FIG. 13 with local transmitter 1302 being silent (or transmitting zero bits per second and zero bits per symbol) within block 1322 while remote receiver 1306 is receiving silence (or not receiving at all or receiving zero bits per second and zero bits per symbol) within block 1326.

Also shown in FIG. 13, local transmitter 1302 and local receiver 1304 are connected to hybrid 1374, while remote receiver 1306 and remote transmitter 1308 are connected to hybrid 1378. As is known by one of ordinary skill in the art, the two hybrids 1374 and 1378 generally convert between four wire connections and a two wire transmission line or communication media between hybrid 1374 and 1378. Furthermore, TDD/ATDD may be used for symmetric communications in which W=X, so that both local-to-remote communication and remote-to-local communication may communicate up to the same number of bits per symbol. Alternatively, W may not equal X, so that TDD/ATDD may be used for asymmetric communication relative to the number of bits per symbol. In addition, the amount of time spent in mode 1 for local-to-remote communication does not have to equal the amount of time spent in mode 2 for remote-to-local communication. Also, the symbol rates in the two different directions may or may not be equal. Thus, many characteristics in TDD/ATDD communications may be either symmetric or asymmetric, and this description is not intended to be limited with respect to the symmetry or asymmetry of various aspects of TDD/ATDD communication.

Time Division Duplex (TDD)/Adaptive Time Division Duplex (ATDD) Timing Diagrams

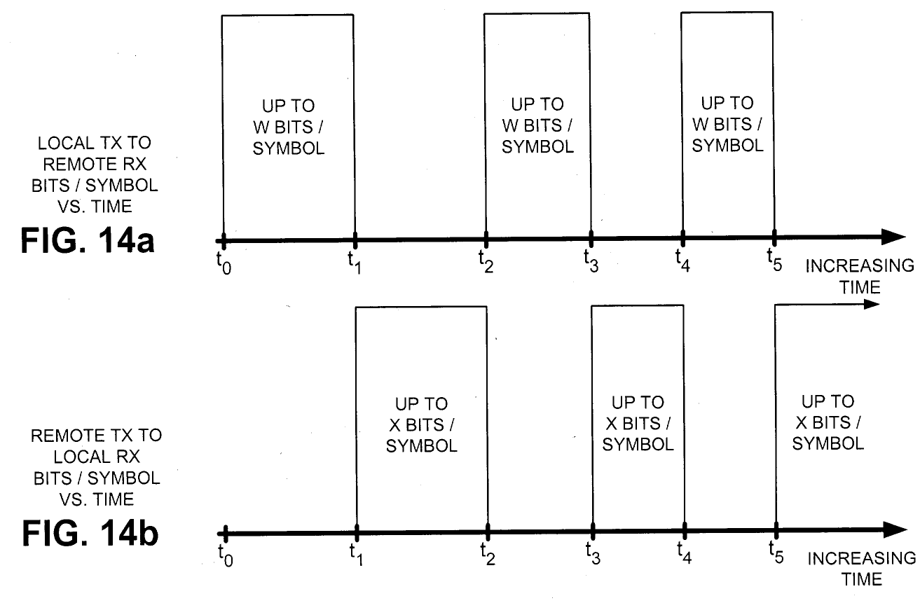

Given the basic description of TDD/ATDD related to FIG. 13, the timing diagrams of FIGS. 14a and 14b may better illustrate the principles of TDD/ATDD. The time points to, t₁, t₂, t₃, t₄, and t₅ generally are just used to mark interesting points in the timing diagrams and do not imply any limitations. Also, the time interval between any time, tₓ, and any other time, t_{y}, in FIGS. 14a and 14b is denoted as (tₓ, t_{y}). For the purposes of the description of FIGS. 14a and 14b, it is irrelevant whether a time interval includes the end points as in the interval [tₓ, t_{y}].

Moreover, the vertical axes in FIGS. 14a and 14b relate to bits per symbol while the horizontal axes relate to time. Nothing in the timing diagrams of FIGS. 14a and 14b is intended to imply any limitations on the symbol rates in the local-to-remote direction and in the remote-to-local direction during mode 1 and mode 2 respectively. This example representation is not intended to limit the preferred embodiments of the present invention to the symbol clock rates being the same in the local-to-remote and the remote-to-local directions during any time interval. Likewise, the symbol clock rates in a direction of communication do not necessarily have to be the same as the preferred embodiment of the present invention switches among various modes and/or manners of operation. Those skilled in the art will be aware of various tradeoffs in selecting symbol clock rates.

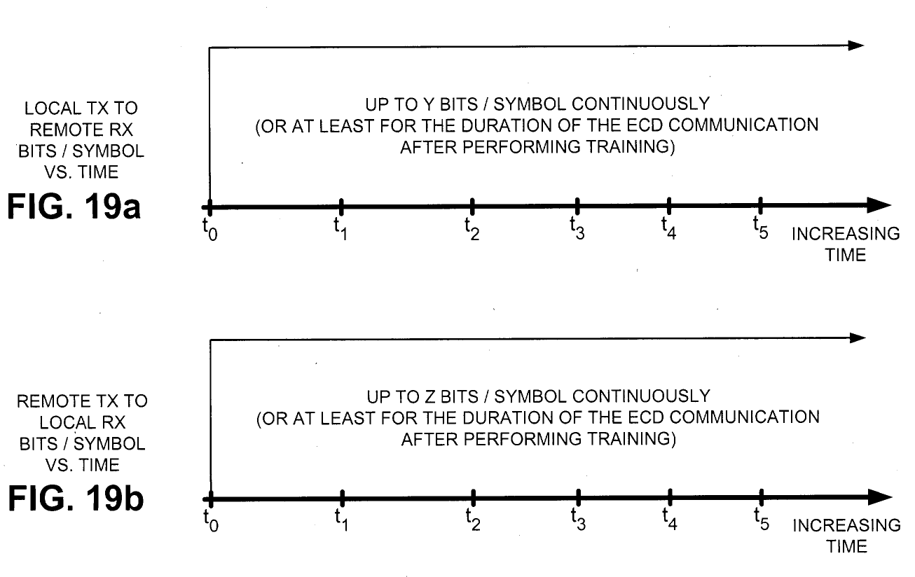

Furthermore, the time points in FIGS. 14a and 14b generally are intended to be the same. However, as stated previously the mode change time periods at to, t₁, t₂, t₃, t₄, and t₅ for the local device may not be exactly the same as the mode change time periods for the remote device. Furthermore, a mode change between mode 1 and mode 2 may not necessarily occur instantaneously. Moreover, the time points of FIGS. 14a and 14b need not necessarily be the same as the time points of FIGS. 19a, 19b, 25a, 25b, 29a, and 29b.

FIGS. 14a and 14b show timing diagrams in pure TDD/ATDD. FIG. 14a shows a potential timing of the transmissions of the local device 301 to the remote device 305, while FIG. 14b shows a potential timing of the transmissions of the remote device 305 to the local device 301. In the non-limiting example TDD/ATDD timing diagram of FIG. 14a, the local device 301 is capable of transmitting at up to W bits per symbol during the time intervals (t₀, t₁), (t₂, t₃), and (t₄, t₅), while the local device 301 generally stops transmission (zero bits per second or zero bits per symbol) during the time intervals such as (t₁, t₂) and (t₃, t₄) when the remote device 305 is capable of transmitting. Similarly, in the non-limiting example TDD/ATDD timing diagram of FIG. 14b, the remote device 305 is capable of transmitting at up to X bits per symbol during the time intervals such as (t₁, t₂) and (t₃, t₄), while the remote device 305 generally stops transmission (zero bits per second or zero bits per symbol) during the time intervals (t₀, t₁), (t₂, t₃), and (t₄, t₅) when the local device 301 is capable of transmitting. As can be seen from FIGS. 14a and 14b, pure TDD/ATDD basically allows only the local device 301 or the remote device 305 to transmit at any given instance of time.

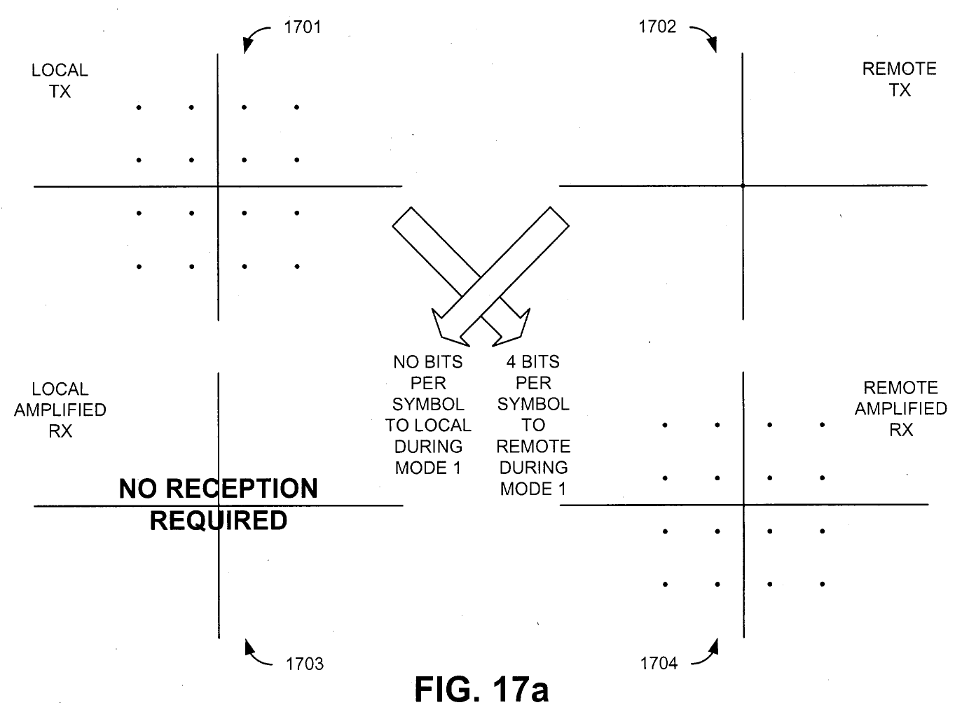

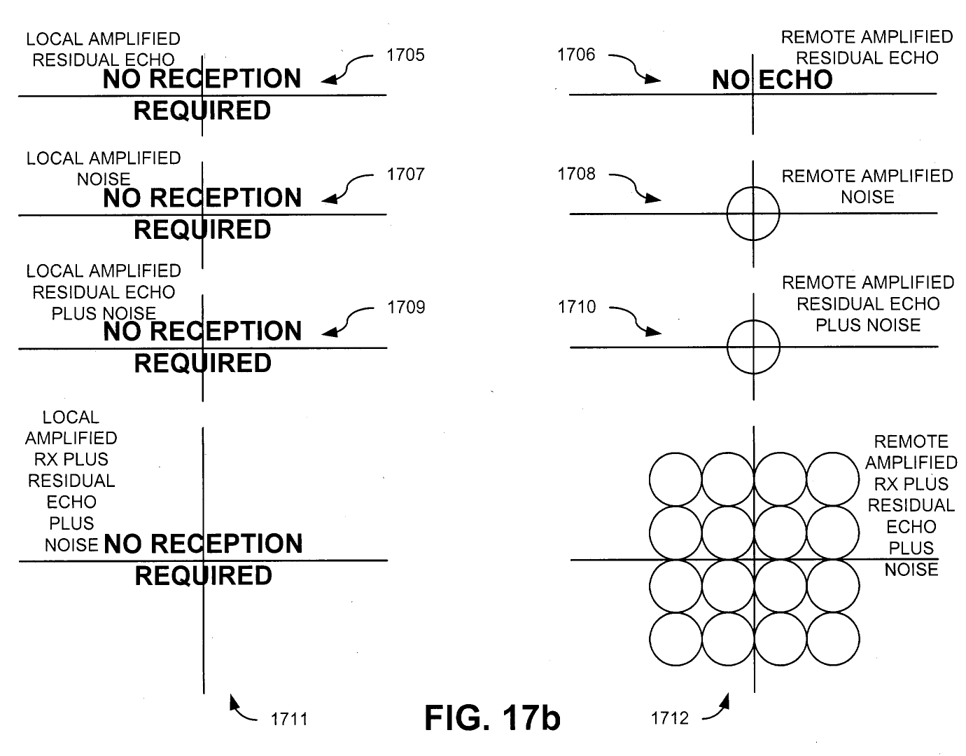

In a non-limiting example, if W=four bits per symbol and X=four bits per symbol, then the four bits per symbol could be from symbol spaces with sixteen signal points as shown in FIGS. 17a and 17b, which can encode four bits per symbol. Such a TDD/ATDD communication system could communicate up to four bits per symbol in either direction without ambiguity. However, to recover the information in the receive signal of FIG. 10 without ambiguity and/or error, a pure TDD/ATDD system generally gives up the contemporaneous transmission and reception that are allowed in pure ECD. In this non-limiting example, FIG. 14a shows the local device 301 transmitting at W=four bits per symbol while the remote device 305 basically is silent (i.e., transmitting at zero bits per symbol interval). Also, FIG. 14b shows the remote device 305 transmitting at X four bits per symbol interval while the local device 301 basically is silent (i.e., transmitting at zero bits per symbol interval).

Time Division Duplex (TDD)/Adaptive Time Division Duplex (ATDD) Signal Space Diagrams or Signal Constellations Without Channel Noise

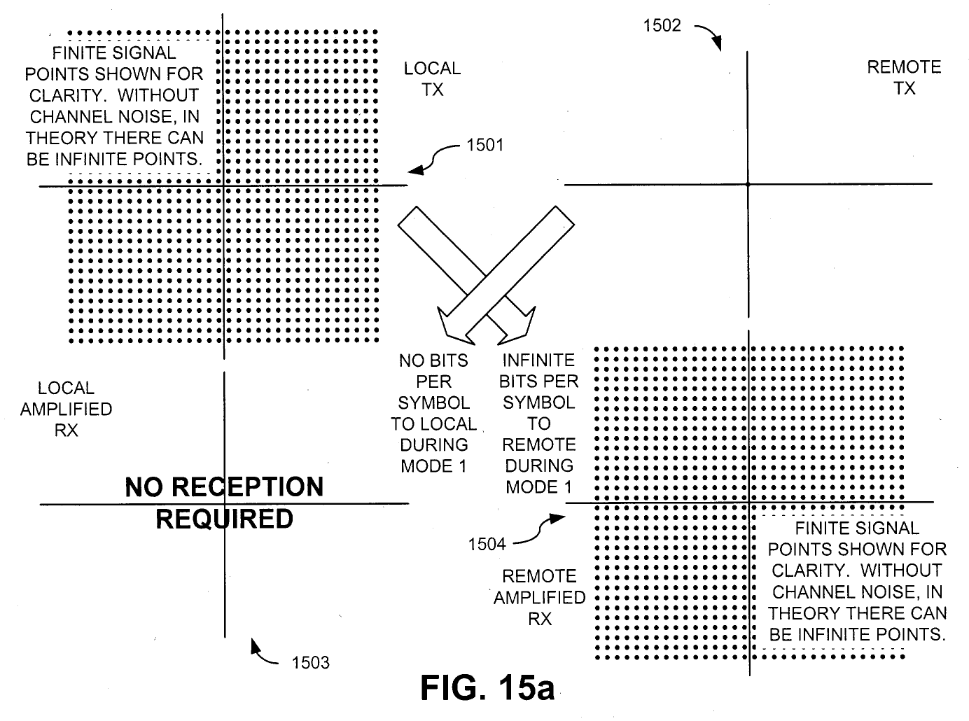

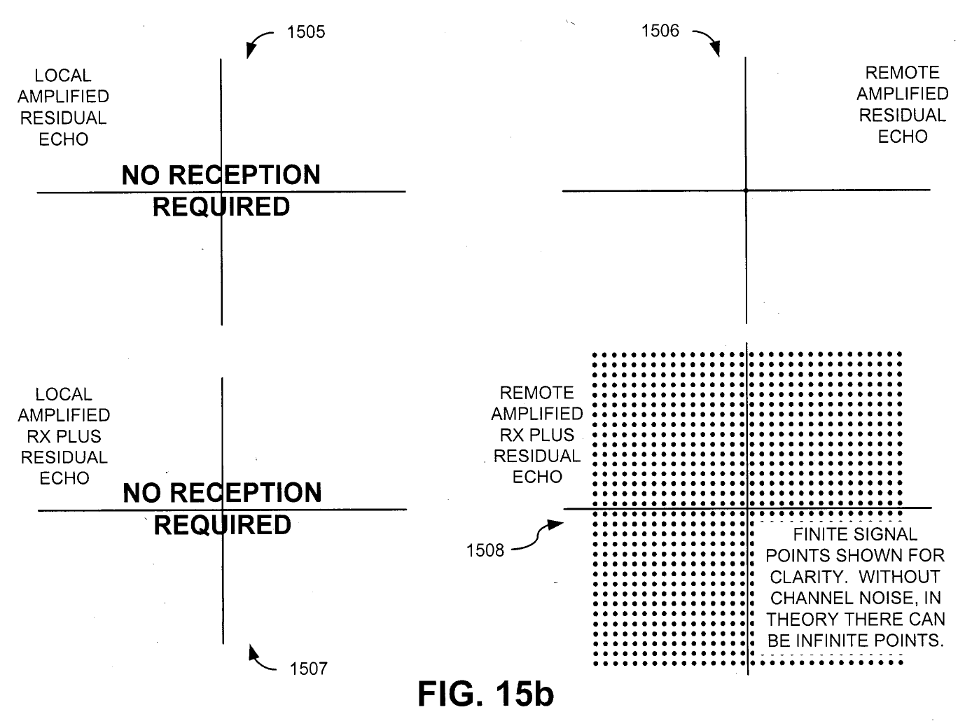

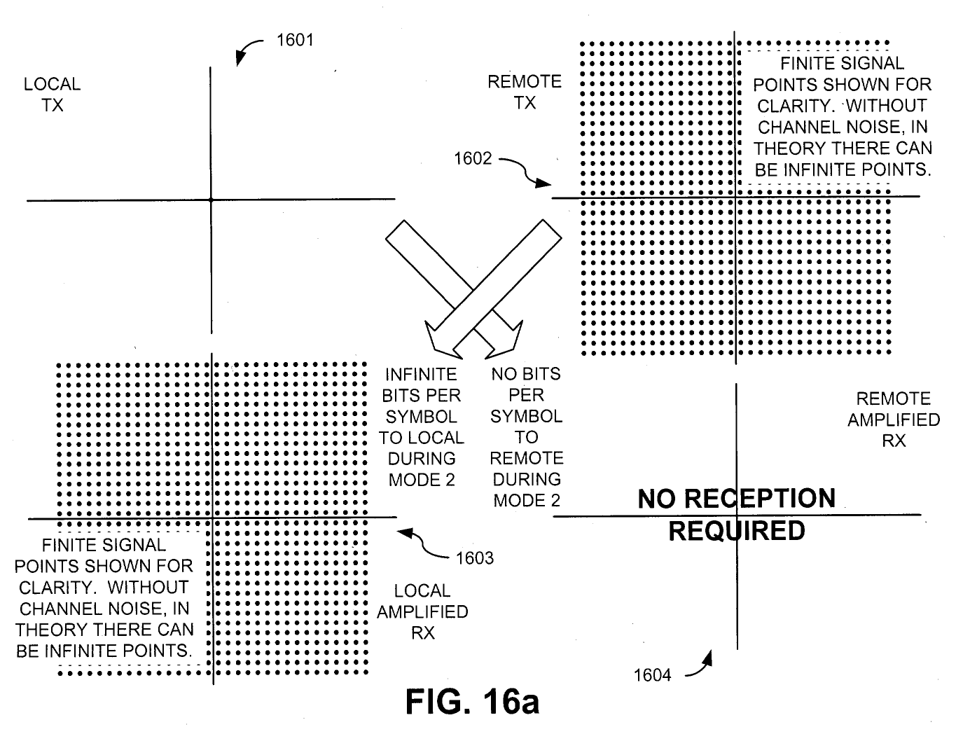

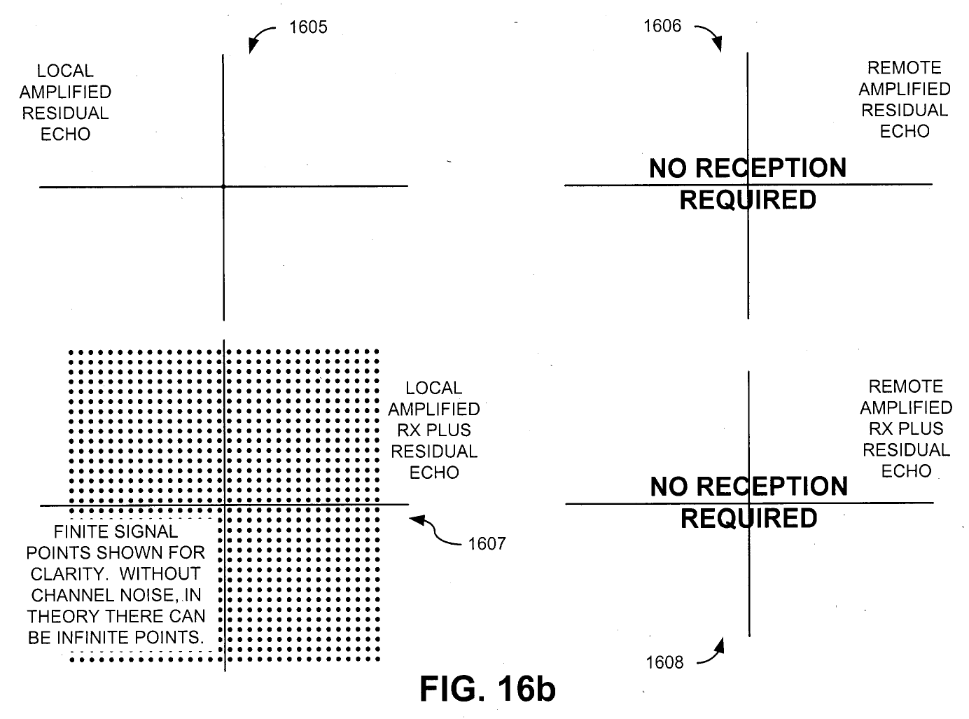

FIGS. 15a, 15b, 16a, and 16b show signal space diagrams for a non-limiting example of a communication system using pure TDD/ATDD in the absence of channel noise. FIGS. 15a and 15b show the idealized operation of a non-limiting example of a TDD/ATDD communication system during mode 1, while FIGS. 16a and 16b show the idealized operation of a non-limiting example of a TDD/ATDD communication system during mode 2. As shown in FIGS. 15a and 15b, this non-limiting TDD/ATDD example generally involves some amount of local-to-remote communication during mode 1 and no remote-to-local communication during mode 1. Also as shown in FIGS. 16a and 16b, this non-limiting TDD/ATDD example generally involves some amount of remote-to-local communication during mode 2 and no local-to-remote communication during mode 2.

With the idealized condition of no channel noise, an idealized TDD/ATDD communication system generally would have no noise from the channel and no noise from echo. Such a noiseless communication system theoretically could communicate using an infinite number of signal points. However, since infinite signal points cannot be shown graphically, FIGS. 15a, 15b, 16a, and 16b generally show 1024 signal points in a 32 signal point×32 signal point square constellation. 1024 QAM could encode 10 bits per symbol. The idealized condition of infinite signal points could encode infinite bits per symbol.

As shown in the idealized signal space diagrams of FIG. 15a, the local transmit signal space diagram 1501 has an infinite number of signal points during mode 1. Also, during mode 1 of TDD/ATDD, the remote transmit signal space diagram 1502 has a single point at the origin that indicates silence (or zero bits per symbol or zero bits per second) during mode 1. After propagation through the communication channel causes attenuation that may be reversed through an amplification process, the remote transmit signal space 1502 arrives as the local amplified receive signal space 1503. Because the remote transmit signal space 1502 is silent during mode 1, no reception is required in the local receive signal space 1503 during mode 1. Also, after propagation through the communication channel causes attenuation that may be reversed through an amplification process, the local transmit signal space 1501 arrives as the remote amplified receive signal space 1504. FIG. 15a also has arrows that show the relationship of the local transmit signal space 1501 to the remote receive signal space 1504 and the relationship of the remote transmit signal space 1502 to the local receive signal space 1503. In the idealized TDD/ATDD conditions of FIG. 15a, the local-to-remote communication can transfer infinite bits per symbol during mode 1, while the remote-to-local communication can transfer zero bits per symbol during mode 1.

FIG. 15b shows the amplified residual echo noise signal space diagrams and the amplified receive signal space plus residual echo noise diagrams during mode 1 for the idealized TDD/ATDD communication system of FIG. 15a. Because TDD/ATDD generally does not involve reception by a device while that device is transmitting, there generally is no echo and no residual echo. Thus, local amplified residual echo noise signal space 1505 is not used because no reception is required for the local device during mode 1. Also, during mode 1 the silence (or zero bits per symbol or zero bits per second) of the remote transmitter generally results in no remote echo noise and no remote residual echo noise as shown in the remote amplified residual echo noise signal space 1506. This remote amplified residual echo noise signal space 1506 shows a single point at the origin that generally indicates silence during mode 1.

Adding the local amplified receive signal space 1503 to the local amplified residual echo noise signal space 1505 results in local amplified receive plus residual echo noise signal space 1507 during mode 1. However, since the local device generally does not receive information from the remote device during mode 1 in TDD/ATDD, no reception is required of the local amplified receive plus residual echo noise signal space 1507 during mode 1. Adding the remote amplified receive signal space 1504 to the remote amplified residual echo noise signal space 1506 results in remote amplified receive plus residual echo noise signal space 1508 during mode 1. However, since the remote device generally does not transmit information to the local device during mode 1 in TDD/ATDD, the remote residual echo noise signal space 1506 is basically silent. Adding this silence (represented by a single point at the origin of remote residual echo noise signal space 1506) basically yields remote amplified receive plus echo noise signal space 1508 that generally is the same as remote amplified receive signal space 1504. Thus, in TDD/ATDD during mode 1, the local-to-remote communication generally is not affected by echo noise (or residual echo noise though there generally is no echo cancellation function in TDD/ATDD), while there generally is no remote-to-local communication during mode 1.

In contrast to FIGS. 15a and 15b that show the idealized operation of a non-limiting example of a TDD/ATDD communication system during mode 1, FIGS. 16a and 16b show the idealized operation of a non-limiting example of a TDD/ATDD communication system during mode 2. In the example of FIGS. 15a, 15b, 16a, and 16b, the local-to-remote communication during mode 1 generally is symmetric to the remote-to-local communication during mode 2. However, this symmetric behavior is only for example purposes and is not intended to be limiting. One skilled in the art will recognize that TDD/ATDD could also use asymmetric numbers of bits per symbol in the local-to-remote communication during mode 1 in comparison to the remote-to-local communication during mode 2. As shown in FIGS. 16a and 16b, this non-limiting TDD/ATDD example generally involves some amount of remote-to-local communication during mode 2 and no local-to-remote communication during mode 2. In contrast, FIGS. 15a and 15b generally show some amount of local-to-remote communication during mode 1 and no remote-to-local communication during mode 1.

As shown in the idealized signal space diagrams of FIG. 16a, the local transmit signal space diagram 1601 has a single point at the origin that indicates silence (or zero bits per symbol or zero bits per second) during mode 2. Also, during mode 2 of TDD/ATDD, the remote transmit signal space diagram 1602 has an infinite number of signal points during mode 2. After propagation through the communication channel causes attenuation that may be reversed through an amplification process, the remote transmit signal space 1602 arrives as the local amplified receive signal space 1603. Also, after propagation through the communication channel causes attenuation that may be reversed through an amplification process, the local transmit signal space 1601 arrives as the remote amplified receive signal space 1604. Because the local transmit signal space 1601 is silent during mode 2, no reception is required in the remote receive signal space 1604 during mode 2. FIG. 16a also has arrows that show the relationship of the local transmit signal space 1601 to the remote receive signal space 1604 and the relationship of the remote transmit signal space 1602 to the local receive signal space 1603. In the idealized TDD/ATDD conditions of FIG. 16a, the local-to-remote communication can transfer zero bits per symbol during mode 2, while the remote-to-local communication can transfer infinite bits per symbol during mode 2.

FIG. 16b shows the amplified residual echo noise signal space diagrams and the amplified receive signal space plus residual echo noise diagrams during mode 2 for the idealized TDD/ATDD communication system of FIG. 16a. During mode 2 the silence (or zero bits per symbol or zero bits per second) of the local transmitter generally results in no local echo noise and no local residual echo noise as shown in the local amplified residual echo noise signal space 1605. This local amplified residual echo noise signal space 1605 shows a single point at the origin that generally indicates silence during mode 2. Also, because TDD/ATDD generally does not involve reception by a device while that device is transmitting, there generally is no echo and no residual echo. Thus, remote amplified residual echo noise signal space 1606 is not used because no reception is required for the remote device during mode 2.

Adding the local amplified receive signal space 1603 to the local amplified residual echo noise signal space 1605 results in local amplified receive plus residual echo noise signal space 1607 during mode 2. However, since the local device generally does not transmit information to the remote device during mode 2 in TDD/ATDD, the local residual echo noise signal space 1605 is basically silent. Adding this silence (represented by a single point at the origin of local residual echo noise signal space 1605) basically yields local amplified receive plus echo noise signal space 1607 that generally is the same as local amplified receive signal space 1603.

Adding the remote amplified receive signal space 1604 to the remote amplified residual echo noise signal space 1606 results in remote amplified receive plus residual echo noise signal space 1608 during mode 2. However, since the remote device generally does not receive information from the local device during mode 2 in TDD/ATDD, no reception is required of the remote amplified receive plus residual echo noise signal space 1608 during mode 2. Thus, in TDD/ATDD during mode 2, the remote-to-local communication generally is not affected by echo noise (or residual echo noise though there generally is no echo cancellation function in TDD/ATDD), while there generally is no local-to-remote communication during mode 2.

In addition to fixed time-division duplexing (TDD), the same signal space diagrams of FIGS. 15a, 15b, 16a, and 16b also could represent adaptive time-division duplexing (ATDD). ATDD may use the same signal spaces of TDD; however, in contrast to TDD, an ATDD system may adaptively change the durations of mode 1 and mode 2. Usually the change in communication duration is determined based on the dynamic demands for data transmission of the local device 301 (or 401) and/or the remote device 305 (or 405).

Time Division Duplex (TDD)/Adaptive Time Division Duplex (ATDD) Signal Space Diagrams or Signal Constellations Including Channel Noise

In contrast to FIGS. 15a, 15b, 16a, and 16b, the complexity of channel noise is introduced to TDD/ATDD communications in FIGS. 17a and 17b. Because one non-limiting example of TDD/ATDD could involve symmetric behavior of the local device and the remote device such that the local device during mode 1 behaves similarly to the remote device during mode 2 and that the local device during mode 2 behaves similarly to the remote device during mode 1, FIGS. 17a and 17b only show the behavior of the local and remote devices during mode 1. Basically, the mode 1 signal space diagrams of FIGS. 17a and 17b would just be reversed for the mode 2 signal space diagrams (not shown). As a non-limiting example of reversing the signal space diagrams in switching between modes 1 and 2, the mode 2 signal space diagrams in FIGS. 16a and 16b are just a reversal of the signal space diagrams of FIGS. 15a and 15b for mode 1. This reversal of signal space diagrams represents the behavior of a non-limiting example of TDD/ATDD where the local and remote devices operate symmetrically when switching between modes 1 and 2.

In FIG. 17a, the local transmit signal space diagram 1701 shows sixteen signal points that can encode four bits per symbol during mode 1. With the addition of channel noise, the non-limiting example of TDD/ATDD in FIG. 17a generally will no longer support an infinite number of signal points in the signal space in contrast to the infinite number of bits per symbol that were supported in FIG. 15a. Also, during mode 1 of TDD/ATDD with channel noise, the remote transmit signal space diagram 1702 is shown in FIG. 17a with a single point at the origin that indicates silence (or zero bits per symbol or zero bits per second) of the remote device during mode 1. After propagation through the communication channel causes attenuation that may be reversed through an amplification process, the remote transmit signal space 1702 arrives as the local amplified receive signal space 1703. Because the remote transmit signal space 1702 is silent during mode 1, no reception is required in the local receive signal space 1703 during mode 1. Also, after propagation through the communication channel causes attenuation that may be reversed through an amplification process, the local transmit signal space 1701 arrives as the remote amplified receive signal space 1704. FIG. 17a also has arrows that show the relationship of the local transmit signal space 1701 to the remote receive signal space 1704 and the relationship of the remote transmit signal space 1702 to the local receive signal space 1703. In the TDD/ATDD conditions of FIG. 17a that include channel noise, the local-to-remote communication can transfer four bits per symbol during mode 1, while the remote-to-local communication can transfer zero bits per symbol during mode 1.

FIG. 17b shows the amplified residual echo noise signal space diagrams, the amplified channel noise, the combined amplified residual echo noise plus channel noise, and the amplified receive signal space plus residual echo noise plus channel noise diagrams during mode 1 for the TDD/ATDD communication system with channel noise of FIG. 17a. Because TDD/ATDD generally does not involve reception by a device while that device is transmitting, there generally is no echo and no residual echo. Thus, local amplified residual echo noise signal space 1705 is not used because no reception is required for the local device during mode 1. Also, during mode 1 the silence (or zero bits per symbol or zero bits per second) of the remote transmitter generally results in no remote echo noise and no remote residual echo noise as shown in the remote amplified residual echo noise signal space 1706. This remote amplified residual echo noise signal space 1706 shows that there generally is no echo from the transmission silence of the remote device during mode 1 as shown in the single point at the origin of remote transmit signal space diagram 1702 in FIG. 17a.

In addition, FIG. 17b also shows the amplified channel noise in signal space diagrams 1707 and 1708 for the non-limiting example TDD/ATDD communication system of FIGS. 17a and 17b. Signal space diagram 1707 of the local amplified channel noise is not utilized in TDD/ATDD during mode 1 because the local device generally does not receive during its mode 1 transmissions. Thus, no reception is required in the local amplified channel noise signal space diagram 1707 of FIG. 17b. In contrast, the remote device is receiving during mode 1 of TDD/ATDD and receives the remote amplified channel noise of signal space 1708 during mode 1.

The respective residual echo noises and channel noises are additive and may be combined to form local amplified residual echo noise plus channel noise signal space diagram 1709 and remote amplified residual echo noise plus channel noise signal space diagram 1710. Local amplified residual echo noise plus channel noise signal space diagram 1710 is formed by the addition of local amplified residual echo noise signal space diagram 1705 to the local amplified channel noise signal space diagram 1707. Because the local device generally does not receive during its mode 1 transmissions, no reception generally is required for the local amplified residual echo noise plus channel noise signal space 1709 of FIG. 17b. In contrast, the remote device generally is receiving during mode 1. Thus, adding the remote amplified residual echo noise signal space 1706 (which generally has no echo) to the remote amplified channel noise signal space 1708 yields the remote amplified residual echo noise plus channel noise signal space 1710 of FIG. 17b. Without echo noise and residual echo noise, the remote amplified residual echo noise plus channel noise signal space 1710 is generally the same as the remote amplified channel noise signal space 1708 of FIG. 17b.

Assuming that channel noise and residual echo noise are the only types of noise affecting the non-limiting example TDD/ATDD communications system for the purposes of model simplicity, the combination of these two noise components with the receive signal space yields the resulting signal space seen by the receiving functionality of a device. Thus, adding the local amplified receive signal space 1703 to the local amplified residual echo noise plus channel noise signal space 1709 results in local amplified receive plus residual echo noise plus channel noise signal space 1711 during mode 1. However, since the local device generally does not receive information from the remote device during mode 1 in TDD/ATDD, no reception is required of the local amplified receive plus residual echo noise plus channel noise signal space 1711 during mode 1. Adding the remote amplified receive signal space 1704 to the remote amplified residual echo noise plus channel noise signal space 1710 results in remote amplified receive plus residual echo noise plus channel noise signal space 1712 during mode 1. Adding the remote residual echo noise plus channel noise signal space 1710 to the remote amplified signal space 1704 basically involves copying the residual echo noise plus channel noise signal space 1710 of FIG. 17b into the remote receive plus residual echo noise plus channel noise signal space 1712 of FIG. 17b with each of the sixteen signal points of remote amplified receive signal space 1704 being an origin onto which the remote amplified residual echo noise plus channel noise signal space 1710 is copied. The resulting remote amplified receive plus residual echo noise plus channel noise signal space 1712 of FIG. 17b has a zero-margin for errorless operation because all the sixteen circles just touch other circles. Any additional noise added to the zero-margin communications shown in remote amplified receive plus residual echo noise plus channel noise signal space 1712 generally would cause errors in detecting the originally transmitted signals. If the communication system has additional margin that would further separate the circles and allow the system to be tolerant of a higher level of noise, the communication system might be said to have good-margin. However, in FIG. 17b there generally is no ambiguity in detecting an originally transmitted signal point so long as the receiver generally is of high enough quality to accurately divide the signal space 1712 into sixteen regions with each region containing only one of the sixteen circles, and there generally is no additional noise.

Because the remote amplified residual echo noise plus channel noise signal space 1710 (which basically is the total noise in this simplistic example) is basically the same as the remote amplified channel noise signal space 1708 of FIG. 17b, the remote receive plus residual echo noise plus channel noise signal space 1712 is basically unaffected by echo noise during mode 1. Thus, in TDD/ATDD during mode 1, the local-to-remote communication generally is not affected by echo noise (or residual echo noise though there generally is no echo cancellation function in TDD/ATDD), while there generally is no remote-to-local communication during mode 1. Much like FIGS. 17a and 17b show the operation of the local device and the remote device during mode 1, a similar set of signal spaces diagrams could be created for the operation during mode 2 with reversed signal spaces when the local and remote devices operate symmetrically in modes 1 and 2.

In addition to fixed time-division duplexing (TDD), the same signal space diagrams of FIGS. 17a and 17b also could represent adaptive time-division duplexing (ATDD). ATDD may use the same signal spaces of TDD; however, in contrast to TDD, an ATDD system may adaptively change the durations of mode 1 and mode 2. Usually the change in communication duration is determined based on the dynamic demands for data transmission of the local device 301 (or 401) and/or the remote device 305 (or 405).

Echo Cancelled Duplex (ECD)

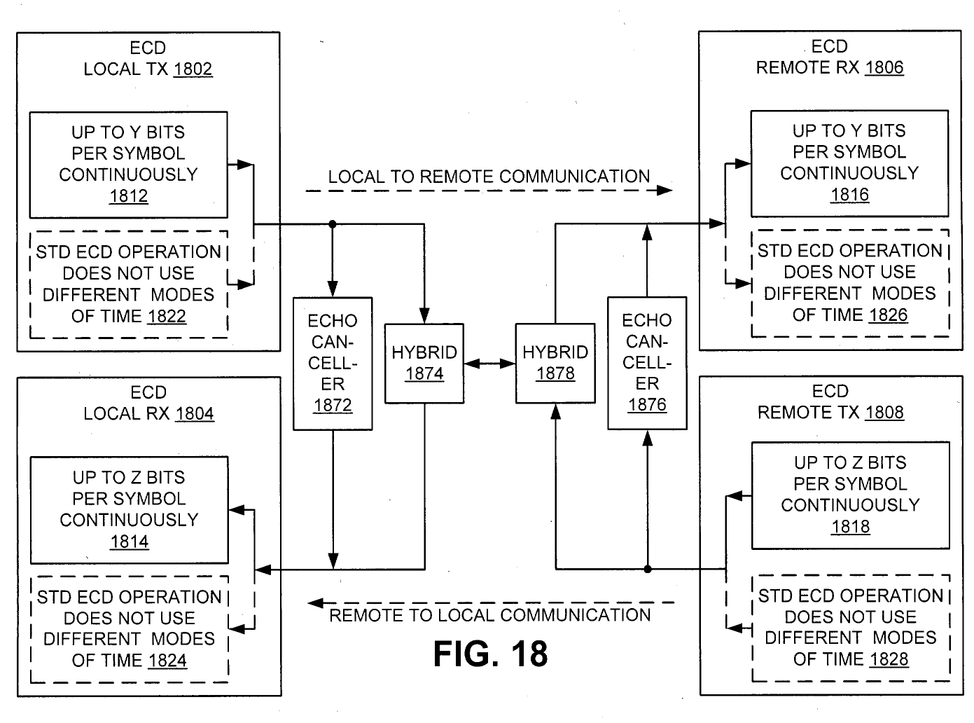

In contrast to generally stopping the simultaneous transmission and reception of a device to avoid echoes in the TDD/ATDD approach to duplexing, echo cancelled duplexing (ECD) is capable of, and generally performs by simultaneously transmitting and receiving continuously in each device, while attempting to use echo cancellation technology to subtract out an estimate of a transmitting device's echo from the signals received at that device. FIG. 18 shows a block diagram of communication devices that might be using ECD. The local transceiver generally comprises local transmitter 1802 and local receiver 1804, while the remote transceiver generally comprises remote receiver 1806 and remote transmitter 1808. Local transmitter 1802 and remote receiver 1806 generally provide local-to-remote communication, while remote transmitter 1808 and local receiver 1804 generally provide remote-to-local communication. Unlike TDD and/or ATDD that generally divides communication up into essentially or substantially (but not necessarily perfectly) non-overlapping intervals of time that might be known as mode 1 and mode 2 with respect to FIG. 13, an ECD communication system generally does not use different modes of time for the two different directions of communication.

Referring again to FIG. 18, the local transmitter 4802 in ECD may transmit up to Y bits per symbol continuously as shown in block 1812 that relates to local-to-remote communication. Also, the remote receiver 1806 may receive up to Y bits per symbol continuously as shown in block 1816 that relates to local-to-remote communication. In contrast to TDD/ATDD, standard ECD generally does not use different modes of time. Thus, block 1822 of local transmitter 1802 and block 1826 of remote receiver 1806 are shown as dashed blocks to indicate that local-to-remote communication for standard ECD operation does not use different modes of time as was done by TDD/ATDD in FIG. 13.

In ECD both the local-to-remote communication and the remote-to-local communication generally are capable of occurring simultaneously. Thus, in ECD at the same time that local-to-remote communications may be transferring up to Y bits per symbol continuously from block 1812 of local transmitter 1802 to block 1816 of remote receiver 1806, remote transmitter 1808 may be transferring up to Z bits per symbol to local receiver 1804 between blocks 1818 and 1814. Generally, ECD does not use different modes of time. Therefore, block 1828 of r emote transmitter 1808 and block 1824 of local receiver 1806 are shown as dashed blocks to indicate that remote-to-local communication for standard ECD operation does not use different modes of time as was done by TDD/ATDD in FIG. 13.

FIG. 18 shows how local transmitter 1802 is connected to local receiver 1804 through echo canceller 1872. In addition, FIG. 18 shows how remote transmitter 1806 is connected to local receiver 1808 through echo canceller 1876. Echo cancellers 1872 and 1876 may conform to the general style of echo canceller 104 that is shown in FIG. 1a or they may have some other configuration. In general, echo cancellers 1872 and 1876 use the transmitted signals from local transmitter 1802 and remote transmitter 1808 respectively as input to develop an estimate of the incoming echo signal and to attempt to remove this incoming echo from the receive signals at local receiver 1804 and remote receiver 1806 respectively.

Also shown in FIG. 18, local transmitter 1802 and local receiver 1804 are connected to hybrid 1874, while remote receiver 1806 and remote transmitter 1808 are connected to hybrid 1878. As is known by one of ordinary skill in the art, the two hybrids 1874 and 1878 generally convert between four wire connections and a two wire transmission line or communication media between hybrid 1874 and 1878. Furthermore, ECD may be used for symmetric communications in which Y=Z, so that both local-to-remote communication and remote-to-local communication may communicate up to the same number of bits per symbol. Alternatively, Y may not equal Z, so that ECD may be used for asymmetric communication relative to the number of bits per symbol. Also, the symbol rates in the two different directions may or may not be equal. Thus, many characteristics in ECD communications may be either symmetric or asymmetric, and this description is not intended to be limited with respect to the symmetry or asymmetry of various aspects of ECD communication.

Echo Cancelled Duplex (ECD) Timing Diagrams

Given the basic description of pure echo cancelled duplex (ECD) related to FIG. 18, the timing diagrams of FIGS. 19a and 19b may better illustrate the principles of pure ECD. The time points t₀, t₁, t₂, t₃, t₄, and t₅ generally are just used to mark interesting points in the timing diagrams and do not imply any limitations. Also, the time interval between any time, tₓ, and any other time, t_{y}, in FIGS. 19a and 19b is denoted as (tₓ, t_{y}). For the purposes of the description of FIGS. 19a-19b, it is irrelevant whether a time interval includes the end points as in the interval [tₓ, t_{y}].

Moreover, the vertical axes in FIGS. 19a and 19b relate to bits per symbol while the horizontal axes relate to time. Nothing in the timing diagrams of FIGS. 19a and 19b is intended to imply any limitations on the symbol rates in the local-to-remote direction and in the remote-to-local direction respectively. This example representation is not intended to limit the preferred embodiments of the present invention to the symbol clock rates being the same in the local-to-remote and the remote-to-local directions during any time interval. Likewise, the symbol clock rates in a direction of communication do not necessarily have to be the same as the preferred embodiment of the present invention switches among various modes and/or manners of operation. Those skilled in the art will be aware of various tradeoffs in selecting symbol clock rates.

Furthermore, the time points in FIGS. 19a and 19b generally are intended to be the same. Moreover, the time points of FIGS. 19a and 19b need not necessarily be the same as the time points of FIGS. 14a, 14b, 25a, 25b, 29a, and 29b. FIGS. 19a and 19b show timing diagrams in pure ECD. FIG. 19a shows a potential timing of the transmissions of the local device 301 to the remote device 305, while FIG. 19b shows a potential timing of the transmissions of the remote device 305 to the local device 301.

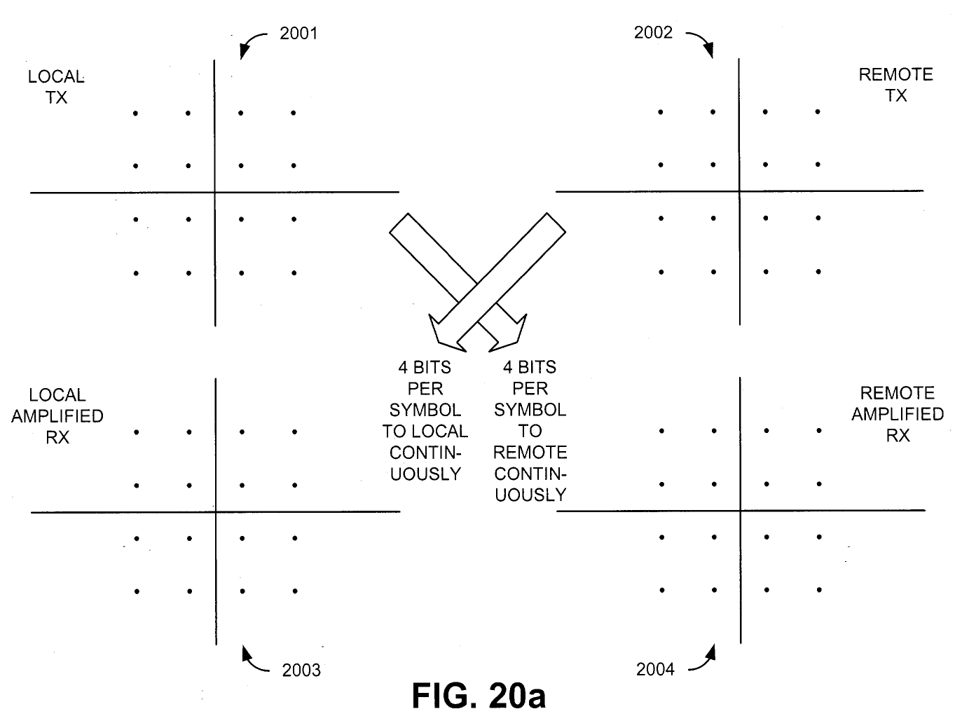

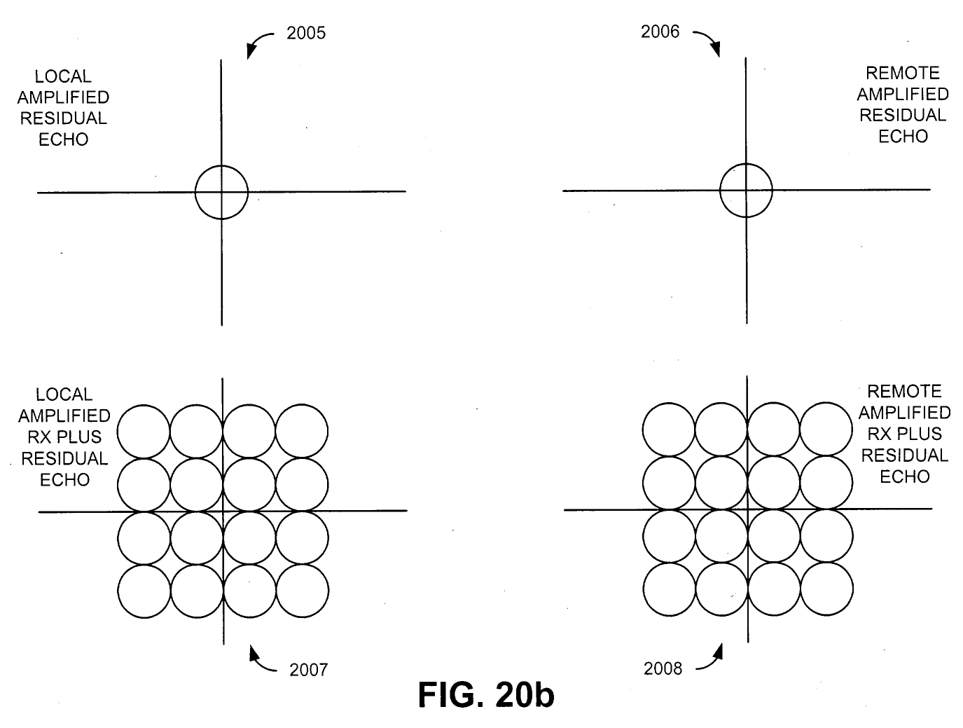

FIGS. 19a and 19b specifically show example timing diagrams for pure echo-cancelled duplex (ECD) in the local-to-remote direction and the remote-to-local direction, respectively. In FIG. 19a using pure ECD, the local device 301 generally is capable of transmitting to the remote device 305 at a steady rate of Y bits per symbol over any time interval (t₀, t₁), (t₁, t₂), (t₂, t₃), (t₃, t₄), and (t₄, t₅) in FIGS. 19a and 19b. FIG. 19b shows that in pure ECD the remote device 305 generally is capable of transmitting to the local device 301 at a steady rate of Z bits per symbol over any time interval (t₀, t₁), (t₁, t₂), (t₂, t₃), (t₃, t₄), (t₄, t₅) in FIGS. 20a and 20b. As can be clearly seen in FIGS. 19a and 19b, in pure ECD the local device 301 and the remote device 305 both are simultaneously capable of transmitting and receiving over any time interval (t₀, t₁), (t₁, t₂), (t₂, t₃), (t₃, t₄), and (t₄, t₅).

Although a perfect echo cancellation receiver might be able to properly recover the transmitted information given an idealized one-to-one relationship between transmitted signal points and the received echo, in general some residual echo noise will exist that might cause information recovery problems. To reduce the effect of communication errors (i.e., ambiguities in recovering or decoding the received signal) due to this residual echo noise, the pure ECD example could reduce the number of signal points in the transmit and receive signal spaces.

In a non-limiting example, if Y=four bits per symbol and Z=four bits per symbol, then the four bits per symbol could be from symbol spaces with sixteen signal points as shown in FIGS. 20a and 20b, which can encode four bits per symbol. Such a pure ECD communication system could communicate up to four bits per symbol in either direction without ambiguity. In this non-limiting example, FIG. 19a shows the local device 301 transmitting at Y=four bits per symbol continuously, while FIG. 19b shows the remote device 305 transmitting at Z=four bits per symbol continuously.

Echo Cancelled Duplex (ECD) Signal Space Diagrams or Signal Constellations Without Channel Noise

FIGS. 20a and 20b show signal space diagrams for a non-limiting example of a communication system using pure ECD in the absence of channel noise. As shown in FIGS. 20a and 20b, this non-limiting pure ECD example generally involves some amount of local-to-remote communication that generally occurs simultaneously and/or contemporaneously with remote-to-local communication. With the idealized condition of no channel noise, an idealized ECD communication system generally would have no noise from the channel but would still have to contend with echo noise. To the extent that echo noise is not perfectly cancelled using perfect echo cancellation, such a real-world communication system with imperfect echo cancellation and a noiseless communication channel might be able to communicate using sixteen signal points.

Sixteen signal points could encode four bits per symbol.

As shown in the idealized noiseless channel signal space diagrams of FIG. 20a, the local transmit signal space diagram 2001 has sixteen signal points that can encode Y=four bits per symbol continuously in the local-to-remote direction using pure ECD. Also, the remote transmit signal space diagram 2002 has sixteen signal points that can encode Z=four bits per symbol continuously in the remote-to-local direction using pure ECD. After propagation through the communication channel causes attenuation that may be reversed through an amplification process, the remote transmit signal space 2002 arrives as the local amplified receive signal space 2003. Also, after propagation through the communication channel causes attenuation that may be reversed through an amplification process, the local transmit signal space 2001 arrives as the remote amplified receive signal space 2004. FIG. 20a also has arrows that show the relationship of the local transmit signal space 2001 to the remote receive signal space 2004 and the relationship of the remote transmit signal space 2002 to the local receive signal space 2003. In the idealized pure ECD conditions of FIG. 20a, the local-to-remote communication can transfer four bits per symbol continuously, while the remote-to-local communication can transfer four bits per symbol continuously.

FIG. 20b shows the local and remote amplified residual echo noise signal space diagrams and the amplified local and remote receive signal space plus residual echo noise diagrams for the idealized pure ECD communication system of FIG. 20a in the absence of channel noise. Because ECD generally does involve reception by a device while that device is transmitting, there generally is echo. Also, to the extent that echo cancellation is imperfect, there generally is some residual echo. Thus, local amplified residual echo noise signal space 2005 has some residual echo noise (due to imperfect echo cancellation) that is contained within the circle of local amplified residual echo noise signal space 2005. Similarly, remote amplified residual echo noise signal space 2006 has some residual echo noise (due to imperfect echo cancellation) that is contained within the circle of remote amplified residual echo noise signal space 2006.

Adding the local amplified receive signal space 2003 to the local amplified residual echo noise signal space 2005 results in local amplified receive plus residual echo noise signal space 2007. The addition can be performed graphically by copying the circle of local amplified residual echo noise signal space 2005 sixteen times using each of the sixteen signal points local amplified receive signal space 2003 as an origin. Graphical additions of the signal spaces in the figures are only described to help better understand the preferred embodiments of the present invention and are not intended to introduce any limitations on the way signals are added together in a communication system. The resulting local amplified receive plus residual echo noise signal space 2007 has a zero-margin for errorless operation because all the sixteen circles just touch other circles. If the communication system has additional margin that would further separate the circles and allow the system to be tolerant of a higher level of noise, the communication system might be said to have good-margin.

Adding the remote amplified receive signal space 2004 to the remote amplified residual echo noise signal space 2006 results in remote amplified receive plus residual echo noise signal space 2008. The addition can be performed graphically by copying the circle of remote amplified residual echo noise signal space 2006 sixteen times using each of the sixteen signal points remote amplified receive signal space 2004 as an origin. Graphical additions of the signal spaces in the figures are only described to help better understand the preferred embodiments of the present invention and are not intended to introduce any limitations on the way signals are added together in a communication system. The resulting remote amplified receive plus residual echo noise signal space 2008 has a zero-margin for errorless operation because all the sixteen circles just touch other circles. If the communication system has additional margin that would further separate the circles and allow the system to be tolerant of a higher level of noise, the communication system might be said to have good-margin.

In the non-limiting example of ECD in FIGS. 20a and 20b, the local-to-remote communication generally is symmetric to the remote-to-local communication. However, this symmetric behavior is only for example purposes and is not intended to be limiting. One skilled in the art will recognize that ECD could also use asymmetric numbers of bits per symbol in the local-to-remote communication in comparison to the remote-to-local communication. As shown in FIGS. 20a and 20b, this non-limiting ECD example generally involves the capability of some amount of continuous local-to-remote communication and some amount of continuous remote-to-local communication.

Echo Cancelled Duplex (ECD) Signal Space Diagrams or Signal Constellations Including Channel Noise

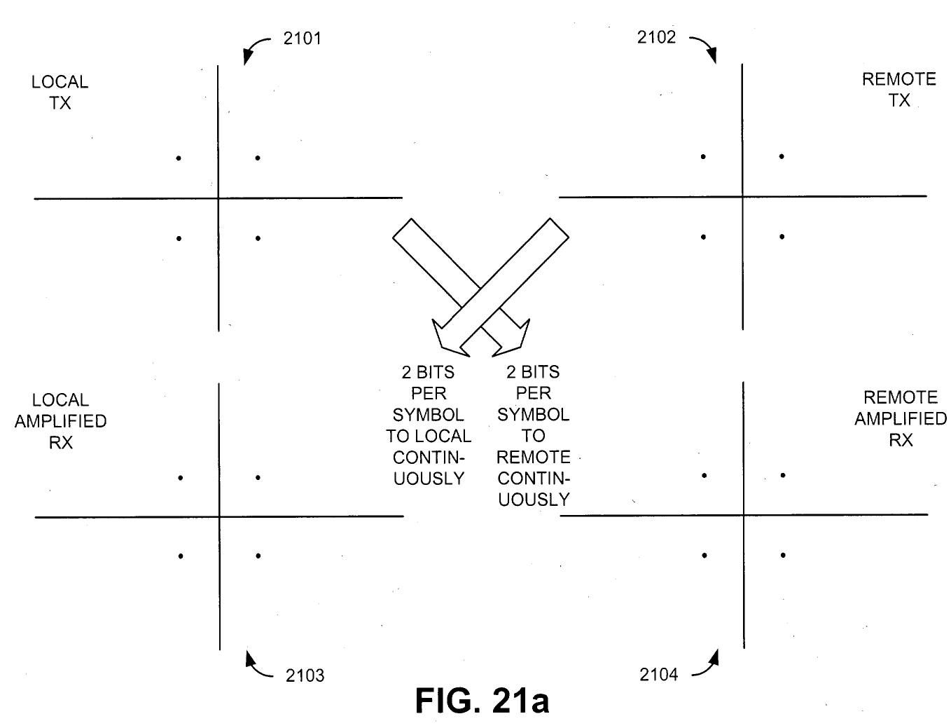

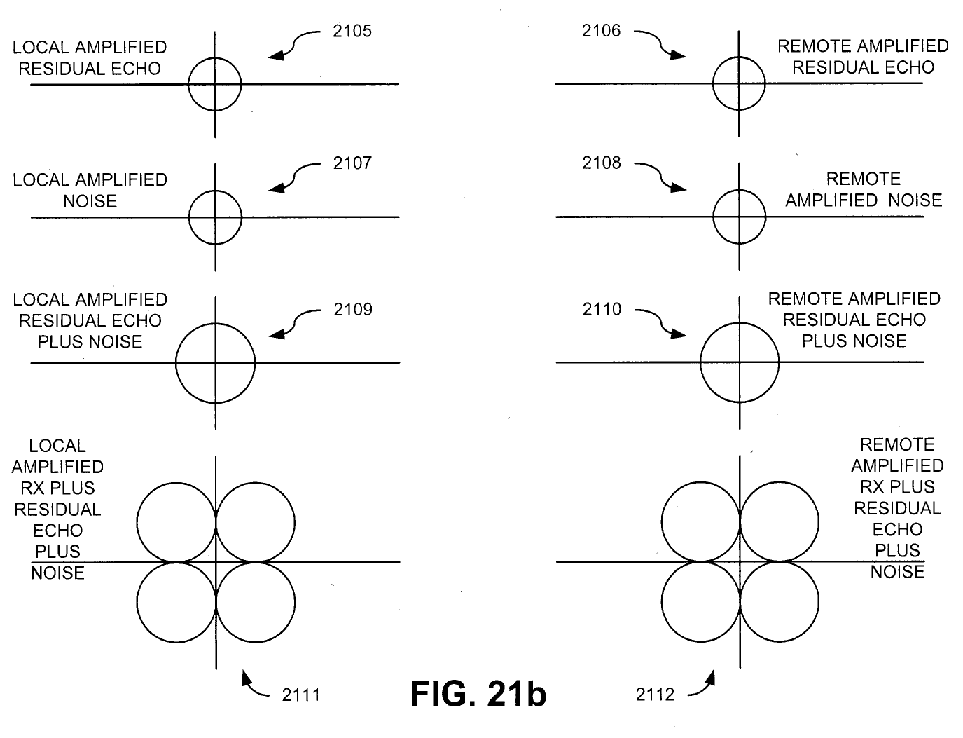

In contrast to FIGS. 20a and 20b, the complexity of channel noise is introduced to ECD communications in FIGS. 21a and 21b. In FIG. 21a, the local transmit signal space diagram 2101 shows four signal points that can encode two bits per symbol. FIGS. 21a and 21b show signal space diagrams for a non-limiting example of a communication system using pure ECD with channel noise. As shown in FIGS. 21a and 21b, this non-limiting pure ECD example generally involves some amount of local-to-remote communication that generally occurs simultaneously and/or contemporaneously with remote-to-local communication. With the addition of channel noise, an ECD communication system generally would have to contend with channel noise in addition to echo noise. To the extent that echo noise is not perfectly cancelled using perfect echo cancellation, such a real-world communication system with imperfect echo cancellation and a noisy communication channel might be able to communicate using four signal points. Four signal points could encode two bits per symbol.

As shown in the noisy channel signal space diagrams of FIG. 21a, the local transmit signal space diagram 2101 has four signal points that can encode Y=two bits per symbol continuously in the local-to-remote direction using pure ECD. Also, the remote transmit signal space diagram 2102 has four signal points that can encode Z=two bits per symbol continuously in the remote-to-local direction using pure ECD. After propagation through the communication channel causes attenuation that may be reversed through an amplification process, the remote transmit signal space 2102 arrives as the local amplified receive signal space 2103. Also, after propagation through the communication channel causes attenuation that may be reversed through an amplification process, the local transmit signal space 2101 arrives as the remote amplified receive signal space 2104. FIG. 21a also has arrows that show the relationship of the local transmit signal space 2101 to the remote receive signal space 2104 and the relationship of the remote transmit signal space 2102 to the local receive signal space 2103. In the pure ECD conditions of FIG. 21a with channel noise, the local-to-remote communication can transfer two bits per symbol continuously, while the remote-to-local communication can transfer two bits per symbol continuously.

With the addition of channel noise, the non-limiting example of ECD in FIG. 21a generally will no longer support sixteen signal points in the signal space in contrast to the four bits per symbol that were supported in FIG. 20a. After propagation through the communication channel causes attenuation that may be reversed through an amplification process, the remote transmit signal space 2102 arrives as the local amplified receive signal space 2103. Also, after propagation through the communication channel causes attenuation that may be reversed through an amplification process, the local transmit signal space 2101 arrives as the remote amplified receive signal space 2104. FIG. 21a also has arrows that show the relationship of the local transmit signal space 2101 to the remote receive signal space 2104 and the relationship of the remote transmit signal space 2102 to the local receive signal space 2103. In the ECD conditions of FIG. 21a that include channel noise, the local-to-remote communication can transfer Y=two bits per symbol continuously, while the remote-to-local communication can transfer Z=two bits per symbol continuously.

FIG. 21b shows the amplified residual echo noise signal space diagrams, the amplified channel noise, the combined amplified residual echo noise plus channel noise, and the amplified receive signal space plus residual echo noise plus channel noise diagrams for the ECD communication system with channel noise of FIG. 21a. Because ECD generally does involve reception by a device while that device is transmitting, there generally is echo. Also, to the extent that echo cancellation is imperfect, there generally is some residual echo. Thus, local amplified residual echo noise signal space 1705 has some residual echo noise (due to imperfect echo cancellation) that is contained within the circle of local amplified residual echo noise signal space 2105. Similarly, remote amplified residual echo noise signal space 2106 has some residual echo noise (due to imperfect echo cancellation) that is contained within the circle of remote amplified residual echo noise signal space 2106.

In addition, FIG. 21b also shows the amplified channel noise in signal space diagrams 2107 and 2108 for the non-limiting example ECD communication system of FIGS. 21a and 21b. Signal space diagram 2107 of the local amplified channel noise is utilized in ECD because the local device generally does receive during its transmissions. Also, signal space diagram 2108 of the remote amplified channel noise is utilized in ECD because the remote device generally does receive during its transmissions.

The residual echo noise and channel noise are additive and may be combined to form local amplified residual echo noise plus channel noise signal space diagram 2109 and remote amplified residual echo noise plus channel noise signal space diagram 2110. Local amplified residual echo noise plus channel noise signal space diagram 2109 is formed by the addition of local amplified residual echo noise signal space diagram 2105 to the local amplified channel noise signal space diagram 2107. As a non-limiting example, the local amplified residual echo noise signal space 2105 might contain a noise distribution generally within a circle with a diameter size of 1.0, while the local amplified channel noise signal space 2107 also might contain a noise distribution generally within a circle with a diameter size of 1.0. The actual units of the diameter measurement for the noise signal spaces would depend on the modulation methods and the actual physical phenomena used to carry information. For the purposes of this example, the relative diameter size of the noise is more relevant than the actual units of the diameter size. Because the noise is additive, adding the local amplified residual echo noise signal space 2105 to the local amplified channel noise signal space 2107 results in a noise distribution with a larger diameter circle such as 1.414 for the local amplified residual echo noise plus channel noise signal space 2109. The choice of circle diameters as 1.0 and 1.414 is only a non-limiting example. In general, the addition of the local amplified residual echo noise signal space 2105 (with a distribution within a circle of a diameter greater than zero) to the local amplified channel noise signal space 2107 (with a distribution within a circle of a diameter greater than zero) will result in a combined noise signal space 2109 that has a distribution within a circle larger than the distribution of either the residual echo noise distribution or the channel noise distribution.

Remote amplified residual echo noise plus channel noise signal space diagram 2110 is formed by the addition of remote amplified residual echo noise signal space diagram 2106 to the remote amplified channel noise signal space diagram 2108. As a non-limiting example, the remote amplified residual echo noise signal space 2106 might contain a noise distribution generally within a circle with a diameter size of 1.0, while the remote amplified channel noise signal space 2108 also might contain a noise distribution generally within a circle with a diameter size of 1.0. The actual units of the diameter measurement for the noise signal spaces would depend on the modulation methods and the actual physical phenomena used to carry information. For the purposes of this example, the relative diameter size of the noise is more relevant than the actual units of the diameter size. Because the noise is additive, adding the remote amplified residual echo noise signal space 2106 to the remote amplified channel noise signal space 2108 results in a noise distribution with a larger diameter circle such as 1.414 for the remote amplified residual echo noise plus channel noise signal space 2110. The choice of circle diameters as 1.0 and 1.414 is only a non-limiting example. In general, the addition of the remote amplified residual echo noise signal space 2106 (with a distribution within a circle of a diameter greater than zero) to the remote amplified channel noise signal space 2108 (with a distribution within a circle of a diameter greater than zero) will result in a combined noise signal space 2110 that has a distribution within a circle larger than the distribution of either the residual echo noise distribution or the channel noise distribution.

Assuming that channel noise and residual echo noise are the only types of noise affecting the non-limiting example ECD communications system for the purposes of model simplicity, the combination of these two noise components with the receive signal space yields the resulting signal space seen by the receiving functionality of a device. Thus, adding the local amplified receive signal space 2103 to the local amplified residual echo noise plus channel noise signal space 2109 results in local amplified receive plus residual echo noise plus channel noise signal space 2111. In addition, adding the local residual echo noise plus channel noise signal space 2109 to the local amplified signal space 2103 basically involves copying the local residual echo noise plus channel noise signal space 2109 of FIG. 21b into the local receive plus residual echo noise plus channel noise signal space 2111 of FIG. 21b with each of the four signal points of local amplified receive signal space 2103 being an origin onto which the local amplified residual echo noise plus channel noise signal space 2109 is copied. The resulting local amplified receive plus residual echo noise plus channel noise signal space 2111 of FIG. 21b has a zero-margin for errorless operation because all the four circles just touch other circles. Any additional noise added to the zero-margin communications shown in local amplified receive plus residual echo noise plus channel noise signal space 2111 generally would cause errors in detecting the originally transmitted signals. However, in FIG. 21b there generally is no ambiguity in detecting an originally transmitted signal point so long as the receiver generally is of high enough quality to accurately divide the signal space 2111 into four regions with each region containing only one of the four circles, and there generally is no additional noise.

Also, adding the remote amplified receive signal space 2104 to the remote amplified residual echo noise plus channel noise signal space 2110 results in remote amplified receive plus residual echo noise plus channel noise signal space 2112. In addition, adding the remote residual echo noise plus channel noise signal space 2110 to the remote amplified signal space 2104 basically involves copying the remote residual echo noise plus channel noise signal space 2110 of FIG. 21b into the remote receive plus residual echo noise plus channel noise signal space 2112 of FIG. 21b with each of the four signal points of remote amplified receive signal space 2104 being an origin onto which the remote amplified residual echo noise plus channel noise signal space 2110 is copied. The resulting remote amplified receive plus residual echo noise plus channel noise signal space 2112 of FIG. 21b has a zero-margin for errorless operation because all the four circles just touch other circles. Any additional noise added to the zero-margin communications shown in remote amplified receive plus residual echo noise plus channel noise signal space 2112 generally would cause errors in detecting the originally transmitted signals. However, in FIG. 21b there generally is no ambiguity in detecting an originally transmitted signal point so long as the receiver generally is of high enough quality to accurately divide the signal space 2112 into four regions with each region containing only one of the four circles, and there generally is no additional noise.

In the non-limiting example of ECD with channel noise in FIGS. 21a and 21b, the local-to-remote communication generally is symmetric to the remote-to-local communication. However, this symmetric behavior is only for example purposes and is not intended to be limiting. One skilled in the art will recognize that ECD could also use asymmetric numbers of bits per symbol in the local-to-remote communication in comparison to the remote-to-local communication. As shown in FIGS. 21a and 21b, this non-limiting ECD example generally involves the capability of some amount of continuous local-to-remote communication and some amount of continuous remote-to-local communication.

Asymmetric Echo Cancelled Duplex (ECD) Signal Space Diagrams or Signal Constellations Without Channel Noise

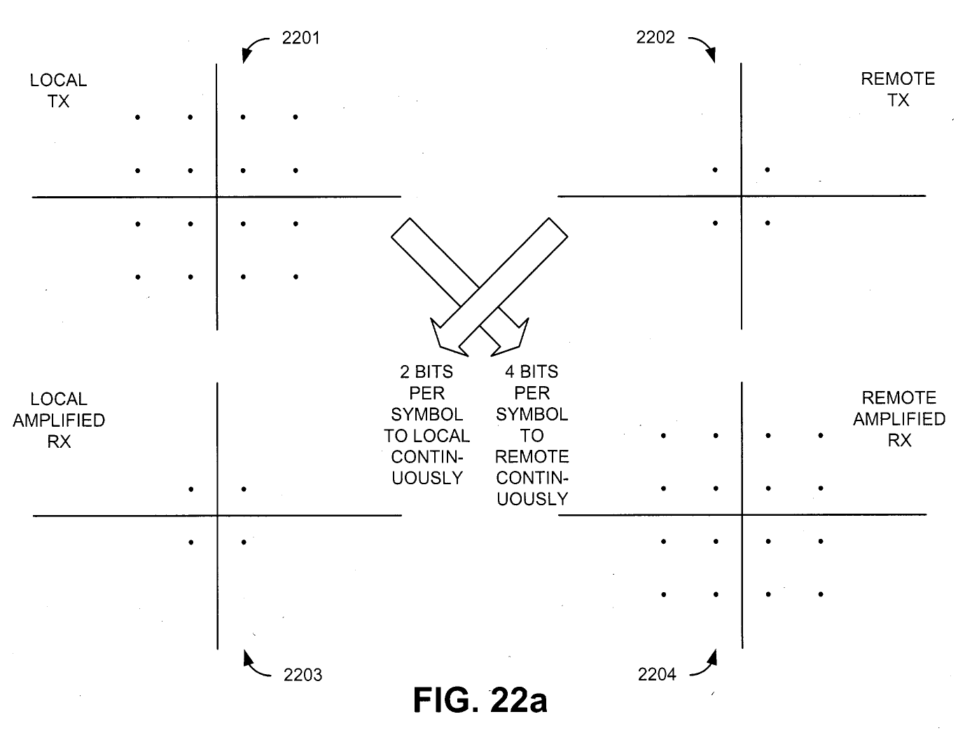

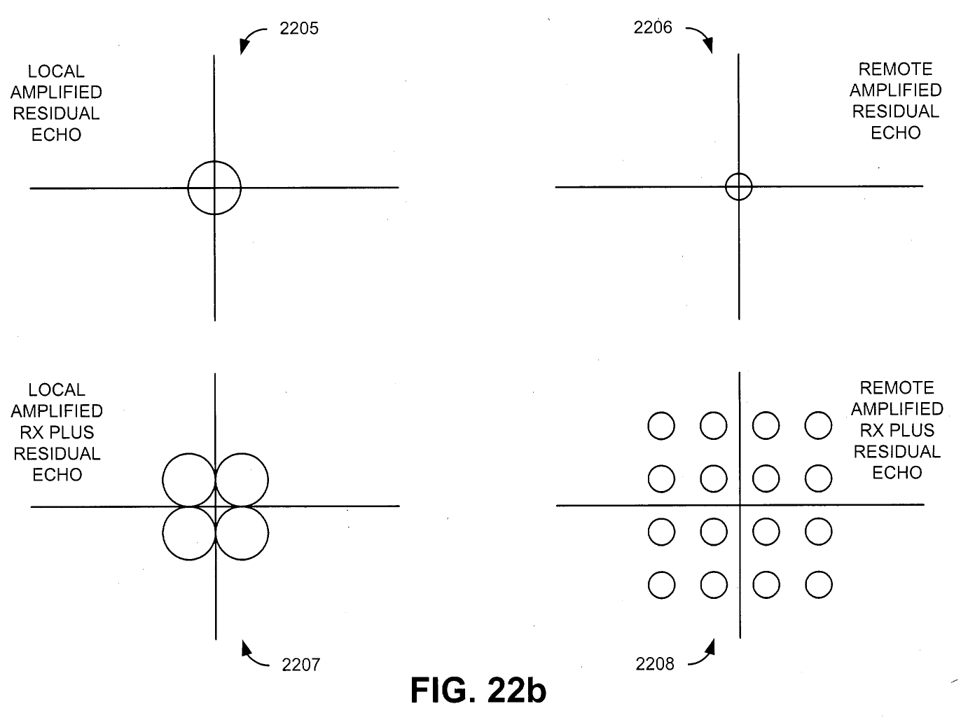

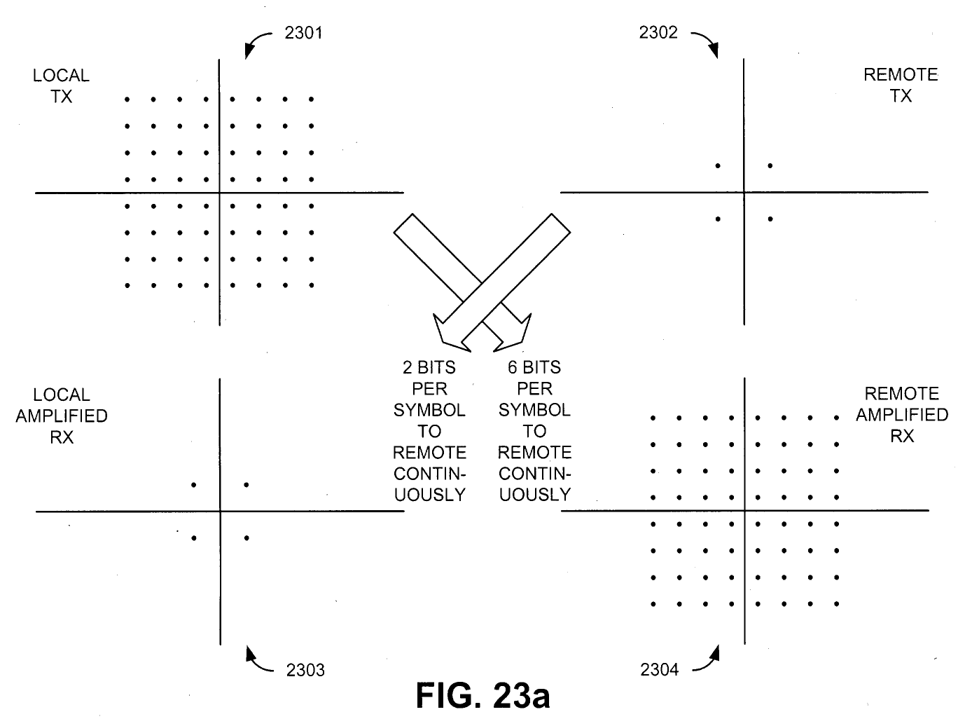

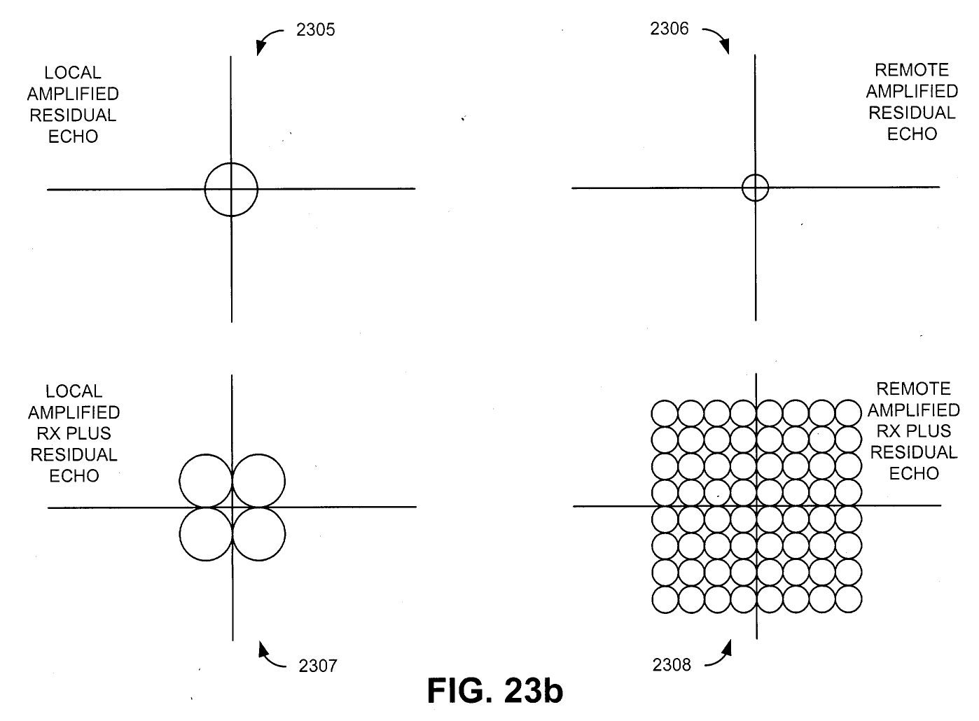

FIGS. 22a, 22b, 23a, and 23b show signal space diagrams for non-limiting examples of a communication system using pure ECD in the absence of channel noise. In comparison to FIGS. 20a and 20b, FIGS. 22a and 22b show that the transmit level of the remote transmitter can be reduced while the transmit level of the local transmitter generally remains unchanged. As shown in FIGS. 22a and 22b, this non-limiting pure ECD example generally involves some amount of local-to-remote communication that generally occurs simultaneously and/or contemporaneously with remote-to-local communication. With the idealized condition of no channel noise, an idealized ECD communication system generally would have no noise from the channel but would still have to contend with echo noise. To the extent that echo noise is not perfectly cancelled using perfect echo cancellation, such a real-world communication system with imperfect echo cancellation and a noiseless communication channel might be able to communicate using sixteen signal points in the local-to-remote direction and four signal points in the remote-to-local direction. Sixteen signal points could encode four bits per symbol, while four signal points could encode two bits per symbol.

As shown in the idealized noiseless channel signal space diagrams of FIG. 22a, the local transmit signal space diagram 2201 has sixteen signal points that can encode Y=four bits per symbol continuously in the local-to-remote direction using pure ECD. Also, the remote transmit signal space diagram 2202 has four signal points that can encode Z=two bits per symbol continuously in the remote-to-local direction using pure ECD. After propagation through the communication channel causes attenuation that may be reversed through an amplification process, the remote transmit signal space 2202 arrives as the local amplified receive signal space 2203. Also, after propagation through the communication channel causes attenuation that may be reversed through an amplification process, the local transmit signal space 2201 arrives as the remote amplified receive signal space 2204. FIG. 22a also has arrows that show the relationship of the local transmit signal space 2201 to the remote receive signal space 2204 and the relationship of the remote transmit signal space 2202 to the local receive signal space 2203. In the idealized pure ECD conditions of FIG. 22a, the local-to-remote communication can transfer four bits per symbol continuously, while the remote-to-local communication can transfer two bits per symbol continuously.

FIG. 22b shows the amplified residual echo noise signal space diagrams and the amplified receive signal space plus residual echo noise diagrams for the idealized pure ECD communication system of FIG. 22a in the absence of channel noise. Because ECD generally does involve reception by a device while that device is transmitting, there generally is echo. Also, to the extent that echo cancellation is imperfect, there generally is some residual echo. Thus, local amplified residual echo noise signal space 2205 has some residual echo noise (due to imperfect echo cancellation) that is contained within the circle of local amplified residual echo noise signal space 2205. Similarly, remote amplified residual echo noise signal space 2206 has some residual echo noise (due to imperfect echo cancellation) that is contained within the circle of remote amplified residual echo noise signal space 2206.

As a non-limiting example, the local amplified residual echo noise signal space 2205 might contain a noise distribution generally within a circle with a diameter size of 1.0. Also, the remote amplified residual echo noise signal space 2206 might contain a noise distribution generally within a circle with a diameter size of 0.45. The actual units of the diameter measurement for the noise signal spaces would depend on the modulation methods and the actual physical phenomena used to carry information. For the purposes of this example, the relative diameter size of the noise is more relevant than the actual units of the diameter size.

Because the remote transmit signal space 2202 has a lower transmit power than the local transmit signal space 2201, the remote echo reflected back to the remote device has a lower level than the local echo reflected back to the local device. Furthermore, the lower echo level received by the remote device also results in smaller errors in echo cancellation. Therefore, the remote amplified residual echo noise 2206 is contained within a smaller noise distribution circle than the local amplified residual echo noise 2205.

Adding the local amplified receive signal space 2203 to the local amplified residual echo noise signal space 2205 results in local amplified receive plus residual echo noise signal space 2207. The addition can be performed graphically by copying the circle of local amplified residual echo noise signal space 2205 four times using each of the four signal points local amplified receive signal space 2203 as an origin. Graphical additions of the signal spaces in the figures are only described to help better understand the preferred embodiments of the present invention and are not intended to introduce any limitations on the way signals are added together in a communication system. The resulting local amplified receive plus residual echo noise signal space 2207 has a zero-margin for errorless operation because all the four circles just touch other circles. If the communication system has additional margin that would further separate the circles and allow the system to be tolerant of a higher level of noise, the communication system might be said to have good-margin.

Adding the remote amplified receive signal space 2204 to the remote amplified residual echo noise signal space 2206 results in remote amplified receive plus residual echo noise signal space 2208. The addition can be performed graphically by copying the circle of remote amplified residual echo noise signal space 2206 sixteen times using each of the sixteen signal points remote amplified receive signal space 2204 as an origin. Graphical additions of the signal spaces in the figures are only described to help better understand the preferred embodiments of the present invention and are not intended to introduce any limitations on the way signals are added together in a communication system. The resulting remote amplified receive plus residual echo noise signal space 2208 has a good margin for errorless operation because all the sixteen circles do not touch other circles.

Given this good margin of the remote amplified receive plus residual echo noise signal space 2208, one way to take advantage of the good margin is to increase the communication system performance in the local-to-remote direction. Accordingly, FIG. 23a shows how the local transmit signal space 2301 can be increased to sixty-four signal points that are capable of encoding six bits per symbol continuously in echo cancelled duplex (ECD) communications. The remote transmit signal space 2302 of FIG. 23a stays the same as the remote transmit signal space 2202 of FIG. 22a with four signal points and is capable of encoding two bits per symbol continuously in echo cancelled duplex (ECD) communications.

In comparison to FIGS. 22a and 22b, FIGS. 23a and 23b show that the transmit level of the local transmitter can be increased while the transmit level of the remote transmitter generally remains unchanged. As shown in FIGS. 23a and 23b, this non-limiting pure ECD example generally involves some amount of local-to-remote communication that generally occurs simultaneously and/or contemporaneously with remote-to-local communication. With the idealized condition of no channel noise, an idealized ECD communication system generally would have no noise from the channel but would still have to contend with echo noise. To the extent that echo noise is not perfectly cancelled using perfect echo cancellation, such a real-world communication system with imperfect echo cancellation and a noiseless communication channel might be able to communicate using sixty-four signal points in the local-to-remote direction and four signal points in the remote-to-local direction. Sixty-four signal points could encode six bits per symbol, while four signal points could encode two bits per symbol.

As shown in the idealized noiseless channel signal space diagrams of FIG. 23a, the local transmit signal space diagram 2301 has sixty-four signal points that can encode Y=six bits per symbol continuously in the local-to-remote direction using pure ECD. Also, the remote transmit signal space diagram 2302 has four signal points that can encode Z=two bits per symbol continuously in the remote-to-local direction using pure ECD. After propagation through the communication channel causes attenuation that may be reversed through an amplification process, the remote transmit signal space 2302 arrives as the local amplified receive signal space 2303. Also, after propagation through the communication channel causes attenuation that may be reversed through an amplification process, the local transmit signal space 2301 arrives as the remote amplified receive signal space 2304. FIG. 23a also has arrows that show the relationship of the local transmit signal space 2301 to the remote receive signal space 2304 and the relationship of the remote transmit signal space 2302 to the local receive signal space 2303. In the idealized pure ECD conditions of FIG. 23a, the local-to-remote communication can transfer six bits per symbol continuously, while the remote-to-local communication can transfer two bits per symbol continuously.

FIG. 23b shows the amplified residual echo noise signal space diagrams and the amplified receive signal space plus residual echo noise diagrams for the idealized pure ECD communication system of FIG. 23a in the absence of channel noise. Because ECD generally does involve reception by a device while that device is transmitting, there generally is echo. Also, to the extent that echo cancellation is imperfect, there generally is some residual echo. Thus, local amplified residual echo noise signal space 2305 has some residual echo noise (due to imperfect echo cancellation) that is contained within the circle of local amplified residual echo noise signal space 2305. Similarly, remote amplified residual echo noise signal space 2306 has some residual echo noise (due to imperfect echo cancellation) that is contained within the circle of remote amplified residual echo noise signal space 2306.

Because of the good-margin in the remote amplified receive and residual echo noise signal space 2208 in FIG. 22b, the number of signal points in the local transmit signal space 2301 can be increased to sixty-four signal points as compared to the sixteen signal points of local transmit signal space 2201 without significantly increasing the transmit power level from local transmit signal space 2201 to local transmit signal space 2301.

As a non-limiting example, the local amplified residual echo noise signal space 2305 might contain a noise distribution generally within a circle with a diameter size of 1.0. Also, the remote amplified residual echo noise signal space 2306 might contain a noise distribution generally within a circle with a diameter size of 0.45. The actual units of the diameter measurement for the noise signal spaces would depend on the modulation methods and the actual physical phenomena used to carry information. For the purposes of this example, the relative diameter size of the noise is more relevant than the actual units of the diameter size.

Because the remote transmit signal space 2302 has a lower transmit power than the local transmit signal space 2301, the remote echo reflected back to the remote device has a lower level than the local echo reflected back to the local device. Furthermore, the lower echo level received by the remote device also results in smaller errors in echo cancellation. Therefore, the remote amplified residual echo noise 2306 is contained within a smaller noise distribution circle than the local amplified residual echo noise 2305.

Adding the local amplified receive signal space 2303 to the local amplified residual echo noise signal space 2305 results in local amplified receive plus residual echo noise signal space 2307. The addition can be performed graphically by copying the circle of local amplified residual echo noise signal space 2305 four times using each of the four signal points local amplified receive signal space 2303 as an origin. Graphical additions of the signal spaces in the figures are only described to help better understand the preferred embodiments of the present invention and are not intended to introduce any limitations on the way signals are added together in a communication system. The resulting local amplified receive plus residual echo noise signal space 2307 has a zero-margin for errorless operation because all the four circles just touch other circles. If the communication system has additional margin that would further separate the circles and allow the system to be tolerant of a higher level of noise, the communication system might be said to have good-margin.

Adding the remote amplified receive signal space 2304 to the remote amplified residual echo noise signal space 2306 results in remote amplified receive plus residual echo noise signal space 2308. The addition can be performed graphically by copying the circle of remote amplified residual echo noise signal space 2306 sixty-four times using each of the sixty-four signal points remote amplified receive signal space 2304 as an origin. Graphical additions of the signal spaces in the figures are only described to help better understand the preferred embodiments of the present invention and are not intended to introduce any limitations on the way signals are added together in a communication system. The resulting remote amplified receive plus residual echo noise signal space 2308 has a zero-margin for errorless operation because all the sixty-four circles just touch other circles. If the communication system has additional margin that would further separate the circles and allow the system to be tolerant of a higher level of noise, the communication system might be said to have good-margin.

In the non-limiting example of ECD with channel noise in FIGS. 22a, 22b, 23a, and 23b, the local-to-remote communication generally is asymmetric to the remote-to-local communication. However, this asymmetric behavior is only for example purposes and is not intended to be limiting. One skilled in the art will recognize that ECD could also use symmetric numbers of bits per symbol in the local-to-remote communication in comparison to the remote-to-local communication. As shown in FIGS. 22a, 22b, 23a, and 23b, this non-limiting ECD example generally involves the capability of some amount of continuous local-to-remote communication and some amount of continuous remote-to-local communication.

Extended Performance Echo Cancelled Duplex (EP ECD)

These various duplexing solutions of ECD and TDD/ATDD both have some drawbacks. First, because echo cancellation is not perfect, ECD results in residual echo noise that may degrade communications. Also, although a fixed TDD system does not utilize echo canceling and thus does not suffer degradation from echo noise, the data demands of the local device 301 (or 401) and the remote device 305 (or 405) might not match the desired allocation of communication throughput direction. This situation in TDD often results in under-utilization of the bi-directional channel capacity and other inefficiencies. Furthermore, even though ATDD does not utilize echo canceling and thus does not suffer degradation from echo noise and even though ATDD provides flexible allocation of communication throughput compared to fixed TDD, ATDD may provide under-utilization of the bi-directional channel capacity compared to an ECD system under some conditions. Thus, another solution to providing duplex communications problem is desirable.

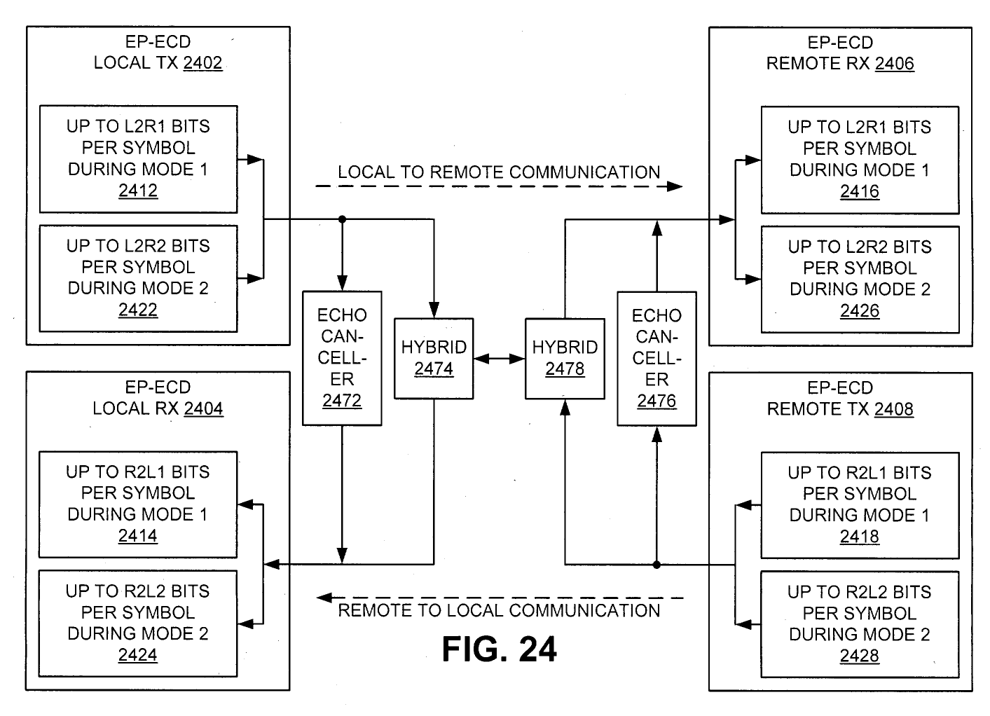

FIG. 24 shows a block diagram of communication devices that might be using a preferred embodiment of the present invention. Like pure ECD and unlike pure TDD/ATDD, the preferred embodiments of the present invention generally use echo cancellation technology to subtract out an estimate of a transmitting device's echo from the signals received at that device. However, unlike pure ECD and like pure TDD/ATDD, the preferred embodiments of the present invention generally utilize multiple modes of communication at different bits per symbol. The local transceiver generally comprises local transmitter 2402 and local receiver 2404, while the remote transceiver generally comprises remote receiver 2406 and remote transmitter 2408. Local transmitter 2402 and remote receiver 2406 generally provide local-to-remote communication, while remote transmitter 2408 and local receiver 2404 generally provide remote-to-local communication. Furthermore, the preferred embodiments of the present invention generally divide communication up into essentially or substantially (but not necessarily perfectly) non-overlapping intervals of time that might be known as mode 1 and mode 2 with respect to FIG. 24. In general, there is some small amount of time involved in switching between modes 1 and 2.

Furthermore, the local and remote devices might not switch between modes 1 and 2 at the exact same instant. The actual procedures used to cause the local and remote devices to switch modes may vary. As a non-limiting example, the local and remote devices may communicate with each other about switching between mode 1 and 2 in extended performance (EP) echo cancelled duplex (ECD). However, this communication on switching modes takes time to be propagated between the local device and the remote device. As a result, the two devices might not switch between modes 1 and 2 at the exact same instant of time. However, the two devices can be expected to change between modes 1 and 2 at approximately the same time. Another non-limiting example of mode switching in a fixed or static extended performance (EP) echo cancelled duplex (ECD) arrangement might be based on the number of clock ticks that each device has received. However, even the distribution of synchronized clock information between the local device and the remote device also may require propagation time. Regardless of the use of different types of mechanisms to synchronize the local and remote devices, one skilled in the art will recognize that the switching between modes 1 and 2 in the local device may not occur at the exact same time as the switching between modes 1 and 2 in the remote device. Thus, at a detailed technical level, the absolute time during which the local device is in mode 1 (after switching from mode 2) might slightly overlap the absolute time during which the remote device is in mode 2 and preparing to switch to mode 1. Thus, mode 1 and mode 2 generally correspond to essentially or substantially (but not necessarily perfectly) non-overlapping intervals of time.

Referring again to FIG. 24, the local transmitter 2402 in EP ECD may transmit up to L2R1 bits per symbol during mode 1 as shown in block 2412 that relates to local-to-remote communication during mode 1. Also, during mode 1, the remote receiver 2406 may receive up to L2R1 bits per symbol during mode 1 as shown in block 2416 that relates to local-to-remote communication during mode 1. The remote-to-local direction of communication is shown in FIG. 24 as block 2418 of remote transmitter 2408 and as block 2414 of local receiver 2404. Unlike TDD/ATDD, extended performance (EP) echo cancelled duplex (ECD) generally does not utilize silence in the remote-to-local communication while communication is occurring in the local-to-remote communication during mode 1.

In switching between mode 1 and mode 2, an EP ECD communication system of the preferred embodiments of the present invention generally switches the local transmit level and/or the remote transmit level in changing the direction of communication with the improved signal-to-noise ratio between local-to-remote communication and remote-to-local communication. The local-to-remote communication during mode 2 is shown in FIG. 24 as local transmitter 2402 transmitting up to L2R2 bits per symbol from block 2422 during mode 2 to remote receiver 2406 receiving up to L2R2 bits per symbol in block 2426 during mode 2. Also, the remote-to-local communication during mode 2 is shown in FIG. 24 as remote transmitter 2408 transmitting up to R2L2 bits per symbol from block 2428 during mode 2 to local receiver 2404 receiving up to R2L2 bits per symbol in block 2424 during mode 2.

Unlike TDD/ATDD, extended performance (EP) echo cancelled duplex (ECD) generally does not utilize silence in the local-to-remote communication while communication is occurring in the remote-to-local communication during mode 2. L2R1 is the number of bits per symbol in the local-to-remote direction during mode 1, while L2R2 is the number of bits per symbol in the local-to-remote direction during mode 2. In addition, R2L is the number of bits per symbol in the remote-to-local direction during mode 1, while R2L2 is the number of bits per symbol in the remote-to-local direction during mode 2.

In extended performance (EP) echo cancelled duplex (ECD) of the preferred embodiments of the present invention, both the local-to-remote communication and the remote-to-local communication generally are capable of occurring simultaneously. Thus, in EP ECD at the same time that local-to-remote communications may be transferring up to L2R1 bits per symbol continuously from block 2412 of local transmitter 2402 to block 2416 of remote receiver 2406 during mode 1, remote transmitter 2408 may be transferring up to R2L1 bits per symbol to local receiver 2404 between blocks 2418 and 2414 during mode 1. Similarly, in EP ECD at the same time that local-to-remote communications may be transferring up to L2R2 bits per symbol continuously from block 2422 of local transmitter 2402 to block 2426 of remote receiver 2406 during mode 2, remote transmitter 2408 may be transferring up to R2L2 bits per symbol to local receiver 2404 between blocks 2428 and 2424 during mode 2.

Generally, unlike standard ECD that does not use different modes of time, the extended performance (EP) echo cancelled duplex (ECD) of the preferred embodiments of the present invention does use different modes of time. Therefore unlike the pure ECD of FIG. 18, block 2422 of local transmitter 2402 and block 2426 of remote receiver 1806 are shown as solid blocks to indicate that local-to-remote communication for standard ECD operation does use different modes of time in EP ECD as was done by TDD/ATDD in FIG. 13. Also unlike the pure ECD of FIG. 18, block 2428 of remote transmitter 2408 and block 2424 of local receiver 2406 are shown as solid blocks to indicate that remote-to-local communication does use different modes of time in EP ECD as was done by TDD/ATDD in FIG. 13.

Furthermore, FIG. 24 shows how local transmitter 2402 is connected to local receiver 2404 through echo canceller 2472. In addition, FIG. 24 shows how remote transmitter 2406 is connected to local receiver 2408 through echo canceller 2476. Echo cancellers 2472 and 2476 may conform to the general style of echo canceller 104 that is shown in FIG. 1a or they may have some other configuration. In general, echo cancellers 2472 and 2476 use the transmitted signals from local transmitter 2402 and remote transmitter 2408 respectively as input to develop an estimate of the incoming echo signal and remove this echo estimate from the receive signals at local receiver 2404 and remote receiver 2406 respectively.

Also shown in FIG. 24, local transmitter 2402 and local receiver 2404 are connected to hybrid 2474, while remote receiver 2406 and remote transmitter 2408 are connected to hybrid 2478. As is known by one of ordinary skill in the art, the two hybrids 2474 and 2478 generally convert between four wire connections and a two wire transmission line or communication media between hybrid 2474 and 2478. Furthermore, EP ECD may be used for symmetric communications in which L2R1=R2L2, so that both local-to-remote communication during mode 1 and remote-to-local communication mode 2 may communicate up to the same number of bits per symbol. Also, EP ECD may be used for symmetric communications in which L2R2=R2L1, so that both local-to-remote communication during mode 2 and remote-to-local communication mode 1 may communicate up to the same number of bits per symbol.

Alternatively, L2R1 may not equal R2L2 and/or L2R2 may not equal R2L1, so that EP ECD may be used for asymmetric communication relative to the number of bits per symbol. In addition, the amount of time spent in mode 1 for local-to-remote communication does not have to equal the amount of time spent in mode 2 for remote-to-local communication. Also, the symbol rates in the two different directions may or may not be equal. Thus, many characteristics in EP ECD communications may be either symmetric or asymmetric, and this description is not intended to be limited with respect to the symmetry or asymmetry of various aspects of EP ECD communication.

Extended Performance Echo Cancelled Duplex (EP ECD) Timing Diagrams

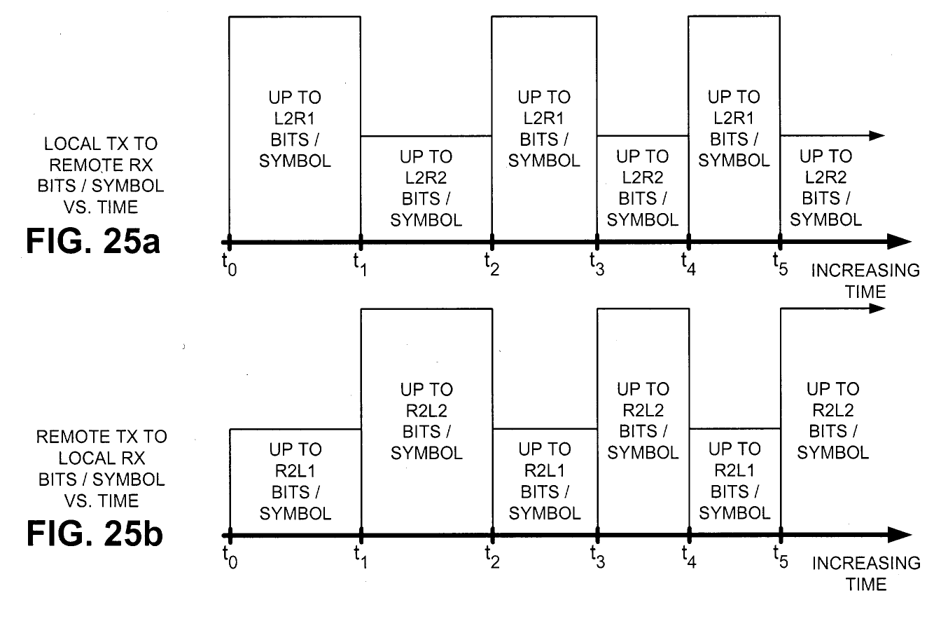

Given the basic description of EP ECD related to FIG. 24, the timing diagrams of FIGS. 25a and 25b may better illustrate the principles of EP ECD of the preferred embodiments of the present invention. The time points to, t₁, t₂, t₃, t₄, and t₅ generally are just used to mark interesting points in the timing diagrams and do not imply any limitations. Also, the time interval between any time, tₓ, and any other time, t_{y}, in FIGS. 25a and 25b is denoted as (tₓ, t_{y}). For the purposes of the description of FIGS. 25a and 25b, it is irrelevant whether a time interval includes the end points as in the interval [tₓ, t_{y}].

Moreover, the vertical axes in FIGS. 25a and 25b relate to bits per symbol while the horizontal axes relate to time. Nothing in the timing diagrams of FIGS. 25a and 25b is intended to imply any limitations on the symbol rates in the local-to-remote direction and in the remote-to-local direction during mode 1 (or the first mode) and mode 2 (or the send mode) respectively. This example representation is not intended to limit the preferred embodiments of the present invention to the symbol clock rates being the same in the local-to-remote and the remote-to-local directions during any time interval. Likewise, the symbol clock rates in a direction of communication do not necessarily have to be the same as the preferred embodiment of the present invention switches among various modes and/or manners of operation. Those skilled in the art will be aware of various tradeoffs in selecting symbol clock rates.

Furthermore, the time points in FIGS. 25a and 25b generally are intended to be the same. However, as stated previously the mode change time periods at to, t₁, t₂, t₃, t₄, and t₅ for the local device may not be exactly the same as the mode change time periods for the remote device. Furthermore, a mode change between mode 1 and mode 2 may not necessarily occur instantaneously. Moreover, the time points of FIGS. 25a and 25b need not necessarily be the same as the time points of FIGS. 14a, 14b, 19a, and 19b.

FIGS. 25a and 25b show timing diagrams in a non-limiting example of the preferred embodiments of the present invention using EP ECD. FIG. 25a shows a potential timing of the transmissions of the local device 301 to the remote device 305, while FIG. 25b shows a potential timing of the transmissions of the remote device 305 to the local device 301. In the non-limiting example EP ECD timing diagram of FIG. 25a, the local device 301 is capable of transmitting at up to L2R1 bits per symbol during the time intervals (t₀, t₁), (t₂, t₃), and (t₄, t₅) that generally relate to mode 1 or the first mode, while the local device 301 is capable of transmitting at up to L2R2 bits per symbol during the time intervals such as (t₁, t₂) and (t₃, t₄) that generally relate to mode 2 or the second mode. Similarly, in the non-limiting example EP ECD timing diagram of FIG. 25b, the remote device 305 is capable of transmitting at up to R2L1 bits per symbol during the time intervals (t₀, t₁), (t₂, t₃), and (t₄, t₅) that generally relate to mode 1 or the first mode, while the remote device 305 is capable of transmitting at up to R2L2 bits per symbol during the time intervals such as (t₁, t₂) and (t₃, t₄) that generally relate to mode 2 or the second mode. In general, unlike pure TDD/ATDD at least one and possibly both of L2R2 and R2L1 are greater than zero bits per symbol (and zero bits per second). As can be seen from FIGS. 25a and 25b, EP ECD generally allows both the local device 301 and the remote device 305 to transmit at any given instance of time.

In a non-limiting example, during mode 1 if L2R1=six bits per symbol and R2L1=two bits per symbol, then the six bits per symbol and the two bits per symbol could be from symbol spaces with signal points from signal spaces as shown in FIGS. 23a and 23b, which can encode six bits per symbol in one direction and two bits per symbol in the other direction. Assuming that the local device and remote device basically exchange behaviors in switching between mode 1 and mode 2, then the signal spaces of FIGS. 23a and 23b can be reversed to show the behavior of the remote device during mode 2 and the local device during mode 2. During mode 2 if L2R2=two bits per symbol and R2L2=six bits per symbol, then the six bits per symbol and the two bits per symbol could be from symbol spaces with signal points from signal spaces as shown in FIGS. 23a and 23b, which can encode six bits per symbol in one direction and two bits per symbol in the other direction.

Communication System Using Extended Performance Echo Cancelled Duplex (EP ECD) and Switching Modes Without Substantial Delay

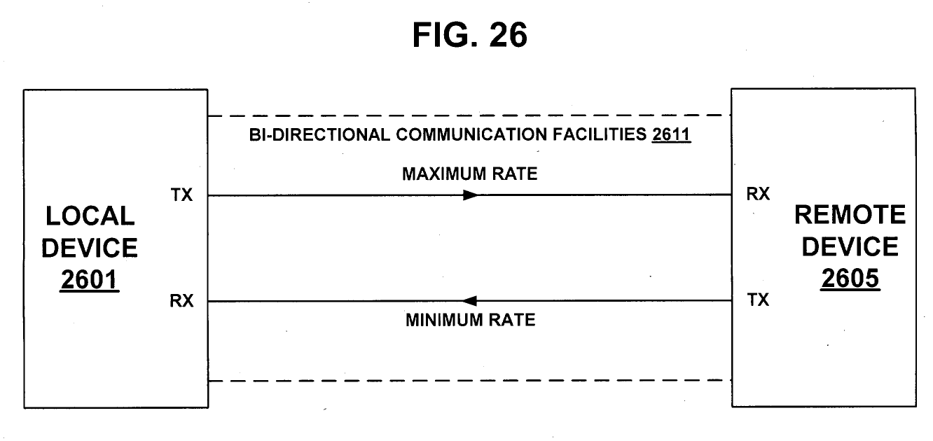

FIG. 26 shows a diagram of a communication system that might be using an embodiment of the present invention. In FIG. 26 the embodiment of the present invention allows local device 2601 to communicate with remote device 2605 using bi-directional communication facilities 2611. In general, the preferred embodiments of the present invention involve changing the relative signal levels of transmissions between the local device 2601 and the remote device 2605 in a switch between a first mode and a second mode of operation. The first mode of operation together with the second mode of operation are referred to as a first manner of operation.

The first mode and the second mode of operation generally occur during different, non-overlapping time intervals. Much like time-division duplexing (TDD), the time periods of the first mode and the second mode can be fixed for example with a 50% or other duty cycle. Alternatively, like adaptive time-division duplexing (ATDD), the time periods of the modes may be dynamically adapted. As a non-limiting example, a decision to make a dynamic change in modes might be based upon the demands to communicate data and/or some other quality of service (QoS) factor.

Furthermore, although the switch between the first mode and the second mode would likely not be perfectly instantaneous, the delay in switching between the first mode and the second mode may be a small, but not completely infinitesimal amount of time. In general, the switch between the first mode and the second mode does not require a significant or substantial delay that may occur with processes such as, but not limited to, training and/or retraining devices to acquire communication parameters for the communications over the bi-directional communication facilities 2611, negotiating parameters, synchronizing devices using phase-locked loops (PLL), and/or combinations and permutations thereof.

Instead in a preferred embodiment of the present invention, at least some of the communication parameters for the local device 2601 and the remote device 2605 operating in the first and second modes would likely be stored in some memory or storage of the respective devices. Although the communication parameters for operating in the first mode and the second mode might have initially been acquired through some training process, the readily-available nature of the stored communication parameters allows a quick change from operating in the first mode to operating in the second mode. If instead of quickly changing between the first mode and the second mode of operation the local device 2601 and/or the remote device 2605 had to perform a process such as, but not limited to, training and/or retraining with each switch of modes, then data transmission generally would be interrupted during the longer time that might be needed for a process such as retraining. Complete interruption of data transmission for significant periods of time adversely affects users of communication systems and may result in some communication protocols timing out and terminating connections.

Switching between a first mode and a second mode during a small, but not infinitesimal, amount of time may involve transitioning through intermediary behavior. However, the intermediary behavior in switching between the first mode and the second mode generally would not introduce substantial delay that could be on the order of the time delays for transmission line retraining. Transmission line training or retraining that involves testing the transmission line or communications medium to acquire the performance parameters or characteristics of the transmission line or communication media (or channel) is notoriously long. In general, the time delays in switching between the first mode and the second mode may be as small as on the order of time it takes to change memory of communication parameters (or pointers to the memory containing a different set of communication parameters). In addition, when the decision to switch between a first mode and a second mode is dynamically determined, often the device (local or remote) that makes the decision to switch modes may notify the other device about the switch in modes. Although this switch in modes between the first mode and the second mode in the preferred embodiment of the present invention may involve some negotiating of communication parameters, the preferred embodiments of the present invention may work without negotiating any communication parameters (or even providing notice of the values of the new communication parameters). In general, the delay occurring with the switch between the first and second modes (including transitional behaviors and states) is substantially less than the delay of initial training and the associated initial parameter negotiation.

One skilled in the art will be aware of the relatively large time delays of communication line training and/or retraining as compared to the substantially smaller amount of time needed to change memory or to change a few pointers to memory (generally based on memory, storage, and/or register access times) to change at least one communications parameter. As a non-limiting and non-specific example, current personal computer speeds of Intel Pentium chips are around 2.0 GHz or 2,000,000,000 cycles per second. Given that many of these chips may execute an instruction per cycle, and that the value of a register might be changed in a single instruction, a register containing a pointer to at least one communication parameter might be changed in as fast as 1/2,000,000,000 seconds or 5×10⁻⁸ seconds, thereby changing the at least one communication parameter used by the device. Furthermore, if a communications device has to notify the device at the other side about a switch between a first mode and a second mode, often the amount of information that needs to be conveyed (if at all) about the switch between the first mode and the second mode generally is small so that the information can be quickly communicated. Thus, in contrast to the substantial delays of training/retraining which may have durations of many seconds, the switching between the first mode and the second mode generally may be able to occur with sub-second delays or even better depending on various factors. These factors include, but are not limited to, access times for the storage or memory technology used in the device and the amount of information (if any) that might need to be propagated to the other side to inform the other device of the switch between the first mode and the second mode.

Thus, the local device 2601 and the remote device 2605 using the preferred embodiments of the present invention generally can switch between the first mode and the second mode without the substantial delay that is incurred for actions such as, but not limited to, training and/or retraining. With this fast and, in comparison to retraining time, almost instantaneous change between the first and second modes, the local device 2601 and the remote device 2605 can quickly and dynamically adapt the communications bandwidth to the demands for data transmission in the two directions of communication.

Extended Performance Echo Cancelled Duplex (EP ECD) Signal-to-Noise Ratios

In the preferred embodiments of the present invention, the local device 2601 and the remote device 2605 generally are both capable of concurrently transmitting and receiving during at least one and possibly both of the first mode and the second mode. This concurrent transmission and reception generally results in receiving echo. In general, echo cancellation is used to mitigate the effects of echo when the local device 2601 and the remote device 2605 generally are both concurrently transmitting and receiving during at least one and possibly both of the first mode and the second mode. However, echo cancellation technology is not perfect. Thus, there is some resulting residual echo noise.

In general, the change in relative signals levels in switching between the first mode and the second mode of operation results in a change to the relative amount of residual echo noise in the first mode as compared to the second mode. These changes in the relative signal levels and the resulting changes in the residual echo noise generally affect the signal-level-to-noise-level ratios (or signal-to-noise ratios) of the communication system. The residual echo noise after performing echo cancellation may not necessarily have a Gaussian distribution so that the Shannon-Hartley Capacity Theorem of C=B log₂ (1+S/N) for band-limited, additive white Gaussian noise (AWGN) channels may not be the equation that exactly characterizes the communication system. However, based on Shannon's Theory, those skilled in the art will be aware that changes in the signal-to-noise ratio of a communication channel generally relate to changes in the bit rate capacity of that communication channel, other things being equal (ceteris parabus).

Generally, because a signal-to-noise ratio basically relates to the signal and noise levels at the receiver and/or detector, in a bi-directional communications systems there is a signal-to-noise ratio for each direction of communication. Also, because the amount of attenuation and the amount of additive noise both vary based on the distance that a signal propagates, the signal-to-noise ratio generally varies throughout the communication facilities. However, Shannon's Theory (and the signal-to-noise ratio in Shannon's Theory) is based on recovering or detecting the originally transmitted information in a signal. Thus, in general the relevant signal-to-noise ratio for each direction is the signal-to-noise ratio at the point of recovering or detecting the information in the signal. As those skilled in the art will be aware, this detection or recovery generally would be located within the local device 2601 and within the remote device 2605 at some point in the receive path or incoming signal processing path of the two devices.

Furthermore just with regard to signal levels, the local device 2601 generally can only directly control the level at which it transmits, and the remote device 2605 generally can only directly control the level at which it transmits. However, based upon the transmit signal level of the local device 2601, the remote device 2605 may have an expectation of a receive signal level. Also, based upon the transmit signal level of the remote device 2605, the local device 2601 may have an expectation of a receive signal level.

With the relative change in signal levels in changing between the first mode and the second mode of the embodiments of the present invention, in general there is a resulting change in signal-to-noise ratios and in bit rate capacities. FIG. 26 shows an embodiment of the present invention that is operating in the first mode with a relative maximum bit rate capacity in the local-to-remote direction and with a relative minimum bit rate capacity in the remote-to-local direction.

Extended Performance Echo Cancelled Duplex (EP ECD) Signal Space Diagrams or Signal Constellations Without Channel Noise

Based on the general principles of the embodiments of the present invention, one particular embodiment of the present invention is further described with respect to the signal space diagrams of FIGS. 23a and 23b. Generally the signal spaces of FIGS. 23a and 23b relate to the communication system of FIG. 26 operating in the first mode when the local-to-remote bit rate capacity is at a relative maximum and the remote-to-local bit rate capacity is at a relative minimum. The second mode of operation for an embodiment of the present invention could be implemented by just reversing the roles and behaviors of the local device 2601 and the remote device 2605 as related to the signal spaces of FIGS. 23a and 23b. Though FIGS. 23a and 23b were originally used to illustrate a non-limiting example of asymmetric echo cancelled duplex (ECD), the same signal space diagrams can also be used to illustrate a non-limiting example of extended performance echo cancelled duplex (EP ECD) with the understanding that unlike pure ECD, EP ECD generally switches modes without substantial delay and operates differently during different periods of time.

However, the concepts of the preferred embodiments of the present invention are not necessarily limited to the local device 2601 and the remote device 2605 behaving similarly when there is a switch between a first mode with a relative maximum local-to-remote bit rate capacity (as well as a relative minimum remote-to-local bit rate capacity) and a second mode with a relative maximum remote-to-local bit rate capacity (as well as a relative minimum local-to-remote bit rate capacity). Thus, the behavior of the local device 2601 in a first mode of operation need not be exactly the same as the behavior of the remote device 2605 in a second mode of operation, and the behavior of the local device 2601 in the second mode of operation need not be exactly the same as the behavior of the remote device 2605 in the first mode of operation.

Although the preferred embodiments of the present invention generally are described with both the local-to-remote bits per symbol (and possibly the local-to-remote bit rate capacity) as well as the remote-to-local bits per symbol (and possibly the remote-to-local bit rate capacity) changing in a shift between a first mode and a second mode, the preferred embodiments of the invention are not limited to changes in both of the bit rate capacities. Instead, in an embodiment of the present invention at least one and possibly both of the local-to-remote bit rate capacity and the remote-to-local bit rate capacity generally changes in a mode shift between a first mode and a second mode.

Those skilled in the art will be aware that the concepts of the preferred embodiments of the present invention generally will work in any communication system where there is some non-insignificant level of echo that results in a residual amount of noise in the incoming signals at the point of recovery. Thus, the concepts of the preferred embodiment of the present invention could apply in a communication system that is experiencing some interference from the echo of its own transmissions with either the echo not cancelled at all because the communication system does not use echo cancellation technology or with the echo interference imperfectly cancelled because the echo cancellation technology does not perfectly estimate the echo and does not perfectly remove it from the incoming signals.

In general, no real-world echo cancellation technology is perfect, so the concepts of the present invention generally apply to real-world or actual communication systems that use echo cancellation to try to mitigate the effects of echo. However, the preferred embodiments of the present invention are not necessarily just limited to communication systems using echo cancellation technology. Instead, the preferred embodiments of the present invention generally manipulate signal levels as a way of reducing, at the point of recovery, the interference that is due to echo (or jointly due to echo and imperfect echo cancellation technology) in the incoming signal. However, unlike TDD/ATDD the preferred embodiments of the present invention do not have to completely stop communication (i.e., the bit rate is zero bits per second) in one direction, which basically causes echo to become insignificant or negligible in TDD/ATDD. Furthermore, those skilled in the art will recognize that there are potential tradeoffs between implementing better (i.e., more expensive and potentially more accurate) echo cancellation technology and utilizing communication system resources (such as, but not limited to, additional memory) to implement the preferred embodiments of the present invention.

Those skilled in the art will recognize that some of the tradeoffs between implementing better echo cancellation technology and implementing the preferred embodiments of the present invention generally depend on using processing and/or memory resources for echo cancellation technology versus using the resources for EP ECD. Based on Gordon Moore's Law of semiconductors and the continually declining costs of memory and processing power, it is expected that the preferred embodiment of the present invention generally will implement echo cancellation technology, ATDD/TDD technology and EP ECD to achieve optimum performance. In general, the concepts of the preferred embodiments of the present invention offer additional advantages even in communication systems using the best available (but still imperfect) echo cancellation technology. However, the present invention is not limited to use only in communication systems with echo cancellation technology. Instead, the lack of any echo cancellation technology could be viewed as being much like the implementation of extremely bad echo cancellation technology that does not provide any advantage in reducing echo noise. In such a case of poorly-performing echo cancellation technology, the residual echo noise levels generally would be the same as the echo noise levels without any echo cancellation, and the preferred embodiments of the present invention could advantageously improve system performance.

The preferred embodiment of the present invention may be described using the signal space diagrams of FIGS. 23a-23b that may represent various signal spaces of local device 2601 and remote device 2605 during the first manner of operation. The first manner of operation further comprises the first mode and the second mode. In the preferred embodiment of the present invention, the local device 2601 and the remote device 2605 may act similarly such that the local device 2601 in the first mode behaves like the remote device 2605 in the second mode and that the remote device 2605 in the first mode behaves like the local device 2601 in the second mode. However, the embodiments of the invention are not limited to this perfect exchange of behaviors between the local device 2601 and the remote device 2605 in switching between the first mode and the second mode.

The local transmit signal space 2301 has sixty-four signal points, which can encode six bits per symbol, while the remote transmit signal space 2302 has four signal points, which can encode two bits per symbol, because the local-to-remote signal-to-noise ratio generally is relatively higher in the first mode of operation, and the remote-to-local signal-to-noise generally is relatively lower in the first mode of operation. Also, reversing the behavior of the local and remote devices in switching between the first and second modes, the local transmit signal space during mode 2 would have four signal points, which can encode two bits per symbol, while the remote transmit signal space during mode 2 would have sixty-four signal points, which can encode six bits per symbol, because the local-to-remote signal-to-noise ratio generally is relatively lower in the second mode of operation, and the remote-to-local signal-to-noise generally is relatively higher in the second mode of operation.

In general, the signal-to-noise ratio changes in switching between the first mode and the second mode of operation are the result of adjusting the transmit power level of a first device, which affects not only the level of the signal received at a second device but also the level of the residual echo noise received at the first device's own receiver. Based on Shannon's theory, these signal-to-noise ratios correspond to various bit rate capacities, and lowering the number of bits encoded per symbol (i.e., the number of signal points in a signal space) is one way to adjust the bit rate to conform to signal-to-noise ratios. As a non-limiting example, with lowered (or raised) transmit levels that lower (or raise) signal-to-noise levels, the same bit error rate in the communications can often be maintained by decreasing (or increasing) the number of signal points in the signal space such that the distance between signal points in the revised signal space is about the same as the distance between signal points in the original signal space. One skilled in the art will be aware that this adjustment in the number of signal points in a signal space is only one possible non-limiting way of modifying communications based on the signal-to-noise ratio. Another non-limiting example of adjusting the communications system for lowered (or raised) transmit levels that lower (or raise) signal-to-noise ratios would be to allow the number of signal points to remain the same and to decrease (or increase) the distance between the signal points. Other things being equal, the decreased (or increased) distance between signal points generally would result in an increased (or decreased) bit error rate that could be compensated for by increasing (or decreasing) the number of error control bits associated with each transmission. Thus, the embodiments of the present invention also will work with a change in coding in changing between a first mode and a second mode of EP ECD.

Furthermore, one skilled in the art will be aware of many tradeoffs in communication systems that involve choosing the optimum communication parameters to maximize performance over a channel with a transmit level limit that affects the signal-to-noise ratio by at least affecting residual echo noise. Some non-limiting parameters that might be adjusted include, but are not limited to, bit error rates, the symbol rate, the number of signal points, the spacing between the signal points, the geometry of the signal space, the number of error control bits, and the method of error control coding, as well as many other characteristics that are far too numerous to provide an exhaustive list. Though only a few possible changes to a communication system in response to a change in signal-to-noise ratios in switching between a first mode and a second mode of the preferred embodiments of the present invention are described in detail and/or shown in the figures, these descriptions are only for non-limiting example purposes. In general, all possible reactions of a communication system in response to a change in the signal-to-noise ratio of a communication system are intended to be within the scope of this disclosure.

One skilled in the art will be aware of the multitude of design decisions that are possible for efficiently utilizing a communication channel with a set of signal-to-noise characteristics that generally change in changing between a first and a second mode of the preferred embodiments of the present invention Moreover, one skilled in the art should be aware that a change in the number of signal points of a signal space in reaction to a change in the signal-to-noise ratio of a communication system is only a non-limiting example of a response to the signal-to-noise ratio change. In addition to adjusting the number of signal points in a signal space in changing between a first mode and a second mode, many other communication parameters as well as combinations of communication parameters can be changed to efficiently utilize the communication channels in the first and second modes that have different signal-to-noise ratios as a result of adjusting signal levels in changing between and/or among modes. The changed signal levels in changing between and/or among modes generally lead to changes in the residual echo noise.

Returning to FIG. 23, the local amplified residual echo noise signal space 2305 might represent the local-incoming residual echo noise effect during the first mode and might represent the remote-incoming residual echo noise effect during the second mode. Even with echo-cancellation technology that provides some benefits, real-world imperfections will still result in a local-incoming residual echo noise effect and a remote-incoming residual echo noise effect that generally are jointly the result of the echo noise and the imperfect and/or incorrect echo cancellation. Because the bi-directional communications facilities 2611 comprise at least one additive channel, the local amplified residual echo noise signal space 2305 can be added to the local amplified receive signal space 2303 to obtain the local amplified receive plus residual echo noise signal space 2307.

Also, because of the relatively low signal level of the transmissions of the remote device 2605 and the relatively high level of echo received in the remote-to-local signal during the first mode of operation, the remote-to-local signal-to-noise ratio in the first mode of operation generally supports a relatively lower bit rate capacity in the remote-to-local direction during the first mode of operation. Thus in the preferred embodiment of the present invention, the remote transmit signal space 2303 can only encode two bits per symbol in the remote-to-local direction during the first mode of operation. Furthermore, if the local device 2601 and the remote device 2605 basically exchange behaviors in switching between the first and second modes of the preferred embodiment of the present invention, then the remote transmit signal space 2303 becomes a local transmit signal space during mode 2 and is received by the remote device 2605 during the second mode of operation with the local-to-remote direction only encoding two bits per symbol during the second mode of operation. Those skilled in the art will recognize that other tradeoffs could be used instead of or in addition to lowering the number of signal points in a signal space in response to a lower signal-to-noise ratio.

In contrast to the remote-to-local signal-to-noise level that generally is relatively lower in the first mode of operation than in the second mode of operation, the local-to-remote signal-to-noise level generally is relatively higher in the first mode of operation than in the second mode of operation. In the first mode of operation, the transmissions of the remote device 2605 using the remote transmit signal space 2302 may result in the remote amplified residual echo noise signal space 2306 arriving back at the remote device 2605.

Therefore, the remote amplified residual echo noise signal space 2306 might represent the remote-incoming echo noise effect during the first mode and might represent the local-incoming echo noise effect during the second mode. Even with echo-cancellation technology that provides some benefits, real-world imperfections with still result in a local-incoming residual echo noise effect and a remote-incoming residual echo noise effect that generally are jointly the result of the echo noise and the imperfect and/or incorrect echo cancellation.

Because the bi-directional communications facilities 2611 comprise at least one additive channel, the remote amplified residual echo noise signal space 2306 can be added to the remote amplified receive signal space 2304. Remote amplified receive plus residual echo noise signal space 2308 represents the resulting receive signal space when the remote amplified residual echo noise signal space 2306 is added to the remote amplified receive signal space 2304. In the first mode of operation, the remote device 2605 receives the remote amplified receive signal space 2304 from the local device 2601. Furthermore, in the first mode of operation, the remote device 2605 also receives the remote amplified residual echo noise signal space 2306 based upon echoes of the remote device's 2605 own transmissions.

Because of the relatively high signal level of the transmissions of the local device 2601 and the relatively low level of echo received in the local-to-remote signal during the first mode of operation, the local-to-remote signal-to-noise ratio in the first mode of operation generally supports a relatively higher bit rate capacity in the local-to-remote direction during the first mode of operation. Thus, the sixty-four signal points of local transmit signal space 2301 can encode six bits per symbol in the local-to-remote direction during the first mode of operation. Furthermore, if the local device 2601 and the remote device 2605 basically exchange behaviors in switching between the first and second modes of the preferred embodiment of the present invention, then the local transmit signal space 2301 becomes a remote transmit signal space during mode 2 and is received by the local device 2601 during the second mode of operation with the remote-to-local direction encoding six bits per symbol during the second mode of operation. Those skilled in the art will recognize that other tradeoffs could be used instead of or in addition to raising the number of signal points in a signal space in response to a higher signal-to-noise ratio.

Changing the Mapping of Information

FIGS. 23a and 23b generally show the effect of changing the maximum signal level of signal spaces with the result being that the signal-to-noise ratio at the local device 2601 during the second mode is better than the signal-to-noise ratio at the local device 2605 during the first mode. However, in general the concepts of the preferred embodiments of the present invention can be applied to making at least one change to the mapping of information to physical phenomena or signals that represent information in the signal space. This mapping change might involve changing the signal space to adjust the level of the signals. Thus, as shown in FIGS. 23a and 23b of the preferred embodiment of the present invention, the maximum signal level of the transmit signal space could be reduced to reduce the residual effect of echo on the receiver.

Also, the way that information is mapped onto a signal space might be changed to lower the expected transmit signal level and the resulting residual echo noise. For instance, if a signal point with a higher signal level has a higher probability of being transmitted than another signal point with a lower signal level, then the expected value or average transmit signal level for a signal space could be reduced by changing the mapping of information onto the signal space. As a result of the changed mapping, the signal point with a higher signal level then would have a lower probability of being transmitted than the signal point with the lower signal level. Generally, this should result in a reduced expected value of the magnitude of the transmit signal level and possibly a reduced residual echo noise. Thus, changing the way information is mapped onto the signal space may well result in reductions in the average signal level and residual echo noise.

Changing the mapping of information to a signal space to reduce the probability of transmitting higher signal levels generally would work if there is some probability difference in the likelihood of transmitting various signal points. If some signal points have significantly higher probabilities of being transmitted, then there may be some redundancy in the data to be transmitted. Instead of changing the mapping of information onto the signal space, some source coding techniques might be used to reduce the redundancy in the data, to improve system performance through compression, and generally to reduce differences in the probabilities of transmitting various signal points.

In general, the preferred embodiment of the present invention involves changing signal levels in switching between the first mode and the second mode. The signals levels may be changed if there is a change in the signal space (i.e., the physical phenomena used to represent information). A change in the physical phenomena that make up a signal space generally involves a change in the mapping between information and the physical phenomena of the changed signal space. However, there can be changes in mappings of information to signal spaces that do not necessarily involve changing the physical phenomena that are used in the signal space. One non-limiting example of such a mapping change that adjusts signal levels is based on changing the probabilities of various signal points in the signal space.

In addition, the mappings between information and signal space need not necessarily involve a fixed relationship between the bits of a codeword and a specific physical phenomena. Instead, those skilled in the art will recognize that there are many ways of relating bits or other forms of information to physical phenomena. As a non-limiting example, often information can be encoded differentially such that only changes in information are communicated through the physical phenomena. Also, often changes in physical phenomena are used to communicate information. A non-limiting baseband example of standard versus differential coding might be the comparison of Manchester encoding with differential Manchester encoding that is used in ethernet. Thus, the preferred embodiment of the present invention generally is not limited to communication systems that only have a fixed mapping between a specific bit pattern of information and a specific physical phenomena of a signal space.

Furthermore, although FIGS. 23a and 23b show signal spaces with a reduced number of signal points in the remote transmit signal space 2302 during mode 1 of EP ECD to compensate for the reduced signal-to-noise ratios, those skilled in the art will realize that Shannon's theory suggests other ways to compensate for reduced signal-to-noise ratios. In general with a reduced signal-to-noise ratio, Shannon's limit for channel capacity implies that the maximum communication bit rate is reduced, other things being equal (ceteris parabus).

This reduced communication bit rate might be dealt with using various methods. As a first non-limiting example, the devices may reduce the number of signal points in the signal space and increase the distance between signal points. In another non-limiting example the devices could increase the number of error control bits. By increasing the number of error control bits, the transmission bit rate might not be decreased, but the communication bit rate would be decreased due to the added overhead of the error control bits. Also, as another non-limiting example the symbol rate could be reduced. In addition, the communication devices could continue communicating with a higher bit error rate (BER) and place responsibility on handling the communication errors on higher level protocols and entities that retransmit the data when errors are detected. These non-limiting examples of changes in the communications are not exclusive and may be used in various combinations to compensate for the reduced signal-to-noise level. Furthermore, the few listed examples of changes to the communication system are definitely not limiting. Those skilled in the art will be aware of many other possible areas of modification to communication systems to d cal with a reduced signal-to-noise ratio and generally stay within a link budget.

Relative Changes in Switching Between Modes of Extended Performance Echo Cancelled Duplex (EP ECD)

The following relationships generally summarize how changes in one transmit signal level will affect other characteristics of the communications when that one transmit signal level and only that one transmit signal level is independently changed and other characteristics of a communication system are not independently modified or changed by other forces (i.e., other things being equal or ceteris parabus).

Other things being equal (ceteris parabus), increases in the transmit signal level of the local device 2601 cause increases in the local-to-remote signal-to-noise ratio at the remote device 2605 by increasing the expected receive signal level (the numerator of the SNR) at the remote device 2605. Also, other things being equal, increases in the transmit signal level of the local device 2601 cause increases in the receive echo signal level of the local device 2601. Because echo cancellation is imperfect, increases in the receive echo signal level at the local device 2601 generally lead to increased variance or noise around a signal point even after applying echo cancellation. Thus, an increased receive echo signal level at the local device 2601 generally leads to an increased residual echo noise level at the local device 2601. This increased residual echo noise level (the denominator of the SNR) at the local device 2601 likely results in a decreased remote-to-local signal-to-noise ratio at the local device 2601, other things being equal (ceteris parabus). Based on the same reasoning, for a decrease in the transmit signal level of the local device 2601, the local-to-remote signal-to-noise ratio decreases and the remote-to-local signal-to-noise ratio increases, other things being equal (ceteris parabus).

Similarly, other things being equal (ceteris parabus), increases in the transmit signal level of the remote device 2605 cause increases in the remote-to-local signal-to-noise ratio at the local device 2601 by increasing the expected receive signal level (the numerator of the SNR) at the local device 2601. Also, other things being equal, increases in the transmit signal level of the remote device 2605 cause increases in the receive echo signal level of the remote device 2605. Because echo cancellation is imperfect, increases in the receive echo signal level at the remote device 2605 generally lead to increased variance or noise around a signal point even after applying echo cancellation. Thus, an increased receive echo signal level at the remote device 2605 generally leads to an increased residual echo noise level at the remote device 2605. This increased residual echo noise level (the denominator of the SNR) at the remote device 2605 likely results in a decreased local-to-remote signal-to-noise ratio at the remote device 2605, other things being equal (ceteris parabus). Based on the same reasoning, for a decrease in the transmit signal level of the remote device 2605, the remote-to-local signal-to-noise ratio decreases and the local-to-remote signal-to-noise ratio increases, other things being equal (ceteris parabus).

In the preferred embodiment of the present invention these relationships are utilized to allow bi-directional communications over a first manner of operation that comprises the first mode and the second mode. During at least one and possibly both of the first mode and second mode, the communications are asymmetric with a local-to-remote communication bit rate capacity being different from a remote-to-local communication bit rate capacity. Also, during at least one and possibly both of the first mode and the second mode, echo cancellation technology may be employed to mitigate the effects of concurrent (or at the very least nearly concurrent) transmitting and receiving. Then as part of the change between the first mode and the second mode at least one and possibly both of the local device's 2601 transmit signal level and the remote device's 2605 transmit signal level are changed. To correspond with a change in the transmit signal level of the local device 2601, the remote device 2605 has a change in its expected receive signal level. In addition, to correspond with a change in the transmit signal level of the remote device 2605, the local device 2601 has a change in its expected receive signal level.

Other things being equal (ceteris parabus), decreasing the average transmit signal level of the local device 2601 in switching from the first mode to the second mode would tend to decrease the resulting average echo level in the signal received at the local device 2601. With a lower average echo level in the receive signal at the local device 2601 during the second mode of operation, echo cancellation technology generally might make smaller errors when subtracting an estimate of the echo from the received signal of the local device 2601. In effect, the amount of echo in the receive signal at the local device 2601 generally becomes a smaller portion of the received signal, which results in smaller errors caused by residual echo noise. This reduction in the percentage of the receive signal that is due to echo is further magnified if the remote device 2605 increases its transmit level in switching from the first mode to the second mode.

Also, decreasing the maximum transmit signal level of the local device 2601 in switching from the first mode to the second mode would tend to decrease the resulting maximum echo level in the signal received at the local device 2601. With a lower maximum echo level in the receive signal at the local device 2601 during the second mode of operation, echo cancellation technology generally might make smaller errors when subtracting an estimate of the echo from the received signal of the local device 2601. Once again, the amount of echo in the receive signal at the local device 2601 generally becomes a smaller portion of the received signal, which results in smaller errors caused by residual echo noise. Also, this reduction in the percentage of the receive signal that is due to echo is further magnified if the remote device 2605 increases its transmit level in switching from the first mode to the second mode.

Given these general relationships, the first mode and the second mode generally can be related by some inequality equations, other things being equal (ceteris parabus). The inequality equations generally are only based on just changing the relative transmit signal levels and the resulting effects on the communication system (i.e., other things being equal). The inequality equations may not hold if there are other things that affect the communication system that are different while operating in the first mode and the second mode. As a non-limiting example, an unrelated electric motor might turn on after a particular change between the first mode and the second mode. Any electromagnetic interference from an electric motor in close proximity to the communications medium might affect the signal-to-noise ratios in the communication system. When an electric motor turns on and generates additional interference, other things in the communication system generally are no longer equal. In listing the following inequality equations, some identifiers are used to symbolically represent various values. The following symbolic identifiers are defined as:

L2R S₁—The signal level of the local-to-remote signal-to-noise ratio when operating in the first mode. Because this signal level generally is in the numerator of the signal-to-noise ratio, the L2R S₁ generally is directly related to the L2R SNR₁.

L2R S₂—The signal level of the local-to-remote signal-to-noise ratio when operating in the second mode. Because this signal level generally is in the numerator of the signal-to-noise ratio, the L2R S₂ generally is directly related to the L2R SNR₂.

R2L S₁—The signal level of the remote-to-local signal-to-noise ratio when operating in the first mode. Because this signal level generally is in the numerator of the signal-to-noise ratio, the R2L S₁ generally is directly related to the R2L SNR₁.

R2L S₂—The signal level of the remote-to-local signal-to-noise ratio when operating in the second mode. Because this signal level generally is in the numerator of the signal-to-noise ratio, the R2L S₂ generally is directly related to the R2L SNR₂.

L1 EN₁—The local-incoming echo noise component of the remote-to-local signal-to-noise ratio when operating in the first mode. Because this echo noise component generally is in the denominator of the signal-to-noise ratio, the L1 EN₁ generally is inversely related to the R2L SNR₁.

L1 EN₂—The local-incoming echo noise component of the remote-to-local signal-to-noise ratio when operating in the second mode. Because this echo noise component generally is in the denominator of the signal-to-noise ratio, the L1 EN₂ generally is inversely related to the R2L SNR₂.

R1 EN₁—The remote-incoming echo noise component of the local-to-remote signal-to-noise ratio when operating in the first mode. Because this echo noise component generally is in the denominator of the signal-to-noise ratio, the R1 EN₁ generally is inversely related to the L2R SNR₁.

R1 EN₂—The remote-incoming echo noise component of the local-to-remote signal-to-noise ratio when operating in the second mode. Because this echo noise component generally is in the denominator of the signal-to-noise ratio, the R1 EN₂ generally is inversely related to the L2R SNR₂.

L2R SNR₁—The local-to-remote signal-to-noise ratio of receiving communications in the local-to-remote direction when operating in the first mode.

L2R SNR₂—The local-to-remote signal-to-noise ratio of receiving communications in the local-to-remote direction when operating in the second mode.

R2L SNR₁—The remote-to-local signal-to-noise ratio of receiving communications in the remote-to-local direction when operating in the first mode.

R2L SNR₂—The remote-to-local signal-to-noise ratio of receiving communications in the remote-to-local direction when operating in the second mode.

L2R BR₁—The local-to-remote bit rate capacity when operating in the first mode.

L2R BR₂—The local-to-remote bit rate capacity when operating in the second mode.

R2L BR₁—The remote-to-local bit rate capacity when operating in the first mode.

R2L BR₂—The remote-to-local bit rate capacity when operating in the second mode.

In general, the preferred embodiment of the present invention may be implemented such that the signal level in the local-to-remote direction is greater in the first mode than in the second mode, and the signal level in the remote-to-local direction is greater in the second mode than in the first mode, other things being equal (ceteris parabus). However, alternative embodiments do exist that are readily apparent from the following equations and analysis.

Generally for EP ECD operating differently than pure ECD, with respect to signal level:

L2RS₁>L2RS₂ (1)

and

R2LS₁<R2LS₂ (2)

However, in switching between the first mode and the second mode, there is a change in at least one and possibly both of the local-to-remote signal level and the remote-to-local signal level. Thus, more generally for EP ECD operating differently than pure ECD, as long as there is a change in at least one of the signal levels in the switch between the first mode and the second mode:

L2RS₁≧L2RS₂ (3)

and

R2LS≦R2LS₂ (4)

Note that there could be a change in the average signal level without a change in the signal space by changing the probabilities of transmitting a particular signal point in the signal space. This change in probabilities could occur as the result of a change in the mapping of information to the signal space in switching between the first mode and the second mode.

Even more generally, when R2L S₁≠0 and R2L S₂≠0 (because division by 0 is undefined) and when at least one of the signal levels changes in switching between the first mode and the second mode (the inequality becomes a strict inequality):

$$\frac{L2R {S}_{1}}{R2L {S}_{1}} > \frac{L2R {S}_{2}}{R2L {S}_{2}} \qquad ( 5 )$$

Also, when L2R S₁≠0 and L2R S₂≠0 (because division by 0 is undefined) and when at least one of the signal levels changes in switching between the first mode and the second mode (the inequality becomes a strict inequality):

$$\frac{R2L {S}_{1}}{L2R {S}_{1}} < \frac{R2L {S}_{2}}{L2R {S}_{2}} \qquad ( 6 )$$

Also, when L2R S₁>0, L2R S₂>0, R2L S₁>0, and R2L S₂>0 (because division by 0 is undefined) and based on the properties of fractions:

$$\begin{matrix}\frac{L2R {S}_{1}}{L2R {S}_{2}} > \frac{R2L {S}_{1}}{R2L {S}_{2}} & ( 7 ) \\ and \\ \frac{L2R {S}_{2}}{L2R {S}_{1}} < \frac{R2L {S}_{2}}{R2L {S}_{1}} & ( 8 )\end{matrix}$$

In general in the preferred embodiments of the present invention, for bi-directional communications in the first manner of operation comprising the first mode and the second mode, L2R S₁ and L2R S₂ cannot both be zero (otherwise the communication would be uni-directional). Also, R2L S₁ and R2L S₂ cannot both be zero (otherwise the communication would be uni-directional). Generally in pure time-division duplexing (TDD) or ATDD, the local-to-remote signal level is positive (i.e., non-zero) when the remote-to-local signal level is zero (or effectively zero), and the remote-to-local signal level is positive (i.e., non-zero) when the local-to-remote signal level is zero (or effectively zero). Thus, in TDD or ATDD generally two of the signal levels are always zero (or effectively zero). In contrast to pure TDD and pure ATDD, when the preferred embodiment of the present invention is operating in a first manner of operation comprising a first mode and a second mode, all four of the values for L2R S₁, L2R S₂, R2L S₁, and R2L S₂ may be non-zero. In general, as long as three of the four values of L2R S₁, L2R S₂, R2L S₁, and R2L S₂ are capable of being non-zero, the preferred embodiments of the present invention are different from pure TDD and pure ATDD, and the preferred embodiments of the present invention provide the capability of bi-directional communications. Furthermore, as long as three of the four of L2R S₁, L2R S₂, R2L S₁, and R2L S₂ are capable of being non-zero, then equations 1 and 2 can be combined into the following equation that describes the relationship among signal levels in the first and second modes:

L2RS₁×R2LS₂>L2RS₂×R2LS₁ (9)

The signal levels in equations 1 through 9 generally could be maximum or average signal levels. Furthermore, the preferred embodiments of the present invention can be considered to involve information theory concepts, and some of the information capacity equations of information theory generally are proven using the law of large numbers. In general, the law of large numbers will apply to large numbers of symbol clock ticks when a symbol selection is transmitted at each symbol clock tick. In effect, the law of large numbers generally will apply to repeated transmissions of various selections from a signal space.

Based on the law of large numbers, the concepts of the preferred embodiments of the present invention generally are still relevant for signal spaces that have one or more outlyer signal points of very high signal level and very low probability of being transmitted. Even though these outlyer signal points might affect the average or maximum levels of signal points in a signal space, the low probability of transmission of these outlyer signal points generally makes them irrelevant to the basic concepts of the preferred embodiments of the present invention. In effect, large numbers of transmissions selected from the non-outlyer signal points in the signal space relative to very small numbers of transmissions of these outlyer signal points, makes the signal level and residual echo noise predominately formed based on the significantly higher probability non-outlyer signal points as opposed to the significantly lower probability outlyer signal points.

The situation of a signal space with a very high probability of transmitting non-outlyer signal points and a very low probability of transmitting outlyer signal points might be considered analogous to transmitting by making selections from two different signal spaces at different symbol clock ticks. During a very high probability of time, transmission selections could be chosen from a signal space that just contains the non-outlyer signal points. Then during a very low probability of time, transmission selections could be chosen from another signal space that just contains the outlyer signal points. Thus, the preferred embodiments of the present invention still cover implementations that introduce these high-value, low-probability signal points into the signal spaces to manipulate the average and/or maximum signal level of the signal space in switching between a first mode and a second mode.

Although changes to the maximum and/or average level of a signal space may be manipulated by these very low probability outlyer signal points, the preferred embodiments of the present invention generally involve reducing the residual echo noise in switching between the first mode and the second mode. Because of the low probability of the outlyer signal points, the residual echo noise generally will not be affected by transmission of the outlyer signal points for a relatively large amount of time. In effect, the high-value, low-probability outlyer signal points generally act like a low probability or rare noise disturbance that only affects performance of the communication system for small amounts of time.

Furthermore, the preferred embodiment of the present invention generally may be implemented such that the residual echo noise in the remote-to-local direction is greater in the first mode than in the second mode, and the residual echo noise in the local-to-remote direction is greater in the second mode than in the first mode, other things being equal (ceteris parabus). However, alternative embodiments do exist that are readily apparent from the following equations and analysis.

Generally, with respect to echo noise:

L1 EN₁>L1 EN₂ (10)

and

R1 EN₁<R1 EN₂ (11)

However, in switching between the first mode and the second mode, there is a change in at least one and possibly both of the local-incoming echo noise and the remote-incoming echo noise. Thus, more generally as long as there is a change in at least one of the echo noise levels in the switch between the first mode and the second mode:

L1 EN₁≧L1 EN₂ (12)

and

R1 EN₁≦R1 EN₂ (13)

Note that there could be a change in the average echo noise level without a change in the signal space by changing the probabilities of transmitting a particular signal point in the signal space. This change in probabilities could occur as the result of a change in the mapping of information to the signal space in switching between the first mode and the second mode.

Even more generally, when L1 EN₁≠0 and L1 EN₂≠0 (because division by 0 is undefined) and when at least one echo noise level changes as a result of at least one signal level change in switching between the first mode and the second mode (the inequality becomes a strict inequality):

$$\frac{RI {EN}_{1}}{LI {EN}_{1}} < \frac{RI {EN}_{2}}{LI {EN}_{2}} \qquad ( 14 )$$

Also, when R1 EN₁≠0 and R1 EN₂≠0 (because division by 0 is undefined) and when at least one echo noise level changes as a result of at least one signal level change in switching between the first mode and the second mode (the inequality becomes a strict inequality):

$$\frac{LI {EN}_{1}}{RI {EN}_{1}} > \frac{LI {EN}_{2}}{RI {EN}_{2}} \qquad ( 15 )$$

Dividing equation 5 by equation 14 generally yields

$$\frac{\frac{L2R {S}_{1}}{R2L {S}_{1}}}{\frac{RI {EN}_{1}}{LI {EN}_{1}}} > \frac{\frac{L2R {S}_{2}}{R2L {S}_{2}}}{\frac{RI {EN}_{2}}{LI {EN}_{2}}} \qquad ( 16 )$$

Rearranging equation 16 generally yields:

$$\frac{\frac{L2R {S}_{1}}{RI {EN}_{1}}}{\frac{R2L {S}_{1}}{LI {EN}_{1}}} > \frac{\frac{L2R {S}_{2}}{RI {EN}_{2}}}{\frac{R2L {S}_{2}}{LI {EN}_{2}}} \qquad ( 17 )$$

Also, assuming that there are no other changes affecting the SNR (i.e., ceteris parabus) then equation 17 basically relates to:

$$\frac{L2R {SNR}_{1}}{R2L {SNR}_{1}} > \frac{L2R {SNR}_{2}}{R2L {SNR}_{2}} \qquad ( 18 )$$

A similar derivation is available for:

$$\frac{R2L {SNR}_{1}}{L2R {SNR}_{1}} < \frac{R2L {SNR}_{2}}{L2R {SNR}_{2}} \qquad ( 19 )$$

Generally, based on the properties of fractions:

$$\begin{matrix}\frac{L2R {SNR}_{1}}{L2R {SNR}_{2}} > \frac{R2L {SNR}_{1}}{R2L {SNR}_{2}} & ( 20 ) \\ and \\ \frac{L2R {SNR}_{2}}{L2R {SNR}_{1}} < \frac{R2L {SNR}_{2}}{R2L {SNR}_{1}} & ( 21 )\end{matrix}$$

In general in the preferred embodiments of the present invention, for bi-directional communications in the first manner of operation comprising the first mode and the second mode, L2R SNR₁ and L2R SNR₂ cannot both be below the level(s) that allow communication to occur (i.e., below the level(s) that allow non-zero bit rate(s)) otherwise the communication would be uni-directional. Also, R2L SNR₁ and R2L SNR₂ cannot both be below the level(s) that allow communication to occur (i.e., below the level(s) that allow non-zero bit rate(s)) otherwise the communication would be uni-directional. Generally in pure time-division duplexing (TDD) or ATDD, the local-to-remote SNR allows communication when the remote-to-local SNR may not allow communication, and the remote-to-local SNR allows communication when the local-to-remote SNR may not allow communication. Thus, in TDD or ATDD generally two of the signal-to-noise ratios may not allow communication. In contrast to pure TDD and pure ATDD, when the preferred embodiment of the present invention is operating in a first manner of operation comprising a first mode and a second mode, all four of the values for L2R SNR₁, L2R SNR₂, R2L SNR₁, and R2L SNR₂ may allow communication. In general, as long as three of the four values of L2R SNR₁, L2R SNR₂, R2L SNR₁, and R2L SNR₂ allow communication, the preferred embodiments of the present invention are different from pure TDD and pure ATDD, and the preferred embodiments of the present invention provide the capability of bi-directional communications. Furthermore, as long as three of the four values of L2R SNR₁, L2R SNR₂, R2L SNR₁, and R2L SNR₂ allow communication, then instead of equations 18 and 19 the following equation could have been derived that describes the relationship among signal-to-noise ratios in the first and second modes, other things being equal:

L2RSNR₁×R2LSNR₂>L2RSNR₂×R2LSNR₁ (22)

Based on the general information theory relationship between bit rate capacities and signal-to-noise ratios, the local-to-remote bit rate capacity is greater in the first mode than in the second mode, and the remote-to-local bit rate capacity is greater in the second mode than in the first mode.

Generally, with respect to bit rate capacity:

$$\begin{matrix}\frac{L2R {BR}_{1}}{R2L {BR}_{1}} > \frac{L2R {BR}_{2}}{R2L {BR}_{2}} & ( 23 ) \\ and \\ \frac{R2L {BR}_{1}}{L2R {BR}_{1}} < \frac{R2L {BR}_{2}}{L2R {BR}_{2}} & ( 24 )\end{matrix}$$

Also, based on the properties of fractions:

$$\begin{matrix}\frac{L2R {BR}_{1}}{L2R {BR}_{2}} > \frac{R2L {BR}_{1}}{R2L {BR}_{2}} & ( 25 ) \\ and \\ \frac{L2R {BR}_{2}}{L2R {BR}_{1}} < \frac{R2L {BR}_{2}}{R2L {BR}_{1}} & ( 26 )\end{matrix}$$

In general in the preferred embodiments of the present invention, for bi-directional communications in the first manner of operation comprising the first mode and the second mode, L2R BR₁ and L2R BR₂ cannot both be zero (otherwise the communication would be uni-directional). Also, R2L BR₁ and R2L BR₂ cannot both be zero (otherwise the communication would be uni-directional). Generally in pure time-division duplexing (TDD) or ATDD, the local-to-remote bit rate capacity is positive (i.e., non-zero) when the remote-to-local bit rate capacity is zero, and the remote-to-local bit rate capacity is positive (i.e., non-zero) when the local-to-remote bit rate capacity is zero. Thus, in TDD or ATDD generally two of the bit rate capacities are zero. In contrast to pure TDD and pure ATDD, when the preferred embodiment of the present invention is operating in a first manner of operation comprising a first mode and a second mode, at most one of the bit rate capacity values of L2R BR₁, L2R BR₂, R2L BR₁, and R2L BR₂ generally may be zero. In addition, the bit rate capacities generally are related to the communication bit rates, which are the rates that devices are capable of communicating given that the devices have information to communicate. Furthermore, as long as three of the four values of L2R BR₁, L2R BR₂, R2L BR₁, and R2L BR₂ are capable of being non-zero, then instead of equations 23 and 24 the following equation could have been derived that describes the relationship among bit rate capacities in the first and second modes, other things being equal:

L2R BR₁×R2L BR₂>L2R BR₂×R2L BR₁ (27)

In contrast to equation 27 for EP-ECD, in pure ECD there are not two different modes of operation. In pure ECD, modes 1 and 2 really are just the same mode with L2R BR, =L2R BR₂ and R2L BR, =R2L BR₂ such that the inequality of equation 27 does not hold. In pure TDD/ATDD, two of the values of L2R BR₁, L2R BR₂, R2L BR₁, and R2L BR₂ are zero bits per second. Thus, the derivation of equation 27 from equations 25 and 26 would not be apply to TDD/ATDD because two of the bit rates would be zero and division by zero is undefined. Therefore, EP ECD is different from both pure ECD and pure TDD/ATDD.

Bit Rates

In addition, many concepts that generally are well-known by those skilled in the art also apply to the preferred embodiments of the present invention. For instance, because bits are discrete items of the minimum quanta of information, a time related count of the complete number of bits transferred generally is a discontinuous function without a derivative. Thus, computation of an instantaneous bit rate (i.e., an instantaneous rate of bits or the first derivative) generally is not possible by attempting to take the derivative of a discontinuous function. However, average bit rates may be calculated based on the average number of bits transferred over a period of time. When average rates are determined, the average rate often depends upon the time interval over which the average is calculated.

Furthermore, the number of bits that a communication system actually transfers over a specific time period may be less than the number of bits that the communication system is capable of transferring over the time period because during some periods of time there may be no data to transmit. In other words, a communication system may not transmit any bits during time periods when there is no data to transmit (e.g., when the transmit queue may be empty). Also, the number of bits transferred over a period of time may include, among other things, bits for communication from the source to the destination and various additional bits that are used for functions such as, but not limited to, redundancy that provides detection and/or correction of errors. This use of redundant bits for detecting and/or correcting communication errors generally is called error control coding. The concepts of information theory, coding theory, and error control coding generally have grown out of the work of Claude Shannon and his paper “A Mathematical Theory of Communication” that is referenced in the background section of this patent application. For more information on error control coding see Error Control Systems for Digital Communication and Storage by Stephen B. Wicker, which is incorporated by reference in its entirety herein. These communication system concepts are well-known by those skilled in the art and will not be described in detail herein, but the concepts do apply to the preferred embodiments of the present invention.

The change of at least one and possibly both the local-to-remote bit rate capacity and the remote-to-local bit rate capacity in a mode switch between the first mode and the second mode might be more accurately described as a change in at least one and possibly both of a local-to-remote communication bit rate and a remote-to-local communication bit rate. As defined herein the local-to-remote communication bit rate generally is the bit rate at which the local device 2601 is capable of communicating bits to the remote device 2605. The local-to-remote communication bit rate generally may be less than Shannon's theoretical limit bit rate capacity in the local-to-remote direction because of various imperfections. However, the local-to-remote communication bit rate at which the local device 2601 is capable of communicating generally increases with increases in Shannon's bit rate capacity and decreases with decreases in Shannon's bit rate capacity. Furthermore, the actual local-to-remote communication bit rate from the local device 2601 to the remote device 2605 may be less than the capabilities of the local device 2601 because the local device 2601 may not constantly transmit at its maximum capability when it does not have data ready for transfer.

In addition, the bit rate associated with the transfer of signals from the local device 2601 to the remote device 2605 could be called a local-to-remote transmission bit rate and may be greater than the local-to-remote communication bit rate. The local-to-remote transmission bit rate as defined herein generally is the bit rate at which the local device 2601 is capable of sending communication bits and other bits (such as bits used in error control coding) to the remote device 2605. The actual local-to-remote transmission bit rate from the local device 2601 to the remote device 2605 may be less than the capabilities of the local device because the local device 2601 may not constantly transmit at its maximum capability when it does not have data ready for transfer. Also, because the local-to-remote transmission bit rate may include error control bits, the local-to-remote transmission bit rate generally is greater than or equal to the local-to-remote communication bit rate. (This consequence of adding overhead with the addition of bits for error control coding is well-known to those skilled in the art and is based on the efficiency of error control coding being less than or equal to 100%.)

As defined herein the remote-to-local communication bit rate generally is the bit rate at which the remote device 2605 is capable of communicating bits to the local device 2601. The remote-to-local communication bit rate generally may be less than Shannon's theoretical limit bit rate capacity in the remote-to-local direction because of various imperfections. However, the remote-to-local communication bit rate at which the remote device 2605 is capable of communicating generally increases with increases in Shannon's bit rate capacity and decreases with decreases in Shannon's bit rate capacity. Furthermore, the actual remote-to-local communication bit rate from the remote device 2605 to the local device 2601 may be less than the capabilities of the remote device 2605 because the remote device 2605 may not constantly transmit at its maximum capability when it does not have data ready for transfer.

Furthermore, the bit rate associated with the transfer of signals from the remote device 2605 to the local device 2601 could be called a remote-to-local transmission bit rate and may be greater than the remote-to-local communication bit rate. The remote-to-local transmission bit rate as defined herein generally is the bit rate at which the local device 2601 is capable of sending communication bits and other bits (such as bits used in error control coding) to the remote device 2605. The actual remote-to-local transmission bit rate from the local device 2601 to the remote device 2605 may be less than the capabilities of the local device because the local device 2601 may not constantly transmit at its maximum capability when it does not have data ready for transfer. Also, because the remote-to-local transmission bit rate may include error control bits, the remote-to-local transmission bit rate generally is greater than or equal to the remote-to-local communication bit rate. (This consequence of adding overhead with the addition of bits for error control coding is well-known to those skilled in the art and is based on the efficiency of error control coding being less than or equal to 100%.)

Because bit rates generally are average rates and because average rates often depend on the time over which the average is computed, the following bit rates generally would be average rates computed over a time interval: the local-to-remote communication bit rate, the local-to-remote transmission bit rate, the remote-to-local communication bit rate, and the remote-to-local transmission bit rate. In general, these bit rates might be determined as the average bit rates of which a device is capable (i.e., given that it has data to transmit) during the time interval that begins when a device starts a mode of operation and ends when the device stops a mode of operation. Generally, a device starts a mode of operation and ends a mode of operation by switching between modes, but there are other ways of starting and stopping modes. For example, a device likely will start a mode of operation after initialization (or re-initialization), training, and/or negotiation of configuration(s). Also, a device likely will end a mode of operation when the communication terminates. These examples of the starting and stopping of modes are not intended to be a complete list of all the situations when the mode of a device may change.

Because a switch between the first mode and the second mode is unlikely to occur in a perfectly instantaneous manner, this description of average bit rates over time intervals does not take into account whether the average bit rates include the likely small, but not completely infinitesimal, amount of time when the local device 2601 and/or the remote device 2605 are switching modes. However, the issue of including this small amount of switching time in the computation of bit rates does not affect the concepts of the preferred embodiments of the present invention. Furthermore, the method of computing bit rates described herein (as average rates over the relevant time interval given there is data to be transmitted) is only one possible way of computing the bit rates, and those skilled in the art will recognize other possible computations of bit rates.

Given these understandings of bit rates as average bit rates over the relevant time interval that generally is bounded by the moments when a device enters and exits a mode of operation, of bit rates being the rates at which a device has the capability to transmit when data is constantly available, and of transmission bit rates being greater than or equal to communication bit rates due to the possibility of error control bits, the relationship between the first mode and second mode of operation can now be better described.

The change of at least one and possibly both the local-to-remote bit rate and the remote-to-local bit rate in a mode switch between the first mode and the second mode might be more accurately described as a change in at least one and possibly both of a local-to-remote communication bit rate and a remote-to-local communication bit rate. In general, a communication bit rate ratio might be defined with the local-to-remote communication bit rate as the numerator and the remote-to-local communication bit rate as the denominator. The communication bit rate ratio changes in the switch between the first mode of operation and the second mode of operation. Generally, the communication bit rate ratio is greater in the first mode of operation than the communication bit rate ratio is in the second mode of operation. Thus, by changing at least one and possibly both of the local-to-remote communication bit rate and the remote-to-local communication bit rate in switching between the first mode and the second mode, the communication bit rate ratio changes.

The local-to-remote communication bit rate generally is the bit rate at which the local device 2601 is capable of communicating given that it has data to send. Also, the remote-to-local communication bit rate generally is the bit rate at which the remote device 2605 is capable of communicating given that it has data to send. Furthermore, the local-to-remote communication bit rate during the first mode of operation generally might be computed as an average bit rate based upon the number of bits that the local device 2601 is capable of communicating to the remote device 2605 in the first mode of operation divided by the time of operation of the first mode. In addition, the remote-to-local communication bit rate during the first mode of operation generally might be computed as an average bit rate based upon the number of bits that the remote device 2605 is capable of communicating to the local device 2601 in the first mode of operation divided by the time of operation of the first mode. Likewise, the local-to-remote communication bit rate during the second mode of operation generally might be computed as an average bit rate based upon the number of bits that the local device 2601 is capable of communicating to the remote device 2605 in the second mode of operation divided by the time of operation of the second mode. Moreover, the remote-to-local communication bit rate during the second mode of operation generally might be computed as an average bit rate based upon the number of bits that the remote device 2605 is capable of communicating to the local device 2601 in the second mode of operation divided by the time of operation of the second mode. Generally, the counts of the number of bits and time might be reset upon each switch in modes of the local device 2601 and the remote device 2605.

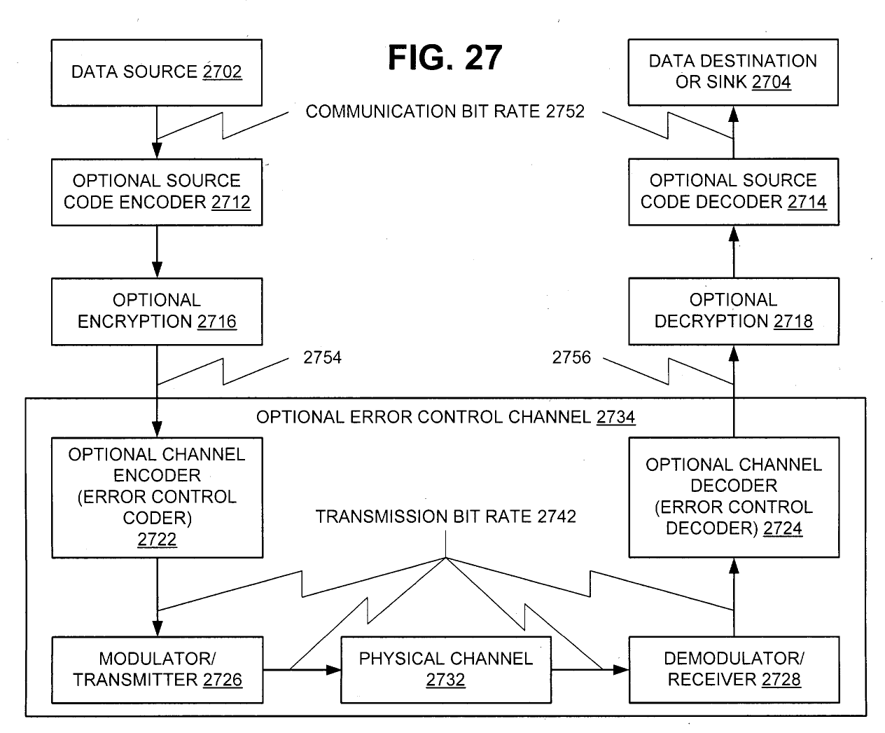

FIG. 27 shows a generalized model of a communication system and some of the different types of information coding as well as the different bit rates at different portions of the communications between data source 2702 and data destination or sink 2704. This communication model of FIG. 27 is general and is further described in Error Control Systems for Digital Communication and Storage by Stephen B. Wicker, which is incorporated by reference in its entirety herein.

In general, information from data source 2702 is communicated to data destination or sink 2704 by being passed through various blocks of FIG. 27. The optional source code encoder 2712 and the optional source code decoder 2714 generally might be used to perform source coding that generally removes uncontrolled redundancy in some source information streams. A non-limiting example of the operation of optional source code encoder 2712 and optional source code decoder 2714 might include data compression and data decompression. In addition, source coding might include codes used to format data for the transmitter/modulator and receiver/demodulator. Optional encryption 2716 and optional decryption 2718 generally add bits to the data and/or scramble the data as to make it unintelligible to anyone except for the intended recipient.

Optional channel encoder 2722 and optional channel decoder 2724 generally perform channel coding or error control coding that introduces controlled redundancy into the data to increase the noise immunity of the communication system. The error control codes are used to detect and/or correct at least some communication errors. After error control coding is optionally performed in optional channel coder 2722 and optional channel decoder 2724, the information is communicated from modulator/transmitter 2726 through physical channel 2732 to demodulator/receiver 2728. Though the physical channel may have certain communication characteristics including a specific bit error rate, the option channel coding (or error control coding) creates an optional error control channel 2734 that may have different characteristics including a different bit error rate from the physical channel 2732.

As each one of the optional coding blocks (2712, 2714, 2716, 2718, 2722, and/or 2724) may introduce and/or remove bits from the stream of data, the bit rate at different portions of the communication in FIG. 27 may be different. In the case of FIG. 27, the rate of bits being communicated between the modulator/transmitter 2726 and the demodulator/receiver 2728 is shown as a transmission bit rate 2742, while the rate of communicating bits between the data source 2702 and the data destination or sink 2704 is shown as communication bit rate 2752.

To the extent that the communication system does not perform optional source coding in blocks 2712 and 2714, optional encryption in blocks 2716 and 2718, as well as optional channel or error coding in blocks 2722 and 2724, the communication bit rate 2752 would likely be equal to the transmission bit rate 2742. Furthermore, to the extent the that the communication system does not perform optional source coding in blocks 2712 and 2714 and does not perform optional encryption in blocks 2716 and 2718, the bit rates at points 2754 and 2756 would likely be equal to the communication bit rate 2752. If the communication system performs error control coding in blocks 2722 and 2724, then the error control coding likely introduces some additional bits so that the transmission bit rate would be more than the bit rate at points 2754 and 2756.

Quality of Service (QoS)

Looking at the example local-to-remote timing diagram of FIG. 25a, it can be concluded that the local-to-remote direction supports a minimum of L2R2 bits per symbol clock as well as a maximum of L2R1 bits per symbol. Furthermore, based upon the example local-to-remote timing diagram of FIG. 25b, it can be concluded that the remote-to-local direction also supports a minimum of R2L1 bits per symbol clock as well as a maximum of R2L2 bits per symbol. Based on these observations and an understanding of the quality of service (QoS) and traffic classes that have been defined for technologies such as asynchronous transfer mode (ATM), the communications of the preferred embodiment of the present invention in FIGS. 25a and 25b can be viewed as comprising at least one constant bit rate (CBR) channel and at least one variable bit rate (VBR) channel.

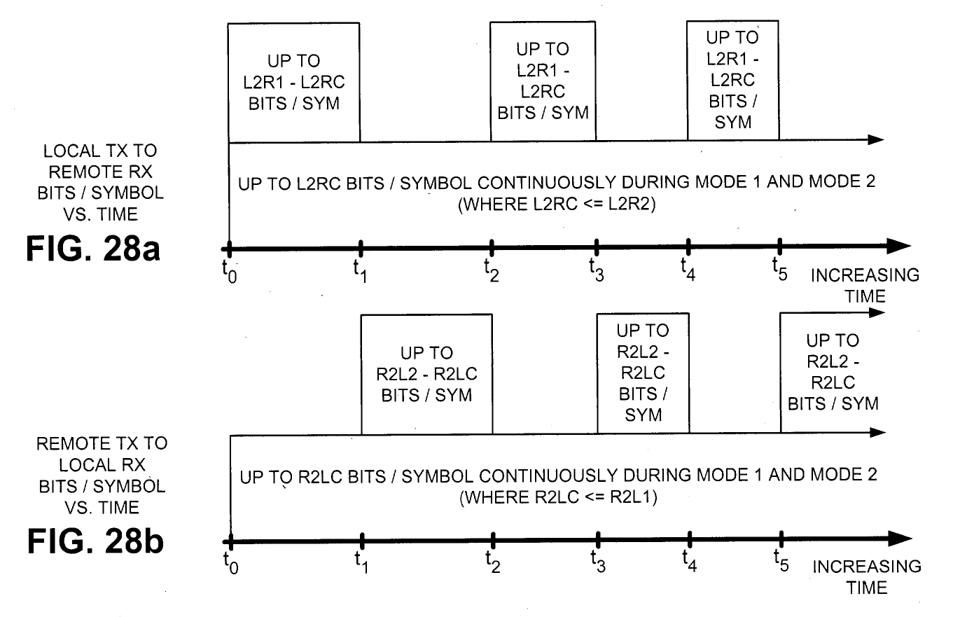

FIG. 28a shows how the local-to-remote communications of FIG. 25a can be utilized to support CBR and VBR capabilities. As shown in the example of FIG. 28a, the local-to-remote direction generally can continuously or constantly support without interruption up to L2RC bits per symbol, where L2RC is less than or equal to L2R2. The excess bandwidth that is not being used to support continuous or constant traffic can be used to handle other variable demands of the communication. Thus, FIG. 28a shows the data rates available for other traffic when L2RC bits per symbol generally are used for basically continuous or constant traffic. In FIG. 28a, the excess bandwidth available in the time intervals (t₀, t₁), (t₂, t₃), and (t₄, t₅) is L2R1−L2RC bits per symbol. In contrast, if L2RC=L2R2, then no excess bandwidth is available in the time intervals (t₁, t₂) and (t₃, t₄) in FIG. 28a.

FIG. 28b shows how the remote-to-local communications of FIG. 25b can be utilized to support CBR and VBR capabilities. As shown in the example of FIG. 28b, the remote-to-local direction generally can continuously or constantly support without interruption up to R2LC bits per symbol, where R2LC is less than or equal to R2L1. The excess bandwidth that is not being used to support continuous or constant traffic can be used to handle other variable demands of the communication. Thus, FIG. 28b shows the data rates available for other traffic when R2LC bits per symbol generally are used for basically continuous or constant traffic. In FIG. 28b, the excess bandwidth available in the time intervals (t₁, t₂) and (t₃, t₄) is R2L2-R2LC bits per symbol interval. In contrast, if R2LC=R2L1, then no excess bandwidth is available in the time intervals (t₀, t₁), (t₂, t₃), and (t₄, t₅) in FIG. 28b.

In effect the communications of FIGS. 28a and 28b can be viewed as combining an ECD communication of L2RC bits per symbol in the local-to-remote direction and R2LC bits per symbol in the remote-to-local direction simultaneously in FIGS. 28a and 28b with a TDD/ATDD communication that carries L2R1-L2RC bits per symbol in the local-to-remote direction and R2L2-R2LC bits per symbol in the remote-to-local direction during modes 1 and 2 respectively. Note that the continuous or constant bit rate (CBR) traffic does not necessarily have to use all of the L2R2 bits per symbol and R2L1 bits per symbol available in FIGS. 28a and 28b. Any excess bandwidth not used for constant bit rate traffic could be used to carry variable bit rate (VBR) or available bit rate (ABR) traffic.

Non-limiting equipment implementations that advantageously utilize this characteristic of the preferred embodiment of the present invention may have two or more queues that each handle the separate types of data (CBR, VBR, and/or ABR). However, those skilled in the art will recognize that there are many ways of advantageously using this feature of the preferred embodiment of the present invention to support various types of traffic such as, but not limited to, the ATM traffic classes. Furthermore, the constant bit rate communications of L2RC and R2LC in FIGS. 28a and 28b likely is better for delay-sensitive traffic because the local device 2601 and the remote device 2605 may transmit at any time. Thus, the constant bit rate communications of L2RC and R2LC bits per symbol in FIGS. 28a and 28b generally has relatively lower latency. In contrast, the variable bit rate communications of L2R1-L2RC and R2L2-R2LC bits per symbol of FIGS. 28a and 28b may introduce delays as the local device 2601 and/or the remote device 2605 may have to wait for and/or negotiate a change in the direction of communication before transmitting. Therefore, the communications in the variable bit rate portion of FIGS. 28a and 28b generally has relatively higher latency.

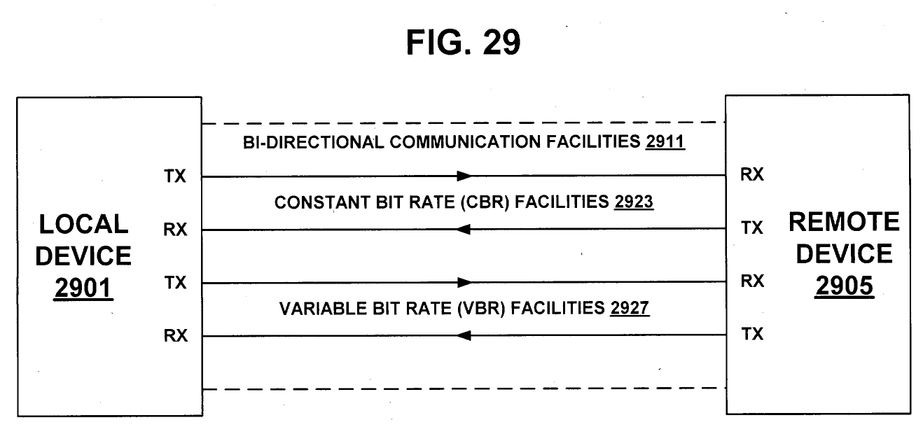

The queues to support relatively lower latency and relatively higher latency communications might be called lower latency queues and higher latency queues, and the use of different queues with different latencies to handle different application requirements is well-known to those skilled in the art. FIG. 29 shows how a local device 2902 may communicate with a remote device 2905 over bi-directional communication facilities 2911, which may be viewed as being comprised of constant bit rate (CBR) facilities 2923 and variable bit rate (VBR) facilities 2927.

Multiple Manners of Operation

One of the advantages of the preferred embodiment of the present invention is that it can be implemented in the same system that also supports pure ECD, pure TDD/ATDD, and/or both pure ECD and pure TDD/ATDD. In general, when operating in the first manner of operation comprising the first mode and the second mode, the preferred embodiments of the present invention support the EP ECD capability of changing at least one and possibly both signal levels in switching between modes. In addition, in the first manner of operation the preferred embodiments of the present invention might use echo cancellation technology during at least one and possibly both of the first mode and the second mode.

Also, the preferred embodiment of the present invention may further support pure TDD and/or pure ATDD during a second manner of operation. In pure TDD and pure ATDD one of the devices is basically silent during the transmissions of the other device, so that echo cancellation technology generally is not used or needed. The second manner of operation of the preferred embodiment of the present invention can be considered to be comprised of a third mode and a fourth mode. Basically in pure TDD/ATDD during a third mode of operation, one of the devices (such as the local device) is capable of transmitting while the other device (such as the remote device) is silent. Then during the fourth mode of operation the local device is silent while the remote device is capable of transmitting. Pure TDD/ATDD generally differs from EP ECD because EP ECD supports generally simultaneous transmission and reception of signals during at least one and possibly both of the first mode and the second mode. Also, echo cancellation technology generally offers some benefit under EP ECD during the generally simultaneous transmissions and receptions of EP ECD. The generally non-concurrent transmission and reception in TDD/ATDD makes echo cancellation relatively useless in TDD/ATDD (though there may be some relatively small echo depending on the amount of time it takes for echoes of previous transmissions to subside).

In addition, the preferred embodiment of the present invention may further support pure ECD during a third manner of operation that comprises a fifth mode. In pure ECD both devices are capable of simultaneously transmitting and receiving during the fifth mode. In general, the simultaneous transmission and reception of signals in the fifth mode of operation results in interference from echo that generally is reduced or mitigated through echo cancellation technology. Pure ECD generally differs from EP ECD because EP ECD generally supports quickly changing the direction of maximum bit rate between the local-to-remote direction and the remote-to-local direction.

In at least some of the preferred embodiments of the present invention, devices can change among various manners of operation including, but not necessarily limited to, EP ECD, pure TDD/ATDD, and/or pure ECD. In general, as in all digital systems having states, modes, and/or manners of operation, the preferred embodiment of the present invention generally does not switch or change states, modes, and/or manners of operation completely instantaneously. Instead, there generally is some amount of transition time between states, modes, and/or manners of operation, though the transition times may be quite small. Therefore, the switching between and/or among the first manner, the second manner, the third manner, the fourth manner, the fifth manner, and the sixth manner of operation may involve some non-infinitesimal amount of time during which the device is transitioning between and/or among the manners of operation. Thus, switching between manners of operation is intended to comprise any of these transitional times. Sometimes the transitional periods are sufficiently defined that they are given labels as additional states, modes, and/or manners of operation. The switching between manners of operation in the preferred embodiments of the present invention generally is intended to include these transitional periods and any intermediary states, modes, and/or manners of operation in the switching between and/or among the various manners of operation.

Also, the switching between modes within manners of operation based upon EP ECD and/or TDD/ATDD may involve some non-infinitesimal amount of time during which the device is transitioning between and/or among the various modes. The switching between modes is intended to comprise any of these transitional times. Sometimes the transitional periods are sufficiently defined that they are given labels as additional states, modes, and/or manners of operation. The switching of modes in the preferred embodiments of the present invention generally is intended to include these transitional periods and any intermediary states, modes, and/or manners of operation in the switching between and/or among the various modes within a manner of operation.

Generally, in the preferred embodiments of the present invention, the switching between and/or among manners of operation may take longer than the switching between and/or among modes within a manner of operation. Often the switching between modes within the manners of operation based at least upon TDD/ATDD and/or EP ECD may be accomplished without the substantial delay commonly associated with training. TDD/ATDD and EP ECD generally are capable of switching between modes that generally are associated with the predominate direction of communication traffic without incurring substantial delay. Thus, a preferred embodiment of the present invention might work not only in the first manner of operation comprising the first and second modes, but also be able to switch among the first manner of operation of EP ECD, the second manner of operation of pure TDD/ATDD, and the third manner of operation of pure ECD.

Also, a communication system supporting at least two manners of operation of an embodiment of the present invention with the manners of operation selected from a first manner of EP ECD operation, a second manner of pure TDD/ATDD operation, and a third manner of pure ECD operation, could test the communications line to determine various transmission line characteristics and noise performance to decide on the optimal manner of operation selecting among the supported manners of operation. In this way such a communication system could utilize the duplexing technique that provides optimum efficiency on a particular transmission line. This dynamic testing of the transmission line and selecting the proper manner of duplexing operation from EP ECD, pure TDD/ATDD, and/or pure ECD would allow such a system to the communication to achieve the best possible performance without the necessity of a network administrator testing the communication transmission line and manually selecting the manner of operation for the communication system. Thus, dynamically testing the behavior of a communication line and automatically selecting the proper manner of operation from EP ECD, pure TDD/ATDD, and/or pure ECD could adjust the communication system to operate optimally on communication lines with significantly different performance characteristics. This dynamic testing and automatic configuration could be very useful if a preferred embodiment of the present invention is used on telephone local loops that often have widely varying characteristics and generally are too numerous to absorb the costs of custom manual configuration with human intervention by a network transmission professional.

Second Manner of Operation Utilizing Pure TDD/ATDD

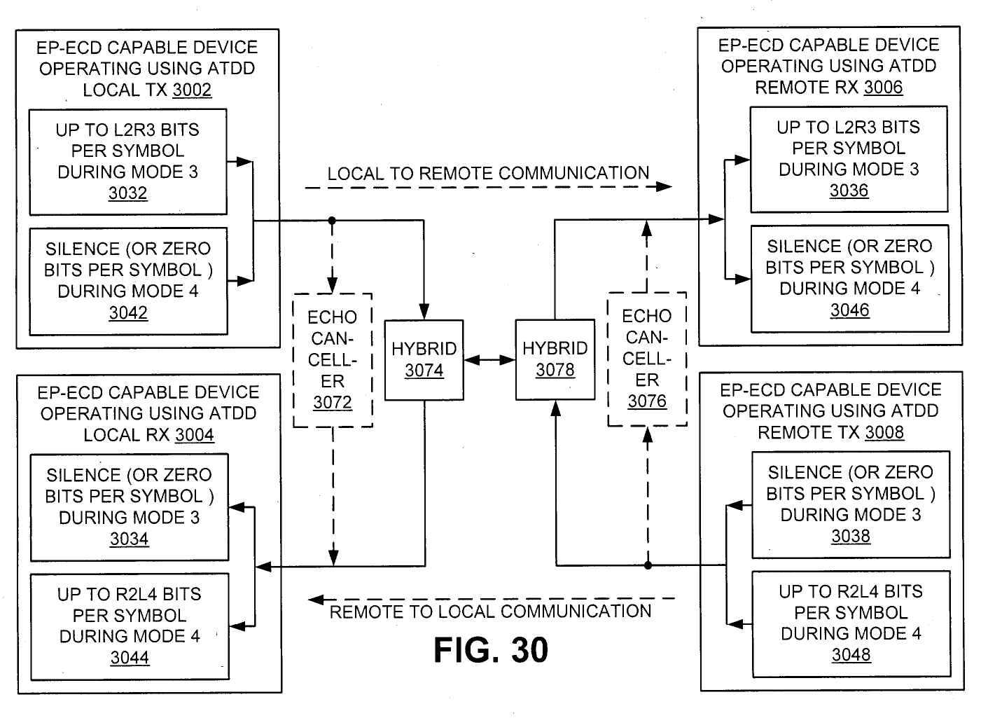

FIG. 30 shows a block diagram of communication devices that might be using a preferred embodiment of the present invention during a second optional manner of operation. Like pure TDD/ATDD, the preferred embodiments of the present invention operating in a second optional manner of operation generally utilize multiple modes of communication at different bits per symbol. The local transceiver generally comprises local transmitter 3002 and local receiver 3004, while the remote transceiver generally comprises remote receiver 3006 and remote transmitter 3008. Local transmitter 3002 and remote receiver 3006 generally provide local-to-remote communication, while remote transmitter 3008 and local receiver 3004 generally provide remote-to-local communication. Furthermore, the preferred embodiments of the present invention generally divide communication up into essentially or substantially (but not necessarily perfectly) non-overlapping intervals of time that might be known as mode 3 and mode 4 with respect to FIG. 30. In general, there is some small amount of time involved in switching between modes 3 and 4.

Furthermore, the local and remote devices might not switch between modes 3 and 4 at the exact same instant. The actual procedures used to cause the local and remote devices to switch modes may vary. As a non-limiting example, the local and remote devices may communicate with each other about switching between mode 3 and 4 in pure TDD/ATDD operation. However, this communication on switching modes takes time to be propagated between the local device and the remote device. As a result, the two devices might not switch between modes 3 and 4 at the exact same instant of time. However, the two devices can be expected to change between modes 3 and 4 at approximately the same time. Another non-limiting example of mode switching in a fixed or static TDD arrangement of the second manner of operation of the preferred embodiments of the present invention might be based on the number of clock ticks that each device has received. However, even the distribution of synchronized clock information between the local device and the remote device also may require propagation time. Regardless of the use of different types of mechanisms to synchronize the local and remote devices, one skilled in the art will recognize that the switching between modes 3 and 4 in the local device may not occur at the exact same time as the switching between modes 3 and 4 in the remote device. Thus, at a detailed technical level, the absolute time during which the local device is in mode 3 (after switching from mode 4) might slightly overlap the absolute time during which the remote device is in mode 4 and preparing to switch to mode 3. Thus, mode 3 and mode 4 generally correspond to essentially or substantially (but not necessarily perfectly) non-overlapping intervals of time.

Referring again to FIG. 30, the local transmitter 3002 operating in a pure TDD/ATDD second manner of operation may transmit up to L2R3 bits per symbol during mode 3 as shown in block 3032 that relates to local-to-remote communication during mode 3. Also, during mode 3, the remote receiver 3006 may receive up to L2R3 bits per symbol during mode 3 as shown in block 3036 that relates to local-to-remote communication during mode 3. The remote-to-local direction of communication is shown in FIG. 30 as block 3038 of remote transmitter 3008 and as block 3034 of local receiver 3004. Like TDD/ATDD, a communication system with extended performance (EP) echo cancelled duplex (ECD) that is operating in a pure TDD/ATDD second manner of operation generally does utilize silence in the remote-to-local communication while communication is occurring in the local-to-remote communication during mode 3. This silence of remote-to-local communication during mode 3 is shown in FIG. 30 as remote transmitter 3008 transmitting zero bits per symbol from block 3038 during mode 3 to local receiver 3004 receiving zero bits per symbol in block 3034 during mode 3.

In switching between mode 3 and mode 4, an EP ECD communication system of the preferred embodiments of the present invention operating in the second pure TDD/ATDD manner of operation generally switches between some local-to-remote communication and no remote-to-local communication during mode 3 and some remote-to-local communication and no local-to-remote communication during mode 4. The silence of local-to-remote communication during mode 4 is shown in FIG. 30 as local transmitter 3002 transmitting zero bits per symbol from block 3042 during mode 4 to remote receiver 3006 receiving zero bits per symbol in block 3046 during mode 4. Also, the remote-to-local communication during mode 4 is shown in FIG. 30 as remote transmitter 3008 transmitting up to R2L4 bits per symbol from block 3048 during mode 4 to local receiver 3004 receiving up to R2L4 bits per symbol in block 3044 during mode 4.

Like TDD/ATDD, extended performance (EP) echo cancelled duplex (ECD) operating in a second manner of pure TDD/ATDD operation generally does utilize silence in the local-to-remote communication while communication is occurring in the remote-to-local communication during mode 4. L2R3 is the number of bits per symbol in the local-to-remote direction during mode 3, while L2R4 is the number of bits per symbol in the local-to-remote direction during mode 4 and equals zero. In addition, R2L3 is the number of bits per symbol in the remote-to-local direction during mode 3 and equals zero, while R2L4 is the number of bits per symbol in the remote-to-local direction during mode 4.

In extended performance (EP) echo cancelled duplex (ECD) of the preferred embodiments of the present invention while operating in a second pure TDD/ATDD manner of operation, both the local-to-remote communication and the remote-to-local communication generally are not capable of occurring at the same time. Thus, in a communication system with EP ECD that is operating in a second pure TDD/ATDD manner of operation, at the same time that local-to-remote communications may be transferring up to L2R3 bits per symbol from block 3032 of local transmitter 3002 to block 3036 of remote receiver 3006 during mode 3, remote transmitter 3008 is silent and therefore transferring zero bits per symbol to local receiver 3004 between blocks 3038 and 3034 during mode 3. Similarly, in a communication with EP ECD that is operating in a second pure TDD/ATDD manner of operation, at the same time that local-to-remote communications is silent and therefore transferring zero bits per symbol from block 3042 of local transmitter 3002 to block 3046 of remote receiver 3006 during mode 4, remote transmitter 3008 may be transferring up to R2L4 bits per symbol to local receiver 3004 between blocks 3048 and 3044 during mode 4.

Generally, unlike the first manner of operation of a system with EP ECD, the second pure TDD/ATDD manner of operation does not use echo cancellation. Therefore, FIG. 30 shows echo cancellers 3072 and 3076 as dashed lines. Though a communication system with EP ECD of the preferred embodiments of the present invention may have echo cancellers, these echo cancellers generally are not used (or are just used marginally) while operating in a second pure TDD/ATDD manner of operation.

Also shown in FIG. 30, local transmitter 3002 and local receiver 3004 are connected to hybrid 3074, while remote receiver 3006 and remote transmitter 3008 are connected to hybrid 3078. As is known by one of ordinary skill in the art, the two hybrids 3074 and 3078 generally convert between four wire connections and a two wire transmission line or communication media between hybrid 3074 and 3078. Furthermore, the preferred embodiments of the present invention operating in an optional second pure TDD/ATDD manner of operation may be used for symmetric TDD/ATDD communications and for asymmetric TDD/ATDD communications. In general, the characteristics, timing diagrams, and signal spaces in FIGS. 13-17b of pure TDD/ATDD also apply to the preferred embodiments of the present invention operating in an optional second manner of pure TDD/ATDD operation.

Third Manner of Operation Utilizing Pure ECD

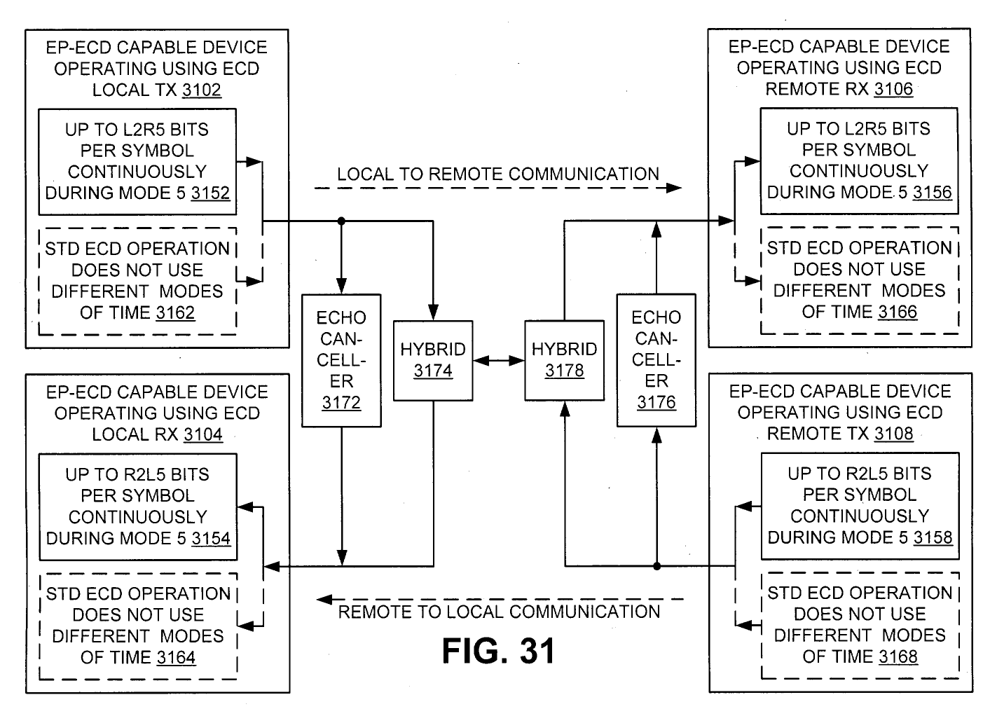

FIG. 31 shows a block diagram of communication devices that might be using a preferred embodiment of the present invention during a third optional manner of operation. Like pure ECD, the preferred embodiments of the present invention operating in a third optional manner of operation generally do not utilize multiple modes of communication at different bits per symbol. However, to distinguish the third manner of pure ECD operation, the time period during which this third manner occurs is referred to as mode 5. The local transceiver generally comprises local transmitter 3102 and local receiver 3104, while the remote transceiver generally comprises remote receiver 3106 and remote transmitter 3108. Local transmitter 3102 and remote receiver 3106 generally provide local-to-remote communication, while remote transmitter 3108 and local receiver 3104 generally provide remote-to-local communication.

Referring again to FIG. 31, the local transmitter 3102 operating in a pure ECD third manner of operation may transmit up to L2R5 bits per symbol continuously during mode 5 as shown in block 3152 that relates to local-to-remote communication during mode 5. Also, during mode 5, the remote receiver 3106 may receive up to L2R5 bits per symbol continuously during mode 5 as shown in block 3156 that relates to local-to-remote communication during mode 5. The remote-to-local direction of communication is shown in FIG. 31 as block 3158 of remote transmitter 3108 and as block 3154 of local receiver 3104. Like pure ECD, a communication system with extended performance (EP) echo cancelled duplex (ECD) that is operating in a pure ECD third manner of operation generally does not utilize silence in the remote-to-local communication while communication is occurring in the local-to-remote communication during mode 5. Thus, the remote-to-local communication during mode 5 is shown in FIG. 31 as remote transmitter 3108 transmitting R2L5 bits per symbol from block 3158 during mode 5 to local receiver 3104 receiving R2L5 bits per symbol in block 3154 during mode 5.

Because an EP ECD communication system of the preferred embodiments of the present invention operating in the third pure ECD manner of operation generally does not have multiple modes of time, blocks 3162, 3164, 3166, and 3168 are shown as dashed lines to indicate that pure ECD does not need to use multiple modes of time. However, an EP ECD device operating in a third pure ECD manner of operation could still retain the capabilities of EP ECD that might be used to communicate and command bit rate capabilities as is commonly done in TDD/ATDD. Such communication and command of bit rate capabilities would allow features such as, but not limited to, the ability to seamlessly change bit rates using a different set of pure ECD parameters when the transmission characteristics of a communications medium change due to events such as, but not limited to, the addition (or subtraction) of more (or less) noise. Like pure ECD, extended performance (EP) echo cancelled duplex (ECD) operating in a third manner of pure ECD operation generally allows continuous transmission in both the local-to-remote direction and in the remote-to-local direction. Thus, L2R5 bits per symbol may be continuously transmitted in the local-to-remote direction, while R2L5 bits per symbol may be continuously transmitted in the remote-to-local direction during the third optional manner of pure ECD operation of a preferred embodiment of the present invention. Generally, like the first manner of operation of a system with EP ECD, the third optional manner of pure ECD operation does use echo cancellation. Therefore, FIG. 31 shows echo cancellers 3172 and 3176 as solid lines. Though a communication system with EP ECD of the preferred embodiments of the present invention may have echo cancellers, these echo cancellers generally are used while operating in a third pure ECD manner of operation.

Also shown in FIG. 31, local transmitter 3102 and local receiver 3104 are connected to hybrid 3174, while remote receiver 3106 and remote transmitter 3108 are connected to hybrid 3178. As is known by one of ordinary skill in the art, the two hybrids 3174 and 3178 generally convert between four wire connections and a two wire transmission line or communication media between hybrid 3174 and 3178. Furthermore, the preferred embodiments of the present invention operating in an optional third pure ECD manner of operation may be used for symmetric ECD communications and for asymmetric ECD communications. In general, the characteristics, timing diagrams, and signal spaces in FIGS. 18-23b of pure ECD also apply to the preferred embodiments of the present invention operating in an optional third manner of pure ECD operation.

Multi-Point or Line Sharing

Furthermore, although FIGS. 3, 4, 13, 18, 24, 30, and 31 generally show point-to-point communications between a local device 301 (or 401 or 2601) and a remote device 305 (or 405 or 2605), it is possible to use echo-cancelled duplex (ECD) as well as the preferred embodiments of the present invention (using any one of the three manners of operation of EP ECD, pure TDD/ATDD, and/or pure ECD) in a multi-point fashion. The use of multi-point ECD is described in U.S. Pat. No. 6,014,371, entitled “Echo Cancellation System and Method for Multipoint Networks”, filed on Dec. 19, 1997, and issued to William L. Betts on Jan. 11, 2000. U.S. Pat. No. 6,014,371 is incorporated in its entirety by reference herein. Those skilled in the art will recognize that the concepts of the U.S. Pat. No. 6,014,371 apply just as well to the preferred embodiments of the present invention as they do to the multi-point ECD communications that are described in the U.S. Pat. No. 6,014,317. Thus, with its ability to support multi-point or line-shared operation, the preferred embodiment of the present invention will work not only in a point-to-point fashion, but also in a multi-point fashion.

In general, echo cancellation generally works with two devices at any time, because the receiving device subtracts its estimate of its own echo from the received signals. U.S. Pat. No. 6,014,317 generally describes a polling method that allows one device to operate using ECD at any time with one other device using ECD. The polling mechanism ensures that only two devices are using the communications media at a time. One skilled in the art will be aware of other methods for time sharing communications media. Many of the communication systems using time sharing algorithms for media access control (MAC) are known as time division multiple access (TDMA) systems. Polling is only one type of non-limiting example of a TDMA method that can be used to ensure that a communication system using echo cancellation is only used by two devices at a time. Another non-limiting method might be fixed or assigned time slots in which two devices can communicate on a transmission media using ECD (or EP ECD). The line-shared or multi-point version of EP ECD also could work with various TDMA methods. Furthermore, since TDD/ATDD already is a time sharing mechanism it may also be used with in a multi-point or line-shared configuration with multiple devices sharing the use of the communications media.

Thus, the preferred embodiments of the present invention also will work in multiple manners of operation (EP ECD, pure ECD, and/or pure TDD/ATDD) with multiple devices in a multi-point configuration. As a non-limiting example, the preferred embodiments of the present invention could communicate between a local device and a first remote device using EP ECD and also support multi-point communications with a second remote device using EP ECD, pure ECD, and/or TDD/ATDD.

With the line-shared capability of the preferred embodiments of the present invention, one local device could communicate in a first manner of operation using EP ECD with a first remote device. The line-shared capability of the preferred embodiment of the present invention also allows the local device to communicate with a second remote device using EP ECD, pure TDD/ATDD, and/or pure ECD during a fourth, fifth, and/or sixth manner of operation, respectively.

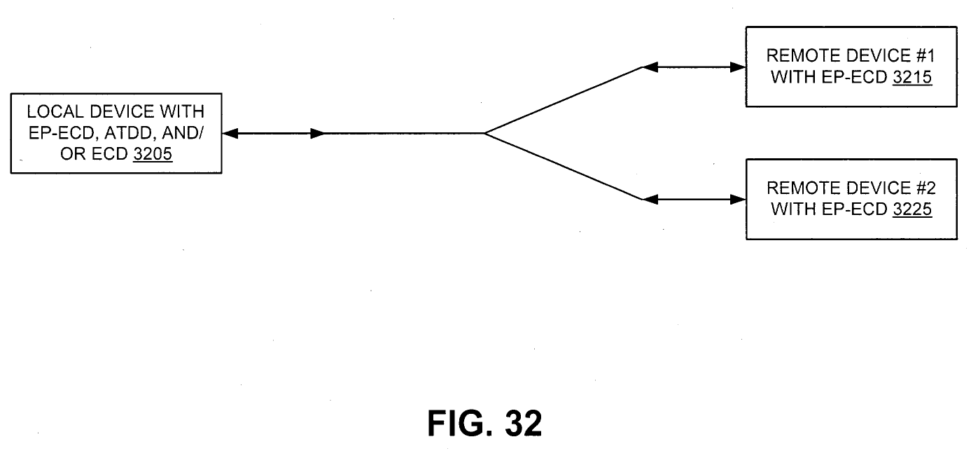

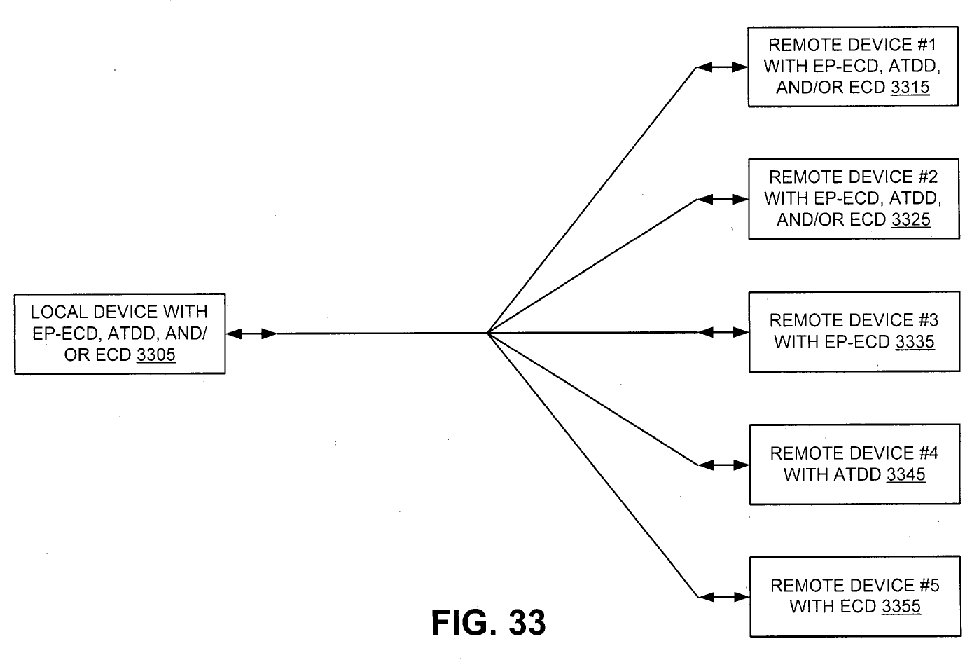

A non-limiting example of multi-point operation of EP ECD is shown in FIG. 32 where local device with EP ECD, ATDD, and/or ECD 3205 shares a communication line with two remote devices. Remote device number 1 in block 3215 supports EP ECD, and remote device number 2 in block 3225 also supports EP ECD. FIG. 33 shows another non-limiting example of multi-point operation of a preferred embodiment of the present invention. In FIG. 33 local device with EP ECD, ATDD, and/or ECD 3305 shares a communication line with five remote devices. The local device 3305 communicates using EP ECD, pure TDD/ATDD, and/or pure ECD with remote device number 1 in block 3315 and with remote device number 2 in block 3325. Also, local device 3305 communicates using EP ECD with remote device number 3 in block 3335. In addition, local device 3305 communicates using ATDD with remote device number 4 in block 3345. Finally, local device 3305 communicates using ECD with remote device number 5 in block 3355.

Nothing in FIG. 33 is intended to imply that a remote device could not communicate with another remote device given a media access control (MAC) algorithm that allows this remote to remote behavior. Thus, remote device number 1 in block 3315 could communicate with remote device number 2 in block 3325 using EP ECD, pure TDD/ATDD, and/or pure ECD, so long as the MAC protocol supports remote-to-remote communication. Also, remote device number 1 in block 3315 could communicate with remote device number 3 in block 3335, with remote device number 4 in block 3345, and remote device number 5 in block 3355 using the proper duplexing technique of EP ECD, pure TDD/ATDD, and/or pure ECD. In addition, remote device number 2 in block 3325 could communicate with remote device number 3 in block 3335, with remote device number 4 in block 3345, and remote device number 5 in block 3355 using the proper duplexing technique of EP ECD, pure TDD/ATDD, and/or pure ECD. Furthermore, remote device number 3 in block 3335 utilizing EP ECD likely has the capability both to communicate with remote device number 4 in block 3345 using pure ATDD and to communicate with remote device number 5 in block 3355 using pure E CD so long as remote device number 3 in block 3335 is properly configured. In general, remote device number 4 in block 3345 using pure ATDD could not communicate with remote device number 5 in block 3355 using pure ECD.

Extended Reach

The preferred embodiments of the present invention are at least partially based upon applying Shannon's information theory ideas to alter the bit rate capacities of the local-to-remote and remote-to-local directions of communication. However, those skilled in the art will be aware that increasing the propagation distance of a signal generally increases the amount of attenuation that a signal experiences. Thus, the attenuation reduces the signal level and decreases the signal-to-noise ratio at the receiver, other things being equal. Those skilled in the art will be aware that instead of using the improvements from the concepts of the preferred embodiment of the present invention to improve bit rates between devices, the concepts of the preferred embodiment of the present invention could be used to extend the range or reach of a communication system. Thus, the preferred embodiment of the present invention could be used to increase the distance between devices while generally maintaining the same bit rates that would be supported on shorter length transmission lines using other technology such as pure ECD or pure TDD/ATDD. Those skilled in the art will be aware of many potential tradeoffs between bit rates and transmission line lengths that can be advantageously improved using the concepts of the present invention. Based on recognizing this potential improvement in communication range and the use of echo cancellation, the preferred embodiment of the present invention essentially allows extended-reach (or range) for a communication system using extended performance (EP) echo-cancelled duplex (ECD).

Seamless Rate Changes

The preferred embodiments of the present invention also can be used with various mechanisms to communicate information about changes in information rates and bits per symbol between the local device and the remote device and between the remote device and the local device. Such mechanisms generally allow for seamless and error-free changes in the communications between a local device and a remote device. As a non-limiting example, the local device could communicate its information rate in the signal it sends to the remote device during each mode. Also, the local device could communicate during one mode the information rate at which it is capable of receiving during another mode. The remote device could communicate similar information on currently transmitted information rates and the information rates at which the remote device is capable of receiving in upcoming modes. With these information rates and information rate capabilities, the local and remote devices can adjust their information rates for efficient performance. Adjusting the information rates could be accomplished by various changes including, but not limited to, changing the number of bits per symbol transmitted in the local-to-remote and/or remote-to-local directions. One skilled in the art will b e aware of many other types of performance information and communication settings that can be dynamically adjusted when the local device and the remote device communicate with each other regarding performance information and capabilities. Also, one skilled in the art will be aware of other mechanisms for communicating performance information between two devices.

Non-Limiting Model of Performance Enhancements

Given the previous description, a simplified model might help to show the benefits of the preferred embodiments of the present invention. Generally, the model involves varying the channel loss and comparing the performance of various duplexing methods. In general, the local device's transmit level is held constant at 0 dB, while the channel loss is increased from 0 dB to 99 dB in steps of 3 dB.

In addition, for the purposes of the model the symbol rates in each direction are assumed to be equal and unchanging in switching between and/or among modes. However, the preferred embodiments of the invention are not to be limited just to communication systems with equal symbol rates in the local-to-remote and remote-to-local directions. One skilled in the art should be aware that the concepts of the preferred embodiments of the present invention apply even though the symbol rates in the two directions may be different and also may change in switching between and/or among modes. Furthermore, as previously mentioned the remote device may, but does not have to, behave similarly to the local device in switching between and/or among modes. Thus, not only may the symbol rates be symmetric and/or asymmetric in the local-to-remote and remote-to-local directions during any particular mode, but also the symbol rates of the local device and/or the remote device may or may not change in switching between and/or among modes. One skilled in the art should be aware that the symbol rate is one non-limiting communication parameter that can be adjusted to efficiently utilize a communications channel, which has certain characteristics such as a particular signal-to-noise ratio during a mode.

Definition of terms in Tables 1-5 and Equations 28-42 for the Model:

Local TX Level=The signal level of transmissions of the local transmitter.

Local TX Bits/Symbol=The number of bits per symbol that can be successfully encoded at the local TX power level and communicated to the remote RX.

Channel Loss=The attenuation of the communications channel. The model assumes that channel loss is the same in both directions, but this is not a limitation on the preferred embodiments of the present invention.

Remote RX Noise Floor Level=The noise floor of the communications channel at the remote without the echo noise.

Remote RX Level=The signal level received at the remote after experiencing channel loss.

Remote TX Bits/Symbol Less Than Local TX Bits/Symbol=Symmetry or asymmetry in the bits/symbol transmitted in the local-to-remote direction minus the bits/symbol transmitted in the remote-to-local direction. In TDD/ATDD there generally are no bits/symbol in one direction when the other direction is transmitting.

Remote TX Bits/Symbol=The number of bits per symbol that can be successfully encoded at the remote TX power level and communicated to the local RX given the channel loss. The symmetry or asymmetry in the bits/symbol may be chosen in the model based on the Remote TX Bits/Symbol Less Than Local TX Bits/Symbol being selected to determine the Remote TX Bits/Symbol.

Remote TX Level=Determined for the model based on the number of Remote Bits/Symbol to be communicated in the remote-to-local direction with 3 dB needed to communicate each additional bit/symbol beyond the first bit/symbol.

Echo Cancellation=The attenuation from an attempt to cancel the transmitted signal and reflections or echoes thereof appearing at the input of the companion receiver.

Remote RX Residual Echo Noise Level=The noise level from the transmitted signal and echoes or reflections thereof that exists even after potentially performing echo cancellation in the remote receiver. The residual echo noise depends on the Remote TX Level and the amount of Echo Cancellation.

Remote RX Combined Noise Level=Additive noise from Remote RX Residual Echo Noise plus Remote RX Noise Floor Level. The noise floor of the communications channel and system is added to the residual echo noise.

Remote RX SNR=The signal-to-noise ratio (as understood from Shannon's Theory) at the remote receiver. Relates the Remote RX level to the Remote RX Combined Noise Level.

Average Bits/Symbol=Average of the local-to-remote and remote-to-local bits/symbol. This is the bi-directional average number of bits per symbol for the forward and reverse directions.

Equations for the Model

SNR_{dB}=10×log₁₀(S/N) (28)

S/N=10^{(SNR}^{_{dB}}^{/10)} (29)

Local TX Level (dB)=0 dB (30)

The Local TX Level is not adjusted in the models of Tables 1-5. The Remote TX Level is adjusted among Tables 2-5. One skilled in the art will be aware that the local and remote devices may or may not exchange behaviors in changing between modes of operation. The local device may or may not behave similarly to the remote device. Thus, the models of Tables 1-5 illustrate one possible behavior of the remote device, and the local device may behave similarly if it basically exchanges behavior with the remote device in changing between modes of operation. This choice for the model is not to imply any limitation on the local device behaving symmetrically to the remote device after a change in the mode of both devices during TDD/ATDD and EP ECD.

If (((Remote RX SNR (dB)=Allowable SNR for 10⁻⁷ Error Rate (dB) to Communicate 1 Bit/Symbol)/(3 dB/Bit/Symbol))+1 Bit/Symbol)>0,

then Local TX Bits/Symbol=

((Remote RX SNR(dB)−Allowable SNR for 10⁻⁷ Error Rate (dB))/(3 dB/Bit/Sym else Local TX Bits/Symbol=0 (bits/symbol). (31)

With no channel loss and a 0 dB Local TX Level communicating 1 bit/symbol as well as with a 0 dB Remote TX Level communicating 1 bit/symbol, the allowable SNR for a 10⁻⁷ error rate is −14.56 dB. Without channel noise, echo cancellation must be 14.56 dB or greater for communicating 1 bit/symbol in both directions. Also, the model assumes that communicating an additional bit per symbol at the 10 error rate requires an additional 3 dB of TX level. The Local TX Bits/Symbol is calibrated according to equation 31 from the SNR, the allowable noise for a 10⁻⁷ error rate communicating 1 bit/symbol, and the 3 dB TX level needed for each additional bit/symbol. Thus, the model is calibrated to the local transmitter and the remote transmitter each transmitting at 0 dB, each needing 14.56 dB to communicate 1 bit/symbol with no channel loss, and each needing an additional 3 dB to communicate each additional bit/symbol with no channel loss.

Channel Loss (dB) Cases 1-34 of Tables 25 vary the channel loss from 0 dB to 99 dB in 3 dB increments to evaluate the model under varying conditions of channel loss.

Remote RX Noise Floor (dB)=Selected as the noise level at the receiver due to other factors besides echo noise and residual echo noise. Chosen to be −90.0 dB for Tables 2-5. This number would be different in different transmission media with different characteristics.

Remote RX Level (dB)=Local TX Level (dB)−Channel Loss (dB) (32)

Remote TX Bits/Symbol Less Than Local TX Bits/Symbol Selected to determine the symmetry and/or asymmetry between the Local TX Bits/Symbol and the Remote TX Bits/Symbol. In pure TDD/ATDD, the Remote TX Bits/Symbol Less Than Local TX Bits/Symbol is selected such that the Remote TX Bits/Symbol is zero. In pure ECD, the Remote TX Bits/Symbol Less Than Local TX Bits/Symbol is set to zero such that symmetry exists in the bits per symbol with the Remote TX Bits/Symbol equaling the Local TX Bits/Symbol.

$$Remote TX level ( dB ) = Base Remote TX Level - \\ ( ( 3 dB \text{/} Each 1 Bit Reduction \\ in Bits \text{/} S ymbol ) \\ X ( Number of Bits \text{/} S ymbol \\ Reduced from the \\ Bits \text{/} S ymbol at the \\ Base Remote TX Level ) \\ = 0 dB - ( 3 dB X ( Remote TX \\ Bits \text{/} S ymbol Less Than Local \\ TX Bits \text{/} S ymbol ) ) \qquad ( 35 )$$

Base Remote TX Level (dB)=0 (34)

$$Remote TX Bits \text{/} S ymbol = Local TX Bits \text{/} S ymbol - \\ Remote TX Bits \text{/} S ymbol \\ Less Than Local TX Bits \text{/} S ymbol \qquad ( 33 )$$

The Base Remote TX Level is 0 dB with the Remote TX Level reduced from 0 dB according to equation 35 that depends on the number of bits/symbol communicated in the remote-to-local direction with each 1 bit per symbol reduction corresponding to a 3 dB drop in Remote TX Level.

Echo Cancellation (dB)=60 dB (36)

Echo Cancellation of 60 dB is chosen for the model although other reasonable values also could be selected. This Echo Cancellation number includes, among other things, attenuation of echo due to any loss in the channel from propagation as well as attenuation due to active signal processing to reduce the echo.

Remote RX Residual Echo Noise Level (dB)=Remote TX Level (dB)−Echo Cancellation (dB) (37)

Subtracting the total echo cancellation caused by the attenuation of the channel on the transmitted signal and its echoes and caused by the performance of any potential echo cancellation logic and/or circuitry yields the residual echo noise.

Remote RX Combined Noise Level=Remote RX Noise Floor Level+Remote RX Residual Noise Level (38)

Noise Addition in dB:

Remote RX Combined Noise Level (dB)=10 log₁₀(10^{(Remote RX Noise Floor Level (dB)/10)}+10^{(Remote RX Residual Noise Level (dB)/10)}) (39)

Signal to Noise Ratio in dB=Signal Level in dB—Noise Level in dB:

Remote RX SNR(dB)=Remote RX Level (dB)−Remote RX Combined Noise Level (dB) (40)

If (Local TX Bits/Symbol−(Remote TX Bits/Symbol Less Than Local TX Bits/Symbol))>0,

then Remote TX Bits/Symbol=

Local TX Bits/Symbol−

(Remote TX Bits/Symbol Less Than Local TX Bits/Symbol), else Remote TX Bits/Symbol=0 (bits/symbol). (41)

Average Bits/Symbol=(Local TX Bits/Symbol+Remote TX Bits/Symbol)/2 (42)

Equation 42 computes a bi-directional average of the forward and reverse bits/symbol.

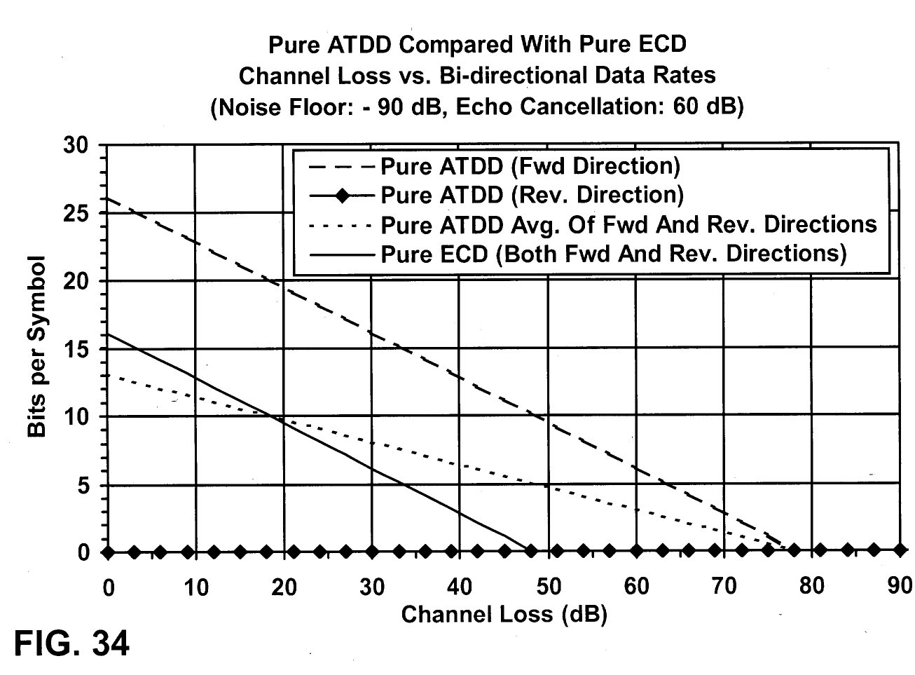

Performance Model in Tables 1-5 and FIGS. 34-39

Table 1 shows some model parameters and calibration values for the model. Tables 2a-2e show the data for the performance model of pure ATDD, while Tables 3a-3e show the data for the performance model of pure ECD. Tables 4a-4e show the data for the performance model of a non-limiting example A of EPECD with ten bits per symbol less in the reverse direction than in the forward direction, while Tables 5a-5e show the data for the performance model of a non-limiting example B of EP ECD with eight bits per symbol less in the reverse direction than in the forward direction.

TABLE 1
Model Parameters and Calibration

| Model Parameters and Calibration | Value |
|---|---|
| Local TX Power (dB) | 0.0 |
| Base Remote TX Power (dB) | 0.0 |
| Channel Loss Step Amount (dB) | 3.0 |
| Allowable Noise (dB) for 10⁻⁷ BER at 1 Bit/ | −14.56 |
| Symbol Local TX and Remote TX with | |
| No Channel Loss and Local TX and | |
| Remote TX both at 0 dB | |
| Reduction in TX Power for a 1 Bit/ | 3.0 |
| Symbol Reduction in Modulation Index (dB) | |

TABLE 2a
Model of Pure ATDD

| Model | | Case No. | | | | | | |
|---|---|---|---|---|---|---|---|---|
| Parameter(s) | Units | 1 | 2 | 3 | 4 | 5 | 6 | 7 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 26.15 | 25.15 | 24.15 | 23.15 | 22.15 | 21.15 | 20.15 |
| Bits/Symbol | | | | | | | | |
| (determined) | | | | | | | | |
| Channel Loss | (dB) | 0.00 | 3.00 | 6.00 | 9.00 | 12.00 | 15.00 | 18.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | 0.00 | −3.00 | −6.00 | −9.00 | −12.00 | −15.00 | −18.00 |
| Level | | | | | | | | |
| Remote TX | (dB) | −90.00 | −90.00 | −90.00 | −90.00 | −90.00 | −90.00 | −90.00 |
| Level | | | | | | | | |
| (determined) | | | | | | | | |
| Remote TX | | 30.00 | 30.00 | 30.00 | 30.00 | 30.00 | 30.00 | 30.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −150.00 | −150.00 | −150.00 | −150.00 | −150.00 | −150.00 | −150.00 |
| Residual | | | | | | | | |
| Echo Noise | | | | | | | | |
| Level | | | | | | | | |
| Remote RX | (dB) | −90.00 | −90.00 | −90.00 | −90.00 | −90.00 | −90.00 | −90.00 |
| Combined | | | | | | | | |
| Noise Level | | | | | | | | |
| Remote RX | (dB) | 90.00 | 87.00 | 84.00 | 81.00 | 78.00 | 75.00 | 72.00 |
| SNR | | | | | | | | |
| Average | | 13.07 | 12.57 | 12.07 | 11.57 | 11.07 | 10.57 | 10.07 |
| Bits/Symbol | | | | | | | | |

TABLE 2b
Model of Pure ATDD

| Model | | Case No. | | | | | | |
|---|---|---|---|---|---|---|---|---|
| Parameter(s) | Units | 8 | 9 | 10 | 11 | 12 | 13 | 14 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 19.15 | 18.15 | 17.15 | 16.15 | 15.15 | 14.15 | 13.15 |
| Bits/Symbol | | | | | | | | |
| (determined) | | | | | | | | |
| Channel Loss | (dB) | 21.00 | 24.00 | 27.00 | 30.00 | 33.00 | 36.00 | 39.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −21.00 | −24.00 | −27.00 | −30.00 | −33.00 | −36.00 | −39.00 |
| Level | | | | | | | | |
| Remote TX | (dB) | −90.00 | −90.00 | −90.00 | −90.00 | −90.00 | −90.00 | −90.00 |
| Level | | | | | | | | |
| (determined) | | | | | | | | |
| Remote TX | | 30.00 | 30.00 | 30.00 | 30.00 | 30.00 | 30.00 | 30.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −150.00 | −150.00 | −150.00 | −150.00 | −150.00 | −150.00 | −150.00 |
| Residual | | | | | | | | |
| Echo Noise | | | | | | | | |
| Level | | | | | | | | |
| Remote RX | (dB) | −90.00 | −90.00 | −90.00 | −90.00 | −90.00 | −90.00 | −90.00 |
| Combined | | | | | | | | |
| Noise Level | | | | | | | | |
| Remote RX | (dB) | 69.00 | 66.00 | 63.00 | 60.00 | 57.00 | 54.00 | 51.00 |
| SNR | | | | | | | | |
| Average | | 9.57 | 9.07 | 8.57 | 8.07 | 7.57 | 7.07 | 6.57 |
| Bits/Symbol | | | | | | | | |

TABLE 2c
Model of Pure ATDD

| Model | | Case No. | | | | | | |
|---|---|---|---|---|---|---|---|---|
| Parameter(s) | Units | 15 | 16 | 17 | 18 | 19 | 20 | 21 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 12.15 | 11.15 | 10.15 | 9.15 | 8.15 | 7.15 | 6.15 |
| Bits/Symbol | | | | | | | | |
| (determined) | | | | | | | | |
| Channel Loss | (dB) | 42.00 | 45.00 | 48.00 | 51.00 | 54.00 | 57.00 | 60.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −42.00 | −45.00 | −48.00 | −51.00 | −54.00 | −57.00 | −60.00 |
| Level | | | | | | | | |
| Remote TX | (dB) | −90.00 | −90.00 | −90.00 | −90.00 | −90.00 | −90.00 | −90.00 |
| Level | | | | | | | | |
| (determined) | | | | | | | | |
| Remote TX | | 30.00 | 30.00 | 30.00 | 30.00 | 30.00 | 30.00 | 30.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −150.00 | −150.00 | −150.00 | −150.00 | −150.00 | −150.00 | −150.00 |
| Residual | | | | | | | | |
| Echo Noise | | | | | | | | |
| Level | | | | | | | | |
| Remote RX | (dB) | −90.00 | −90.00 | −90.00 | −90.00 | −90.00 | −90.00 | −90.00 |
| Combined | | | | | | | | |
| Noise Level | | | | | | | | |
| Remote RX | (dB) | 48.00 | 45.00 | 42.00 | 39.00 | 36.00 | 33.00 | 30.00 |
| SNR | | | | | | | | |
| Average | | 6.07 | 5.57 | 5.07 | 4.57 | 4.07 | 3.57 | 3.07 |
| Bits/Symbol | | | | | | | | |

TABLE 2d
Model of Pure ATDD

| Model | | Case No. | | | | | | |
|---|---|---|---|---|---|---|---|---|
| Parameter(s) | Units | 22 | 23 | 24 | 25 | 26 | 27 | 28 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 5.15 | 4.15 | 3.15 | 2.15 | 1.15 | 0.00 | 0.00 |
| Bits/Symbol | | | | | | | | |
| (determined) | | | | | | | | |
| Channel Loss | (dB) | 63.00 | 66.00 | 69.00 | 72.00 | 75.00 | 78.00 | 81.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −63.00 | −66.00 | −69.00 | −72.00 | −75.00 | −78.00 | −81.00 |
| Level | | | | | | | | |
| Remote TX | (dB) | −90.00 | −90.00 | −90.00 | −90.00 | −90.00 | −90.00 | −90.00 |
| Level | | | | | | | | |
| (determined) | | | | | | | | |
| Remote TX | | 30.00 | 30.00 | 30.00 | 30.00 | 30.00 | 30.00 | 30.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −150.00 | −150.00 | −150.00 | −150.00 | −150.00 | −150.00 | −150.00 |
| Residual | | | | | | | | |
| Echo Noise | | | | | | | | |
| Level | | | | | | | | |
| Remote RX | (dB) | −90.00 | −90.00 | −90.00 | −90.00 | −90.00 | −90.00 | −90.00 |
| Combined | | | | | | | | |
| Noise Level | | | | | | | | |
| Remote RX | (dB) | 27.00 | 24.00 | 21.00 | 18.00 | 15.00 | 12.00 | 9.00 |
| SNR | | | | | | | | |
| Average | | 2.57 | 2.07 | 1.57 | 1.07 | 0.57 | 0.00 | 0.00 |
| Bits/Symbol | | | | | | | | |

TABLE 2e
Model of Pure ATDD

| Model | | Case No. | | | | | |
|---|---|---|---|---|---|---|---|
| Parameter(s) | Units | 29 | 30 | 31 | 32 | 33 | 34 |
| Local TX | (dB) | 0.00 | 0.00 | 0.00 | 0.00 | 0.00 | 0.00 |
| Level | | | | | | | |
| (fixed) | | | | | | | |
| Local TX | | 0.00 | 0.00 | 0.00 | 0.00 | 0.00 | 0.00 |
| Bits/Symbol | | | | | | | |
| (determined) | | | | | | | |
| Channel Loss | (dB) | 84.00 | 87.00 | 90.00 | 93.00 | 96.00 | 99.00 |
| (variable) | | | | | | | |
| Remote RX | (dB) | −90.00 | −90.00 | −90.00 | −90.00 | −90.00 | −90.00 |
| Noise Floor | | | | | | | |
| Level | | | | | | | |
| (selected) | | | | | | | |
| Remote RX | (dB) | −84.00 | −87.00 | −90.00 | −93.00 | −96.00 | −99.00 |
| Level | | | | | | | |
| Remote TX | (dB) | −90.00 | −90.00 | −90.00 | −90.00 | −90.00 | −90.00 |
| Level | | | | | | | |
| (determined) | | | | | | | |
| Remote TX | | 30.00 | 30.00 | 30.00 | 30.00 | 30.00 | 30.00 |
| Bits/Symbol | | | | | | | |
| Less than | | | | | | | |
| Local TX | | | | | | | |
| Bits/Symbol | | | | | | | |
| (selected) | | | | | | | |
| Remote TX | | 0.00 | 0.00 | 0.00 | 0.00 | 0.00 | 0.00 |
| Bits/Symbol | | | | | | | |
| (net) | | | | | | | |
| Echo- | (dB) | 60.00 | 60.00 | 60.00 | 60.00 | 60.00 | 60.00 |
| Cancellation | | | | | | | |
| (selected) | | | | | | | |
| Remote RX | (dB) | −150.00 | −150.00 | −150.00 | −150.00 | −150.00 | −150.00 |
| Residual | | | | | | | |
| Echo Noise | | | | | | | |
| Level | | | | | | | |
| Remote RX | (dB) | −90.00 | −90.00 | −90.00 | −90.00 | −90.00 | −90.00 |
| Combined | | | | | | | |
| Noise Level | | | | | | | |
| Remote RX | (dB) | 6.00 | 3.00 | 0.00 | −3.00 | −6.00 | −9.00 |
| SNR | | | | | | | |
| Average | | 0.00 | 0.00 | 0.00 | 0.00 | 0.00 | 0.00 |
| Bits/Symbol | | | | | | | |

TABLE 3a
Model of Pure ECD

| Model | | Case No. | | | | | | |
|---|---|---|---|---|---|---|---|---|
| Parameter(s) | Units | 1 | 2 | 3 | 4 | 5 | 6 | 7 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 16.15 | 15.15 | 14.15 | 13.15 | 12.15 | 11.15 | 10.15 |
| Bits/Symbol | | | | | | | | |
| (determined) | | | | | | | | |
| Channel Loss | (dB) | 0.00 | 3.00 | 6.00 | 9.00 | 12.00 | 15.00 | 18.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | 0.00 | −3.00 | −6.00 | −9.00 | −12.00 | −15.00 | −18.00 |
| Level | | | | | | | | |
| Remote TX | (dB) | 0.00 | 0.00 | 0.00 | 0.00 | 0.00 | 0.00 | 0.00 |
| Level | | | | | | | | |
| (determined) | | | | | | | | |
| Remote TX | | 0.00 | 0.00 | 0.00 | 0.00 | 0.00 | 0.00 | 0.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 16.15 | 15.15 | 14.15 | 13.15 | 12.15 | 11.15 | 10.15 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −60.00 | −60.00 | −60.00 | −60.00 | −60.00 | −60.00 | −60.00 |
| Residual | | | | | | | | |
| Echo Noise | | | | | | | | |
| Level | | | | | | | | |
| Remote RX | (dB) | −60.00 | −60.00 | −60.00 | −60.00 | −60.00 | −60.00 | −60.00 |
| Combined | | | | | | | | |
| Noise Level | | | | | | | | |
| Remote RX | (dB) | 60.00 | 57.00 | 54.00 | 51.00 | 48.00 | 45.00 | 42.00 |
| SNR | | | | | | | | |
| Average | | 16.15 | 15.15 | 14.15 | 13.15 | 12.15 | 11.15 | 10.15 |
| Bits/Symbol | | | | | | | | |

TABLE 3b
Model of Pure ECD

| Model | | Case No. | | | | | | |
|---|---|---|---|---|---|---|---|---|
| Parameter(s) | Units | 8 | 9 | 10 | 11 | 12 | 13 | 14 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 9.15 | 8.15 | 7.15 | 6.15 | 5.15 | 4.15 | 3.15 |
| Bits/Symbol | | | | | | | | |
| (determined) | | | | | | | | |
| Channel Loss | (dB) | 21.00 | 24.00 | 27.00 | 30.00 | 33.00 | 36.00 | 39.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −21.00 | −24.00 | −27.00 | −30.00 | −33.00 | −36.00 | −39.00 |
| Level | | | | | | | | |
| Remote TX | (dB) | 0.00 | 0.00 | 0.00 | 0.00 | 0.00 | 0.00 | 0.00 |
| Level | | | | | | | | |
| (determined) | | | | | | | | |
| Remote TX | | 0.00 | 0.00 | 0.00 | 0.00 | 0.00 | 0.00 | 0.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 9.15 | 8.15 | 7.15 | 6.15 | 5.15 | 4.15 | 3.15 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −60.00 | −60.00 | −60.00 | −60.00 | −60.00 | −60.00 | −60.00 |
| Residual | | | | | | | | |
| Echo Noise | | | | | | | | |
| Level | | | | | | | | |
| Remote RX | (dB) | −60.00 | −60.00 | −60.00 | −60.00 | −60.00 | −60.00 | −60.00 |
| Combined | | | | | | | | |
| Noise Level | | | | | | | | |
| Remote RX | (dB) | 39.00 | 36.00 | 33.00 | 30.00 | 27.00 | 24.00 | 21.00 |
| SNR | | | | | | | | |
| Average | | 9.15 | 8.15 | 7.15 | 6.15 | 5.15 | 4.15 | 3.15 |
| Bits/Symbol | | | | | | | | |

TABLE 3c
Model of Pure ECD

| Model | | Case No. | | | | | | |
|---|---|---|---|---|---|---|---|---|
| Parameter(s) | Units | 15 | 16 | 17 | 18 | 19 | 20 | 21 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 2.15 | 1.15 | 0.00 | 0.00 | 0.00 | 0.00 | 0.00 |
| Bits/Symbol | | | | | | | | |
| (determined) | | | | | | | | |
| Channel Loss | (dB) | 42.00 | 45.00 | 48.00 | 51.00 | 54.00 | 57.00 | 60.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −42.00 | −45.00 | −48.00 | −51.00 | −54.00 | −57.00 | −60.00 |
| Level | | | | | | | | |
| Remote TX | (dB) | 0.00 | 0.00 | 0.00 | 0.00 | 0.00 | 0.00 | 0.00 |
| Level | | | | | | | | |
| (determined) | | | | | | | | |
| Remote TX | | 0.00 | 0.00 | 0.00 | 0.00 | 0.00 | 0.00 | 0.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 2.15 | 1.15 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −60.00 | −60.00 | −60.00 | −60.00 | −60.00 | −60.00 | −60.00 |
| Residual | | | | | | | | |
| Echo Noise | | | | | | | | |
| Level | | | | | | | | |
| Remote RX | (dB) | −60.00 | −60.00 | −60.00 | −60.00 | −60.00 | −60.00 | −60.00 |
| Combined | | | | | | | | |
| Noise Level | | | | | | | | |
| Remote RX | (dB) | 18.00 | 15.00 | 12.00 | 9.00 | 6.00 | 3.00 | 0.00 |
| SNR | | | | | | | | |
| Average | | 2.15 | 1.15 | 0.00 | 0.00 | 0.00 | 0.00 | 0.00 |
| Bits/Symbol | | | | | | | | |

TABLE 3d
Model of Pure ECD

| Model | | Case No. | | | | | | |
|---|---|---|---|---|---|---|---|---|
| Parameter(s) | Units | 22 | 23 | 24 | 25 | 26 | 27 | 28 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 0.00 | 0.00 | 0.00 | 0.00 | 0.00 | 0.00 | 0.00 |
| Bits/Symbol | | | | | | | | |
| (determined) | | | | | | | | |
| Channel Loss | (dB) | 63.00 | 66.00 | 69.00 | 72.00 | 75.00 | 78.00 | 81.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −63.00 | −66.00 | −69.00 | −72.00 | −75.00 | −78.00 | −81.00 |
| Level | | | | | | | | |
| Remote TX | (dB) | 0.00 | 0.00 | 0.00 | 0.00 | 0.00 | 0.00 | 0.00 |
| Level | | | | | | | | |
| (determined) | | | | | | | | |
| Remote TX | | 0.00 | 0.00 | 0.00 | 0.00 | 0.00 | 0.00 | 0.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −60.00 | −60.00 | −60.00 | −60.00 | −60.00 | −60.00 | −60.00 |
| Residual | | | | | | | | |
| Echo Noise | | | | | | | | |
| Level | | | | | | | | |
| Remote RX | (dB) | −60.00 | −60.00 | −60.00 | −60.00 | −60.00 | −60.00 | −60.00 |
| Combined | | | | | | | | |
| Noise Level | | | | | | | | |
| Remote RX | (dB) | −3.00 | −6.00 | −9.00 | −12.00 | −15.00 | −18.00 | −21.00 |
| SNR | | | | | | | | |
| Average | | 0.00 | 0.00 | 0.00 | 0.00 | 0.00 | 0.00 | 0.00 |
| Bits/Symbol | | | | | | | | |

TABLE 3e
Model of Pure ECD

| Model | | Case No. | | | | | |
|---|---|---|---|---|---|---|---|
| Parameter(s) | Units | 29 | 30 | 31 | 32 | 33 | 34 |
| Local TX | (dB) | 0.00 | 0.00 | 0.00 | 0.00 | 0.00 | 0.00 |
| Level | | | | | | | |
| (fixed) | | | | | | | |
| Local TX | | 0.00 | 0.00 | 0.00 | 0.00 | 0.00 | 0.00 |
| Bits/Symbol | | | | | | | |
| (determined) | | | | | | | |
| Channel Loss | (dB) | 84.00 | 87.00 | 90.00 | 93.00 | 96.00 | 99.00 |
| (variable) | | | | | | | |
| Remote RX | (dB) | −90.00 | −90.00 | −90.00 | −90.00 | −90.00 | −90.00 |
| Noise Floor | | | | | | | |
| Level | | | | | | | |
| (selected) | | | | | | | |
| Remote RX | (dB) | −84.00 | −87.00 | −90.00 | −93.00 | −96.00 | −99.00 |
| Level | | | | | | | |
| Remote TX | (dB) | 0.00 | 0.00 | 0.00 | 0.00 | 0.00 | 0.00 |
| Level | | | | | | | |
| (determined) | | | | | | | |
| Remote TX | | 0.00 | 0.00 | 0.00 | 0.00 | 0.00 | 0.00 |
| Bits/Symbol | | | | | | | |
| Less than | | | | | | | |
| Local TX | | | | | | | |
| Bits/Symbol | | | | | | | |
| (selected) | | | | | | | |
| Remote TX | | 0.00 | 0.00 | 0.00 | 0.00 | 0.00 | 0.00 |
| Bits/Symbol | | | | | | | |
| (net) | | | | | | | |
| Echo- | (dB) | 60.00 | 60.00 | 60.00 | 60.00 | 60.00 | 60.00 |
| Cancellation | | | | | | | |
| (selected) | | | | | | | |
| Remote RX | (dB) | −60.00 | −60.00 | −60.00 | −60.00 | −60.00 | −60.00 |
| Residual | | | | | | | |
| Echo Noise | | | | | | | |
| Level | | | | | | | |
| Remote RX | (dB) | −60.00 | −60.00 | −60.00 | −60.00 | −60.00 | −60.00 |
| Combined | | | | | | | |
| Noise Level | | | | | | | |
| Remote RX | (dB) | −24.00 | −27.00 | −30.00 | −33.00 | −36.00 | −39.00 |
| SNR | | | | | | | |
| Average | | 0.00 | 0.00 | 0.00 | 0.00 | 0.00 | 0.00 |
| Bits/Symbol | | | | | | | |

TABLE 4a
Model of EP ECD Ex. A With 10 Bits/Symbol Less in Rev. Dir.

| Model | | Case No. | | | | | | |
|---|---|---|---|---|---|---|---|---|
| Parameter(s) | Units | 1 | 2 | 3 | 4 | 5 | 6 | 7 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 25.14 | 24.14 | 23.14 | 22.14 | 21.14 | 20.14 | 19.14 |
| Bits/Symbol | | | | | | | | |
| (determined) | | | | | | | | |
| Channel Loss | (dB) | 0.00 | 3.00 | 6.00 | 9.00 | 12.00 | 15.00 | 18.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | 0.00 | −3.00 | −6.00 | −9.00 | −12.00 | −15.00 | −18.00 |
| Level | | | | | | | | |
| Remote TX | (dB) | −30.00 | −30.00 | −30.00 | −30.00 | −30.00 | −30.00 | −30.00 |
| Level | | | | | | | | |
| (determined) | | | | | | | | |
| Remote TX | | 10.00 | 10.00 | 10.00 | 10.00 | 10.00 | 10.00 | 10.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 15.14 | 14.14 | 13.14 | 12.14 | 11.14 | 10.14 | 9.14 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −90.00 | −90.00 | −90.00 | −90.00 | −90.00 | −90.00 | −90.00 |
| Residual | | | | | | | | |
| Echo Noise | | | | | | | | |
| Level | | | | | | | | |
| Remote RX | (dB) | −86.99 | −86.99 | −86.99 | −86.99 | −86.99 | −86.99 | −86.99 |
| Combined | | | | | | | | |
| Noise Level | | | | | | | | |
| Remote RX | (dB) | 86.99 | 83.99 | 80.99 | 77.99 | 74.99 | 71.99 | 68.99 |
| SNR | | | | | | | | |
| Average | | 20.14 | 19.14 | 18.14 | 17.14 | 16.14 | 15.14 | 14.14 |
| Bits/Symbol | | | | | | | | |

TABLE 4b
Model of EP ECD Ex. A With 10 Bits/Symbol Less in Rev. Dir.

| Model | | Case No. | | | | | | |
|---|---|---|---|---|---|---|---|---|
| Parameter(s) | Units | 8 | 9 | 10 | 11 | 12 | 13 | 14 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 18.14 | 17.14 | 16.14 | 15.14 | 14.14 | 13.14 | 12.14 |
| Bits/Symbol | | | | | | | | |
| (determined) | | | | | | | | |
| Channel Loss | (dB) | 21.00 | 24.00 | 27.00 | 30.00 | 33.00 | 36.00 | 39.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −21.00 | −24.00 | −27.00 | −30.00 | −33.00 | −36.00 | −39.00 |
| Level | | | | | | | | |
| Remote TX | (dB) | −30.00 | −30.00 | −30.00 | −30.00 | −30.00 | −30.00 | −30.00 |
| Level | | | | | | | | |
| (determined) | | | | | | | | |
| Remote TX | | 10.00 | 10.00 | 10.00 | 10.00 | 10.00 | 10.00 | 10.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 8.14 | 7.14 | 6.14 | 5.14 | 4.14 | 3.14 | 2.14 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −90.00 | −90.00 | −90.00 | −90.00 | −90.00 | −90.00 | −90.00 |
| Residual | | | | | | | | |
| Echo Noise | | | | | | | | |
| Level | | | | | | | | |
| Remote RX | (dB) | −86.99 | −86.99 | −86.99 | −86.99 | −86.99 | −86.99 | −86.99 |
| Combined | | | | | | | | |
| Noise Level | | | | | | | | |
| Remote RX | (dB) | 65.99 | 62.99 | 59.99 | 56.99 | 53.99 | 50.99 | 47.99 |
| SNR | | | | | | | | |
| Average | | 13.14 | 12.14 | 11.14 | 10.14 | 9.14 | 8.14 | 7.14 |
| Bits/Symbol | | | | | | | | |

TABLE 4c
Model of EP ECD Ex. A With 10 Bits/Symbol Less in Rev. Dir.

| Model | | Case No. | | | | | | |
|---|---|---|---|---|---|---|---|---|
| Parameter(s) | Units | 15 | 16 | 17 | 18 | 19 | 20 | 21 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 11.14 | 10.14 | 9.14 | 8.14 | 7.14 | 6.14 | 5.14 |
| Bits/Symbol | | | | | | | | |
| (determined) | | | | | | | | |
| Channel Loss | (dB) | 42.00 | 45.00 | 48.00 | 51.00 | 54.00 | 57.00 | 60.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −42.00 | −45.00 | −48.00 | −51.00 | −54.00 | −57.00 | −60.00 |
| Level | | | | | | | | |
| Remote TX | (dB) | −30.00 | −30.00 | −30.00 | −30.00 | −30.00 | −30.00 | −30.00 |
| Level | | | | | | | | |
| (determined) | | | | | | | | |
| Remote TX | | 10.00 | 10.00 | 10.00 | 10.00 | 10.00 | 10.00 | 10.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 1.14 | 0.14 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −90.00 | −90.00 | −90.00 | −90.00 | −90.00 | −90.00 | −90.00 |
| Residual | | | | | | | | |
| Echo Noise | | | | | | | | |
| Level | | | | | | | | |
| Remote RX | (dB) | −86.99 | −86.99 | −86.99 | −86.99 | −86.99 | −86.99 | −86.99 |
| Combined | | | | | | | | |
| Noise Level | | | | | | | | |
| Remote RX | (dB) | 44.99 | 41.99 | 38.99 | 35.99 | 32.99 | 29.99 | 26.99 |
| SNR | | | | | | | | |
| Average | | 6.14 | 5.14 | 4.57 | 4.07 | 3.57 | 3.07 | 2.57 |
| Bits/Symbol | | | | | | | | |

TABLE 4d
Model of EP ECD Ex. A With 10 Bits/Symbol Less in Rev. Dir.

| Model | | Case No. | | | | | | |
|---|---|---|---|---|---|---|---|---|
| Parameter(s) | Units | 22 | 23 | 24 | 25 | 26 | 27 | 28 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 4.14 | 3.14 | 2.14 | 1.14 | 0.00 | 0.00 | 0.00 |
| Bits/Symbol | | | | | | | | |
| (determined) | | | | | | | | |
| Channel Loss | (dB) | 63.00 | 66.00 | 69.00 | 72.00 | 75.00 | 78.00 | 81.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −63.00 | −66.00 | −69.00 | −72.00 | −75.00 | −78.00 | −81.00 |
| Level | | | | | | | | |
| Remote TX | (dB) | −30.00 | −30.00 | −30.00 | −30.00 | −30.00 | −30.00 | −30.00 |
| Level | | | | | | | | |
| (determined) | | | | | | | | |
| Remote TX | | 10.00 | 10.00 | 10.00 | 10.00 | 10.00 | 10.00 | 10.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −90.00 | −90.00 | −90.00 | −90.00 | −90.00 | −90.00 | −90.00 |
| Residual | | | | | | | | |
| Echo Noise | | | | | | | | |
| Level | | | | | | | | |
| Remote RX | (dB) | −86.99 | −86.99 | −86.99 | −86.99 | −86.99 | −86.99 | −86.99 |
| Combined | | | | | | | | |
| Noise Level | | | | | | | | |
| Remote RX | (dB) | 23.99 | 20.99 | 17.99 | 14.99 | 11.99 | 8.99 | 5.99 |
| SNR | | | | | | | | |
| Average | | 2.07 | 1.57 | 1.07 | 0.57 | 0.00 | 0.00 | 0.00 |
| Bits/Symbol | | | | | | | | |

TABLE 4e
Model of EP ECD Ex. A With 10 Bits/Symbol Less in Rev. Dir.

| Model | | Case No. | | | | | |
|---|---|---|---|---|---|---|---|
| Parameter(s) | Units | 29 | 30 | 31 | 32 | 33 | 34 |
| Local TX Level | (dB) | 0.00 | 0.00 | 0.00 | 0.00 | 0.00 | 0.00 |
| (fixed) | | | | | | | |
| Local TX Bits/ | | 0.00 | 0.00 | 0.00 | 0.00 | 0.00 | 0.00 |
| Symbol (determined) | | | | | | | |
| Channel Loss | (dB) | 84.00 | 87.00 | 90.00 | 93.00 | 96.00 | 99.00 |
| (variable) | | | | | | | |
| Remote RX | (dB) | −90.00 | −90.00 | −90.00 | −90.00 | −90.00 | −90.00 |
| Noise Floor Level | | | | | | | |
| (selected) | | | | | | | |
| Remote RX Level | (dB) | −84.00 | −87.00 | −90.00 | −93.00 | −96.00 | −99.00 |
| Remote TX Level | (dB) | −30.00 | −30.00 | −30.00 | −30.00 | −30.00 | −30.00 |
| (determined) | | | | | | | |
| Remote TX | | 10.00 | 10.00 | 10.00 | 10.00 | 10.00 | 10.00 |
| Bits/Symbol | | | | | | | |
| Less than Local | | | | | | | |
| TX Bits/Symbol | | | | | | | |
| (selected) | | | | | | | |
| Remote TX | | 0.00 | 0.00 | 0.00 | 0.00 | 0.00 | 0.00 |
| Bits/Symbol (net) | | | | | | | |
| Echo-Cancellation | (dB) | 60.00 | 60.00 | 60.00 | 60.00 | 60.00 | 60.00 |
| (selected) | | | | | | | |
| Remote RX | (dB) | −90.00 | −90.00 | −90.00 | −90.00 | −90.00 | −90.00 |
| Residual Echo | | | | | | | |
| Noise Level | | | | | | | |
| Remote RX | (dB) | −86.99 | −86.99 | −86.99 | −86.99 | −86.99 | −86.99 |
| Combined Noise | | | | | | | |
| Level | | | | | | | |
| Remote RX SNR | (dB) | 2.99 | −0.01 | −3.01 | −6.01 | −9.01 | −12.01 |
| Average | | 0.00 | 0.00 | 0.00 | 0.00 | 0.00 | 0.00 |
| Bits/Symbol | | | | | | | |

TABLE 5a
Model of EP ECD Ex. B With 8 Bits/Symbol Less in Rev. Dir.

| Model | | Case No. | | | | | | |
|---|---|---|---|---|---|---|---|---|
| Parameter(s) | Units | 1 | 2 | 3 | 4 | 5 | 6 | 7 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 23.82 | 22.82 | 21.82 | 20.82 | 19.82 | 18.82 | 17.82 |
| Bits/Symbol | | | | | | | | |
| (determined) | | | | | | | | |
| Channel Loss | (dB) | 0.00 | 3.00 | 6.00 | 9.00 | 12.00 | 15.00 | 18.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | 0.00 | −3.00 | −6.00 | −9.00 | −12.00 | −15.00 | −18.00 |
| Level | | | | | | | | |
| Remote TX | (dB) | −24.00 | −24.00 | −24.00 | −24.00 | −24.00 | −24.00 | −24.00 |
| Level | | | | | | | | |
| (determined) | | | | | | | | |
| Remote TX | | 8.00 | 8.00 | 8.00 | 8.00 | 8.00 | 8.00 | 8.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 15.82 | 14.82 | 13.82 | 12.82 | 11.82 | 10.82 | 9.82 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −84.00 | −84.00 | −84.00 | −84.00 | −84.00 | −84.00 | −84.00 |
| Residual | | | | | | | | |
| Echo Noise | | | | | | | | |
| Level | | | | | | | | |
| Remote RX | (dB) | −83.03 | −83.03 | −83.03 | −83.03 | −83.03 | −83.03 | −83.03 |
| Combined | | | | | | | | |
| Noise Level | | | | | | | | |
| Remote RX | (dB) | 83.03 | 80.03 | 77.03 | 74.03 | 71.03 | 68.03 | 65.03 |
| SNR | | | | | | | | |
| Average | | 19.82 | 18.82 | 17.82 | 16.82 | 15.82 | 14.82 | 13.82 |
| Bits/Symbol | | | | | | | | |

TABLE 5b
Model of EP ECD Ex. B With 8 Bits/Symbol Less in Rev. Dir.

| Model | | Case No. | | | | | | |
|---|---|---|---|---|---|---|---|---|
| Parameter(s) | Units | 8 | 9 | 10 | 11 | 12 | 13 | 14 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 16.82 | 15.82 | 14.82 | 13.82 | 12.82 | 11.82 | 10.82 |
| Bits/Symbol | | | | | | | | |
| (determined) | | | | | | | | |
| Channel Loss | (dB) | 21.00 | 24.00 | 27.00 | 30.00 | 33.00 | 36.00 | 39.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −21.00 | −24.00 | −27.00 | −30.00 | −33.00 | −36.00 | −39.00 |
| Level | | | | | | | | |
| Remote TX | (dB) | −24.00 | −24.00 | −24.00 | −24.00 | −24.00 | −24.00 | −24.00 |
| Level | | | | | | | | |
| (determined) | | | | | | | | |
| Remote TX | | 8.00 | 8.00 | 8.00 | 8.00 | 8.00 | 8.00 | 8.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 8.82 | 7.82 | 6.82 | 5.82 | 4.82 | 3.82 | 2.82 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −84.00 | −84.00 | −84.00 | −84.00 | −84.00 | −84.00 | −84.00 |
| Residual | | | | | | | | |
| Echo Noise | | | | | | | | |
| Level | | | | | | | | |
| Remote RX | (dB) | −83.03 | −83.03 | −83.03 | −83.03 | −83.03 | −83.03 | −83.03 |
| Combined | | | | | | | | |
| Noise Level | | | | | | | | |
| Remote RX | (dB) | 62.03 | 59.03 | 56.03 | 53.03 | 50.03 | 47.03 | 44.03 |
| SNR | | | | | | | | |
| Average | | 12.82 | 11.82 | 10.82 | 9.82 | 8.82 | 7.82 | 6.82 |
| Bits/Symbol | | | | | | | | |

TABLE 5c
Model of EP ECD Ex. B With 8 Bits/Symbol Less in Rev. Dir.

| Model | | Case No. | | | | | | |
|---|---|---|---|---|---|---|---|---|
| Parameter(s) | Units | 15 | 16 | 17 | 18 | 19 | 20 | 21 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 9.82 | 8.82 | 7.82 | 6.82 | 5.82 | 4.82 | 3.82 |
| Bits/Symbol | | | | | | | | |
| (determined) | | | | | | | | |
| Channel Loss | (dB) | 42.00 | 45.00 | 48.00 | 51.00 | 54.00 | 57.00 | 60.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −42.00 | −45.00 | −48.00 | −51.00 | −54.00 | −57.00 | −60.00 |
| Level | | | | | | | | |
| Remote TX | (dB) | −24.00 | −24.00 | −24.00 | −24.00 | −24.00 | −24.00 | −24.00 |
| Level | | | | | | | | |
| (determined) | | | | | | | | |
| Remote TX | | 8.00 | 8.00 | 8.00 | 8.00 | 8.00 | 8.00 | 8.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 1.82 | 0.82 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −84.00 | −84.00 | −84.00 | −84.00 | −84.00 | −84.00 | −84.00 |
| Residual | | | | | | | | |
| Echo Noise | | | | | | | | |
| Level | | | | | | | | |
| Remote RX | (dB) | −83.03 | −83.03 | −83.03 | −83.03 | −83.03 | −83.03 | −83.03 |
| Combined | | | | | | | | |
| Noise Level | | | | | | | | |
| Remote RX | (dB) | 41.03 | 38.03 | 35.03 | 32.03 | 29.03 | 26.03 | 23.03 |
| SNR | | | | | | | | |
| Average | | 5.82 | 4.82 | 3.91 | 3.41 | 2.91 | 2.41 | 1.91 |
| Bits/Symbol | | | | | | | | |

TABLE 5d
Model of EP ECD Ex. B With 8 Bits/Symbol Less in Rev. Dir.

| Model | | Case No. | | | | | | |
|---|---|---|---|---|---|---|---|---|
| Parameter(s) | Units | 22 | 23 | 24 | 25 | 26 | 27 | 28 |
| Local TX | (dB) | 0.00 | 0.00 | 0.00 | 0.00 | 0.00 | 0.00 | 0.00 |
| Level | | | | | | | | |
| (fixed) | | | | | | | | |
| Local TX | | 2.82 | 1.82 | 0.00 | 0.00 | 0.00 | 0.00 | 0.00 |
| Bits/Symbol | | | | | | | | |
| (determined) | | | | | | | | |
| Channel Loss | (dB) | 63.00 | 66.00 | 69.00 | 72.00 | 75.00 | 78.00 | 81.00 |
| (variable) | | | | | | | | |
| Remote RX | (dB) | −90.00 | −90.00 | −90.00 | −90.00 | −90.00 | −90.00 | −90.00 |
| Noise Floor | | | | | | | | |
| Level | | | | | | | | |
| (selected) | | | | | | | | |
| Remote RX | (dB) | −63.00 | −66.00 | −69.00 | −72.00 | −75.00 | −78.00 | −81.00 |
| Level | | | | | | | | |
| Remote TX | (dB) | −24.00 | −24.00 | −24.00 | −24.00 | −24.00 | −24.00 | −24.00 |
| Level | | | | | | | | |
| (determined) | | | | | | | | |
| Remote TX | | 8.00 | 8.00 | 8.00 | 8.00 | 8.00 | 8.00 | 8.00 |
| Bits/Symbol | | | | | | | | |
| Less than | | | | | | | | |
| Local TX | | | | | | | | |
| Bits/Symbol | | | | | | | | |
| (selected) | | | | | | | | |
| Remote TX | | 0.00 | 0.00 | 0.00 | 0.00 | 0.00 | 0.00 | 0.00 |
| Bits/Symbol | | | | | | | | |
| (net) | | | | | | | | |
| Echo- | (dB) | 60.00 | 60.00 | 60.00 | 60.00 | 60.00 | 60.00 | 60.00 |
| Cancellation | | | | | | | | |
| (selected) | | | | | | | | |
| Remote RX | (dB) | −84.00 | −84.00 | −84.00 | −84.00 | −84.00 | −84.00 | −84.00 |
| Residual | | | | | | | | |
| Echo Noise | | | | | | | | |
| Level | | | | | | | | |
| Remote RX | (dB) | −83.03 | −83.03 | −83.03 | −83.03 | −83.03 | −83.03 | −83.03 |
| Combined | | | | | | | | |
| Noise Level | | | | | | | | |
| Remote RX | (dB) | 20.03 | 17.03 | 14.03 | 11.03 | 8.03 | 5.03 | 2.03 |
| SNR | | | | | | | | |
| Average | | 1.41 | 0.91 | 0.00 | 0.00 | 0.00 | 0.00 | 0.00 |
| Bits/Symbol | | | | | | | | |

TABLE 5e
Model of EP ECD Ex. B With 8 Bits/Symbol Less in Rev. Dir.

| Model | | Case No. | | | | | |
|---|---|---|---|---|---|---|---|
| Parameter(s) | Units | 29 | 30 | 31 | 32 | 33 | 34 |
| Local TX Level | (dB) | 0.00 | 0.00 | 0.00 | 0.00 | 0.00 | 0.00 |
| (fixed) | | | | | | | |
| Local TX Bits/ | | 0.00 | 0.00 | 0.00 | 0.00 | 0.00 | 0.00 |
| Symbol (determined) | | | | | | | |
| Channel Loss | (dB) | 84.00 | 87.00 | 90.00 | 93.00 | 96.00 | 99.00 |
| (variable) | | | | | | | |
| Remote RX | (dB) | −90.00 | −90.00 | −90.00 | −90.00 | −90.00 | −90.00 |
| Noise Floor | | | | | | | |
| Level (selected) | | | | | | | |
| Remote RX Level | (dB) | −84.00 | −87.00 | −90.00 | −93.00 | −96.00 | −99.00 |
| Remote TX Level | (dB) | −24.00 | −24.00 | −24.00 | −24.00 | −24.00 | −24.00 |
| (determined) | | | | | | | |
| Remote TX | | 8.00 | 8.00 | 8.00 | 8.00 | 8.00 | 8.00 |
| Bits/Symbol | | | | | | | |
| Less than Local | | | | | | | |
| TX Bits/Symbol | | | | | | | |
| (selected) | | | | | | | |
| Remote TX | | 0.00 | 0.00 | 0.00 | 0.00 | 0.00 | 0.00 |
| Bits/Symbol (net) | | | | | | | |
| Echo-Cancellation | (dB) | 60.00 | 60.00 | 60.00 | 60.00 | 60.00 | 60.00 |
| (selected) | | | | | | | |
| Remote RX | (dB) | −84.00 | −84.00 | −84.00 | −84.00 | −84.00 | −84.00 |
| Residual | | | | | | | |
| Echo Noise Level | | | | | | | |
| Remote RX | (dB) | −83.03 | −83.03 | −83.03 | −83.03 | −83.03 | −83.03 |
| Combined Noise | | | | | | | |
| Level | | | | | | | |
| Remote RX SNR | (dB) | −0.97 | −3.97 | −6.97 | −9.97 | −12.97 | −15.97 |
| Average | | 0.00 | 0.00 | 0.00 | 0.00 | 0.00 | 0.00 |
| Bits/Symbol | | | | | | | |

In FIGS. 34-39, terminology is introduced that identifies one direction of communication in pure ATDD and EP ECD as a forward (fwd) direction and one direction as a reverse (rev.) direction. FIGS. 34-39 graphically plot some of the data from Tables 1-5 to better illustrate the performance of some non-limiting embodiments of the present invention. For the purposes of the model of Tables 1-5 and FIGS. 34-39, the forward direction is the direction of communication (whether local-to-remote or remote-to-local) that generally has the higher bits per symbol while the reverse direction is the opposite direction of communication (whether remote-to-local or local-to-remote respectively) that generally has the lower bits per symbol. In the case of TDD/ATDD, the forward direction of communication is capable of communicating a positive number of bits per symbol, while the reverse direction of communication is not capable of communicating (i.e., the reverse direction communicates zero bits per symbol). This forward and reverse terminology is only used to establish an initial convention for purposes of explaining the model and is not intended to introduce any limitations on the preferred embodiments of the present invention. For the non-limiting purposes of Tables 1-5, the local-to-remote direction is considered to be the forward direction, and the remote-to-local direction is considered to be the reverse direction.

As previously explained one skilled in the art will be aware that the local and remote devices may behave symmetrically or asymmetrically in switching between the essentially non-overlapping intervals of time that correspond to the modes of TDD/ATDD and EP ECD. Thus, the model of Tables 1-5 and FIGS. 34-39 generally only describes the behavior of the local and remote devices during one mode of TDD/ATDD or one mode of EP ECD. In a non-limiting situation, the local device and the remote device may just exchange behaviors to act symmetrically in switching between modes of TDD/ATDD and in switching between modes of EP ECD. However, the preferred embodiments of the present invention are not limited to just a symmetric exchange of behaviors between the local device and the remote device in switching between modes of TDD/ATDD and in switching between modes of EP ECD.

For the model of Tables 1-5 and FIGS. 34-39, four non-limiting exemplary duplexing configurations were chosen with essentially pure ATDD and essentially pure ECD being the first two duplexing methods on which the model is applied. In the model of Tables 1-5 and FIGS. 34-39, the symbol rates are assumed to be equal in both the forward and reverse directions such that both the forward and reverse directions generally have equal spectral bandwidths. However, this model is only a non-limiting example to evaluate the performance of the concepts in the preferred embodiments of the present invention. The concepts of the preferred embodiments of the present invention also apply to communication systems with unequal symbol rates in the forward and reverse directions.

The data for essentially pure ATDD is shown in Tables 2a-2e, while the data for essentially pure ECD is shown in Tables 3a-3e. FIG. 34 is a graph comparing the results of the model for essentially pure ATDD and essentially pure ECD. Because ATDD generally allows only one direction of communication at a time, FIG. 34 also shows an average bit per symbol graph for ATDD. In ATDD one direction of communication is not capable of communicating (e.g., it is communicating at zero bits per symbol), while the other direction is capable communicating at greater than zero bits per symbol. Thus, the average bit per symbol of the local-to-remote and remote-to-local directions for ATDD will be equal to one-half of the bits per symbol in the communicating direction because the other direction is zero bits per symbol. For the non-limiting symmetric configuration of ECD in the model, the bits per symbol in the local-to-remote and the remote-to-local directions generally will be equal because the non-limiting configuration is assumed to be symmetric. In addition, the average bits per symbol of the two directions in the non-limiting pure ECD example of Tables 3a-3e also will be the same as the bits per symbol in one direction. The average of two equal numbers of bits per symbol is equal to the bits per symbol in the local-to-remote or remote-to-local directions, which are equal in a symmetric pure ECD configuration.

In FIG. 34, the bits per symbol of pure ATDD in the forward direction as compared to channel loss is shown by the top line, while the bits per symbol of pure ATDD in the reverse direction is shown along the X-axis as zero bits per symbol for any level of channel loss because ATDD is silent, not communicating, or communicating at zero bits per symbol in the reverse direction. In TDD/ATDD the forward direction bits per symbol generally is a maximum bits per symbol, while the reverse direction bits per symbol generally is a minimum. The average bits per symbol of the forward and reverse directions of pure ATDD also is shown in FIG. 34. In addition, FIG. 34 shows the average, minimum, and maximum bits per symbol, which are all the same for both the forward and reverse directions of a completely symmetric pure ECD duplexing implementation.

In comparing pure ATDD with pure ECD, FIG. 34 shows that the bits per symbol in the forward direction of pure ATDD is greater than the bits per symbol of pure ECD (in either direction) until the channel loss reaches a level that essentially halts all communication at around 77 dB. Also, FIG. 34 shows that the zero bits per symbol in the reverse direction of pure ATDD is less than the bits per symbol of pure ECD (in either direction) until the channel loss reaches a level that essentially halts all communication at around 77 dB. More interestingly, the average bits per symbol capabilities of pure ATDD and pure ECD are equal at a channel loss level of around 17 dB or 18 dB. As shown in FIG. 34, the average bits per symbol of pure ECD exceeds the average bits per symbol of pure ATDD for channel losses less than about 17 dB or 18 dB. Above 17 dB or 18 dB in channel loss, pure ATDD is able to encode more bits per symbol on average than pure ECD. This, indicates that pure ATDD (and possibly non-limiting choices of EP ECD closer to pure ATDD than pure ECD) performs better than pure ECD for transmission lines with higher channel losses, while pure ECD (and possibly non-limiting choices of EP ECD closer to pure ECD than pure ATDD) performs better than pure ATDD for transmission lines with lower channel losses. Thus, FIG. 34 indicates that the preferred selection of ATDD versus ECD will depend among other things on the channel characteristics including channel loss. Also, the symmetry/asymmetry of the data flow requirements in the local-to-remote and remote-to-local directions may affect the performance choice.

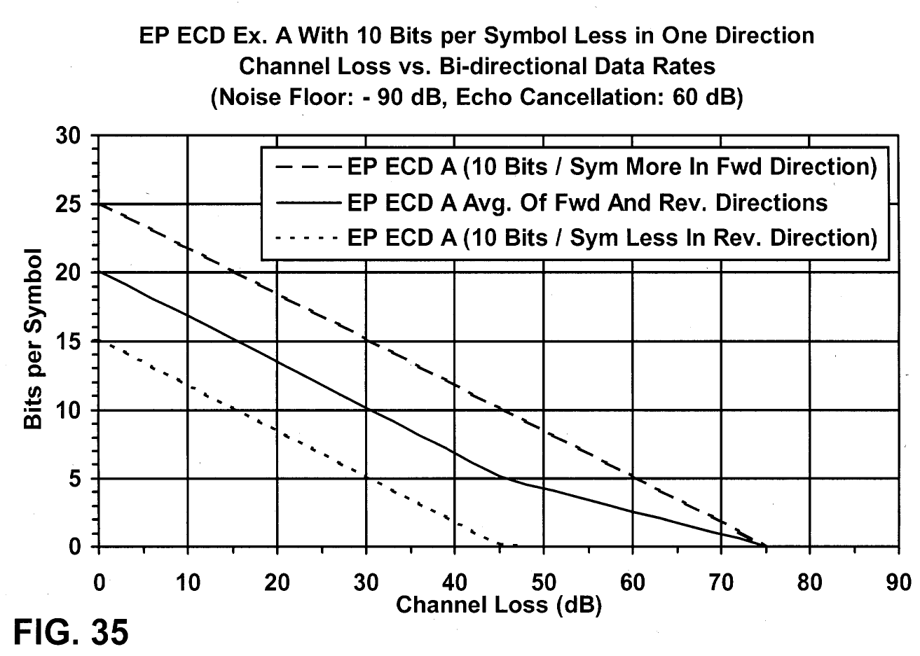

FIG. 35 and Tables 4a-4e show one non-limiting EP ECD configuration wherein the reverse direction of communication is encoding ten bits per symbol less than the forward direction of communication. This non-limiting example of EP ECD is only one possible configuration of many possible EP ECD configurations for the forward and reverse directions. In the preferred embodiments of the present invention, the remote device may behave during a second mode like the local device behaves during a first mode, while the local device may behave during a second mode like the remote device behaves during the first mode. Thus, the forward direction of FIG. 35 and Tables 4a-4e may indicate the behavior of the local device during the first mode and the remote device during the second mode. Also, the reverse direction of FIG. 35 and Tables 4a-4e may indicate the behavior of the remote device during the first mode and the local device during the second mode. However, the concepts of the present invention also apply when the local device and the remote device do not completely mimic each other's behavior in this way as a result of switching between the first mode and the second mode. By switching between the first mode and the second mode, the local-to-remote communication generally is capable of operating part of the time as the forward direction and part of the time as the reverse direction. Similarly, by switching between the first mode and the second mode, the remote-to-local communication generally is capable of operating part of the time as the reverse direction and part of the time as the forward direction.

For the model of Tables 1-5 and FIGS. 34-39, this non-limiting example of EP ECD with ten bits per symbol less in the reverse direction than in the forward direction is labeled as EP ECD A for non-limiting example A of EP ECD. Also, one skilled in the art will recognize that signal point constellations, which encode an integer number of bits (N), generally have a power of two (2^{N}) signal points in the constellation. The preferred embodiments of the present invention are not limited to constellations consisting of a power of two signal points that encode an integer number of bits in each transmission. As shown in FIG. 35, the reverse direction of communication in the non-limiting EP ECD A example communicates ten bits per symbol less than the forward direction of communication until the channel loss becomes so great that the reverse direction of communication reaches a floor of zero bits per symbol at around 45 dB. Even though the reverse direction of communication in EP ECD example A cuts out at around a channel loss of 45 dB, bi-directional communication between the local device and the remote device is still maintained by switching between the first mode and the second mode. Switching modes essentially changes the local-to-remote direction of communication between behaving as the forward direction and behaving as the reverse direction, while switching modes essentially changes the remote-to-local direction of communication between behaving as the reverse direction and behaving as the forward direction. Also, FIG. 35 shows the average bits per symbol of bi-directional communications for the forward and reverse directions. Generally, so long as channel loss is small enough that at least one direction (forward and/or reverse) of communication is possible, the average bits per symbol will be non-zero, and bi-directional communication may be maintained by switching or changing modes.

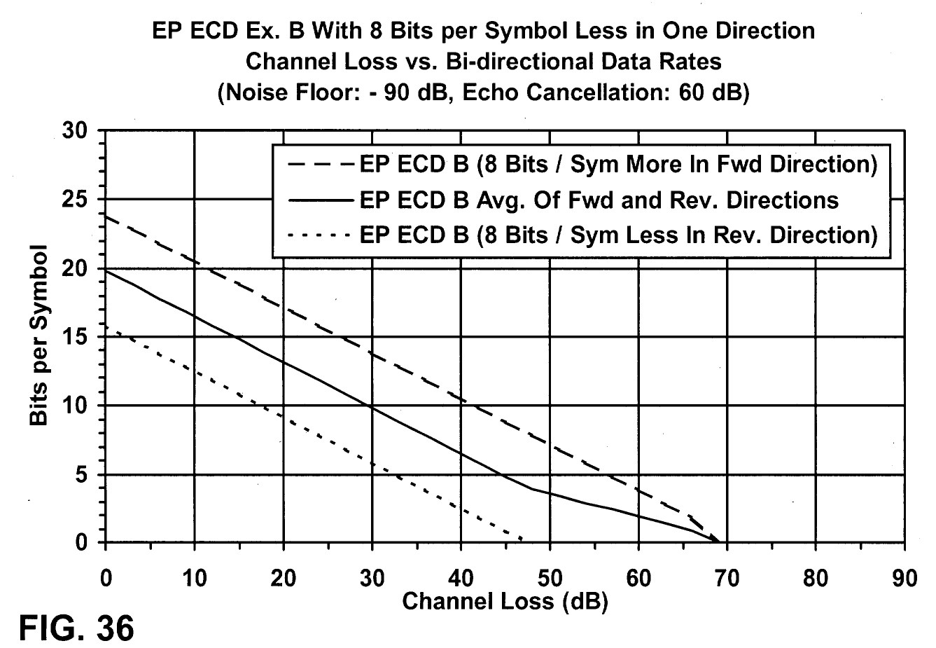

FIG. 36 shows another non-limiting EP ECD configuration wherein the reverse direction of communication is encoding eight bits per symbol less than the forward direction of communication. This non-limiting example of EP ECD is only one possible configuration of many possible EP ECD configurations for the forward and reverse directions, which further may be symmetric or asymmetric. For the model of Tables 1-5 and FIGS. 34-39, this non-limiting example of EP ECD with eight bits per symbol less in the reverse direction than in the forward direction is labeled as EP ECD B for non-limiting example B of EP ECD. Also, one skilled in the art will recognize that signal point constellations, which encode an integer number of bits (N), generally have a power of two (2^{N}) signal points in the constellation. The preferred embodiments of the present invention are not limited to constellations consisting of a power of two signal points that encode an integer number of bits in each transmission. As shown in FIG. 36, the reverse direction of communication in the non-limiting EP ECD B example communicates eight bits per symbol less than the forward direction of communication until the channel loss becomes so great that the reverse direction of communication reaches a floor of zero bits per symbol at around 68 dB. Even though the reverse direction of communication in EP ECD example B cuts out at around a channel loss of 68 dB, bi-directional communication between the local device and the remote device is still maintained by switching between the first mode and the second mode. Switching modes essentially changes the local-to-remote direction of communication between behaving as the forward direction and behaving as the reverse direction, while switching modes essentially changes the remote-to-local direction of communication between behaving as the reverse direction and behaving as the forward direction. Also, FIG. 36 shows the average bits per symbol of the of bi-directional communications for the forward and reverse directions. Generally, so long as channel loss is small enough that at least one direction (forward and/or reverse) of communication is possible, the average bits per symbol will be non-zero, and bi-directional communication may be maintained by switching or changing modes.

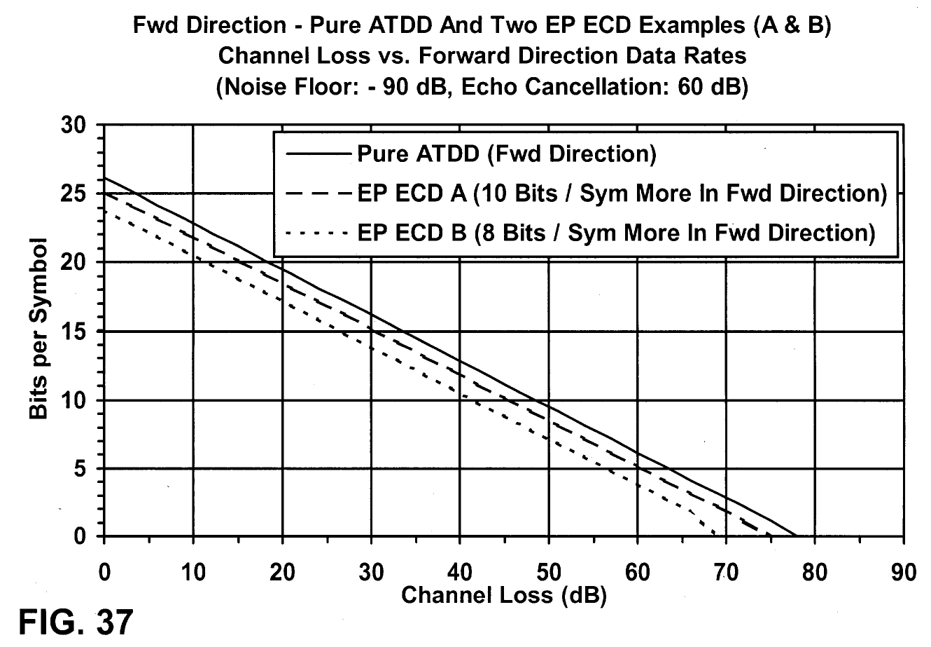

FIG. 37 compares the forward directions of pure ATDD with the forward directions of non-limiting EP ECD example A (at ten bits per symbol greater in the forward direction than in the reverse direction) and non-limiting EP ECD example B (at eight bits per symbol greater in the forward direction than in the reverse direction). As can be seen from FIG. 37, the forward direction of pure ATDD can encode about one additional bit per symbol than the forward direction of non-limiting EP ECD example A for any channel loss. Similarly, the forward direction of non-limiting EP ECD example A can encode about one additional bit per symbol than the forward direction of non-limiting EP ECD example B for any channel loss. Thus, in the forward direction pure ATDD performs slightly better than non-limiting EP ECD example A, which is slightly better than non-limiting EP ECD example B.

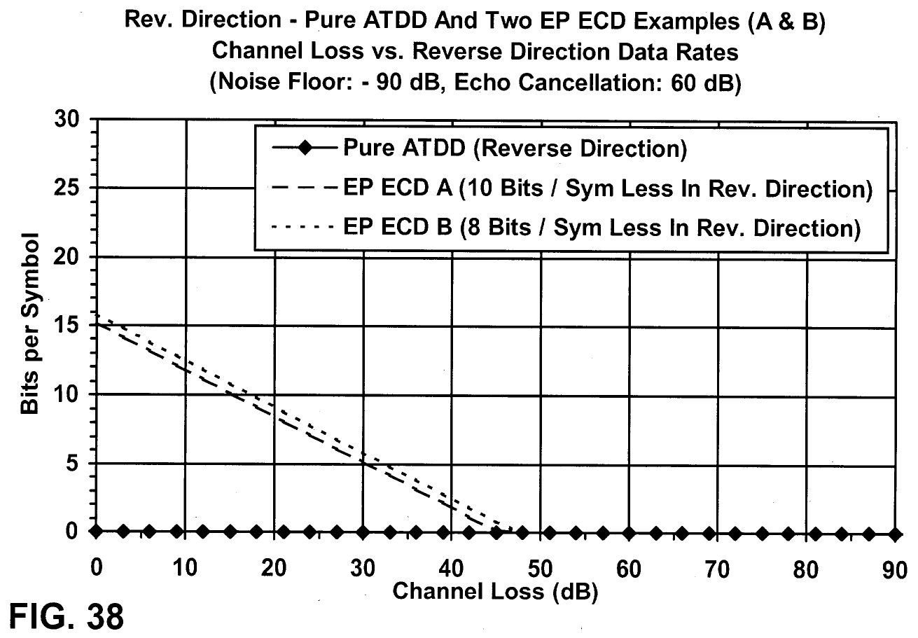

FIG. 38 compares the reverse directions of pure ATDD with the reverse directions of non-limiting EP ECD example A (at ten bits per symbol less in the reverse direction than in the forward direction) and non-limiting EP ECD example B (at eight bits per symbol less in the reverse direction than in the forward direction). As can be seen from FIG. 38, there is no communication in the reverse direction for pure ATDD such that the reverse direction of communication is zero bits per symbol. In contrast, the reverse direction of communication for non-limiting EP ECD example A communicates positive bits per symbol for channel losses less than about 45 dB. Also, the reverse direction of communication for non-limiting EP ECD example B communicates positive bits per symbol for channel losses less than about 45 dB. The reverse direction of communication for non-limiting EP ECD example B slightly outperforms the reverse direction of communication for non-limiting EP ECD example A for channel losses less than about 45 dB until communication is halted due to the high channel losses. In comparing FIGS. 37 and 38, one can see that EP ECD offers the advantage over pure ATDD by allowing some reverse direction of communication in exchange for only giving up a slight amount of forward direction communication in the number of bits per symbol.

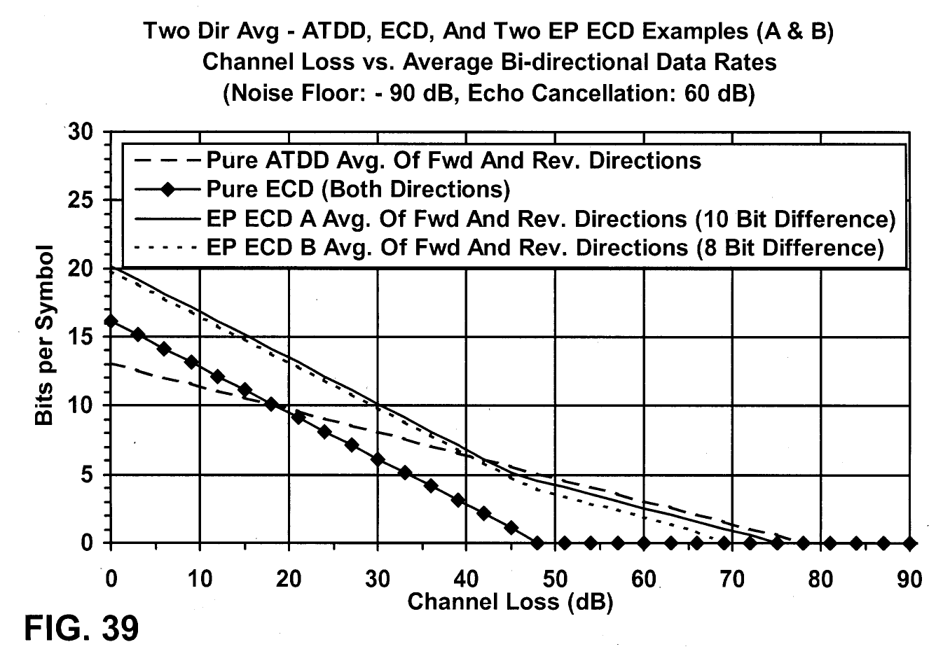

FIG. 39 compares the bi-directional average bits per symbol for the forward and reverse directions of pure ATDD, pure ECD, non-limiting EP ECD example A, and non-limiting EP ECD example B. The comparison of the bi-directional average bits per symbol of pure ATDD and pure ECD is the same as was described in FIG. 34 with the bi-directional average number of bits per symbol of pure ATDD outperforming pure ECD for channel losses greater than about 17 dB or 18 dB. At channel losses of less than about 17 dB or 18 dB, the bi-directional average number of bits per symbol of pure ECD outperforms pure ATDD. However, comparing both non-limiting EP ECD example A and non-limiting EP ECD example B with pure ECD, FIG. 39 shows that both non-limiting EP ECD example A and non-limiting EP ECD example B significantly outperform pure ECD in the bi-directional average number of bits per symbol over the entire range of channel losses in the graph. Furthermore, both non-limiting EP ECD example A and non-limiting EP ECD example B outperform pure ATDD in the bi-directional average number of bits per symbol until channel loss reaches about 42 dB or 43 dB. Moreover, at channel losses greater than about 42 dB or 43 dB, both non-limiting EP ECD example A and non-limiting EP ECD example B perform fairly close to pure ATDD.

Therefore, FIG. 34 shows a potential tradeoff between pure ATDD and pure ECD. FIGS. 35 and 36 show two non-limiting example choices for EP ECD, though one skilled in the art will realize that many other selections could have been made in choosing non-limiting EP ECD examples. FIG. 37 shows that EP ECD generally gives up a little performance in the forward direction relative to pure ATDD, while FIG. 38 shows that EP ECD generally gains a significant amount of performance in the reverse direction relative to pure ATDD. Finally, FIG. 39 shows that there is a tradeoff, which depends on the channel loss of the transmission medium, between pure ECD and pure ATDD as to which duplexing strategy works better for improving the bi-directional average bits per symbol communicated. Furthermore, FIG. 39 shows that EP ECD significantly predominates over pure ECD for the bi-directional average bits per symbol. Also, FIG. 39 shows that the bi-directional average bits per symbol of EP ECD generally is better than pure ATDD on transmission media with relatively lower channel losses, and that EP ECD comes close to pure ATDD on transmission media with relatively higher channel losses.

Thus, FIGS. 37-39 provide some intuition on how communication devices could select a duplexing strategy or methodology to maximize the performance of the communications system in response to communication channel or transmission media characteristics or parameters. The transmission media parameters could be determined by the devices themselves during initial media testing or through other means such as, but not limited to, external test equipment and/or engineering calculations. Given the parameters and/or characteristics of the transmission medium and/or also given expectations about the communication traffic characteristics such as, but not limited to, throughput, delay, and the symmetrical or asymmetrical nature of the traffic, the local and remote devices can select the most appropriate duplexing strategy for the most efficient communication.

It should be emphasized that the above-described preferred embodiments of the present invention, particularly, any “preferred” preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and are to be protected by the following claims.

Therefore, having thus described the invention, at least the following is claimed:

1. A method, comprising the steps of:
transmitting a first information-bearing signal on a communications medium, the transmitting occurring in the presence of a received, second information-bearing signal that substantially frequency overlaps the first information-bearing signal;
changing a first plurality of times among at least two different modes;
during each mode, encoding information on the first information-bearing signal at a first non-zero information rate; and
during each mode, causing the first information-bearing signal to exhibit a first non-zero signal level.

2. The method of claim 1, wherein the first non-zero information rate changes at least based upon each change among the at least two different modes of the step of changing the first plurality of times.

3. The method of claim 1, wherein the first non-zero signal level changes at least based upon each change among the at least two different modes of the step of changing the first plurality of times.

4. The method of claim 1, wherein each change among the at least two different modes of the step of changing the first plurality of times occurs without substantial delay.

5. The method of claim 4, wherein substantial delay results from performing a task that significantly delays communicating beyond an amount of time needed to change at least one communication parameter.

6. The method of claim 5, wherein the task that significantly delays communicating is a training task performed on the communications medium.

7. The method of claim 1, wherein the communications medium comprises a subscriber loop.

8. The method of claim 1, wherein the communications medium comprises a telephone communications system.

9. The method of claim 1, wherein the communications medium carries electromagnetic waves.

10. The method of claim 9, wherein the electromagnetic waves are optical.

11. The method of claim 9, wherein the electromagnetic waves are infrared.

12. The method of claim 9, wherein the electromagnetic waves are radio.

13. The method of claim 1, wherein the communications medium comprises carries audio waves.

14. The method of claim 13, wherein the audio waves are carried in air.

15. The method of claim 13, wherein the audio waves are carried in water.

16. The method of claim 1, wherein the at least two different modes are substantially non-overlapping intervals of time and comprise a first mode and a second mode, and wherein the step of changing the first plurality of times among the at least two different modes further comprises the step of changing the first plurality of times between the first mode and the second mode.

17. The method of claim 16, wherein the first mode and the second mode are of equal durations.

18. The method of claim 16, wherein the first mode and the second mode are of unequal durations.

19. The method of claim 16, wherein the first mode and the second mode are of changing durations.

20. The method of claim 16, wherein the first mode and the second mode are of a duration of at least two bit times.

21. The method of claim 16, wherein the first mode provides for a first channel capable of carrying constant bit rate traffic and provides for a second channel capable of carrying variable bit rate traffic.

22. The method of claim 21, wherein the second mode provides for the first channel capable of carrying constant bit rate traffic and does not provide for the second channel capable of carrying variable bit rate traffic.

23. The method of claim 21, wherein the first channel is lower latency and the second channel is higher latency.

24. The method of claim 16, further comprising the step of:
receiving the second information-bearing signal from the communications medium during at least one of the first mode and the second mode, the second information-bearing signal being affected by echo from the transmitting of the first information-bearing signal, wherein the second information-bearing signal encodes information at a second non-zero information rate during at least one of the first mode and the second mode.

25. The method of claim 24, wherein the second non-zero information rate changes at least based upon each change among the at least two different modes of the step of changing the first plurality of times.

26. The method of claim 24, wherein the second non-zero signal level changes at least based upon each change among the at least two different modes of the step of changing the first plurality of times.

27. The method of claim 24, further comprising the step of:
performing echo cancellation during at least one of the first mode and the second mode to improve performance of the receiving of the second information-bearing signal during at least one of the first mode and the second mode.

28. The method of claim 24, wherein the transmitting of the first information-bearing signal is performed by a local device, and wherein the second information-bearing signal was transmitted from a first remote device.

29. The method of claim 28, wherein the local device behaves in the first mode as the first remote device behaves in the second mode.

30. The method of claim 28, wherein the local device behaves in the second mode as the first remote device behaves in the first mode.

31. The method of claim 28, wherein the first information-bearing signal is transmitted from the local device during the first mode at a first local-to-first-remote symbol rate, wherein the second information-bearing signal is transmitted from the first remote device during the first mode at a first first-remote-to-local symbol rate.

32. The method of claim 31, wherein the first local-to-first-remote symbol rate is equal to the first first-remote-to-local symbol rate.

33. The method of claim 31, wherein the first local-to-first-remote symbol rate is not equal to the first first-remote-to-local symbol rate.

34. The method of claim 28, wherein the first information-bearing signal is transmitted from the local device during the second mode at a second local-to-first-remote symbol rate, wherein the second information-bearing signal is transmitted from the first remote device during the second mode at a second first-remote-to-local symbol rate.

35. The method of claim 34, wherein the second local-to-first-remote symbol rate is equal to the second first-remote-to-local symbol rate.

36. The method of claim 34, wherein the second local-to-first-remote symbol rate is not equal to the second first-remote-to-local symbol rate.

37. The method of claim 16, wherein the transmitting of the first information-bearing signal is performed by a local device, and wherein the second information-bearing signal was transmitted from a first remote device.

38. The method of claim 37, wherein L2R S₁ is a signal level of the first information-bearing signal from the local device during the first mode, wherein L2R S₂ is a signal level of the first information-bearing signal from the local device during the second mode, wherein R2L S₁ is a signal level of the second information-bearing signal from the first remote device during the first mode, wherein R2L S₂ is a signal level of the second information-bearing signal from the first remote device during the second mode, and wherein the signal levels of the first and second modes of the local and the first remote devices are related by the inequality of: L2R S₁×R2L S₂>L2R S₂×R2L S₁.

39. The method of claim 38, wherein the inequality of: L2R S₁×R2L S₂>L2R S₂×R2L S₁ is met by at least one change in at least one signal space of at least one of the local and the first remote devices in changing between the first mode and the second mode.

40. The method of claim 39, wherein each signal space is associated with a number of signal points, and wherein the at least one change in the at least one signal space involves at least one change in the number of signal points in each of the at least one signal space.

41. The method of claim 39, wherein each signal space is associated with a set of at least one pair of adjacent signal points, wherein each pair of adjacent signal points further is associated with a distance, and wherein the at least one change in the at least one signal space involves at least one change in the distance between at least one pair of adjacent signal points.

42. The method of claim 41, wherein the at least one change in the distance between at least one pair of adjacent signal points is at least partially offset by at least one change in error control coding in changing between the first mode and the second mode.

43. The method of claim 37, wherein each signal space is associated with a plurality of signal points and associated with a mapping of information to the plurality of signal points, wherein the inequality of: L2R S₁×R2L S₁>L2R S₂×R2L S₁ is met by at least one change in a first mapping of information to first signal points without a change in an associated first signal space in changing between the first mode and the second mode.

44. The method of claim 37, wherein the step of changing the first plurality of times among the at least two different modes is performed dynamically based at least upon at least one of a local device data transmission demand and a first remote device data transmission demand.

45. The method of claim 44, wherein the local device data transmission demand increases responsive to increases in an amount of local data queued in the local device to be transmitted into the communications medium, and wherein the local device data transmission demand decreases responsive to decreases in the amount of local data queued in the local device to be transmitted into the communications medium.

46. The method of claim 44, wherein the first remote device data transmission demand increases responsive to increases in an amount of first remote data queued in the first remote device to be transmitted into the communications medium, and wherein the first remote device data transmission demand decreases responsive to decreases in the amount of first remote data queued in the first remote device to be transmitted into the communications medium.

47. The method of claim 1, wherein ATM data is carried on the first information-bearing signal during at least one of the at least two different modes.

48. The method of claim 1, wherein IP data is carried on the first information-bearing signal during at least one of the at least two different modes.

49. The method of claim 1, wherein the step of transmitting the first information-bearing signal, the step of changing the first plurality of times, the step of encoding information on the first information-bearing signal, and the step of causing the first information-bearing signal to exhibit are performed by a local device during a first manner of operation in communicating with a first remote device.

50. The method of claim 49, further comprising the steps performed by the local device of:
changing between the first manner of operation and a second manner of operation, the second manner of operation being a substantially non-overlapping interval of time with the first manner of operation; and
communicating with the first remote device using time division duplexing (TDD) during the second manner of operation.

51. The method of claim 50, wherein the time division duplexing (TDD) is adaptive time division duplexing (ATDD).

52. The method of claim 49, further comprising the steps performed by the local device of:
changing between the first manner of operation and a third manner of operation, the third manner of operation being a substantially non-overlapping interval of time with the first manner of operation; and
communicating with the first remote device using echo cancelled duplexing (ECD) during the third manner of operation.

53. The method of claim 49, wherein the at least two different modes are at least two different first-manner-of-operation modes and wherein each mode of the at least two different first-manner-of-operation modes is a first-manner-of-operation mode.

54. The method of claim 53, further comprising the steps performed by the local device of:
changing between the first manner of operation and a fourth manner of operation, the fourth manner of operation being a substantially non-overlapping interval of time with the first manner of operation; and
communicating with a second remote device during the fourth manner of operation by performing the steps further comprising:
transmitting a third information-bearing signal on the communications medium, the transmitting occurring in the presence of a received, fourth information-bearing signal that substantially frequency overlaps the third information-bearing signal;
changing a second plurality of times among at least two different fourth-manner-of-operation modes;
during each fourth-manner-of-operation mode, encoding information on the third information-bearing signal at a third non-zero information rate; and
during each fourth-manner-of-operation mode, causing the third information-bearing signal to exhibit a third non-zero signal level.

55. The method of claim 54, wherein the third non-zero information rate changes at least based upon each change among the at least two different fourth-manner-of-operation modes of the step of changing the second plurality of times.

56. The method of claim 54, wherein the third non-zero signal level changes at least based upon each change among the at least two different fourth-manner-of-operation modes of the step of changing the second plurality of times.

57. The method of claim 54, wherein the first information-bearing signal, the second information-bearing signal, the third information-bearing signal, and the fourth information-bearing signal all substantially overlap each other in frequency.

58. The method of claim 49, further comprising the steps performed by the local device of:
changing between the first manner of operation and a fifth manner of operation, the fifth manner of operation being a substantially non-overlapping interval of time with the first manner of operation; and
communicating with a second remote device using time division duplexing (TDD) during the fifth manner of operation.

59. The method of claim 58, wherein the time division duplexing (TDD) is adaptive time division duplexing (ATDD).

60. The method of claim 49, further comprising the steps performed by the local device of:
changing between the first manner of operation and a sixth manner of operation, the sixth manner of operation being a substantially non-overlapping interval of time with the first manner of operation; and
communicating with a second remote device using echo cancelled duplexing (ECD) during the sixth manner of operation.

61. The method of claim 49, further comprising the step of testing the communications medium to determine an efficient duplexing configuration from among: the first manner of operation, a second manner of operation involving time-division duplexing (TDD), and a third manner of operation involving echo cancelled duplexing (ECD).

62. The method of claim 1, wherein the first information-bearing signal encodes information using at least one modulation type selected from the group consisting of: carrierless amplitude phase (CAP) modulation, quadrature amplitude modulation (QAM), pulse amplitude modulation (PAM), discrete multi-tone (DMT) modulation, frequency-shift keying (FSK) modulation, and optical modulation.

63. The method of claim 1, further comprising the step of: during at least one first mode of the at least two different modes, communicating first information regarding a first information rate at which the step of transmitting the first information-bearing signal is occurring.

64. The method of claim 63, further comprising the step of: during the at least one first mode of the at least two different modes, communicating second information regarding a second information rate at which the second information-bearing signal is capable of being received during at least one second mode of the at least two different modes.

65. The method of claim 64, further comprising the step of: changing at least one of the first information rate and the second information rate seamlessly and without error by using at least one of the first information and the second information.

66. A communication apparatus comprising:
means for transmitting a first information-bearing signal on a communications medium, the transmitting occurring in the presence of a received, second information-bearing signal that substantially frequency overlaps the first information-bearing signal; and
means for changing a first plurality of times among at least two different modes, wherein during each mode, information is encoded on the first information-bearing signal at a first non-zero information rate, and wherein during each mode, the first information-bearing signal exhibits a first non-zero signal level.

67. The communication apparatus of claim 66, wherein the first non-zero information rate changes at least based upon each change among the at least two different modes of the means for changing the first plurality of times.

68. The communication apparatus of claim 66, wherein the first non-zero signal level changes at least based upon each change among the at least two different modes of the means for changing the first plurality of times.

69. The communication apparatus of claim 66, wherein each change among the at least two different modes of the means for changing the first plurality of times occurs without substantial delay.

70. The communication apparatus of claim 69, wherein substantial delay results from performing a task that significantly delays communicating beyond an amount of time needed to change at least one communication parameter.

71. The communication apparatus of claim 70, wherein the task that significantly delays communicating is a training task performed on the communications medium.

72. The communication apparatus of claim 66, wherein the communications medium comprises a subscriber loop.

73. The communication apparatus of claim 66, wherein the communications medium comprises a telephone communications system.

74. The communication apparatus of claim 66, wherein the communications medium carries electromagnetic waves.

75. The communication apparatus of claim 74, wherein the electromagnetic waves are optical.

76. The communication apparatus of claim 74, wherein the electromagnetic waves are infrared.

77. The communication apparatus of claim 74, wherein the electromagnetic waves are radio.

78. The communication apparatus of claim 66, wherein the communications medium comprises carries audio waves.

79. The communication apparatus of claim 78, wherein the audio waves are carried in air.

80. The communication apparatus of claim 78, wherein the audio waves are carried in water.

81. The communication apparatus of claim 66, wherein the at least two different modes are substantially non-overlapping intervals of time and comprise a first mode and a second mode, and wherein the means for changing the first plurality of times among the at least two different modes further comprises a means for changing the first plurality of times between the first mode and the second mode.

82. The communication apparatus of claim 81, wherein the first mode and the second mode are of equal durations.

83. The communication apparatus of claim 81, wherein the first mode and the second mode are of unequal durations.

84. The communication apparatus of claim 81, wherein the first mode and the second mode are of changing durations.

85. The communication apparatus of claim 81, wherein the first mode and the second mode are of a duration of at least two bit times.

86. The communication apparatus of claim 81, wherein the first mode provides for a first channel capable of carrying constant bit rate traffic and provides for a second channel capable of carrying variable bit rate traffic.

87. The communication apparatus of claim 86, wherein the second mode provides for the first channel capable of carrying constant bit rate traffic and does not provide for the second channel capable of carrying variable bit rate traffic.

88. The communication apparatus of claim 86, wherein the first channel is lower latency and the second channel is higher latency.

89. The communication apparatus of claim 81, further comprising:
means for receiving the second information-bearing signal from the communications medium during at least one of the first mode and the second mode, the second information-bearing signal being affected by echo from the transmitting of the first information-bearing signal, wherein the second information-bearing signal encodes information at a second non-zero information rate during at least one of the first mode and the second mode.

90. The communication apparatus of claim 89, wherein the second non-zero information rate changes at least based upon each change among the at least two different modes of means for changing the first plurality of times.

91. The communication apparatus of claim 89, wherein the second non-zero signal level changes at least based upon each change among the at least two different modes of the means for changing the first plurality of times.

92. The communication apparatus of claim 89, further comprising:
means for performing echo cancellation during at least one of the first mode and the second mode to improve performance of the means for receiving of the second information-bearing signal during at least one of the first mode and the second mode.

93. The communication apparatus of claim 89, wherein the means for transmitting of the first information-bearing signal is at least part of a local device, and wherein the second information-bearing signal was transmitted from a first remote device.

94. The communication apparatus of claim 93, wherein the local device behaves in the first mode as the first remote device behaves in the second mode.

95. The communication apparatus of claim 93, wherein the local device behaves in the second mode as the first remote device behaves in the first mode.

96. The communication apparatus of claim 93, wherein the first information-bearing signal is transmitted from the local device during the first mode at a first local-to-first-remote symbol rate, wherein the second information-bearing signal is transmitted from the first remote device during the first mode at a first first-remote-to-local symbol rate.

97. The communication apparatus of claim 96, wherein the first local-to-first-remote symbol rate is equal to the first first-remote-to-local symbol rate.

98. The communication apparatus of claim 96, wherein the first local-to-first-remote symbol rate is not equal to the first first-remote-to-local symbol rate.

99. The communication apparatus of claim 93, wherein the first information-bearing signal is transmitted from the local device during the second mode at a second local-to-first-remote symbol rate, wherein the second information-bearing signal is transmitted from the first remote device during the second mode at a second first-remote-to-local symbol rate.

100. The communication apparatus of claim 99, wherein the second local-to-first-remote symbol rate is equal to the second first-remote-to-local symbol rate.

101. The communication apparatus of claim 99, wherein the second local-to-first-remote symbol rate is not equal to the second first-remote-to-local symbol rate.

102. The communication apparatus of claim 81, wherein the means for transmitting of the first information-bearing signal is at least part of a local device, and wherein the second information-bearing signal was transmitted from a first remote device.

103. The communication apparatus of claim 102, wherein L2R S₁ is a signal level of the first information-bearing signal from the local device during the first mode, wherein L2R S₂ is a signal level of the first information-bearing signal from the local device during the second mode, wherein R2L SI is a signal level of the second information-bearing signal from the first remote device during the first mode, wherein R2L S₂ is a signal level of the second information-bearing signal from the first remote device during the second mode, and wherein the signal levels of the first and second modes of the local and the first remote devices are related by the inequality of: L2R S₁×R2L S₂>L2R S₂×R2L S₁.

104. The communication apparatus of claim 103, wherein the inequality of:
L2R S₁×R2L S₂>L2R S₂×R2L S₁ is met by at least one change in at least one signal space of at least one of the local and the first remote devices responsive to the means for changing the first plurality of times changing at least once between the first mode and the second mode.

105. The communication apparatus of claim 104, wherein each signal space is associated with a number of signal points, and wherein the at least one change in the at least one signal space involves at least one change in the number of signal points in each of the at least one signal space.

106. The communication apparatus of claim 104, wherein each signal space is associated with a set of at least one pair of adjacent signal points, wherein each pair of adjacent signal points further is associated with a distance, and wherein the at least one change in the at least one signal space involves at least one change in the distance between at least one pair of adjacent signal points.

107. The communication apparatus of claim 106, wherein the at least one change in the distance between at least one pair of adjacent signal points is at least partially offset by at least one change in error control coding responsive to the means for changing the first plurality of times changing at least once between the first mode and the second mode.

108. The communication apparatus of claim 102, wherein each signal space is associated with a plurality of signal points and associated with a mapping of information to the plurality of signal points, wherein the inequality of: L2R S₁×R2L S₂>L2R S₂×R2L S₁ is met by at least one change in a first mapping of information to first signal points without a change in an associated first signal space responsive to the means for changing the first plurality of times changing at least once between the first mode and the second mode.

109. The communication apparatus of claim 102, wherein the means for changing the first plurality of times among the at least two different modes performs dynamically based at least upon at least one of a local device data transmission demand and a first remote device data transmission demand.

110. The communication apparatus of claim 109, wherein the local device data transmission demand increases responsive to increases in an amount of local data queued in the local device to be transmitted into the communications medium, and wherein the local device data transmission demand decreases responsive to decreases in the amount of local data queued in the local device to be transmitted into the communications medium.

111. The communication apparatus of claim 109, wherein the first remote device data transmission demand increases responsive to increases in an amount of first remote data queued in the first remote device to be transmitted into the communications medium, and wherein the first remote device data transmission demand decreases responsive to decreases in the amount of first remote data queued in the first remote device to be transmitted into the communications medium.

112. The communication apparatus of claim 66, wherein ATM data is carried on the first information-bearing signal during at least one of the at least two different modes.

113. The communication apparatus of claim 66, wherein IP data is carried on the first information-bearing signal during at least one of the at least two different modes.

114. The communication apparatus of claim 66, wherein the means for transmitting the first information-bearing signal and the means for changing the first plurality of times are at least part of a local device and operate during a first manner of operation in communicating with a first remote device.

115. The communication apparatus of claim 114, further comprising:
means for changing between the first manner of operation and a second manner of operation, the second manner of operation being a substantially non-overlapping interval of time with the first manner of operation; and
means for communicating with the first remote device using time division duplexing (TDD) during the second manner of operation.

116. The communication apparatus of claim 115, wherein the time division duplexing (TDD) is adaptive time division duplexing (ATDD).

117. The communication apparatus of claim 114, further comprising:
means for changing between the first manner of operation and a third manner of operation, the third manner of operation being a substantially non-overlapping interval of time with the first manner of operation; and
means for communicating with the first remote device using echo cancelled duplexing (ECD) during the third manner of operation.

118. The communication apparatus of claim 114, wherein the at least two different modes are at least two different first-manner-of-operation modes and wherein each mode of the at least two different first-manner-of-operation modes is a first-manner-of-operation mode.

119. The communication apparatus of claim 118, further comprising:
means for changing between the first manner of operation and a fourth manner of operation, the fourth manner of operation being a substantially non-overlapping interval of time with the first manner of operation; and
means for communicating with a second remote device during the fourth manner of operation, the means for communicating further comprising:
means for transmitting a third information-bearing signal on the communications medium, the means for transmitting the third information-bearing signal operating in the presence of a received, fourth information-bearing signal that substantially frequency overlaps the third information-bearing signal; and
means for changing a second plurality of times among at least two different fourth-manner-of-operation modes, wherein during each fourth-manner-of-operation mode, information is encoded on the third information-bearing signal at a third non-zero information rate, and wherein during each fourth-manner-of-operation mode, the third information-bearing signal exhibits a third non-zero signal level.

120. The communication apparatus of claim 119, wherein the third non-zero information rate changes at least based upon each change among the at least two different fourth-manner-of-operation modes of the means for changing the second plurality of times.

121. The communication apparatus of claim 119, wherein the third non-zero signal level changes at least based upon each change among the at least two different fourth-manner-of-operation modes of the means for changing the second plurality of times.

122. The communication apparatus of claim 119, wherein the first information-bearing signal, the second information-bearing signal, the third information-bearing signal, and the fourth information-bearing signal all substantially overlap each other in frequency.

123. The communication apparatus of claim 114, further comprising:
means for changing between the first manner of operation and a fifth manner of operation, the fifth manner of operation being a substantially non-overlapping interval of time with the first manner of operation; and
means for communicating with a second remote device using time division duplexing (TDD) during the fifth manner of operation.

124. The communication apparatus of claim 123, wherein the time division duplexing (TDD) is adaptive time division duplexing (ATDD).

125. The communication apparatus of claim 114, further comprising:
means for changing between the first manner of operation and a sixth manner of operation, the sixth manner of operation being a substantially non-overlapping interval of time with the first manner of operation; and
means for communicating with a second remote device using echo cancelled duplexing (ECD) during the sixth manner of operation.

126. The communication apparatus of claim 114, further comprising means for testing the communications medium to determine an efficient duplexing configuration from among: the first manner of operation, a second manner of operation involving time-division duplexing (TDD), and a third manner of operation involving echo cancelled duplexing (ECD).

127. The communication apparatus of claim 66, wherein the first information-bearing signal encodes information using at least one modulation type selected from the group consisting of: carrierless amplitude phase (CAP) modulation, quadrature amplitude modulation (QAM), pulse amplitude modulation (PAM), discrete multi-tone (DMT) modulation, frequency-shift keying (FSK) modulation, and optical modulation.

128. The communication apparatus of claim 66, further comprising means for communicating first information regarding a first information rate at which the means for transmitting the first information-bearing signal is operating, the means for communicating the first information operating during at least one first mode of the at least two different modes.

129. The communication apparatus of claim 128, further comprising means for communicating second information regarding a second information rate at which the second information-bearing signal is capable of being received during at least one second mode of the at least two different modes.

130. The communication apparatus of claim 129, further comprising means for: changing at least one of the first information rate and the second information rate seamlessly and without error by using at least one of the first information and the second information.
